(19) United States
(12) Patent Application Publication
(10) Pub. No.: US 2007/0112523 A1
(43) Pub. Date: May 17, 2007

(54) Ligands for 17i as modulators of orthopox viruses and methods for discovery thereof

(75) Inventors: Adnan M. M. Mjalli, Oak Ridge, NC (US); Mohan Rao, Greensboro, NC (US); Murty N. Arimilli, Oak Ridge, NC (US); Robert C. Andrews, Jamestown, NC (US); Robert Rothlein, Summerfield, NC (US)

Correspondence Address: KILPATRICK STOCKTON LLP - 41305;CHARLES CALKINS, 1001 WEST FOURTH STREET, WINSTON-SALEM, NC, 27101, US

(73) Assignee: TransTech Phama,Inc.

(21) Appl. No.: 10/581,840

(22) PCT Filed: Dec. 10, 2004
(86) PCT No.: PCT/US04/41329

§ 371 Date: Jun. 5, 2006

Related U.S. Application Data
(60) Provisional application No. 60/529,384, filed on Dec. 12, 2003.

(51) Int. Cl. G06F 19/00

(52) U.S. Cl. 702/19

(57) ABSTRACT

Disclosed are structural coordinates that define the three-dimensional (3D) structure of I7L proteinase and methods by which the coordinates may be used to develop compounds that bind to, and/or modulate, I7L. The technology described herein may be applied to the development of antiviral compounds that target I7L, or may be used to develop target compound that may bind to, and/or modify the catalytic activity of, other proteins.

### RELATED APPLICATIONS

This patent application claims priority to provisional patent application Ser. No. 60/529,384, filed Dec. 12, 2003. The disclosure of provisional patent application Ser. No. 60/529,384 is hereby incorporated by reference in its entirety.

### FIELD OF INVENTION

The present invention relates to methods of discovery. The methods may be advantageous for discovering compounds that alter a biological activity of a molecule of interest. The present invention also provides anti-viral compounds that may be identified using such methods.

### BACKGROUND

Viruses are obligatory intracellular parasites that can take over host cell transcription and translation to produce new viral particles. Interception of viral-driven transcription or translation, including both pre- and post-translation events, may result in crippling of the virus.

Smallpox, a member of the orthopox family of viruses, has recently resurfaced as a public heath concern. Until the last several years, the production of vaccines and therapeutics to combat smallpox was not considered necessary, as the last known case of smallpox was reported in 1977 in Somalia. In fact, universal vaccination in the United States was discontinued in 1972, since the risk of complications from the vaccine was actually greater than the risk of being infected with the disease. As a result, a portion of the population has never been vaccinated and thus, may be susceptible to infection by newly emerging strains of smallpox and other orthopox viruses.

Small molecule chemotherapy may be an alternative to vaccination for the prevention and/or treatment of orthopox viruses. For example, since the discovery of non-nucleoside reverse transcriptase inhibitors (NNRTIs), and protease inhibitors (PIs), several classes of organic molecules have been designed to combat viral infections by inhibiting targets responsible for viral replication and morphogenesis. Due to the highly homologous nature of the orthopox family, therapeutics developed against smallpox may also be potential candidate therapies for related viruses such as monkeypox, a virus that recently reemerged in Africa and spread to the United States by importation of exotic animals, and mulluscipox virus, a common cutaneous infection that may be problematic in immunocompromised individuals.

To date, no small molecule antiviral drug has proven to be effective in the treatment of smallpox. The only antiviral agent currently approved for use against orthopoxviruses is cidofovir, a DNA polymerase inhibitor that may be used to treat cytomegalovirus and other herpes viruses. However, the usefulness of cidofovir may be limited in that the drug exhibits low bio-availability when administered orally, and thus, must be administered intravenously (Cundy, K. C., 1999, Clin. Pharmacokinet., 36:127-143).

Because proteolysis catalyzed by viral-encoded proteases can be a necessary step in the development cycle of most viruses, protease inhibitors may provide another class of drugs that act as anti-viral agents. For example, protease inhibitors have proven to be effective against human immunodeficiency virus (HIV), influenza, hepatitis C, and rhinovirus enzymes.

During replication of vaccinia virus (VV), a prototypic member of the orthopox family, two types of proteolytic processing occur: formative and morphogenic. I7L is a protease involved in the maturation of the core protein of the orthopoxvirus virion. I7L appears to be involved in an obligatory morphogenic cleavage of three major structural proteins found in the mature VV virion: 4a, 4b, and 25K. I7L protease is a 47 kDa cysteine protease that contains putative catalytic histidine and cysteine residues embedded in a conserved region containing an aspartic acid residue. The gene for I7L appears to be highly conserved among poxviruses, as the identity among I7L genes between variola virus and vaccinia virus is 99%, and I7L genes from all orthopox viruses also appear to possess a large degree of homology. The importance of I7L has been underscored in studies with temperature-sensitive (ts) viruses in which the I7L gene has been shown to be essential for viral replication using a conditional lethal mutant, ts16, that maps to this locus (Byrd, C. M., et al., Virology, 2003, 77:11279-11283; Byrd, C. M., et al., Virology, 2002, 76:8973-8976).

The resurgence of smallpox virus, and the threat of the use of smallpox virus as a weapon of biological warfare, has resulted in smallpox and other orthopox viruses reemerging as important public health concerns. The identification of agents that can either treat the symptoms caused by orthopoxviruses, or halt the spread of these viruses is of paramount importance. Thus, what is needed are methods for the development of agents that may be used to target orthopoxviruses, such as smallpox. Such methods should allow for the rapid evaluation of large numbers of compounds such that the most effective compounds can be rapidly identified. In addition, such methods may provide a library of putative anti-viral agents. Such anti-viral agents may reduce or remove the threat of the virus as a weapon, and may act as a strong deterrent to those attempting to develop pox viruses as biological weapons.

### SUMMARY

The present invention relates to methods of discovery that may be embodied in a variety of ways. In an embodiment, the methods are useful for discovering compounds that alter a biological activity of a compound of interest. The present also relates to these types of compound.

In one embodiment, the invention may comprise a method for identifying a compound having the ability to modulate virus propagation in a host cell. The virus may comprise an orthopox virus, such as smallpox virus, vaccinia virus, monkeypox virus, mulluscipox virus, or cowpox virus. The method may comprise a first step of generating a three-dimensional model of a protein, or a portion thereof, required for orthopox viability. Next, a three-dimensional model of a potential modulator compound of interest may be generated. Finally, the method may comprise determining at least one atomic interaction between the potential modulator compound and the protein, or a portion thereof, as defined by the three-dimensional models for each.

In one embodiment, the invention may comprise a method for identifying a compound that has the ability to modulate orthopox virus propagation in a host cell by inhibiting a viral I7L protease. The method may comprise the step generating a three-dimensional model of I7L protein, or a portion thereof. The method may further comprise generating a three-dimensional model of a potential modulator compound of interest. Next, the method may comprise determining the nature of at least one of the atomic interactions between the potential modulator compound and the I7L protein, or a portion thereof, as defined by the three-dimensional models for the potential modulator compound and I7L, protein or a portion thereof.

The present invention also provides a method of generating a three-dimensional model of a protein, or a portion thereof. The method may comprise the steps of providing an amino acid sequence of the protein of interest, and comparing the amino acid sequence of the protein of interest to the amino acid sequence of other proteins for which a three-dimensional structure has been defined to identify a second protein having a predetermined level of sequence identity to the protein of interest. Once a second protein having a known three-dimensional structure has been identified, the method may further include the step of aligning conserved residues from the protein of interest with conserved residues from the second protein. Next, the sequence for the protein of interest may be threaded along the three-dimensional structure of the second protein, such that the position of at least two conserved residues from both proteins are aligned.

The present invention also comprises a computer model for I7L protein or a portion thereof, comprising structural coordinates for a three-dimensional model for I7L protein, or a portion thereof, operable to be visualizable on a computer screen.

The present invention also provides anti-viral agents. In one embodiment, the anti-viral agents may inhibit poxvirus. The anti-viral agent may comprise a pharmacophore. For example, in one embodiment, the present invention may comprise a pharmacophore comprising at least one atom or molecular group that interacts with at least one atom or molecular group of I7L protein, or a portion thereof. Or the anti-viral agent may comprise a compound. For example, in one embodiment, the present invention may comprise a compound comprising at least one atom or molecular group that interacts with at least one atom or molecular group of I7L protein, or a portion thereof. In one embodiment, the compound interacts with I7L to modulate the activity of I7L. For example, the compound may be a compound identified by docking a computer representation of the compound, or a synthetic variant thereof, with a computer representation of a three-dimensional structure of I7L protein, or a portion thereof. In one embodiment, the three-dimensional structure of I7L, or a portion thereof, is defined, at least in part, by Table 2. In yet another embodiment, the present invention may comprise a pharmaceutical composition. For example, the present invention may comprise a pharmaceutical composition comprising a compound identified by docking a computer representation of the compound with a computer representation of a structure of I7L protein, or a portion thereof.

The present invention also comprises a method of conducting a drug-discovery business. The method may comprise the step of generating a three-dimensional structural model of a target molecule of interest on a computer. Also, the method may comprise generating a three-dimensional structural model of a potential modulator compound of the target molecule on a computer, and docking the model for the potential modulator compound with the target molecule so as to minimize the free energy of the interaction between the target molecule and the potential modulator. In this way, a modulator compound that may interact with the target may be identified. The method may also include the subsequent steps of providing a modified structure for the modulator compound of interest, and assessing whether the modified structure has a lower free energy of interaction with the target than the original modulator compound.

In another embodiment, the present invention comprises treatment of orthopox viral infections using compounds identified by the methods and systems of the present invention. The orthopox viruses may include smallpox virus or other orthopox virses such as, but not limited to, vaccinia virus, monkeypox, or cowpox.

There may be advantages provided by certain embodiments of the present invention. For example, the methods of the present invention may provide a means to identify a plurality of putative pharmacological agents based upon the known three-dimensional structure of a target protein. Also, the present invention may provide a means to modify the structure of a putative pharmacological agent in silico to determine how such changes can effect the activity of the agent. Making such determinations in silico provides the ability to rapidly evaluate a large number of compounds. Also, making such determinations in silico allows for a rational approach to drug development, such that compounds may be systematically developed and their activity evaluated.

The present invention may provide compounds that may be used as pharmaceuticals for treating humans and animals suffering from, or potentially exposed to, infections caused by orthopox viruses, including smallpox, monkeypox and cowpox viruses. The compounds of the present invention may be used in combination therapy with other anti-viral agents. For example, anti-viral agents of the present invention that are protease inhibitors may be combined with other agents that act by other mechanisms. Also, the compounds of the invention may provide broad spectrum antiviral agents with a low level of toxicity and a high therapeutic index. Such compounds may further provide an antiviral agent that may be used against viral strains that are resistant to other types of antiviral agents such as agents that inhibit DNA replication or immunomodulators.

There are, of course, additional features of the invention, which will be described in more detail hereinafter. It is to be understood that the invention is not limited in its application to the specific details as set forth in the following description and figures. The invention is capable of other embodiments and of being practiced or carried out in various ways.

### BRIEF DESCRIPTION OF THE FIGURES

FIG. 1 shows a superposition of vaccinia virus (VV) I7L protease with the C-terminal domain of ULP1 protease in accordance with an embodiment of the present invention. I7L is shown as a solid ribbon and ULP1 is shown as a multi-lined ribbon. Hang point residues of ULP1 (His514, Cys580, Trp448) and I7L (His241, Cys328, Trp168) are shown. Darker shading indicates regions of the polypeptide or individual residues that are closer to the viewer, whereas lighter shading indicates regions of the polypeptide or individual residues that are farther away.

FIG. 2 shows a three-dimensional homology threading model of vaccinia virus (VV) I7L generated using the structure of the C-terminal portion of ULP1 protease in accordance with an example embodiment of the present invention. Darker shading indicates regions of the polypeptide or individual residues that are closer to the viewer, whereas lighter shading indicates regions of the polypeptide or individual residues that are farther away.

FIG. 3 shows a close-up view of the I7L ligand binding site in accordance with an example embodiment of the present invention. Darker shading indicates regions of the polypeptide or individual residues that are closer to the viewer, whereas lighter shading indicates regions of the polypeptide or individual residues that are farther away.

FIG. 4 shows a computed docking mode of a small organic molecule, TTP-A, on the surface of I7L protease in accordance with an embodiment of the present invention. TTP-A is shown in a meshed three-dimensional surface. Darker shading indicates regions of the polypeptide or individual residues that are closer to the viewer, whereas lighter shading indicates regions of the polypeptide or individual residues that are farther away.

FIG. 5 shows a view of the I7L ligand binding domain in accordance with an example embodiment of the present invention wherein Leu324 is represented in a space-filling representation. Darker shading indicates regions of the polypeptide or individual residues that are closer to the viewer, whereas lighter shading indicates regions of the polypeptide or individual residues that are farther away.

FIG. 6 shows the structure of two small molecule organic compounds, TTP-A and TTP-B, that bind to I7L protein, or a portion thereof in silico and that have an anti-viral effect in a cell culture assay in accordance with an example embodiment of the present invention.

FIG. 7 shows a method for identification of potential therapeutic compounds targeted to I7L using in silico screening and optionally, biological screening, in accordance with an embodiment of the present invention.

### DETAILED DESCRIPTION

Definitions

The following definitions may be used to understand the description herein. Unless defined otherwise, all technical and scientific terms used herein have the same meaning as commonly understood by one of ordinary skill in the art. Practitioners are particularly directed to Current Protocols in Molecular Biology (Ansubel) for definitions and terms of the art. Abbreviations for amino acid residues are the standard 3-letter and/or 1-letter codes used in the art to refer to one of the 20 common L-amino acids.

I7L is a protease involved in the maturation of the orthopox virus virion and thus, is required for orthopox virus viability and/or replication. Vaccinia virus I7L is a 423 amino acid cysteine protease that that catalyzes the cleavage of the 4a, 4b, and 25K structural proteins found in the mature vaccinia virus (VV) virion. The catalytic residues of wild-type I7L comprise a histidine and a cysteine embedded in a conserved region of the protein that contains an aspartic acid. I7L may be derived from a variety of sources, including orthopox viruses such as vaccinia virus, cowpox, camelpox, variola major, variola minor, monkeypox, ectromelia, sheeppox, lumpy skin, Yaba-like, swinepox, rabbit fibroma, myxoma, fowlpox, canarypox, armsacta moorei viruses. The enzyme may be from any source, whether natural, synthetic, semi-synthetic, or recombinant. A number of I7L proteins have been identified and cloned and these may be used in the methods of the invention. All of the I7L proteins characterized to date may be used in the methods of the present invention.

An I7L protein or part thereof in the present invention may be a wild type enzyme or part thereof, a mutant enzyme or part thereof, or variant or homologue of such an enzyme. As used herein, the term “wild type” refers to a polypeptide having a primary amino acid sequence which is identical with the native enzyme. The term “mutant” refers to a polypeptide having a primary amino acid sequence which differs from the wild type sequence by one or more amino acid additions, substitutions or deletions. A mutant may or may not be functional. As used herein, the term “variant” refers to a naturally occurring polypeptide which differs from a wild-type sequence. As used herein, when referring to a protein, the terms “portion” or “part” indicate that the polypeptide comprises a fraction (or fractions) of the amino acid sequence referred to.

“Polypeptide” and “protein” are used interchangeably herein to describe protein molecules that may comprise either partial or full-length proteins.

As used herein, “small organic molecules” are molecules of molecular weight less than 2,000 Daltons that contain at least one carbon atom.

The term “vector” refers to a nucleic acid molecule that may be used to transport a second nucleic acid molecule into a cell. In one embodiment, the vector allows for replication of DNA sequences inserted into the vector. The vector may comprise a promoter to enhance expression of the nucleic acid molecule in at least some host cells. Vectors may replicate autonomously (extra chromosomal) or may be integrated into a host cell chromosome. In one embodiment, the vector may comprise an expression vector capable of producing a protein derived from at least part of a nucleic acid sequence inserted into the vector.

As used herein, the term “interact” refers to a condition of proximity between a ligand or compound, or portions or fragments thereof, and a portion of a second molecule of interest. The interaction may be non-covalent, for example, as a result of hydrogen-bonding, van der Waals interactions, or electrostatic or hydrophobic interactions, or it may be covalent.

As used herein, the term “atomic contacts” or “atomic interaction” refers to the inter-atomic contact between atoms in a test compound and atoms in a second molecule (e.g., the protein of interest) for which a three-dimensional model is made. The atomic interaction is governed by geometric and physiochemical complementarity as well as steric fit between the two molecules for which the atomic contacts/interaction is evaluated. Thus, an atomic interaction between a potential modulator compound and the I7L protein, or a portion thereof, comprises at least one atomic interaction selected from the group consisting of charge, electrostatic, hydrogen bond, and hydrophobic. The atomic interaction may be covalent bond. For example, atomic interactions between I7L ligand binding domain and small molecules TTP-A and TTP-B are described, at least in part, by Tables 5 and 6, respectively.

As used herein, the term “docking” refers to a process by which a test compound is placed in close proximity with a second molecule (e.g., the protein of interest). Docking is also used to describe the process of finding low energy conformations of a test compound and a second molecule (e.g., the protein or polypeptide of interest, or portion thereof). Docking studies include molecular modeling studies aimed at finding a proper fit between a ligand and its binding site.

As used herein, the term “docking mode” refers to a favorable configuration of a test compound docked (e.g., positioned) within a given site on a molecule of interest.

As used herein, the term “hang point residues” refers to residues on a first molecule of known structure that are then used as anchors for the threading of a second molecule of unknown structure along the structure of the first molecule so as to determine a structure for the second molecule. For example, to determine a structure for I7L protein, or a portion thereof, residues Cys580, His514, and Trp448 of a ULP1 protein of known structure were the hang point residues that were aligned with Cys328, His241, and Trp168 of the I7L to determine the structure of I7L.

As used herein, the term “conserved residues” refers to amino acids that are the same among a plurality of proteins having the same structure and/or function. A region of conserved residues may be important for protein structure or function. Thus, contiguous conserved residues as identified in a three-dimensional protein may be important for protein structure or function. To find conserved residues, or conserved regions of 3-D structure, a comparison of sequences for the same or similar proteins from different species, or of individuals of the same species, may be made.

As used herein, the term “homologue” means a polypeptide having a degree of homology with the wild-type amino acid sequence. Homology comparisons can be conducted by eye, or more usually, with the aid of readily available sequence comparison programs. These commercially available computer programs can calculate percent homology between two or more sequences (e.g. Wilbur, W. J. and Lipman, D. J., 1983, Proc. Natl. Acad. Sci. USA, 80:726-730). For example, homologous sequences may be taken to include an amino acid sequences which in alternate embodiments are at least 75% identical, 85% identical, 90% identical, 95% identical, or 98% identical to each other.

The terms “identity” or “percent identical” refers to sequence identity between two amino acid sequences or between two nucleic acid sequences. Percent identity can be determined by aligning two sequences and refers to the number of identical residues (i.e., amino acid or nucleotide) at positions shared by the compared sequences. Sequence alignment and comparison may be conducted using the algorithms standard in the art (e.g. Smith and Waterman, 1981, Adv. Appl. Math. 2:482; Needleman and Wunsch, 1970, J. Mol. Biol. 48:443; Pearson and Lipman, 1988, Proc. Natl. Acad. Sci., USA, 85:2444) or by computerized versions of these algorithms (Wisconsin Genetics Software Package Release 7.0, Genetics Computer Group, 575 Science Drive, Madison, Wis.) publicly available as BLAST and FASTA. Also, ENTREZ, available through the National Institutes of Health, Bethesda Md., may be used for sequence comparison. In one embodiment, the percent identity of two sequences may be determined using GCG with a gap weight of 1, such that each amino acid gap is weighted as if it were a single amino acid mismatch between the two sequences.

As used herein, a polypeptide or protein “domain” comprises a region along a polypeptide or protein that comprises an independent unit. Domains may be defined in terms of structure, sequence and/or biological activity. In one embodiment, a polypeptide domain may comprise a region of a protein that folds in a manner that is substantially independent from the rest of the protein. Domains may be identified using domain databases such as, but not limited to PFAM, PRODOM, PROSITE, BLOCKS, PRINTS, SBASE, ISREC PROFILES, SAMRT, and PROCLASS.

As used herein, “ligand binding domain” (LBD) refers to a domain of a protein responsible for binding a ligand. The term “ligand binding domain” includes homologues of a ligand binding domain or portions thereof. In this regard, deliberate amino acid substitutions may be made in the LBD on the basis of similarity in polarity, charge, solubility, hydrophobicity, hydrophilicity, and/or the amphipathic nature of the residues, as long as the binding specificity of the ligand binding domain is retained. For example, for I7L protein, the ligand binding domain may comprise residues 110-423 of vaccinia virus I7L protein.

As used herein, the “ligand binding site” comprises residues in a protein that directly interact with a ligand, or residues involved in positioning the ligand in close proximity to those residues that directly interact with the ligand. The interaction of residues in the ligand binding site may be defined by the spatial proximity of the residues to a ligand in the model or structure. The term “ligand binding site” includes homologues of a ligand binding site or portions thereof. In this regard, deliberate amino acid substitutions may be made in the ligand binding site on the basis of similarity in polarity, charge, solubility, hydrophobicity, hydrophilicity, and/or the amphipathic nature of the residues, as long as the binding specificity of the ligand binding site is retained. For I7L, the ligand binding site may be defined as comprising those residues in Table 1. For example, the ligand binding site may be defined as comprising those residues in Table 1 and any other residues that are within a 3 angstrom radius of any one of the residues in Table 1.

As used herein, “catalytic domain” refers to a domain of a protein responsible for binding a substrate or that is involved in the catalytic mechanism. The term “catalytic domain” includes homologues of a catalytic binding domain or portions thereof. In this regard, deliberate amino acid substitutions may be made in the catalytic domain on the basis of similarity in polarity, charge, solubility, hydrophobicity, hydrophilicity, and/or the amphipathic nature of the residues, as long as the binding specificity of the catalytic site within the catalytic domain.

As used herein, the “catalytic site” refers to a region of the catalytic domain that directly associates with a substrate or that is involved in the catalytic mechanism. For example, it may be a region of I7L that is responsible for binding a substrate. With reference to the models and structures of the present invention, residues in a catalytic site may be defined by their spatial proximity to a substrate in the model or structure. The term “catalytic site” includes homologues of a catalytic site, or portions thereof. In this regard, deliberate amino acid substitutions may be made in the catalytic domain on the basis of similarity in polarity, charge, solubility, hydrophobicity, hydrophilicity, and/or the amphipathic nature of the residues, as long as the substrate specificity of the catalytic site is retained. For example, for I7L, the catalytic site may be included as part of the ligand binding site to include at least some those residues listed in Table 1.

As used herein, a “ligand” refers to a molecule or compound or entity that associates with a ligand binding domain, including substrates or analogues or parts thereof. As described herein, the term “ligand” may refer to compounds that bind to the protein of interest. A ligand may be a modulator. Or, a ligand may not have a biological effect. Or, a ligand may block the binding of other ligands thereby inhibiting a biological effect. Ligands may include, but are not limited to, small molecule inhibitors of the activity of protein. These small molecules may include peptides, peptidomimetics, organic compounds and the like. For proteases, ligands may also include polypeptide and protein substrates.

As used herein, a “modulator compound” refers to a molecule which changes or alters the biological activity of a molecule of interest. A modulator compound may increase or decrease activity, or change the physical or chemical characteristics, or functional or immunological properties, of the molecule of interest. For I7L, a modulator compound may increase or decrease activity, or change the characteristics, or functional or immunological properties of the I7L, or a portion threof A modulator compound may include natural and/or chemically synthesized or artificial peptides, modified peptides (e.g., phosphopeptides), antibodies, carbohydrates, monosaccharides, oligosaccharides, polysaccharides, glycolipids, heterocyclic compounds, nucleosides or nucleotides or parts thereof, and small organic or inorganic molecules. A modulator compound may be an endogenous physiological compound or it may be a natural or synthetic compound. Or, the modulator compound may be a small organic molecule. The term “modulator compound” also includes a chemically modified ligand or compound, and includes isomers and racemic forms.

The terms “structural coordinates” or “atomic coordinates” as used herein refers to a set of values that define the position of one or more amino acid residues or molecules with reference to a system of axes. A data set of structural coordinates defines the three dimensional structure of a molecule or molecules. Structural coordinates can be slightly modified and still render nearly identical three dimensional structures. A measure of a unique set of structural coordinates is the root-mean-square deviation of the resulting structure. In alternate embodiments, structural coordinates that render three dimensional structures that deviate from one another by a root-mean-square deviation of less than 3 angstroms, or less than 2.0 angstroms, or less than 0.5 angstroms, or less than 0.3 angstroms, may be viewed by a person of ordinary skill in the art as identical. Variations in structural coordinates may be generated because of mathematical manipulations of the structural coordinates of I7L as described herein. For example, the structural coordinates of Tables 24 may be manipulated by crystallographic permutations of the structural coordinates, fractionalization of the structural coordinates, integer additions or subtractions to sets of the structural coordinates, inversion of the structural coordinates or any combination of the above. Variations in structure due to mutations, additions, substitutions, and/or deletions of the amino acids, or other changes in any of the components that make up a structure of the invention may also account for modifications in structural coordinates. If such modifications are within the standard error as compared to the original structural coordinates, the resulting structure may be considered to be the same or equivalent. Therefore, a ligand that bound to a ligand binding domain of an I7L would also be expected to bind to another ligand binding domain whose structural coordinates defined a shape that fell within the margin of error defined by the first structure. Such modified structures of a ligand binding domain are also within the scope of the invention. For example, using the surface topology of a group of ligands, such as low-energy binding modes of TTP-A and TTP-B, which exhibit effector quality (agonist or antagonist) can be overlapped and the contours of all TTP-A and TTP-B averaged into a union surface. This union surface of a ligand is expected to be complementary to the surface mold of the corresponding binding site of I7L enzyme.

As used herein, a structural “model” of a protein of interest, a polypeptide of interest, or any other compound of interest, may be in two or three dimensions. For example, a computer model may be in three dimensions despite the constraints imposed by a computer screen, if it is possible to scroll along at least a pair of axes, causing rotation of the image. Also, a model of a protein or chemical compound of interest may be defined by the structural coordinates for the protein or compound of interest.

As used herein, the terms “modeling” or “generating a model” includes the quantitative and qualitative analysis of molecular structure and/or function based on atomic structural information and interaction models. The term may include conventional numeric-based molecular dynamic and energy minimization models, interactive computer graphic models, modified molecular mechanics models, distance geometry, and other structure-based constraint models.

The term “substrate” refers to the molecule or compound that is the target of an enzyme. For I7L, a substrate may include proteins and polypeptides cleaved by the I7L protease and includes the 4a, 4b, and 25K structural proteins of vaccinia virus.

The term “peptide mimetics” are structures which serve as substitutes for peptides in interactions between molecules (Morgan et al., 1989, Ann. Reports Med. Chem., 24:243-252). Peptide mimetics may include synthetic structures that may or may not contain amino acids and/or peptide bonds but that retain the structural and functional features of a peptide, or agonist, or antagonist. Peptide mimetics also include peptoids, oligopeptoids (Simon et al., 1972, Proc. Natl. Acad, Sci., USA, 89:9367); and peptide libraries containing peptides of a designed length representing all possible sequences of amino acids corresponding to a peptide, or agonist or antagonist of the invention.

The term “treating” refers to improving a symptom of a disease or disorder and may comprise curing the disorder, substantially preventing the onset of the disorder, or improving the subject's condition. The term “treatment” as used herein, refers to the full spectrum of treatments for a given disorder from which the patient is suffering, including alleviation of one, most of all symptoms resulting from that disorder, to an outright cure for the particular disorder or prevention of the onset of the disorder.

As used herein, “TC50” is the concentration at which 50% of the cells display signs of cytotoxicity. Also, “IC50” is the concentration at which there is 50% inhibition of the measured effect of interest. For I7L, “IC50” is the concentration at which there is 50% inhibition of viral cytopathic effect. The therapeutic index, “TI,” is a ratio of the TC50 to the IC50. Thus, clinical beneficial drugs are generally those that have a high TI.

As used herein, “pharmacophore” is a collection of steric and elctronic features that are necessary to ensure the optimal supramolecular interactions with a specific biological target structure. A pharmacophore may comprise a structural definition that comprises a set of active molecules. For example, using the surface topology of a group of ligands, such as low-energy binding modes of TTP-A and TTP-B, which exhibit effector quality (agonist or antagonist) can be overlapped and the contours of all TTP-A and TTP-B averaged into a union surface that comprises a pharmacophore. This pharmacophore is expected to be complementary to the surface mold of the corresponding binding site of I7L enzyme.

As used herein, an “effective amount” as used herein means the amount of an agent that is effective for producing a desired effect in a subject. The term “therapeutically effective amount” denotes that amount of a drug or pharmaceutical agent that will elicit the therapeutic response of an animal or human that is being sought. The actual dose which comprises the effective amount may depend upon the route of administration, the size and health of the subject, the disorder being treated, and the like.

The term “pharmaceutical composition” is used herein to denote a composition that may be administered to a mammalian host, e.g., orally, topically, parenterally, by inhalation spray, or rectally, in unit dosage formulations containing conventional non-toxic carriers, diluents, adjuvants, vehicles and the like. The term “parenteral” as used herein, includes subcutaneous injections, intravenous, intramuscular, intracisternal injection, or by infusion techniques.

The term “a” or “an”, as used herein may refer to more than one object unless the context clearly indicates otherwise. The term “or” is used interchangeably with the term “and/or” unless the context clearly indicates otherwise.

Ligands for I7L as Modulators of Orthopox Viruses

Embodiments of the present invention provide ligands for I7L as modulators of viruses and methods for discovery of such ligands. In one embodiment, the invention may comprise a method for identifying a compound having the ability to modulate orthopox virus propagation in a host cell. The method may comprise the steps of: (a) generating a three-dimensional model of a protein required for orthopox viability, or a portion thereof; (b) generating a three-dimensional model of a potential modulator compound of interest; and (c) determining at least one atomic interaction between the potential modulator compound and the protein, or a portion thereof, as defined by the three-dimensional models of each.

The virus may comprise an orthopox virus, such as smallpox virrus, vaccinia virus, monkeypox virus, mulluscipox virus, cowpox virus, camelpox virus, variola major virus, variola minor virus, ectromelia virus, sheeppox virus, lumpy skin virus, Yaba-like virus, swinepox virus, rabbit fibroma virus, myxoma virus, fowlpox virus, canarypox virus, or amsacta moorei virus. In one example embodiment, the virus is smallpox virus. The protein may be any protein that is required for viability of the virus in a host cell. For example, the protein may be a protease that is required for formation or morphogenesis of the virus. Or, the protein may be required for DNA replication. The protein may be a cysteine protease. In one example embodiment, the protein is an I7L protease, such as vaccinia virus I7L protein.

The method may be performed using a computer. Thus, in one embodiment, the method comprises the steps of: (a) generating a three-dimensional computer model of the protein, or a portion thereof; (b) generating a three-dimensional computer model of the potential modulator compound of interest; (c1) using a computer to dock the three-dimensional model of the potential modulator compound within the model of the protein or a portion thereof; and (c2) quantifying at least one atomic interaction between the potential modulator compound and the protein, or a portion thereof.

The method further allows for varying the structure of the potential modulator compound to determine how changes to the structure of the modulator may affect the fit of the compound with the protein of interest. Thus, the method may further comprise the steps of modifying the computer model of the potential modulator compound, and evaluating how modifying the computer model of the potential modulator compound changes at least one atomic interaction between of the model of the potential modulator compound and the model of the protein, or portion thereof. The potential modulator compound may be modified in silico. Thus, in one embodiment, the step of modifying the computer model of the potential modulator compound of interest comprises the step of searching a library of molecular structures for molecular fragments that can be linked to the potential modulator compound, wherein a molecular fragment comprises at least one atom. The method may further comprise linking a molecular fragment to the potential modulator compound to generate a modified compound. The modified compound may then be evaluated by docking the modified compound to the protein of interest and quantifying at least one atomic interaction between the modified compound and the protein of interest.

Also, the compound may be evaluated in a biological assay. Thus, the compound may be evaluated by its ability to inhibit virus growth or propagation. Also, the compound may be evaluated for cytotoxicity to uninfected cells. In one embodiment, the therapeutic index (TI), comprising the TC50 (concentration of the compound for which 50% of uninfected cells display signs of toxicity) divided by the IC50 (concentration at which the viral cytopathic effect is inhibited 50%) for the compound may be determined.

It may not be required to determine the entire structure of the protein of interest to identify compounds that may act as modulators of the protein. For example, the three-dimensional model of the protein of interest may comprise only a portion of the protein. Thus, the model may comprise the catalytic domain. Additionally or alternatively, the model may comprise a ligand binding domain. Additionally or alternatively, the model may comprise a ligand binding site. Additionally or alternatively, the model may comprise the catalytic site. In some cases, the ligand binding site may also comprise the catalytic site.

It is also not necessarily required to determine how each amino acid of the entire structure of the protein of interest interacts with a potential modulator compound to identify compounds that may act as modulators of the protein. For example, the amino acid used to determine an atomic interaction between a potential modulator compound and the protein of interest may comprise a residue that is conserved in the protein of interest. Additionally, or alternatively, the amino acid used to determine an atomic interaction between a potential modulator compound and the protein of interest may comprise a residue that is present in, or affects the structure of, the catalytic domain and/or the catalytic site. Additionally, and/or alternatively, an amino acid used to determine an atomic interaction between a potential modulator compound and the protein of interest may comprise a residue that is present in, or affects the structure of, the ligand binding domain and/or the ligand binding site.

It has been shown that I7L protein (i.e., virion core protein proteinase) may be required for morphogenesis of orthopox viruses, and that without a functional I7L protein, propagation of the virus may be reduced. Thus, in one embodiment, the invention may comprise a method for identifying a compound having the ability to modulate orthopox virus propagation in a host cell, where the compound acts by inhibiting an I7L protease. The orthopox virus may comprise smallpox virrus, vaccinia virus, monkeypox virus, mulluscipox virus, cowpox virus, camelpox virus, variola major virus, variola minor virus, ectromelia virus, sheeppox virus, lumpy skin virus, Yaba-like virus, swinepox virus, rabbit fibroma virus, myxoma virus, fowlpox virus, canarypox virus, or amsacta moorei virus. In one example embodiment, the virus is smallpox virus. The method may comprise the steps of: (a) generating a three-dimensional model of a I7L protein, or a portion thereof; (b) generating a three-dimensional model of a potential modulator compound of interest; and (c) determining at least one atomic interaction between the potential modulator compound and the I7L protein, or a portion thereof, as defined by the three-dimensional models of the I7L protein, or a portion thereof, and the potential modulator compound of interest.

The model of I7L may comprise a variety of formats. In one embodiment, the model may comprise a three-dimensional structural model. Or, the model of I7L may comprise structural coordinates presented as the position of individual atoms of the I7L protein, or a portion thereof, in space. For example, the model of I7L, or a portion thereof, may comprise the x, y, and z atomic coordinates as defined in Table 2.

The model of I7L protein, or a portion thereof, may be derived at least in part from the structure of a protein that comprises a similar function to I7L. The method of generating the computer model may comprise aligning the structure of the I7L protein, or a portion thereof, with a second cysteine protease. In one example embodiment, the second cysteine protease is ubiquitin-like protein 1 (ULP1) protease.

The model of I7L may be derived at least in part by aligning conserved sequences from the I7L protein, or a portion thereof, and a second protein. In one embodiment, the amino acids used to align the structure of the VV I7L protein or a portion thereof with ULP1 comprise His241, Asp248, and Cys328 of the I7L protein and His 514, Cys 580 and Trp448 of ULP1.

The method may be performed using a computer. Thus, in one embodiment, the method comprises the steps of: (a) generating a three-dimensional computer model of the I7L protein, or a portion thereof; (b) generating a three-dimensional computer model of the potential modulator compound; (c1) using a computer to dock the three-dimensional model of the potential modulator compound with the model of the I7L protein, or a portion thereof; and (c2) quantifying at least one atomic interaction between the potential modulator compound and the I7L as defined by the docking of the model of the potential modulator compound in the computer model of the I7L protein, or a portion thereof.

The method further allows for varying the structure of the potential modulator compound to determine how changes in the structure can affect the fit of the potential modulator compound with the protein of interest. Thus, the method may further comprise the steps of modifying the computer model of the potential modulator compound, and evaluating how modifying the computer model of the potential modulator compound affects the atomic interactions between of the model of the potential modulator compound and the model of the I7L protein, or portion thereof. The potential modulator compound may be modified in silico. Thus, in one embodiment, the step of modifying the computer model of the potential modulator compound of interest comprises the step of searching a library of molecular structures for molecular fragments that can be linked to the potential modulator compound, wherein a molecular fragment comprises at least one atom. The method may further comprise linking a molecular fragment to the potential modulator compound to generate a modified compound. The modified compound may then be evaluated by docking the modified compound to the I7L protein, or a portion thereof, and determining the atomic interactions between the modified compound and the I7L protein.

It is not necessarily required to determine the entire structure of the protein of interest to identify compounds that may act as modulators of the protein. For example, the three-dimensional model of the protein of interest may comprise only a portion of the protein. Thus, the model may comprise the catalytic domain, or a portion thereof. For example, the model may comprise the catalytic site. Additionally or alternatively, the model may comprise a ligand binding domain, or a portion thereof, such as the ligand binding site. For I7L, the ligand binding site may also comprise the catalytic site.

It may not be required to determine how each amino acid of the entire structure of the I7L protein interacts with a potential modulator compound to identify compounds that may act as modulators of the I7L protein. For example, an amino acid used to determine the atomic interactions between a potential modulator compound and the I7L protein may comprise a residue that is conserved in the I7L protein. Additionally or alternatively, the amino acid used to determine an atomic interaction between a potential modulator compound and the I7L protein may comprise a residue that is present in, or affects the structure of, the catalytic domain and/or catalytic site. Additionally, or alternatively, an amino acid used to determine an atomic interaction between a potential modulator compound and the I7L protein may comprise a residue that is present in, or affects the structure of, the ligand binding domain and/or ligand binding site.

The residues that are used to determine the atomic interactions between a potential modulator compound and the I7L protein may comprise an amino acid that is active in catalysis. In one example embodiment, the amino acids used to determine an atomic interaction between a potential modulator compound and the I7L protease, or a portion thereof, comprises the catalytic cysteine of the I7L protein. In one embodiment, the atomic interactions with the catalytic cysteine may comprise a charge or electrostatic interaction. Additionally, or alternatively, the amino acids used to determine an atomic interaction between a potential modulator compound and the I7L protein, or a portion thereof, may comprise at least one of Cys328, His241, Asp248, or Asp258 of the I7L protein. Additionally, or alternatively, the amino acids used to determine an atomic interaction between a potential modulator compound and the I7L protein, or a portion thereof, may comprise at least one of Leu324, Trp242, or Gln322 of the I7L protein. Or, the amino acids used to determine an atomic interaction between a potential modulator compound and the I7L protein, or a portion thereof, may comprise at least one of Gly329, Leu323, Ser240, Trp168, Asp194, Asn171, Ser173, Gln322, Met195, Ser326, Glu327, Leu239, Leu177, Asn199, Met169, Phe236, Ile203, or Met233 of the I7L protein. In one embodiment, the I7L protein, or portion thereof, is VV I7L.

Depending on the source of the protein used to generate a three-dimensional structure, there may be some variability in the absolute positioning of each amino acid. Still, it is to be expected that the relative positions of conserved amino acids may be maintained. For example, it has been found that there is a high degree in the catalytic triad sequence region (i.e., His241, Asp248, and Cys328 for VV I7L) of I7L proteins isolated from various poxviruses (Byrd, C. M. et al., 2004, J. Virol., 78:12147-12156) Thus, alignment of sequences immediately surrounding amino acids in the catalytic triad may comprise 95-99 percent sequence identity and identical spacing between the residues. Thus, for I7L, the amino acids used to determine the atomic interactions between a potential modulator compound and the I7L protein may comprise Cys(N), wherein position N corresponds to the catalytic cysteine. In one embodiment, the catalytic cyeteine corresponds to Cys328 of vaccinia virus I7L. Additionally, the amino acids used to determine the atomic interactions between a potential modulator compound and the I7L protein, or a portion thereof, may comprise at least one of His(N-87), Asp(N-80), or Asp(N-70) of the I7L protein, wherein position N corresponds to the catalytic cysteine of the I7L. Additionally, the amino acids used to determine the atomic interactions between a potential modulator compound and the I7L protein, or a portion thereof, may comprise at least one of Leu(N-4), Trp(N-86), or Gln(N-6) of the I7L protein, wherein position N corresponds to the catalytic cysteine of the I7L. Additionally, or alternatively, the amino acids used to determine the atomic interactions between a potential modulator compound and the I7L protein, or a portion thereof, may comprise at least one of Gly(N+1), Leu(N-5), Ser(N-88), Trp(N-160), Asp(N-134), Asn(N-157), Ser(N-155), Met(N-133), Ser(N-2), Glu(N-1), Leu(N-89), Leu(N-151), Asn(N-129), Met(N-159), Phe(N-92), Ile(N-125) or Met(N-95), wherein position N corresponds to the catalytic cysteine of I7L.

The analysis may further employ a modified protein. Thus, the potential modulator compound may be evaluated for its interaction with a modified I7L protein, or portion thereof, wherein the I7L comprises at least one of an amino acid substitution, an amino acid deletion, or an amino acid insertion. In one embodiment, the amino acids used to determine the nature of the association between a test compound and the I7L protein, or a portion thereof, comprise at least one of wild-type or altered amino acid in the I7L protein corresponding to positions 168, 169, 171, 173, 177, 194, 195, 199, 203, 233, 236, 239, 240, 241, 242, 248, 258, 322, 323, 324, 326, 327, 328, or 329 of the wild-type VV I7L protein.

The nature of the interaction between the potential modulator compound and the protein of interest may be defined in terms of the atomic interaction between the compound and the protein of interest. In an embodiment, the atomic interaction between a potential modulator compound and the I7L protein, or a portion thereof, comprises at least one atomic interaction selected from the group consisting of charge, electrostatic, hydrogen bond, and hydrophobic. Alternatively, the atomic interaction between a potential modulator compound and the I7L protein, or portion thereof, may comprise at least two hydrogen bond atomic interactions, at least two hydrophobic atomic interactions, and at least one of a charge or electrostatic interaction. Or, the atomic interaction between a potential modulator compound and the I7L protein, or a portion thereof, may comprise at least three hydrogen bond atomic interactions, at least three hydrophobic atomic interactions, and at least one of a charge or electrostatic interaction. For example, for I7L, the atomic interactions between the modulator compound and I7L may comprise at least one of the atomic interactions described in Table 5. Or, the atomic interactions between the modulator compound and I7L may comprise at least one of the atomic interactions described in Table 6.

Also, the compound may be evaluated in a biological assay. Thus, the compound may be evaluated for inhibition of the virus. Also, the compound may be evaluated for cytotoxicity on uninfected cells. In one embodiment, the therapeutic index (TI), comprising the TC50 for the compound divided by the IC50 for the compound, may be determined.

The present invention also comprises a method of generating a three-dimensional model of a protein of interest, or a portion thereof. In one embodiment, method may comprise the steps of: (a) providing an amino acid sequence of a protein of interest; (b) comparing the amino acid sequence of the protein of interest to the amino acid sequences of a plurality of other proteins; (c) identifying a second protein for which a three-dimensional structure has been defined, and that has a predetermined level of sequence identity to the protein of interest; (d) aligning conserved residues from the protein of interest with conserved residues from the second protein; and (e) threading the protein of interest along the three-dimensional structure of the second protein such that the position of at least two conserved residues from both proteins are aligned.

The protein aligned with the protein of interest may also comprise a protein having a similar sequence to the protein of interest. The level of sequence identity may range from at least 5% sequence identity, to more than 10% sequence identity, to more than 20% sequence identity. Also, the protein aligned with the protein of interest may comprise a protein having a similar function as the protein of interest.

In one example embodiment, the protein of interest may comprise I7L and the second protein comprises ubiquitin-like protein 1 (ULP1). Where the protein of interest is I7L, and the second protein is ULP1, the amino acids used to align the structure of the I7L protein with ULP1 may comprise His241, Asp248, and Cys328 of the I7L protease, and His 514, Cys 580 and Trp448 of ULP1.

The present invention may also comprise a structural model for a protein, or a portion of a protein, that may be manipulated using a computer. In one example embodiment, the present invention may comprise a computer model for I7L protein, or a portion thereof. The model may comprise atomic coordinates for a three-dimensional model for I7L, or a portion thereof, operable to be visualizable on a computer screen.

In one embodiment, the computer model of the protein of interest may comprise atomic coordinates presented as the position of individual atoms of the I7L protein, or a portion thereof, in space. For example, the model of I7L, or a portion thereof, may comprise at least some of the x, y, and z coordinates as defined in Table 2.

Also, the model may comprise a three-dimensional computer model of a potential modulator compound docked into the I7L structure such that the atomic interaction between the I7L and the potential modulator compound may be quantified. The atomic interactions between the I7L and the potential modulator compound may be defined at least in part determining atomic coordinates for the potential modulator compound as it interacts with the I7L protein. In one embodiment, the three dimensional structure of a potential modulator compound may comprise at least some of the atomic coordinates as defined in Table 3 or Table 4.

The residues that are used to determine the atomic interactions between a potential modulator compound and the I7L protease may comprise an amino acid that is active in catalysis. In one example embodiment, the amino acid used to determine an atomic interaction between a potential modulator compound and the I7L protease, or a portion thereof, comprises the catalytic cysteine of the I7L protein. In one embodiment, the atomic interactions with the catalytic cysteine may comprise a charge or electrostatic interaction. Or, an amino acid used to determine an atomic interaction between a potential modulator compound and the I7L protease, or a portion thereof, may comprise at least one of Cys328, His241, Asp248, Asp258 of the I7L protein. Or, an amino acid used to determine an atomic interaction between a potential modulator compound and the I7L protease, or a portion thereof, may comprise at least one of Leu324, Trp242, or Gln322 of the I7L protein. Additionally, or alternatively, the amino acids used to determine an atomic interaction between a potential modulator compound and the I7L protease, or a portion thereof, may comprise at least one of Gly329, Leu323, Ser240, Trp168, Asp194, Asn171, Ser73, Gln 322, Met195, Ser326, Glu327, Leu239, Leu177, Asn199, Met169, Phe236, Ile203, or Met233 of the I7L protein. In one embodiment, the I7L protein, or portion thereof, is VV I7L.

Depending on the source of the protein used to generate a three-dimensional structure, there may be some variability in the absolute positioning of each amino acid. Still, it is to be expected that the relative positions of conserved amino acids may be maintained as there is a high degree in the catalytic triad sequence region (i.e., His241, Asp248, and Cys328 for VV I7L) of I7L proteins isolated from various poxviruses (Byrd, C. M. et al., 2004, J. Virol., 78:12147-12156) Thus, alignment of sequences immediately surrounding amino acids in the catalytic triad may comprise 95-99 percent sequence identity and identical spacing between the residues. Thus, for I7L, the amino acids used to determine the atomic interactions between a potential modulator compound and I7L protease may comprise Cys(N), wherein position N corresponds to the catalytic cysteine of I7L. Additionally, the amino acids used to determine the atomic interactions between a potential modulator compound and the I7L protein, or a portion thereof, may comprise at least one of His(N-87), Asp(N-80), Asp(N-70), of the I7L protein, wherein position N corresponds to the catalytic cysteine of I7L. Or, the amino acids used to determine the atomic interactions between a potential modulator compound and the I7L protein, or a portion thereof, may comprise at least one of Leu(N-4), Trp(N-86), or Gln(N-6) of the I7L protein, wherein position N corresponds to the catalytic cysteine of I7L. Additionally, the amino acids used to determine the atomic interactions between a potential modulator compound and the I7L protease, or a portion thereof, may comprise at least one of Gly(N+1), Leu(N-5), Ser(N-88), Trp(N-160), Asp(N-134), Asn(N-157), Ser(N-155), Met(N-133), Ser(N-2), Glu(N-1), Leu(N-89), Leu(N-151), Asn(N-129), Met(N-159), Phe(N-92), Ile(N-125) or Met(N-95), wherein position N corresponds to the catalytic cysteine of I7L.

The computer model may further employ a modified protein. Thus, the potential modulator compound may be evaluated for its interaction with a modified I7L protein, or portion thereof, wherein the I7L comprises at least one of an amino acid substitution, an amino acid deletion, or an amino acid insertion. In one embodiment, the amino acids used to determine the nature of the association between a potential modulator compound and the I7L protein, or a portion thereof, comprise at least one of wild-type or altered amino acid in the I7L protein corresponding to positions 168, 169, 171, 173, 177, 194, 195, 199, 203, 233, 236, 239, 240, 241, 242, 248, 258, 322, 323, 324, 326, 327, 328, or 329 of the wild-type VV I7L protein.

The model may allow for the nature of the interaction between the potential modulator compound and the protein of interest to be defined in terms of the atomic interaction between the compound and the protein of interest. In an embodiment, the atomic interaction between a potential modulator compound and the I7L protein, or a portion thereof, comprises at least one atomic interaction selected from the group consisting of charge, electrostatic, hydrogen bond, and hydrophobic. Alternatively, the atomic interaction between a potential modulator compound and the I7L protein, or portion thereof, may comprise at least two hydrogen bond atomic interactions, at least two hydrophobic atomic interactions, and at least one of a charge or electrostatic interaction. Or, the atomic interaction between a potential modulator compound and the I7L protein, or a portion thereof, may comprise at least three hydrogen bond atomic interactions, at least three hydrophobic atomic interactions, and at least one of a charge or electrostatic interaction. For example, for I7L, the atomic interactions between the modulator compound and I7L may comprise at least one of the atomic interactions described in Table 5. Or, the atomic interactions between the modulator compound and I7L may comprise at least one of the atomic interactions described in Table 6.

The model allows for varying the structure of the potential modulator compound to determine how changes in the structure of the modified compound can effect the fit of the compound with the protein of interest. Thus, the model may further comprise a three-dimensional model of a modified compound docked with the I7L structure. The potential modulator compound may be modified in silico. Thus, in one embodiment, the step of modifying the computer model of the potential modulator compound of interest comprises the step of searching a library of molecular structures for molecular fragments that can be linked to the potential modulator compound, wherein a molecular fragment comprise at least one atom, and linking the fragments to the compound. The modified compound may then be evaluated by docking the modified compound to the I7L protein, or a portion thereof, and determining the atomic interactions between the modified compound and the I7L protein.

The present invention also comprises a pharmacophore having a structure required to modify the protein of interest. For example, the pharmacophore may comprise at least one atom or molecular group that interacts with at least one atom or molecular group of I7L protein, or a portion thereof. Additionally, the three dimensional structure of the pharmacophore may comprise a plurality of atoms or molecular groups that interact with at least one atom or molecular group of a three-dimensional structure of I7L protein, or a portion thereof. To be active as a modulator of I7L, the pharmacophore may interact with the ligand binding domain of I7L, or a portion thereof, such as the ligand binding site. Additionally or alternatively, the pharmacophore may interact with the catalytic domain, or a portion therof such as the catalytic site of I7L.

The structure of the pharmacophore may vary with changes in the structure of the protein of interest. In one embodiment for I7L, the three-dimensional structure of I7L may be defined by at least some of the atomic coordinates as defined in Table 2. Where I7L is defined by the coordinates of Table 2, the spatial arrangement of atoms within the pharmacophore may comprise the atomic coordinates for at least one of the docking modes as defined in Table 3. In another example embodiment, the spatial arrangement of atoms within the pharmacophore may comprise the atomic coordinates for at least one of the docking modes as defined in Table 4.

The nature of the interaction between the pharmacophore and the protein of interest may be defined in terms of the atomic interaction between the pharmacophore and the protein of interest. In an embodiment, the atomic interaction between a potential modulator compound and the I7L protein, or a portion thereof, comprises at least one atomic interaction selected from the group consisting of charge, electrostatic, hydrogen bond, and hydrophobic. Alternatively, the atomic interaction between a potential modulator compound and the I7L protein, or portion thereof, may comprise at least two hydrogen bond atomic interactions, at least two hydrophobic atomic interactions, and at least one of a charge or electrostatic interaction. Or, the atomic interaction between a potential modulator compound and the I7L protein, or a portion thereof, may comprise at least three hydrogen bond atomic interactions, at least three hydrophobic atomic interactions, and at least one of a charge or electrostatic interaction. For example, for I7L, the atomic interactions between the pharmacophore and I7L may comprise at least one of the atomic interactions described in Table 5. Or, the atomic interactions between the pharmacophore and I7L may comprise at least one of the atomic interactions described in Table 6.

The pharmacophore may be defined by its ability to interact with amino acids in the protein of interest that are important for catalytic activity and/or substrate binding. In one embodiment for an I7L pharmacophore, the interacting atom or molecular group for I7L may comprise the catalytic cysteine of I7L. In one embodiment, the atomic interactions with the catalytic cysteine may comprise a charge or electrostatic interaction. Or, the interacting atom or molecular group for I7L may comprise at least one of amino acids Cys328, His241, Asp248, Asp258, of I7L. Or, the interacting atom or molecular group for I7L may comprise at least one of amino acids Leu324, Trp242, and Gln322 of I7L. Additionally, or alternatively, the interacting atom or molecular group of I7L may comprise at least one of Gly329, Leu323, Ser240, Trp168, Asp194, Asn171, Ser173, Gln 322, Met195, Ser326, Glu327, Leu239, Leu177, Asn199, Met169, Phe236, Ile203, or Met233 of the I7L protein. In an embodiment, the I7L, or a portion thereof, comprises VV I7L.

Depending on the source of the protein used to generate a three-dimensional structure, there may be some variability in the absolute positioning of each amino acid. Still, it is to be expected that the relative positions of conserved amino acids may be maintained. As described above, there is a high degree in the catalytic triad sequence region (i.e., His241, Asp248, and Cys328 for VV I7L) of I7L proteins isolated from various poxviruses (Byrd, C. M. et al., 2004, J. Virol., 78:12147-12156) Thus, alignment of sequences immediately surrounding amino acids in the catalytic triad may comprise 95-99 percent sequence identity and identical spacing between the residues. For I7L, the interacting group(s) used to determine the atomic interactions between the pharmacophore and I7L protein may comprise Cys(N), wherein position N corresponds to the catalytic cysteine of I7L. Additionally, the interacting group(s) may comprise at least one of His(N-87), Asp(N-80), Asp(N-70), of the I7L protein, wherein position N corresponds to the catalytic cysteine of I7L. Additionally, the interacting group(s) may comprise at least one of Leu(N-4), Trp(N-86), or Gln(N-6) of the I7L protein, wherein position N corresponds to the catalytic cysteine of I7L. Additionally, the interacting group of I7L may comprise at least one of Gly(N+1), Leu(N-5), Ser(N-88), Trp(N-160), Asp(N-134), Asn(N-157), Ser(N-155), Met(N-133), Ser(N-2), Glu(N-1), Leu(N-89), Leu(N-151), Asn(N-129), Met(N-159), Phe(N-92), Ile(N-125) or Met(N-95), wherein position N corresponds to the catalytic cysteine of I7L.

The computer model may further employ a modified protein. Thus, the pharmacophore may be evaluated for its interaction with a modified I7L protein, or portion thereof, wherein the I7L comprises at least one of an amino acid substitution, an amino acid deletion, or an amino acid insertion. In one embodiment, the I7L amino acids used to determine the nature of the association between the pharmacophore and the I7L protein, or a portion thereof, comprise at least one of wild-type or altered amino acid in the I7L protein corresponding to positions 168, 169, 171, 173, 177, 194, 195, 199, 203, 233, 236, 239, 240, 241, 242, 248, 258, 322, 323, 324, 326, 327, 328, or 329 of the wild-type VV I7L protein.

In yet another embodiment, the present invention comprises compounds that interact with at least one atom or molecular group of the I7L protein. In an embodiment, such compounds bind to the catalytic domain and/or catalytic site of I7L. In yet another embodiment, the compounds include molecules that interact with residues known to be in the ligand binding domain and/or ligand binding site. In yet a further embodiment, the compound comprises TTP-A or TTP-B.

The interaction between the compound and I7L may comprise an in silico interaction defined by a computer model of the structure of the compound and a computer model of the I7L protein, or a portion thereof. Thus, the present invention may also comprise a compound identified by docking a computer representation of the compound with a computer representation of a structure of I7L, or a portion thereof, as defined by Table 2. Where I7L is defined by the coordinates of Table 2, the spatial arrangement of atoms within the compound may comprise the atomic coordinates for at least one of the docking modes as defined in Table 3. In another example embodiment, the spatial arrangement of atoms within the compound comprises the atomic coordinates for at least one of the docking modes as defined in Table 4.

The nature of the interaction between the compound and the protein of interest may be defined in terms of the atomic interaction between the compound and the protein of interest. In an embodiment, the atomic interaction between a potential modulator compound and the I7L protein, or a portion thereof, comprises at least one atomic interaction selected from the group consisting of charge, electrostatic, hydrogen bond, and hydrophobic. Alternatively, the atomic interaction between a potential modulator compound and the I7L protein, or portion thereof, may comprise at least two hydrogen bond atomic interactions, at least two hydrophobic atomic interactions, and at least one of a charge or electrostatic interaction. Or, the atomic interaction between a potential modulator compound and the I7L protein, or a portion thereof, may comprise at least three hydrogen bond atomic interactions, at least three hydrophobic atomic interactions, and at least one of a charge or electrostatic interaction. For example, for I7L, the atomic interactions between the compound and I7L may comprise at least one of the atomic interactions described in Table 5. Or, the atomic interactions between the compound and I7L may comprise at least one of the atomic interactions described in Table 6.

The present invention also comprises pharmaceutical compositions comprising compounds able to modify the activity of a protein of interest. In one embodiment, the protein of interest may comprise I7L. Also, the pharmaceutical compositions may comprise anti-viral activity. In one embodiment, the present invention may comprise a pharmaceutical composition comprising a compound identified by docking a computer representation of the compound with a computer representation of a three-dimensional structure of I7L, or a portion thereof. The structure of I7L or a portion thereof, may comprise at least some of the atomic coordinates as defined by Table 2. Also, the three dimensional structure of the compound used in the pharmaceutical composition may comprise at least some of the atomic coordinates of at least one of the docking modes as defined in Table 3. Or, the three dimensional structure of the compound used in the pharmaceutical composition may comprise at least some of the atomic coordinates of at least one of the docking modes as defined in Table 4.

The nature of the interaction between the compound of the pharmaceutical composition and the protein of interest may be defined in terms of the atomic interaction between the compound and the protein of interest. In an embodiment, the atomic interaction between a potential modulator compound and the I7L protein, or a portion thereof, comprises at least one atomic interaction selected from the group consisting of charge, electrostatic, hydrogen bond, and hydrophobic. Alternatively, the atomic interaction between a potential modulator compound and the I7L protein, or portion thereof, may comprise at least two hydrogen bond atomic interactions, at least two hydrophobic atomic interactions, and at least one of a charge or electrostatic interaction. Or, the atomic interaction between a potential modulator compound and the I7L protein, or a portion thereof, may comprise at least three hydrogen bond atomic interactions, at least three hydrophobic atomic interactions, and at least one of a charge or electrostatic interaction. For example, for I7L, the atomic interactions between the compound able to modify I7L and the I7L protein may comprise at least one of the atomic interactions described in Table 5. Or, the atomic interactions between the compound able to modify I7L and the I7L protein may comprise at least one of the atomic interactions described in Table 6.

The compound may be defined by its ability to interact with amino acids in the protein of interest that are important for catalytic activity and/or substrate binding. In one embodiment for an I7L modulating compound, the interacting atom or molecular group for I7L may comprise the catalytic cysteine of I7L. In one embodiment, the atomic interactions with the catalytic cysteine may comprise a charge or electrostatic interaction. Or, the interacting atom or molecular group for I7L may comprise at least one of amino acids Cys328, His241, Asp248, Asp258, of I7L. Or, the interacting atom or molecular group for I7L may comprise at least one of amino acids Leu324, Trp242, and Gln322 of I7L. Additionally, or alternatively, the interacting atom or molecular group of I7L may comprise at least one of Gly329, Leu323, Ser240, Trp168, Asp 194, Asn171, Ser173, Gln 322, Met195, Ser326, Glu327, Leu239, Leu177, Asn199, Met169, Phe236, Ile203, or Met233 of the I7L protein. In one embodiment, the I7L, or a portion thereof, is VV I7L.

Depending on the source of the protein used to generate a three-dimensional structure, there may be some variability in the absolute positioning of each amino acid. Still, due to the high homology maintained among I7L proteins from various sources at least in the catalytic triad region, it is to be expected that the relative positions of conserved amino acids may be maintained. For example, for I7L, the interacting group(s) used to determine the atomic interactions between the compound and I7L protein may comprise Cys(N), wherein position N corresponds to the catalytic cysteine of I7L. Additionally, the interacting group(s) may comprise at least one of His(N-87), Asp(N-80), Asp(N-70), of the I7L protein, wherein position N corresponds to the catalytic cysteine of I7L. Additionally, the interacting group(s) may comprise at least one of Leu(N-4), Trp(N-86), or Gln(N-6) of the I7L protein, wherein position N corresponds to the catalytic cysteine of I7L. Additionally, the interacting group of I7L may comprise at least one of Gly(N+1), Leu(N-5), Ser(N-88), Trp(N-160), Asp(N-134), Asn(N-157), Ser(N-155), Met(N-133), Ser(N-2), Glu(N-1), Leu(N-89), Leu(N-151), Asn(N-129), Met(N-159), Phe(N-92), Ile(N-125) or Met(N-95), wherein position N corresponds to the catalytic cysteine of I7L.

The compound may also be evaluated for its interaction with a modified I7L protein, or portion thereof, wherein the I7L comprises at least one of an amino acid substitution, an amino acid deletion, or an amino acid insertion. In one embodiment, the I7L amino acids used to determine the nature of the association between the compound and the I7L protein, or a portion thereof, comprise at least one of wild-type or altered amino acid in the I7L protein corresponding to positions 168, 169, 171, 173, 177, 194, 195, 199, 203, 233, 236, 239, 240, 241, 242, 248, 258, 322, 323, 324, 326, 327, 328, or 329 of the wild-type VV I7L protein.

The pharmaceutical composition may comprise the compound present in a therapeutically effective amount. In one embodiment, a therapeutically effective amount may comprise an amount sufficient to reduce a viral load in a subject. The dosage used for the pharmaceutical compositions of the present invention may vary depending on the specific compound being used, as well as the methods of administration. In one embodiment, a therapeutically effective amount may comprise a dose in a range from about 0.01 to 1,000 mg of active compound per kg body weight per day.

The pharmaceutical compositions and compounds of the present invention may be used to treat or prevent a variety of viral infections. The virus may comprise an orthopox virus, such as smallpox virrus, vaccinia virus, monkeypox virus, mulluscipox virus, cowpox virus, camelpox virus, variola major virus, variola minor virus, ectromelia virus, sheeppox virus, lumpy skin virus, Yaba-like virus, swinepox virus, rabbit fibroma virus, myxoma virus, fowlpox virus, canarypox virus, or amsacta moorei virus. In one example embodiment, the virus is smallpox virus. Also, additional anti-viral agents may be employed.

The present invention also comprises a method of conducting a drug-discovery business. The method may comprise the step of generating a three-dimensional structural model of a target molecule of interest on a computer. Also, the method may comprise generating a three-dimensional structural model of a potential modulator compound of the target molecule on a computer, and docking the model for the potential modulator compound to with the target molecule so as to minimize the free energy of the interaction between the target molecule and the potential modulator. In this way, a modulator compound that may interact with the target may be identified. The method may also include the subsequent steps of providing a modified structure for the modulator compound of interest, and assessing whether the modified structure has a lower free energy of interaction with the target than the original structure for the modulator compound.

The method may further include evaluating at least some of the potential modulator compounds identified by in silico screening in a biological assay. Once compounds initially identified by the in silico assay are corroborated by a biological assay, animal studies may be used for detailed therapeutic profiling, and pharmaceutical compositions may then be developed. Or, additional in silico assays may be conducted on compounds that appear to be promising based on the biological data.

In another embodiment, the present invention comprises treatment of orthopox viral infections using compounds identified by the methods and systems of the present invention and pharmaceutical compositions comprising such compounds. The virus may comprise smallpox virrus, vaccinia virus, monkeypox virus, mulluscipox virus, cowpox virus, camelpox virus, variola major virus, variola minor virus, ectromelia virus, sheeppox virus, lumpy skin virus, Yaba-like virus, swinepox virus, rabbit fibroma virus, myxoma virus, fowlpox virus, canarypox virus, or amsacta moorei virus. In one example embodiment, the virus is smallpox virus.

The compound may comprise a small organic compound. In one example embodiment, the compound may comprise TTP-A, or a salt or prodrug thereof, as defined herein. Or, the compound may comprise TTP-B, or a salt or prodrug thereof, as defined herein.

Structural Modeling of I7L

Embodiments of the present invention comprise computer modeling methods and systems to identify and optimize specific small molecules that bind to, and thus, are able to modulate the activity of, a particular target protein. In one embodiment, the protein is I7L. Also provided by the present invention are compounds identified using the modeling methods described herein.

Thus, in one embodiment, the present invention provides a method of generating a three-dimensional model of a protein, or a portion thereof. The method may comprise the steps of providing an amino acid sequence of the protein of interest and comparing the amino acid sequence of the protein of interest to the amino acid sequences of other proteins to identify a second protein for which a three-dimensional structure has been defined, and that has a predetermined level of sequence identity to the protein of interest. Once a second protein having a known structure has been identified, the method may include the step of aligning conserved residues from the protein of interest with conserved residues from the second protein. Next, the sequence for the protein of interest may be threaded along the three-dimensional structure of the second protein such that the position of at least two conserved residues from both proteins are aligned. The conserved residues from the first protein and the second protein may comprise residues that are essential for protein function.

Thus, as a first step, a three-dimensional model of the protein of interest may be generated. To generate a three dimensional model of a protein of interest, a sequence comparison to proteins with experimentally determined three-dimensional structures may be performed. The protein aligned with the protein of interest may comprise a protein having a similar sequence to the protein of interest. The level of sequence identity may range from at least 5% sequence identity, to more than 10% sequence identity, to more than 20% sequence identity.

The protein aligned with the protein of interest may not necessarily be functionally related to the protein of interest. Or, the protein aligned with the protein of interest may comprise a protein having a similar function to the protein of interest. In this way, conserved residues that have similar functions in the two proteins may be aligned.

In one embodiment, the protein of interest may comprise I7L. In performing structural modeling for I7L, a high sequence identity for vaccinia virus (VV) I7L is found with the C-terminal domain of another cysteine protease, Ubiquitin-like protease 1 (ULP1). ULP1 protease consists of 221 amino acids, and exhibits a 22% sequence identity with I7L. ULP1 may be used as a template for building the three dimensional model of I7L.

To develop a three dimensional structure for I7L, TTPredict™ site search algorithms may be used to identify the ligand binding site of I7L based on the location of active site residues His241, Asp248, and Cys328, that are known to be essential for I7L activity. Also, TTPredict™ algorithms may be used to identify known I7L-homologous sequences using BLAST searches on protein sequence databases. TTPredict™ algorithms may also be used to access a number of publicly available and vendor supplied fold recognition programs to analyze I7L sequence folds (e.g., MSI suite of programs, TTPGene). Such sequence comparisons reveal that, as compared to other proteins with known 3D structures, the C-terminus domain of ULP1 (wwPDB Protein Data Bank Archive: PDB code:1EUV) has a high structural homology to I7L sequence. The ligand binding domain of the I7L sequence (amino acids 110-423) may be mapped onto residues from the C-terminus of ULP1 protease domain using 3DPSM and the Homology modeling suites within the Accelrys suite of programs (San Diego, Calif.). Despite having only a 22% sequence identity with I7L, the 3D structure of ULP1 may be used as a threading template to generate a 3D model for the I7L query sequence.

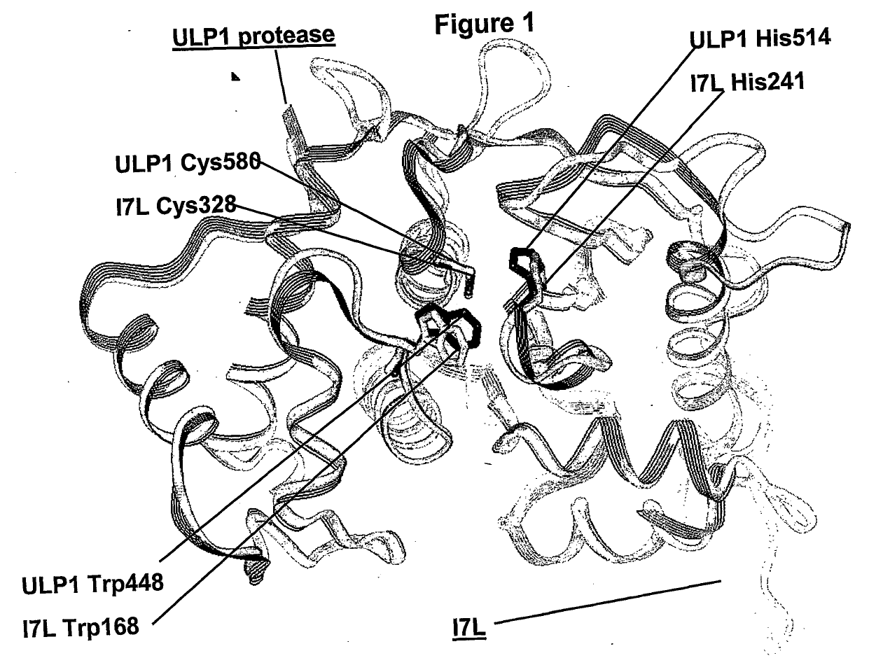

The threading approach may reveal distantly homologous proteins that share the same folding structure, but that do not comprise a high amount of sequence similarity. Rather than relying only on sequence alignment, the fold recognition method may blend the sequence-to-structure fitness with other structural characteristics, such as sequence similarity and predicted secondary structures, to find conserved residues that appear in both the template protein of interest (e.g., I7L) as well as any query sequences, and overlay both sequences, maintaining alignment of the conserved residues. Next, the threading program may match the query sequence on the three-dimensional structure of the template using conserved residues of the query protein as the hang points. The resulting model may then be cleaned-up using standard energy minimization and molecular dynamics techniques. In one embodiment, the conserved residues used as hang points may need to be determined a priori. FIG. 1 shows the results of the analysis for I7L and ULP1, wherein the hang point residues for ULP1 (His514, Cys580, and Trp448) are aligned with analogous and conserved I7L residues (His241, Cys328, Trp168) to generate a three-dimensional structure for I7L.

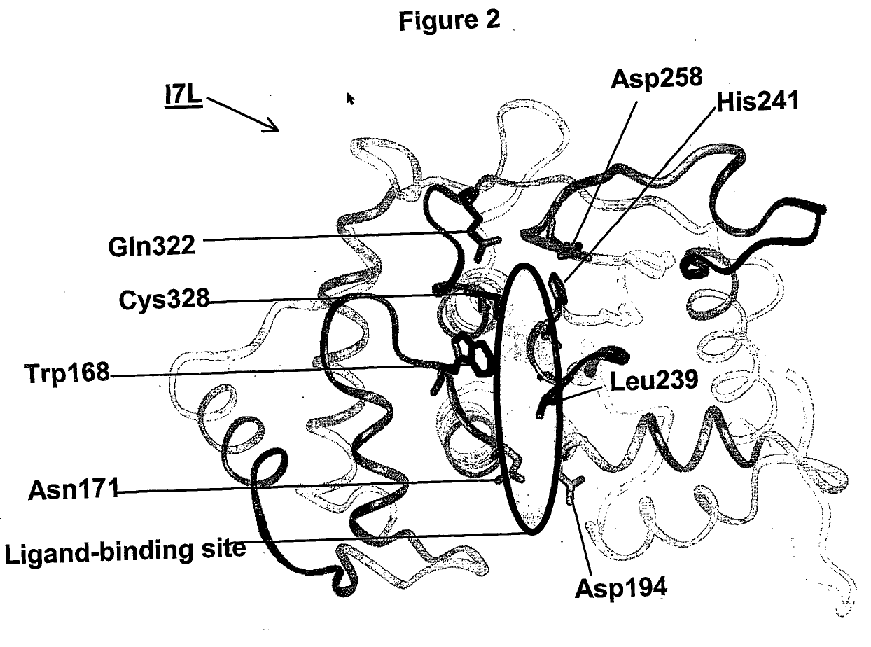

The present invention also comprises a computer-generated molecular model for I7L. For example, FIG. 2 shows a ribbon representation of I7L ligand binding domain based on alignment of the I7L protein sequence with ULP1 to generate a three-dimensional structure for the ligand binding domain of I7L. The model may comprise the catalytic site required for I7L-mediated cleavage of substrate proteins. The model may further include the ligand binding site for antiviral small molecule ligands. The predicted active site residues for I7L may include those residues that form the catalytic site, or residues that form the ligand binding site, or residues that participate in neighboring interactions required to maintain the structure of the ligand binding domain and/or the chemical functions required for the catalytic site. In FIG. 2, amino acid residues that comprise at least a part of the substrate binding pocket are labeled. Also, the predicted ligand binding site is shown within the oval shaped area.

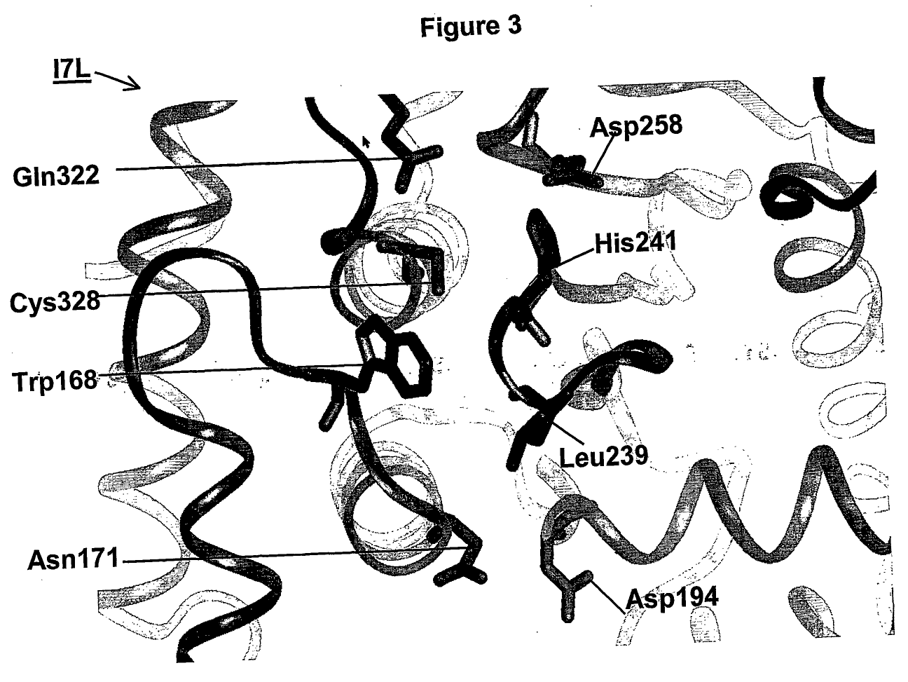

The model may be further refined once the initial structural coordinates are defined. Thus, specific aspects of the model, such as the catalytic site and/or a ligand binding site, may be refined to incorporate the structures of substrates or ligands that may be bound at that site. I7L has two domains, a cyteine protease domain and a DNA regulatory domain. In the present invention, the cysteine protease domain was modeled, and is referred to as the ligand binding domain. The ligand binding domain thus includes the catalytic site, where substrate polypeptides are hydrolyzed, and a ligand binding site, where small molecule ligands bind. For example, FIG. 3 shows a detailed map of the I7L ligand binding site. It can be seen that Gln 322, Cys 328 (the catalytic cysteine), Trp168, Asn171, Asp194, Leu239, His241 and Asp258 line the ligand-binding site to some extent (FIG. 3). As shown in FIG. 3, the catalytic cysteine residue, Cys328, is located deep in the pocket. The Trp168 side chain protects the Cys328 residue from the solvent. Table 1 lists residues that may comprise the I7L ligand binding and catalytic site. In an embodiment, a more detailed view, showing potential intramolecular interactions such as hydrophobic bonds, salt bridges and Van Der Waals interactions may be generated.

TABLE 1
Predicted catalytic site residues of I7L

Cys328, Leu 323, Leu324, His241, Ser240, Trp168, Asp194, Asp258,
Trp242, Asp248, Asn171, Ser173, Gln 322, Met195, Cys237, Leu239,
Leu177, Met233, Ile332, Ile174, Lys175, Leu198, Phe234, Gln192, Ile161

The structure of I7L may be defined by a graphic two-dimensional figure of a three-dimensional model as shown in FIGS. 1-3. The representations shown in FIG. 1-3 may also be viewed on a computer screen. When visualized on the computer, the models may be rotated to provide multiple views. For example, the viewer may rotate the model so as to provide a view that is rotated to the right or the left of the views shown in FIGS. 1-3. Or, the models depicted as FIG. 1-3 may be used to form a physical model.

Additionally, the structure of the I7L protein, or a portion thereof, may be defined by the atomic coordinates in three dimensional space. Table 2 provides the three-dimensional atomic coordinates for the I7L ligand binding domain, wherein the position of each atom is defined by a unique x, y, and z coordinate in three dimensional space. Shown in Table 2, is the identity of the atom (column 3), the amino acid and residue number (cols. 4 and 5), and the actual coordinates for each atom in x, y, and z dimensions (cols. 6, 7, and 8, respectively. As described herein, a data set of structural coordinates defines the three dimensional structure of a molecule or molecules. Structural coordinates can be slightly modified and still render nearly identical three dimensional structures. A measure of a unique set of structural coordinates is the root-mean-square deviation of the resulting structure. In alternate embodiments, structural coordinates that render three dimensional structures that deviate from one another by a root-mean-square deviation of less than 3.0 angstroms, or less than 2.0 angstroms, or less than 0.5 angstroms, or less than 0.3 angstroms, may be viewed by a person of ordinary skill in the art as identical or equivalent.

In Silico Screening of Putative I7L Modulators

The present invention further provides methods to dock compounds of interest, such as putative therapeutic agents, into the structure of the modeled protein to determine whether such putative therapeutic agents may interact with the protein. In one embodiment, the protein of interest is I7L protein, and the putative therapeutic agents are putative modulator compounds. For example, the modulator compounds may act as anti-viral agents. Thus, the putative therapeutic agents may bind to the ligand binding site and/or catalytic site to modify I7L activity.

To generate a three dimensional model of a potential modulator compound of interest, or a plurality of potential modulator compounds, a database of in silico structures for potential modulator compounds of interest, such as provided by TTProbes™, may be used. Once the three-dimensional structures of the modulator compounds of interest have been generated, the compounds may be docked into the ligand binding site of the protein of interest.

For example, in one embodiment, the site tested for interaction with potential modulator compounds being tested for anti-viral activity may comprise the ligand binding domain of I7L as described by the three-dimensional model. The amino acids which are assessed for interaction with the test compounds may comprise amino acids involved in catalysis, such as Cys328 of the VV I7L protein. Many of the residues relevant for I7L catalytic activity appear to be located in the immediate vicinity of the ligand binding site as defined by the three-dimensional model of the present invention. For example, in one embodiment, amino acids important for catatlytic activity are included within a 3 angstrom radius of the residues in Table 1. Additionally or alternatively, the amino acids important for catatlytic activity are included within a 3 angstrom radius of the catalytic cysteine, histindine, and/or aspartate in the catalytic triad. For example, there are several conserved amino acids, including Ser240, His 241, Trp168, Trp 242, Asp 248, Asp 258, Gln 322, Cys 328, and Gly 329, that may be relevant for I7L catalytic activity. Also, compounds may be specifically tested for their ability to interact in silico with Cys328 as the catalytic cysteine. For I7L, the amino acids assessed for putative interactions with test compounds may include at least some of the amino acids listed in Table 1. In one example embodiment, the amino acids tested for interaction with the test compound may comprise His 241, Trp 242, Asp 248, Asp 258, Gln 322, Cys 328, Gly 329, Leu324, Leu323, Ser240, Trp168, Asp194, Asn171, Ser173, Met195, Ser326, Glu327, Leu239, Leu177, Asn199, Met169, Phe236, Ile203, and/or Met233 of the vaccinia virus I7L.

The putative therapeutic agents may comprise a variety of compounds. In one embodiment, the putative therapeutic agent may comprise a peptide or a peptidomimetic. Or, the putative therapeutic agent may comprise an antibody. Alternatively, the putative therapeutic agent may comprise a small organic compound.

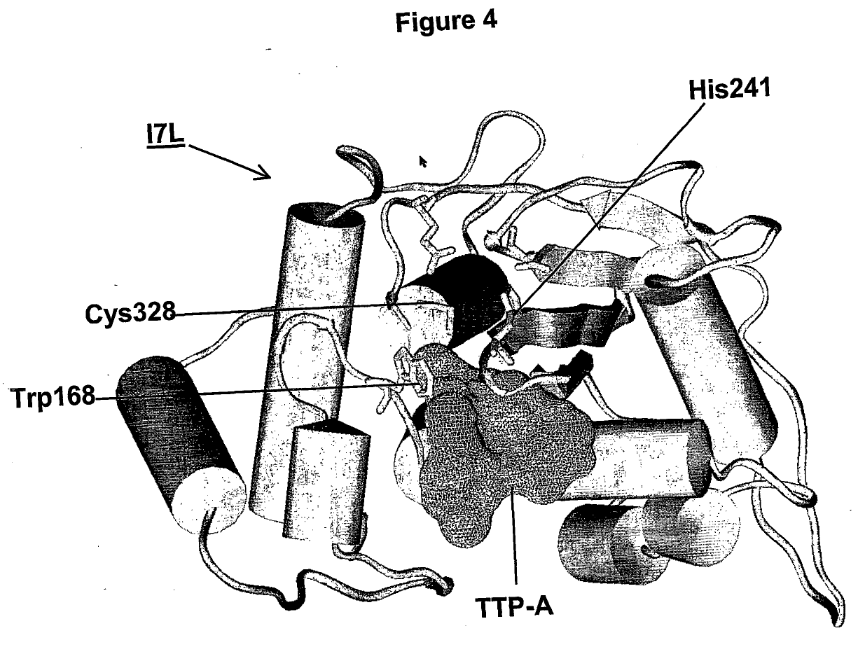

FIG. 4 shows a docking mode of a small organic compound with the I7L ligand binding domain. The compound shown, docked in the ligand binding domain of I7L is 3-hydroxy-naphthalene-2-carboxylic acid [2-(2-methoxy-4′-nitro-biphenyl-3-yl)-ethyl]-amide (TTE-A). TTP-A is shown as a meshed surface. It can be seen that one end of TTP-A makes contact with the catalytic cysteine (Cys328) and histidine (His241) residues and at least some of the other catalytic residues listed in Table 1. A similar compound, 3-(3′-chloro-4′-fluoro-biphenyl-4-yl)-2-[(4-hydroxy-4′-trifluoromethyl-biphenyl-3-carbonyl)-amino]-propionic acid methyl ester, (TTP-B), and other similar active analogs, make canonical contacts with active site residues of I7L protease.

The structure of a putative ligand may be provided as a three-dimensional space-filling model, as a rotatable model on a computer screen, or as atomic coordinates in three-dimensional space. In one embodiment, the compounds that dock into the ligand binding site with a negative free energy are considered to be favorable. In alternative embodiments, a compound having an free energy of interaction with I7L (or another molecule of interest) of less than −2 kcal/mol, or less than −5 kcal/mol, or less than −10 kcal/mole, are considered to provide favorable binding to the protein of interest. For example, Tables 3 and 4 provides the coordinates for several computed low-energy docking modes for TTP-A and TTP-B, respectively. For TTP-A, the energy of interaction is about −11.24 kcal for all five docking modes. For TTP-B, the energy of interaction ranges between −8.81 kcal/mol to about −10.68 kcal/mol for the five low-energy docking modes.

Thus, the three-dimensional coordinates as listed in Tables 3 and 4 provide the low energy structures of TTP-A and TTP-B, respectively, as each compound interacts with I7L. The low-energy docking modes for TTP-A as provided in Table 3, and for TTP-B as provided in Table 4, may favor interactions with at least some of the I7L residues listed in Table 1. In Tables 3 and 4, from the left, the second column identifies atom number, the third column identifies atom type, the fifth column identifies the docking mode (i.e., 1-5) the sixth column identifies the x coordinates, the seventh column identifies y coordinates, and the eighth column identifies the z coordinates.

In one example embodiment, TTP-A, TTP-B, and their derivatives, bind to the same binding surface of the I7L model. For example, in the predicted docking with I7L, active therapeutic compounds will make favorable contacts with at least some of the residues shown in Table 1. As the residues identified in Table 1 appear to be required for catalytic activity, it may be of importance that the putative therapeutic agent recognizes the binding surface that is described in Table 2 and at least some of the residues as described in Table 1 to provide the potential inhibit the cysteine protease activity of I7L.

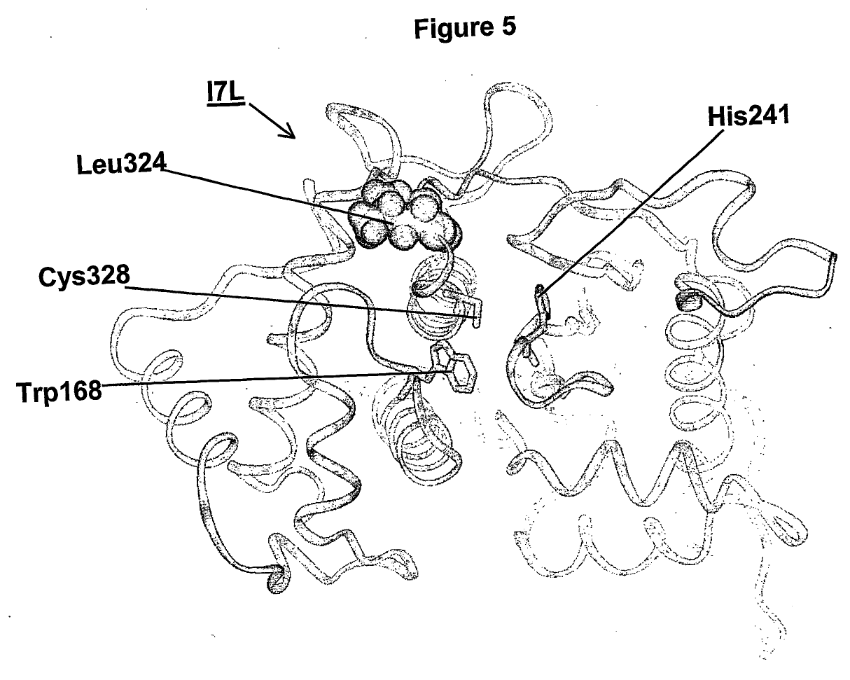

The molecular model may be further corroborated by studies of drug-resistant mutants. For example, in one embodiment, a drug-resistant virus may be isolated by passaging of the virus in the presence of the drug of interest. For example, a vaccinia virus passaged in the presence of TTP-A may, after several passages, result in the emergence of a viral strain that exhibits resistance to the inhibitory effects of TTP-A. The resistant virus may be isolated, and the I7L gene sequenced to determine whether resistance is due to a change of the I7L protein, such that the TTP-A is no longer as effective therapeutically. In one embodiment, passaging of the virus in the presence of TTP-A may result in a mutation of the I7L protein. For example, passage of vaccinia virus in the presence of TTP-A may result in mutations in certain positions of the protein. In alternate embodiments, there may be a Y to C mutation at position 104 of the I7L protein, and an L to M mutation at 324 of the I7L protein. FIG. 5 shows a model of the I7L active site showing that the position of Leu324 is in close proximity to the catalytic cysteine, Cys328.

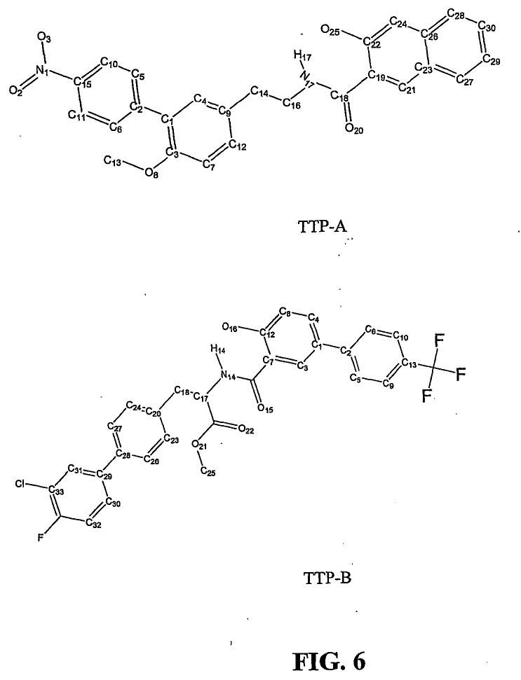

Tables 5 and 6, list the nature of several atomic interactions for TTP-A and TTP-B, respectively, with atoms in the I7L protein. Thus, Tables 5 and 6, identify groups on I7L, as defined by Table 2, that interact with the designated atom on TTP-A or TTF-B, as defined by the first docking mode of either Table 3 or Table 4, respectively. By comparing the relative coordinates of the I7L residues to the coordinates of the atoms in the first docking modes for TTP-A and TTP-B, the distance between the atoms and the type of interaction may be determined. The structures of TTP-A and TTP-B, with the numbering of atoms for each molecule as used in Tables 5 and 6, are shown in FIG. 6.

The molecular model may be used in a computational assay by which virtual ligands are inserted into the active site to identify those agents having the highest potential to bind to, and/or modify, the I7L activity. In a further embodiment, the compounds identified by molecular modeling are tested in a biological assay. For example, compounds may be evaluated to determine whether the compound displays cytotoxic effects on uninfected cells. Additionally, the compound may be evaluated to determine the amount of compound that exhibits an inhibition of cytopathic effect (CPE) of the virus.

The results of the determination of cytotoxicity may be compared to the effectiveness of the compound as an anti-viral agent, to determine the therapeutic index (TI) of the compound. The 50% inhibitory concentrations (IC50), measured as the concentration of the compound that results in inhibition of the viral cytopathic effect (CPE) for 50% of treated cells, and the 50% toxicity concentration, measured as the concentration of the compound at which 50% of uninfected cells display signs of cytotoxicity (TC50), may be compared, and the therapeutic index calculated as the value of TC50 divided by IC50.

The results of the biological assay may provide further data which can be used in the next round of molecular modeling. For example, compounds that display a large therapeutic index may be further modified in silico to attempt to improve the effectiveness of the compound and then reevaluated by a biological assay. The process may be repeated until a compound maximal TI is identified. In addition, the compound may be further developed by animal testing and formulation of an appropriate pharmaceutical composition.

In addition to a cell culture assay, a molecular assay of the effectiveness of the compounds identified by in silico screening may be performed. For example, the ability of a candidate compound such as TTP-A may be evaluated by determining whether the compound inhibits proteolysis of a I7L substrate, such as the P4b precursor protein, by I7L. Such molecular assays may provide evidence that the compound of interest is targeting the protein of interest to inhibit catalysis. If inhibition of cleavage of the substrate is not observed, it may indicate that the compound identified by in silico screening is acting at a different point of the viral formative and/or morphogenic cycle.

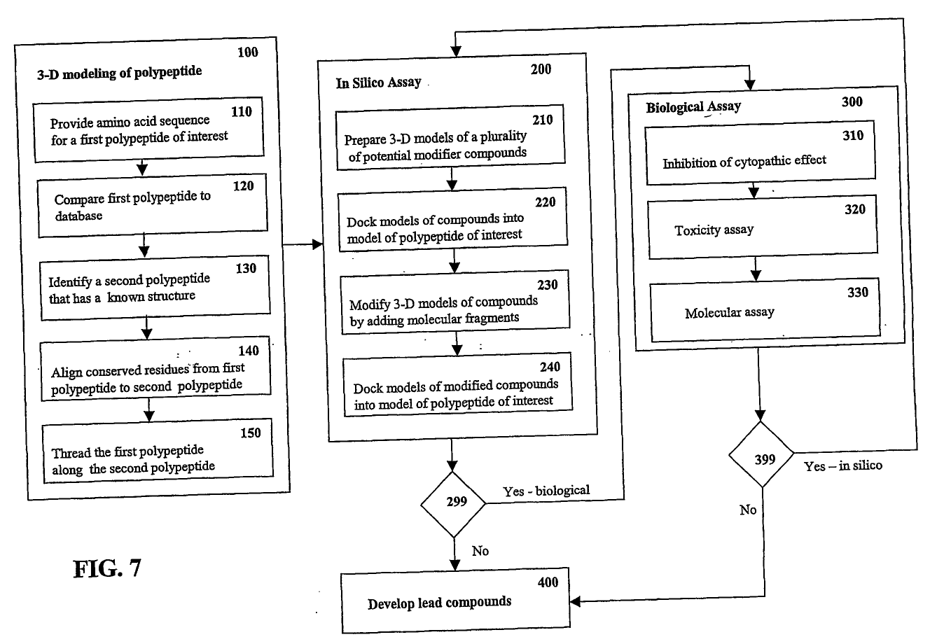

A schematic of a method used to develop anti-viral agents is shown in FIG. 7. Thus, the method may include a first stage 100 of developing a three-dimensional model of a protein or polypeptide of interest (e.g., viral I7L). As described herein, the method may comprise providing the amino acid sequence for the protein or polypeptide of interest 110. The sequence of the protein or polypeptide of interest may then be compared to amino acid sequences available in protein sequence databases 120 to identify proteins or polypeptides that have a known structure, and that may be homologous in structure to the protein or polypeptide of interest 130. If a second polypeptide or protein of known structure that has a sequence that includes regions of identity to the protein or polypeptide of interest is identified, the second protein may be used to align conserved residues from the second protein or polypeptide with the first protein or polypeptide of interest 140. The aligned residues (hang-points) may then be used as anchors as the first polypeptide or protein of interest is threaded along the structure of the second protein or polypeptide of interest to construct a three-dimensional model of the first polypeptide or protein of interest 150.

Once a three-dimensional model of the protein or polypeptide of interest has been constructed, it may be used in an in silico assay for screening a plurality of compounds 200. The in slico assay may comprise generating a library of three-dimensional structures for potential therapeutic agents 210. For example, in one embodiment a library of small high information density organic molecules (i.e., a library, wherein each small molecule within the library contains at least one functional group of interest) may be prepared. Such a library is provided by TTProbes™ (TransTech Pharma., Inc., High Point, N.C.) which is a set of more than 51,000 phramcophorically diverse molecules of high information density. The in silico probes may then be docked into the three-dimensional structure of the protein or polypeptide of interest as described herein to determine the atomic interactions between the protein/polypeptide and the compound 220. Optionally, the compound may also be modified by adding or removing molecular fragments from the compound 230, and then the modified compounds docked into the three-dimensional structure of the protein or polypeptide of interest 240 to determine how the changes to the structure of the compound may affect the interaction of the compound with the protein/polypeptide. Such molecular alterations may be made until there is no longer an apparent improvement in the ability of the compound to interact with the polypeptide/protein of interest. For example, for I7L, and using the TTProbes™ in silico library, over 3,000 candidate potential I7L modulators were identified. The method may include the option 299 of developing the compounds identified by in silico screening, or, performing further testing of the compounds by a biological assay.

Thus, still referring to FIG. 7, the putative therapeutic agents (i.e., potential modulator compounds) identified by in silico screening may then be evaluated by other types of assays for biological activity 300. For example, a putative receptor ligand may be evaluated using a binding assay. For putative anti-viral agents, the compounds may be evaluated to determine whether they inhibit viral growth and propagation 310. Also, the compounds may be evaluated to determine whether they are toxic to uninfected cells 320. For example, results of such biological tests for I7L indicate that of the 3,460 compounds identified by in silico screening, 136 inhibit viral replication and are not toxic. Additionally, compounds may be evaluated to determine if they inhibit enzymatic activity of the protein of interest 330. For example, for I7L, the cleavage of an I7L substrate, P4b, may be measured by electrophoresis of proteins from cell lysates from vaccinia virus-infected cells on SDS-PAGE gels. Treatment with TTP-A of viral infected cells results in inhibition of the cleavage of the P4b protein, as expected if TTP-A inhibits the catalytic activity of I7L (Byrd, C. M., et al., 2004, J. Virol. 78:12147-12156).

The results of the biological testing may indicate that certain structures are of interest as displaying efficacy as anti-viral agents. Thus, there is the option 399 to test at least some of these structures in additional in silico assays to determine if additional chemical modifications may be made to the structures to improve the therapeutic effects. Or, the compounds may then considered to be optimized, and thus, comprise lead compounds for additional animal studies and the like 400.

Therapeutics

The invention further provides pharmaceutical compositions comprising the antiviral active compounds of the invention. The pharmaceutical compositions containing a compound of the invention may be in a form suitable for oral use, for example, as tablets, troches, lozenges, aqueous, or oily suspensions, dispersible powders or granules, emulsions, hard or soft capsules, or syrups or elixirs. Compositions intended for oral use may be prepared according to any known method, and such compositions may contain one or more agents selected from the group consisting of sweetening agents, flavoring agents, coloring agents, and preserving agents in order to provide pharmaceutically elegant and palatable preparations. Tablets may contain the active ingredient in admixture with non-toxic pharmaceutically-acceptable excipients which are suitable for the manufacture of tablets. These excipients may be for example, inert diluents, such as calcium carbonate, sodium carbonate, lactose, calcium phosphate or sodium phosphate; granulating and disintegrating agents, for example corn starch or alginic acid; binding agents, for example, starch, gelatin or acacia; and lubricating agents, for example magnesium stearate, stearic acid or talc. The tablets may be uncoated or they may be coated by known techniques to delay disintegration and absorption in the gastrointestinal tract and thereby provide a sustained action over a longer period. For example, a time delay material such as glyceryl monostearate or glyceryl distearate may be employed. They may also be coated by the techniques described in U.S. Pat. Nos. 4,356,108; 4,166,452; and 4,265,874, to form osmotic therapeutic tablets for controlled release.

Formulations for oral use may also be presented as hard gelatin capsules where the active ingredient is mixed with an inert solid diluent, for example, calcium carbonate, calcium phosphate or kaolin, or a soft gelatin capsules wherein the active ingredient is mixed with water or an oil medium, for example peanut oil, liquid paraffin, or olive oil.

Aqueous suspensions may contain the active compounds in admixture with excipients suitable for the manufacture of aqueous suspensions. Such excipients are suspending agents, for example sodium carboxymethylcellulose, methylcellulose, hydroxypropylmethylcellulose, sodium alginate, polyvinylpyrrolidone, gum tragacanth and gum acacia; dispersing or wetting agents may be a naturally-occurring phosphatide such as lecithin, or condensation products of an alkylene oxide with fatty acids, for example polyoxyethylene stearate, or condensation products of ethylene oxide with long chain aliphatic alcohols, for example, heptadecaethyl-eneoxycetanol, or condensation products of ethylene oxide with partial esters derived from fatty acids and a hexitol such as polyoxyethylene sorbitol monooleate, or condensation products of ethylene oxide with partial esters derived from fatty acids and hexitol anhydrides, for example polyethylene sorbitan monooleate. The aqueous suspensions may also contain one or more coloring agents, one or more flavoring agents, and one or more sweetening agents, such as sucrose or saccharin.

Dispersible powders and granules suitable for preparation of an aqueous suspension by the addition of water provide the active compound in admixture with a dispersing or wetting agent, suspending agent and one or more preservatives. Suitable dispersing or wetting agents and suspending agents are exemplified by those already mentioned above. Additional excipients, for example, sweetening, flavoring, and coloring agents may also be present.

The pharmaceutical compositions of the invention may also be in the form of oil-in-water emulsions. The oily phase may be a vegetable oil, for example, olive oil or arachis oil, or a mineral oil, for example a liquid paraffin, or a mixture thereof. Suitable emulsifying agents may be naturally-occurring gums, for example gum acacia or gum tragacanth, naturally-occurring phosphatides, for example soy bean, lecithin, and esters or partial esters derived from fatty acids and hexitol anhydrides, for example sorbitan monooleate, and condensation products of said partial esters with ethylene oxide, for example polyoxyethylene sorbitan monooleate. The emulsions may also contain sweetening and flavoring agents.

Also, oily suspensions may be formulated by suspending the active ingredient in a vegetable oil, for example arachis oil, olive oil, sesame oil or coconut oil, or in a mineral oil such as a liquid paraffin. The oily suspensions may contain a thickening agent, for example beeswax, hard paraffin or cetyl alcohol. Sweetening agents such as those set forth above, and flavoring agents may be added to provide a palatable oral preparation. These compositions may be preserved by the addition of an anti-oxidant such as ascorbic acid. Syrups and elixirs may be formulated with sweetening agents, for example glycerol, propylene glycol, sorbitol or sucrose. Such formulations may also contain a demulcent, a preservative and flavoring and coloring agents.

The pharmaceutical compositions may also be in the form of a sterile injectible aqueous or oleaginous suspension. This suspension may be formulated according to the known methods using suitable dispersing or wetting agents and suspending agents described above. The sterile injectible preparation may also be a sterile injectible solution or suspension in a non-toxic parenterally-acceptable diluent or solvent, for example as a solution in 1,3-butanediol. Among the acceptable vehicles and solvents that may be employed are water, Ringer's solution, and isotonic sodium chloride solution. In addition, sterile, fixed oils are conveniently employed as solvent or suspending medium. For this purpose, any bland fixed oil may be employed using synthetic mono- or diglycerides. In addition, fatty acids such as oleic acid find use in the preparation of injectibles.

The compositions may also be in the form of suppositories for rectal administration of the compounds of the invention. These compositions can be prepared by mixing the drug with a suitable non-irritating excipient which is solid at ordinary temperatures but liquid at the rectal temperature and will thus melt in the rectum to release the drug. Such materials include cocoa butter and polyethylene glycols, for example.

For topical use, as for example for treatment of molluscipox virus, creams, ointments, jellies, solutions of suspensions, etc., containing the compounds of the invention are contemplated. For the purpose of this application, topical applications shall include mouthwashes and gargles.

The compounds of the present invention may also be administered in the form of liposome delivery systems, such as small unilamellar vesicles, large unilamellar vesicles, and multilamellar vesicles. Liposomes may be formed from a variety of phospholipids, such as cholesterol, stearylamine, or phosphatidylcholines.

Also provided by the present invention are prodrugs of the invention.

Pharmaceutically acceptable salts of the compounds of the present invention, where a basic or acidic group is present in the structure, are also included within the scope of the invention. The term “pharmaceutically acceptable salts” refers to non-toxic salts of the compounds of this invention which are generally prepared by reacting the free base with a suitable organic or inorganic acid or by reacting the acid with a suitable organic or inorganic base. Representative salts include the following salts: Acetate, Benzenesulfonate, Benzoate, Bicarbonate, Bisulfate, Bitartrate, Borate, Bromide, Calcium Edetate, Camsylate, Carbonate, Chloride, Clavulanate, Citrate, Dihydrochloride, Edetate, Edisylate, Estolate, Esylate, Fumarate, Gluceptate, Gluconate, Glutamate, Glycollylarsanilate, Hexylresorcinate, Hydrabamine, Hydrobromide, Hydrocloride, Hydroxynaphthoate, Iodide, Isethionate, Lactate, Lactobionate, Laurate, Malate, Maleate, Mandelate, Methanesulfonate, Methylbromide, Methylnitrate, Methylsulfate, Monopotassium Maleate, Mucate, Napsylate, Nitrate, N-methylglucamine, Oxalate, Pamoate (Embonate), Palmitate, Pantothenate, Phosphate/diphosphate, Polygalacturonate, Potassium, Salicylate, Sodium, Stearate, Subacetate, Succinate, Tannate, Tartrate, Teoclate, Tosylate, Triethiodide, Trimethylammonium and Valerate. When an acidic substituent is present, such as —COOH, there can be formed the ammonium, morpholinium, sodium, potassium, barium, calcium salt, and the like, for use as the dosage form. When a basic group is present, such as amino or a basic heteroaryl radical, such as pyridyl, an acidic salt, such as hydrochloride, hydrobromide, phosphate, sulfate, trifluoroacetate, trichloroacetate, acetate, oxalate, male ate, private, malamute, succinct, citrate, tartarate, fumarate, mandelate, benzoate, cinnamate, methanesulfonate, ethanesulfonate, picrate and the like. Other salts, which are not pharmaceutically acceptable, may be useful in the preparation of compounds of the invention; these form a further aspect of the invention.

In addition, some of the compounds identified as binding to, or modulating I7L, may form solvates with water or common organic solvents. Such solvates are also encompassed within the scope of the invention.

Thus, in another embodiment of the present invention, there is provided a pharmaceutical composition comprising a therapeutically effective amount of a compound identified as binding to or modulating I7L, or a pharmaceutically acceptable salt, solvate, or prodrug thereof, and one or more pharmaceutically acceptable carriers, excipients, or diluents. In an embodiment of the pharmaceutical composition, the compound identified as binding to or modulating I7L, is an inhibitor of orthopox viruses, including smallpox virus.

In another embodiment, the present invention provides a pharmaceutical composition comprising a therapeutically effective amount of the compound identified as binding to or modulating I7L, and one or more pharmaceutically acceptable carriers, excipients, or diluents, wherein said pharmaceutical composition is used to replace or supplement compounds that posses antiviral activity.

In another embodiment, the present invention provides a pharmaceutical composition comprising a therapeutically effective amount of the compound identified as binding to, or modulating I7L, and one or more pharmaceutically acceptable carriers, excipients, or diluents, and further comprising one or more additional therapeutic agents.

The compound identified as binding to, or modulating I7L, may administered in an amount sufficient to reduce the viral load in a subject. The compound identified as binding to, or modulating I7L, may be administered in the form of an oral dosage or parenteral dosage unit. In alternative embodiments, the compound identified as binding to, or modulating I7L, is administered as a dose in a range from about 0.01 to 1,000 mg/kg of body weight per day, or as a dose in a range from about 0.1 to 100 mg/kg of body weight per day, or as a dose in a range from about 0.5 to 10 mg/kg of body weight per day. In another embodiment, the compound identified as binding to, or modulating I7L, is used to replace or supplement a compound that inhibits viruses.

The present invention also provides a prophylactic method for the inhibition of pox virus infection comprising administering to a subject in need thereof a compound identified as binding to, or modulating I7L, wherein the compound is administered to the subject as a pharmaceutical composition comprising a therapeutically effective amount of the compound and one or more pharmaceutically acceptable carriers, excipients, or diluents. The therapeutically effective amount of the compound identified as binding to, or modulating I7L may inhibit a pox virus. A therapeutically effective amount of the compound identified as binding to, or modulating I7L, may comprises an amount sufficient to achieve and maintain a sustained blood level that at least partially inhibit virus growth. In alternative embodiments, the sustained blood level of the compound identified as modulating I7L may comprise a concentration ranging from about 0.01 μM to 2 mM, or from about 1 μM to 300 μM, or from about 20 μM to about 100 μM. In another embodiment of the method, the pharmaceutical composition may further comprise one or more additional therapeutic agents.

The following is a non-exhaustive listing of adjuvants and additional therapeutic agents which may be utilized in combination with the Smallpox inhibitor of the present invention:
1. Analgesics: Aspirin
2. NSAIDs (Nonsteroidal anti-inflammatory drugs): Ibuprofen, Naproxen, Diclofenac
3. DMARDs (Disease-Modifying Antirheumatic drugs): Methotrexate, gold preparations, hydroxychloroquine, sulfasalazine
4. Biological Response Modifiers: Etanercept, Infliximab, Glucocorticoids

In a further preferred embodiment, the present invention provides a method of treating or preventing viral—mediated diseases, the method comprising administering to a subject in need thereof, a therapeutically effective amount of a compound identified as binding to, or modulating I7L, alone or in combination with therapeutic agents selected from the group consisting of antibiotics, hormones, biologic response modifiers, analgesics, NSAIDs, DMARDs, or biological response modifiers. In one embodiment, the viral disease is caused by an orthopox virus, such as smallpox or other orthopox viruses.

For treatment of orthopox-mediated disease, or other viral disease, the compound identified as binding to, or modulating I7L, may be administered at a dosage level of from about 0.01 to 1000 mg/kg of the body weight of the subject being treated, or at a dosage range between 0.01 and 100 mg/kg, or at a dosage range between 0.5 to 10 mg/kg of body weight pet day. The amount of active ingredient that may be combined with the carrier materials to produce a single dosage will vary depending upon the host being treated and the particular mode of administration. For example, a formulation intended for oral administration to humans may contain 1 mg to 2 grams of a compound identified as binding to, or modulating I7L, with an appropriate and convenient amount of carrier material, which may vary from about 5 to 95 percent of the total composition. Dosage unit forms may, in one embodiment, contain between from about 5 mg to about 500 mg of active ingredient. As is known in the art, the dosage may be individualized by the clinician based on the specific clinical condition of the subject being treated. Thus, it will be understood that the specific dosage level for any particular patient will depend upon a variety of factors including the activity of the specific compound employed, the age, body weight, general health, sex, diet, time of administration, route of administration, rate of excretion, drug combination and the severity of the particular disease undergoing therapy.

### EXAMPLES

### Example 1

### Materials and Methods

Small organic compound stocks were prepared at a concentration of 10 mM in 100% dimethyl sulfoxide. The synthesis of TTP-A, TTP-B, and related compound is described in U.S. Patent Application 60/493,879, filed Aug. 8, 2003 (TTP 2003-08). The disclosure of U.S. Patent Application 60/493,879, is hereby incorporated by reference in its entirety herein.

Cell lines used to measure toxicity of the compounds and antiviral effects included BSC40 cells, which are BSC1 African green monkey kidney cells adapted to grow at 40° C. (Raczynski, P., et al., 1983, Virology, 128:458-462). The vvGFP line is a Western Reserve vaccinia virus with GGP in the thymidine kinase (TK) locus (Byrd, C. M., et al., 2004, J. Virol., 78:12147-12156).

### Example 2

### Computer Modeling

TransTech Pharma's Translational Technology™, described in U.S. patent application Ser. Nos. 10/120,278, filed Apr. 10, 2002, Ser. No. 10/410,965, filed Apr. 10, 2003, and Ser. No. 10/411,568, filed Apr. 10, 2003, each of which are incorporated by reference in their entireties, was used to model the I7L cysteine protease domain, to discover specific small molecule inhibitors, and to optimize I7L binding agents into preclinical drug candidates. TransTech Pharma's Translational Technology™ was designed and developed for rapid lead generation and optimization of drug candidates. The system consists of two subtechnologies: TTProbes™ and TTPredict™. TTProbes™ is a set of greater than 51,000 pharmacologically diverse molecules. TTPredict™, is a computer-based technology that automates high-throughput three-dimensional target model building, binding site identification, and conformational analysis. The TTPredict computer program is used to dock, score, and rank members of TTProbes set into a target binding site.

To develop putative anti-viral compounds, TTPredict™ was used to construct threading and homology models for I7L. I7L is known to be a member of the cysteine protease super-family and has 423 amino acid residues. Sequence comparison to proteins with experimentally determined three-dimensional (3D) structures showed that the highest sequence identity with vaccinia virus I7L is achieved by the Ubiquitin-like protease 1 (ULP1) protease C-terminal domain (PDB code: 1EUV). Such sequence comparisons were performed using PDBBlast (available on-line at the NCBI web-site), 3DPSM (Bates, P. A., et al., 2001, Enhancement of Protein Modeling by Human Intervention in Applying the Automatic Programs 3D-JIGSAW and 3D-PSSM, Proteins: Structure, Function and Genetics, Suppl 5:3946), MOE (MOE, Chemical Computing Group) (available on-line at the Chemical Computing Group web-site) and SeqFold within the MSI suite of programs (Accelrys Inc., San Diego, Calif.). ULP1 is also a member of the cysteine protease super-family and has 221 amino acids in the catalytic domain. Based on the sequence comparison, it was determined that ULP1 has a 22% sequence identity with I7L. The 303-residue ligand binding domain of I7L sequence (amino acids 110-423) was mapped onto 301 residues from the C-terminus of ULP1 protease domain using 3DPSM and the Homology modeling suites within the Accelrys suite of programs (San Diego, Calif.). The sequence of the I7L polypeptide comprising the three-dimensional model of Table 2 s provided herein as SEQ ID NO. 1. Despite having only a 22% sequence identity with I7L, the 3D structure of ULP1 was successfully used as a threading template to generate a 3D model for the I7L query sequence.

I7L and ULP1 sequences were aligned in a manner that maintains perfect alignment of their conserved residues. In particular, their catalytic Cys-His-Trp combination from the ULP1 catalytic domain were used as hang points to anchor I7L sequence on the 3D structure of ULP1. The threading protocols identified a Cys/His/Trp hang points triplets in I7L to be residues His241/Cys328/Trp168. The corresponding triplets in ULP1 protease were identified to be His514/Cys580/Trp448. Following threading, the Cα atoms of I7L residues were placed at the corresponding Cα positions of UIP1 using Homology module (Accelrys, San Diego, Calif.). The resulting structure was energy minimized using Discover (Accelrys) to generate I7L structure that served as a model. The hang point residues are shown in FIG. 1, which also shows the locations of these residues in I7L and ULP1 protease.

Site search algorithms were used to identify the catalytic site of I7L. The resulting model agrees well with previous structural and biochemical studies for cysteine proteases. For example, several conserved amino acids including His241, Trp242, Asp248, Asp258, Gln322, Cys328, and Gly329, have been experimentally shown to be relevant for I7L catalytic activity. In the three-dimensional model generated for I7L, it was found that most of these residues are located in the immediate vicinity of the catalytic site (FIG. 2).

Table 2 provides the coordinates for the three dimensional structure for I7L developed using the methods of the present invention. In this table, from the left, the second column identifies atom number; the third identifies atom type; the fourth column identifies amino acid type; the fifth column identifies the residue number; the sixth column identifies the x coordinates, the seventh column identifies y coordinates; and the eighth column identifies the z coordinates. Also, shown in the ninth column the occupancy, and the last column of Table 2 provides the temperature factor or B factor. The B factor can be defined as:
B=8*Π*2(<ud2>+<us2>);
where <ud2>, is the dynamic variability, and contains information on atom variability in an exposed versus buried state, and the temperature dependence on variation; and <us2>, is the static variability, and contains information relating to unresolved occupancy, altered electron density, and crystal disorder. The occupancy and B factor fields are not required for the analyses described herein, however.

### Example 3

### In Silico Assay

TTProbes were docked into the ligand binding site (FIG. 3). The fit of every docked probe was computed using several scoring functions. High-scoring probes were identified, and the highest ranking TTProbes were submitted for in vivo screening.

For I7L, the amino acid residues His 241, Trp 242, Asp 248, Asp 258, Gln 322, Cys 328, Gly 329, Leu324, Leu323, Ser240, Trp168, Asp194, Asn171, Ser173, Met195, Ser326, Glu327, Leu239, Leu177, and/or Met233 are predicted to be important in binding to substrates. In Table 1, additional amino acid residues that potentially bind to the substrate protein as well as that can bind to small molecule ligands are listed. Amino acids shown in bold font in the Table 1 are residues that appear to be critical in binding to small molecule ligands. Amino acid residues that are not in bold also constitute the ligand binding site. For clarity, only a few amino acid residues are identified in FIGS. 1-5, which show the ligand binding site.

The 51,389 probe molecules comprising TTProbes™ database were then docked into the catalytic site. The fit of every docked probe was computed using several scoring functions. Prior to docking the probes into I7L active site, 1000 low energy conformers per probe were generated using Monte-Carlo procedures. TTPredict™ was used to dock in silico every conformer into the predicted site of I7L. Individual or consensus scoring functions including LUDI (Böhm, H. J., 1994, J. Comp. Aided Molec. Design, 8:243-256), PLP (Gehlhaar et al, 1995, Chem. Bio., 2:317-324), DOCK (Meng, E. C., et al., 1992, J. Comp. Chem. 13:505-524), LigFit, (Accelrys, San Diego, Calif.), JAIN (Jain, A. N; 1996, J. Comp. Aided Molec. Design 10:427-440), and Poisson-Boltzmann (Honig, B. et al., 1995, Science, 268:1144-9) were used. High consensus scoring probes were identified and the 3,480 highest-ranking probes were submitted for in vitro (i.e., biological) testing. This process led to the identification of several lead compounds including, but not limited to, TTP-A and TTP-B.

Tables 3 and 4 provide the coordinates for the computed low-energy docking modes for TTP-A and TTP-B, respectively. Thus, the three-dimensional coordinates as listed in Tables 3 and 4 provide structures for TTP-A and TTP-B as each compound interacts with I7L. The docking modes as provided in Tables 2 and 3 are presented in order of increasing energy, where a low energy associated with docking the compound into the I7L protein is thermodynamically more favorable than a high energy of interaction. The low-energy docking modes for TTP-A and TTP-B as shown in Tables 3 and 4 favor interactions with I7L residues listed in Table 1. In Tables 3 and 4, from the left, the second column identifies atom number, the third column identifies atom type, the fourth column identifies molecule name, the sixth column identifies the x coordinates, the seventh column identifies y coordinates and the eighth column identifies the z coordinates. The last column of Tables 3 and 4 provides the temperature (B) factor.

Biological Assay

The following assay methods may be utilized to identify compounds that are effective in showing antiviral activity against vaccinia virus.

a. Cytotoxicity Assay

Cytopathic effect was measured on the BSC40 african green monkey kidney cells using 100 μM concentrations of the compounds tested in silico. In this assay, 96-well black Packard viewplates were seeded with BSC40 cells (2.25×10⁴ cells/well) in Minimum Essential Media supplemented with 5% FCS, 2 mM L-glutamine and 10 μg/mL gentamycin sulfate. When the cells became confluent (24 hrs) they were treated with 100 μM compound diluted in media. The cells were placed in an incubator at 37° C. (5% CO₂) for 24 hours, and checked for toxicity via direct observation under the microscope and also with alamar blue which assesses cell viability and proliferation (healthy cells produce a visible color change from blue to red). The cells were scored on a scale of 0-3 where 0 corresponds to normal healthy cells, 1 corresponds to unhealthy cells but not rounding up, 2 corresponds to cells that are rounding up, and 3 corresponds to cells that have rounded up and pulled off the plate. Compounds at concentrations that scored 1 or greater were diluted and the above assay was repeated to find the concentration at which the compound scored 0.

It was found that TTP-A exhibited a TC50 value of about 900 μM, and TTP-B exhibited a TC50 value of about 600 μM.

b. Anti-Viral Assay

A vvGFP assay may be performed to test the ability of each compound to inhibit viral growth as measured by a reduction in fluorescence from vaccinia virus expressing the green fluorescent protein (vvGFP). In this assay, 96-well black Packard viewplates are seeded with BSC40 cells in Minimum Essential Media supplemented with 5% FCS, 2 mM L-glutamine, and 10 μg/mL gentamycin sulfate. When the cells are confluent they are washed with PBS and then infected with vaccinia virus at a multiplicity of infection (MOI) of 0.1 for 30 min in PBS. At 30 minutes, the cells are overlaid with 100 μl of infection media supplemented with the compound of interest in doubling dilutions. As controls, infected cells are treated with rifampicin (to block assembly of DNA and protein into mature virus particles), AraC, hydroxyurea, with no compound, or mock infected. Cells are put in a 37° C. incubator (5% CO₂) for 24 hrs. At 24 hours post infection (pi), the plates are removed from the incubator, washed with PBS and fluorescence measured on a Wallac plate reader (using an excitation of 485 nm and reading at 535 nm). Wells that show reduced fluorescence are checked visually under the microscope to verify a reduction in viral infection versus a loss of cells due to cytopathic effect from virus infection. Compounds that are found to inhibit viral replication are then checked for inhibitory effect at various concentrations to determine the IC₅₀ and the therapeutic index. It was found that TTP-A exhibited a IC50 value of about 12 μM, and TTP-B exhibited a IC50 value of about 4.6 μM.

c. Determination of TI

The 50% inhibitor concentrations (IC50) were determined by cytopathic effect (CPE) inhibition as seen by fluorescence using vvGFP and plaque reduction assays with crystal violet staining or neutral red uptake. The 50% cell toxicity concentration (TC50) were determined as the concentrations of compounds that caused 50% of the cells to round up and show signs of toxicity both visibly and by the Alamar Blue dye assay. The therapeutic index was calculated as the value for TC50 divided by IC50. For TTP-A, a TI of about 75 was calculated: For TTP-B, a TI of about 130 was calculated.

### Example 3

### Drug-Resistant Viruses

To demonstrate that the target of TTP-A mediated inhibition is I7L protein, vvGFP was subjected to numerous passages in the presence of TTP-A to generate durg-resistant viral mutants (Byrd, C. M., et al., 2004, J. Virol. 78:12147-12156). Cells were infected with vvGFP at an MOI of 0.1 in the presence of the IC50 concentration of TTP-A for 24 h prior to being harvested. After determinining the titer, a portion of the virus-infected cell extract was used to infect fresh BSC40 cells. The titer of virus dropped seven logs from passage 0 to 4. Starting with passage 5, the progeny titer began to rise in the presence of the drug until a four log increase was observed by passage 7, presumably due to the emergence of a drug-resistant mutant population. After passage 9, individual viral plaques were purified, and the viral DNA isolated and sequenced. All of the resistant viruses were found to have mutations in positions 104 and 324, with a Y to C mutation at 104, and an L to M mutation at 324. FIG. 5 shows a model of the I7L active site showing the position of Leu324 in close proximity to the catalytic cysteine, Cys328.

While the invention has been described and illustrated with reference to certain preferred embodiments thereof, those skilled in the art will appreciate that various changes, modifications and substitutions can be made therein without departing from the spirit and scope of the invention. For example, effective dosages other than the preferred dosages as set forth herein may be applicable as a consequence of variations in the responsiveness of the mammal being treated for orthopox-mediated disease(s). Likewise, the specific pharmacological responses observed may vary according to and depending on the particular active compound selected or whether there are present pharmaceutical carriers, as well as the type of formulation and mode of administration employed, and such expected variations or differences in the results are contemplated in accordance with the objects and practices of the present invention.

TABLE 2
REMARK Model of I7L cysteine protease domain
REMARK

| | | | | | | | | | |
|---|---|---|---|---|---|---|---|---|---|
| ATOM | 1 | N | LYS | 120 | 35.399 | 18.046 | 91.616 | 1.00 | 33.54 |
| ATOM | 2 | CA | LYS | 120 | 36.155 | 19.054 | 90.839 | 1.00 | 33.54 |
| ATOM | 3 | CB | LYS | 120 | 36.788 | 18.386 | 89.607 | 1.00 | 33.54 |
| ATOM | 4 | CG | LYS | 120 | 37.840 | 17.338 | 89.979 | 1.00 | 33.54 |
| ATOM | 5 | CD | LYS | 120 | 38.181 | 16.372 | 88.842 | 1.00 | 33.54 |
| ATOM | 6 | CE | LYS | 120 | 39.240 | 15.329 | 89.215 | 1.00 | 33.54 |
| ATOM | 7 | NZ | LYS | 120 | 39.370 | 14.324 | 88.133 | 1.00 | 33.54 |
| ATOM | 8 | C | LYS | 120 | 35.214 | 20.123 | 90.391 | 1.00 | 33.54 |
| ATOM | 9 | O | LYS | 120 | 34.007 | 19.904 | 90.314 | 1.00 | 33.54 |
| ATOM | 10 | N | PRO | 121 | 35.732 | 21.292 | 90.132 | 1.00 | 130.82 |
| ATOM | 11 | CA | PRO | 121 | 34.868 | 22.345 | 89.684 | 1.00 | 130.82 |
| ATOM | 12 | CD | PRO | 121 | 36.861 | 21.796 | 90.893 | 1.00 | 130.82 |
| ATOM | 13 | CB | PRO | 121 | 35.646 | 23.643 | 89.883 | 1.00 | 130.82 |
| ATOM | 14 | CG | PRO | 121 | 36.621 | 23.308 | 91.027 | 1.00 | 130.82 |
| ATOM | 15 | C | PRO | 121 | 34.458 | 22.088 | 88.276 | 1.00 | 130.82 |
| ATOM | 16 | O | PRO | 121 | 35.303 | 21.715 | 87.465 | 1.00 | 130.82 |
| ATOM | 17 | N | ARG | 122 | 33.164 | 22.271 | 87.970 | 1.00 | 108.62 |
| ATOM | 18 | CA | ARG | 122 | 32.676 | 22.105 | 86.635 | 1.00 | 108.62 |
| ATOM | 19 | CB | ARG | 122 | 31.139 | 22.137 | 86.561 | 1.00 | 108.62 |
| ATOM | 20 | CG | ARG | 122 | 30.463 | 21.010 | 87.349 | 1.00 | 108.62 |
| ATOM | 21 | CD | ARG | 122 | 30.257 | 19.714 | 86.559 | 1.00 | 108.62 |
| ATOM | 22 | NE | ARG | 122 | 31.599 | 19.128 | 86.270 | 1.00 | 108.62 |
| ATOM | 23 | CZ | ARG | 122 | 32.195 | 19.334 | 85.057 | 1.00 | 108.62 |
| ATOM | 24 | NH1 | ARG | 122 | 31.553 | 20.056 | 84.094 | 1.00 | 108.62 |
| ATOM | 25 | NH2 | ARG | 122 | 33.429 | 18.808 | 84.806 | 1.00 | 108.62 |
| ATOM | 26 | C | ARG | 122 | 33.186 | 23.250 | 85.820 | 1.00 | 108.62 |
| ATOM | 27 | O | ARG | 122 | 33.508 | 23.103 | 84.643 | 1.00 | 108.62 |
| ATOM | 28 | N | LEU | 123 | 33.260 | 24.433 | 86.458 | 1.00 | 72.61 |
| ATOM | 29 | CA | LEU | 123 | 33.634 | 25.666 | 85.824 | 1.00 | 72.61 |
| ATOM | 30 | CB | LEU | 123 | 33.074 | 26.863 | 86.591 | 1.00 | 72.61 |
| ATOM | 31 | CG | LEU | 123 | 33.617 | 28.215 | 86.135 | 1.00 | 72.61 |
| ATOM | 32 | CD2 | LEU | 123 | 33.353 | 29.259 | 87.223 | 1.00 | 72.61 |
| ATOM | 33 | CD1 | LEU | 123 | 33.125 | 28.598 | 84.735 | 1.00 | 72.61 |
| ATOM | 34 | C | LEU | 123 | 35.117 | 25.813 | 85.846 | 1.00 | 72.61 |
| ATOM | 35 | O | LEU | 123 | 35.709 | 26.039 | 86.898 | 1.00 | 72.61 |
| ATOM | 36 | N | ARG | 124 | 35.742 | 25.733 | 84.657 | 1.00 | 69.73 |
| ATOM | 37 | CA | ARG | 124 | 37.165 | 25.842 | 84.529 | 1.00 | 69.73 |
| ATOM | 38 | CB | ARG | 124 | 37.696 | 25.293 | 83.192 | 1.00 | 69.73 |
| ATOM | 39 | CG | ARG | 124 | 37.332 | 23.830 | 82.919 | 1.00 | 69.73 |
| ATOM | 40 | CD | ARG | 124 | 37.850 | 23.313 | 81.573 | 1.00 | 69.73 |
| ATOM | 41 | NE | ARG | 124 | 37.270 | 21.957 | 81.360 | 1.00 | 69.73 |
| ATOM | 42 | CZ | ARG | 124 | 37.185 | 21.439 | 80.100 | 1.00 | 69.73 |
| ATOM | 43 | NH1 | ARG | 124 | 37.678 | 22.141 | 79.037 | 1.00 | 69.73 |
| ATOM | 44 | NH2 | ARG | 124 | 36.598 | 20.222 | 79.901 | 1.00 | 69.73 |
| ATOM | 45 | C | ARG | 124 | 37.513 | 27.293 | 84.548 | 1.00 | 69.73 |
| ATOM | 46 | O | ARG | 124 | 36.703 | 28.143 | 84.182 | 1.00 | 69.73 |
| ATOM | 47 | N | GLU | 125 | 38.736 | 27.625 | 85.002 | 1.00 | 99.91 |
| ATOM | 48 | CA | GLU | 125 | 39.122 | 28.999 | 84.932 | 1.00 | 99.91 |
| ATOM | 49 | CB | GLU | 125 | 39.774 | 29.571 | 86.198 | 1.00 | 99.91 |
| ATOM | 50 | CG | GLU | 125 | 41.124 | 28.962 | 86.547 | 1.00 | 99.91 |
| ATOM | 51 | CD | GLU | 125 | 41.597 | 29.709 | 87.780 | 1.00 | 99.91 |
| ATOM | 52 | OE1 | GLU | 125 | 41.288 | 30.928 | 87.873 | 1.00 | 99.91 |
| ATOM | 53 | OE2 | GLU | 125 | 42.257 | 29.078 | 88.646 | 1.00 | 99.91 |
| ATOM | 54 | C | GLU | 125 | 40.099 | 29.093 | 83.812 | 1.00 | 99.91 |
| ATOM | 55 | O | GLU | 125 | 40.881 | 28.175 | 83.570 | 1.00 | 99.91 |
| ATOM | 56 | N | LYS | 126 | 40.057 | 30.220 | 83.085 | 1.00 | 124.58 |
| ATOM | 57 | CA | LYS | 126 | 40.858 | 30.377 | 81.910 | 1.00 | 124.58 |
| ATOM | 58 | CB | LYS | 126 | 40.290 | 31.417 | 80.932 | 1.00 | 124.58 |
| ATOM | 59 | CG | LYS | 126 | 38.982 | 30.960 | 80.284 | 1.00 | 124.58 |
| ATOM | 60 | CD | LYS | 126 | 37.862 | 30.713 | 81.296 | 1.00 | 124.58 |
| ATOM | 61 | CE | LYS | 126 | 37.580 | 31.908 | 82.209 | 1.00 | 124.58 |
| ATOM | 62 | NZ | LYS | 126 | 36.552 | 31.544 | 83.207 | 1.00 | 124.58 |
| ATOM | 63 | C | LYS | 126 | 42.249 | 30.784 | 82.254 | 1.00 | 124.58 |
| ATOM | 64 | O | LYS | 126 | 42.528 | 31.325 | 83.322 | 1.00 | 124.58 |
| ATOM | 65 | N | VAL | 127 | 43.162 | 30.486 | 81.309 | 1.00 | 43.57 |
| ATOM | 66 | CA | VAL | 127 | 44.543 | 30.843 | 81.385 | 1.00 | 43.57 |
| ATOM | 67 | CB | VAL | 127 | 45.391 | 30.078 | 80.411 | 1.00 | 43.57 |
| ATOM | 68 | CG1 | VAL | 127 | 46.853 | 30.528 | 80.553 | 1.00 | 43.57 |
| ATOM | 69 | CG2 | VAL | 127 | 45.177 | 28.575 | 80.660 | 1.00 | 43.57 |
| ATOM | 70 | C | VAL | 127 | 44.590 | 32.296 | 81.023 | 1.00 | 43.57 |
| ATOM | 71 | O | VAL | 127 | 43.634 | 32.836 | 80.472 | 1.00 | 43.57 |
| ATOM | 72 | N | SER | 128 | 45.701 | 32.975 | 81.361 | 1.00 | 27.55 |
| ATOM | 73 | CA | SER | 128 | 45.817 | 34.385 | 81.130 | 1.00 | 27.55 |
| ATOM | 74 | CB | SER | 128 | 47.193 | 34.936 | 81.534 | 1.00 | 27.55 |
| ATOM | 75 | OG | SER | 128 | 47.397 | 34.783 | 82.931 | 1.00 | 27.55 |
| ATOM | 76 | C | SER | 128 | 45.641 | 34.676 | 79.673 | 1.00 | 27.55 |
| ATOM | 77 | O | SER | 128 | 44.968 | 35.638 | 79.309 | 1.00 | 27.55 |
| ATOM | 78 | N | LYS | 129 | 46.229 | 33.845 | 78.792 | 1.00 | 93.74 |
| ATOM | 79 | CA | LYS | 129 | 46.155 | 34.125 | 77.387 | 1.00 | 93.74 |
| ATOM | 80 | CB | LYS | 129 | 46.873 | 33.071 | 76.522 | 1.00 | 93.74 |
| ATOM | 81 | CG | LYS | 129 | 46.278 | 31.664 | 76.647 | 1.00 | 93.74 |
| ATOM | 82 | CD | LYS | 129 | 46.694 | 30.709 | 75.522 | 1.00 | 93.74 |
| ATOM | 83 | CE | LYS | 129 | 46.082 | 29.310 | 75.632 | 1.00 | 93.74 |
| ATOM | 84 | NZ | LYS | 129 | 46.523 | 28.653 | 76.883 | 1.00 | 93.74 |
| ATOM | 85 | C | LYS | 129 | 44.722 | 34.126 | 76.961 | 1.00 | 93.74 |
| ATOM | 86 | O | LYS | 129 | 44.268 | 35.036 | 76.268 | 1.00 | 93.74 |
| ATOM | 87 | N | ALA | 130 | 43.965 | 33.103 | 77.394 | 1.00 | 27.03 |
| ATOM | 88 | CA | ALA | 130 | 42.599 | 32.952 | 76.991 | 1.00 | 27.03 |
| ATOM | 89 | CB | ALA | 130 | 41.962 | 31.668 | 77.545 | 1.00 | 27.03 |
| ATOM | 90 | C | ALA | 130 | 41.786 | 34.106 | 77.481 | 1.00 | 27.03 |
| ATOM | 91 | O | ALA | 130 | 40.931 | 34.618 | 76.760 | 1.00 | 27.03 |
| ATOM | 92 | N | ILE | 131 | 42.031 | 34.550 | 78.728 | 1.00 | 34.84 |
| ATOM | 93 | CA | ILE | 131 | 41.253 | 35.613 | 79.303 | 1.00 | 34.84 |
| ATOM | 94 | CB | ILE | 131 | 41.617 | 35.916 | 80.726 | 1.00 | 34.84 |
| ATOM | 95 | CG2 | ILE | 131 | 40.905 | 37.219 | 81.125 | 1.00 | 34.84 |
| ATOM | 96 | CG1 | ILE | 131 | 41.279 | 34.722 | 81.635 | 1.00 | 34.84 |
| ATOM | 97 | CD1 | ILE | 131 | 41.796 | 34.881 | 83.065 | 1.00 | 34.84 |
| ATOM | 98 | C | ILE | 131 | 41.446 | 36.870 | 78.517 | 1.00 | 34.84 |
| ATOM | 99 | O | ILE | 131 | 40.492 | 37.605 | 78.266 | 1.00 | 34.84 |
| ATOM | 100 | N | ASP | 132 | 42.691 | 37.148 | 78.100 | 1.00 | 68.91 |
| ATOM | 101 | CA | ASP | 132 | 42.986 | 38.364 | 77.403 | 1.00 | 68.91 |
| ATOM | 102 | CB | ASP | 132 | 44.470 | 38.463 | 77.009 | 1.00 | 68.91 |
| ATOM | 103 | CG | ASP | 132 | 44.720 | 39.870 | 76.490 | 1.00 | 68.91 |
| ATOM | 104 | OD1 | ASP | 132 | 43.756 | 40.683 | 76.514 | 1.00 | 68.91 |
| ATOM | 105 | OD2 | ASP | 132 | 45.872 | 40.152 | 76.063 | 1.00 | 68.91 |
| ATOM | 106 | C | ASP | 132 | 42.186 | 38.398 | 76.141 | 1.00 | 68.91 |
| ATOM | 107 | O | ASP | 132 | 41.673 | 39.443 | 75.746 | 1.00 | 68.91 |
| ATOM | 108 | N | PHE | 133 | 42.048 | 37.232 | 75.485 | 1.00 | 73.74 |
| ATOM | 109 | CA | PHE | 133 | 41.365 | 37.133 | 74.230 | 1.00 | 73.74 |
| ATOM | 110 | CB | PHE | 133 | 41.384 | 35.691 | 73.696 | 1.00 | 73.74 |
| ATOM | 111 | CG | PHE | 133 | 40.936 | 35.690 | 72.275 | 1.00 | 73.74 |
| ATOM | 112 | CD1 | PHE | 133 | 41.817 | 36.027 | 71.274 | 1.00 | 73.74 |
| ATOM | 113 | CD2 | PHE | 133 | 39.649 | 35.344 | 71.943 | 1.00 | 73.74 |
| ATOM | 114 | CE1 | PHE | 133 | 41.416 | 36.025 | 69.958 | 1.00 | 73.74 |
| ATOM | 115 | CE2 | PHE | 133 | 39.242 | 35.341 | 70.629 | 1.00 | 73.74 |
| ATOM | 116 | CZ | PHE | 133 | 40.126 | 35.683 | 69.635 | 1.00 | 73.74 |
| ATOM | 117 | C | PHE | 133 | 39.943 | 37.555 | 74.434 | 1.00 | 73.74 |
| ATOM | 118 | O | PHE | 133 | 39.386 | 38.308 | 73.634 | 1.00 | 73.74 |
| ATOM | 119 | N | SER | 134 | 39.316 | 37.087 | 75.529 | 1.00 | 70.77 |
| ATOM | 120 | CA | SER | 134 | 37.947 | 37.423 | 75.794 | 1.00 | 70.77 |
| ATOM | 121 | CB | SER | 134 | 37.418 | 36.775 | 77.085 | 1.00 | 70.77 |
| ATOM | 122 | OG | SER | 134 | 37.409 | 35.360 | 76.959 | 1.00 | 70.77 |
| ATOM | 123 | C | SER | 134 | 37.831 | 38.909 | 75.958 | 1.00 | 70.77 |
| ATOM | 124 | O | SER | 134 | 36.913 | 39.529 | 75.424 | 1.00 | 70.77 |
| ATOM | 125 | N | GLN | 135 | 38.783 | 39.529 | 76.677 | 1.00 | 36.15 |
| ATOM | 126 | CA | GLN | 135 | 38.709 | 40.937 | 76.956 | 1.00 | 36.15 |
| ATOM | 127 | CB | GLN | 135 | 39.893 | 41.434 | 77.808 | 1.00 | 36.15 |
| ATOM | 128 | CG | GLN | 135 | 39.866 | 42.932 | 78.126 | 1.00 | 36.15 |
| ATOM | 129 | CD | GLN | 135 | 38.813 | 43.192 | 79.191 | 1.00 | 36.15 |
| ATOM | 130 | OE1 | GLN | 135 | 37.713 | 42.647 | 79.137 | 1.00 | 36.15 |
| ATOM | 131 | NE2 | GLN | 135 | 39.162 | 44.045 | 80.192 | 1.00 | 36.15 |
| ATOM | 132 | C | GLN | 135 | 38.731 | 41.714 | 75.675 | 1.00 | 36.15 |
| ATOM | 133 | O | GLN | 135 | 37.973 | 42.668 | 75.510 | 1.00 | 36.15 |
| ATOM | 134 | N | MET | 136 | 39.596 | 41.316 | 74.724 | 1.00 | 31.95 |
| ATOM | 135 | CA | MET | 136 | 39.739 | 42.050 | 73.500 | 1.00 | 31.95 |
| ATOM | 136 | CB | MET | 136 | 40.810 | 41.436 | 72.586 | 1.00 | 31.95 |
| ATOM | 137 | CG | MET | 136 | 42.207 | 41.448 | 73.209 | 1.00 | 31.95 |
| ATOM | 138 | SD | MET | 136 | 43.465 | 40.522 | 72.280 | 1.00 | 31.95 |
| ATOM | 139 | CE | MET | 136 | 43.593 | 41.727 | 70.929 | 1.00 | 31.95 |
| ATOM | 140 | C | MET | 136 | 38.447 | 42.026 | 72.743 | 1.00 | 31.95 |
| ATOM | 141 | O | MET | 136 | 38.001 | 43.051 | 72.228 | 1.00 | 31.95 |
| ATOM | 142 | N | ASP | 137 | 37.800 | 40.849 | 72.676 | 1.00 | 41.81 |
| ATOM | 143 | CA | ASP | 137 | 36.595 | 40.710 | 71.914 | 1.00 | 41.81 |
| ATOM | 144 | CB | ASP | 137 | 36.073 | 39.264 | 71.857 | 1.00 | 41.81 |
| ATOM | 145 | CG | ASP | 137 | 36.953 | 38.498 | 70.877 | 1.00 | 41.81 |
| ATOM | 146 | OD1 | ASP | 137 | 37.243 | 39.059 | 69.786 | 1.00 | 41.81 |
| ATOM | 147 | OD2 | ASP | 137 | 37.336 | 37.341 | 71.198 | 1.00 | 41.81 |
| ATOM | 148 | C | ASP | 137 | 35.519 | 41.570 | 72.501 | 1.00 | 41.81 |
| ATOM | 149 | O | ASP | 137 | 34.735 | 42.177 | 71.776 | 1.00 | 41.81 |
| ATOM | 150 | N | LEU | 138 | 35.467 | 41.658 | 73.838 | 1.00 | 100.75 |
| ATOM | 151 | CA | LEU | 138 | 34.440 | 42.407 | 74.494 | 1.00 | 100.75 |
| ATOM | 152 | CB | LEU | 138 | 34.625 | 42.351 | 76.028 | 1.00 | 100.75 |
| ATOM | 153 | CG | LEU | 138 | 33.547 | 43.003 | 76.929 | 1.00 | 100.75 |
| ATOM | 154 | CD2 | LEU | 138 | 33.267 | 44.480 | 76.598 | 1.00 | 100.75 |
| ATOM | 155 | CD1 | LEU | 138 | 33.931 | 42.830 | 78.409 | 1.00 | 100.75 |
| ATOM | 156 | C | LEU | 138 | 34.552 | 43.836 | 74.043 | 1.00 | 100.75 |
| ATOM | 157 | O | LEU | 138 | 33.543 | 44.490 | 73.785 | 1.00 | 100.75 |
| ATOM | 158 | N | LYS | 139 | 35.786 | 44.362 | 73.951 | 1.00 | 110.99 |
| ATOM | 159 | CA | LYS | 139 | 36.007 | 45.744 | 73.630 | 1.00 | 110.99 |
| ATOM | 160 | CB | LYS | 139 | 37.415 | 46.265 | 73.985 | 1.00 | 110.99 |
| ATOM | 161 | CG | LYS | 139 | 38.580 | 45.713 | 73.166 | 1.00 | 110.99 |
| ATOM | 162 | CD | LYS | 139 | 39.861 | 46.515 | 73.415 | 1.00 | 110.99 |
| ATOM | 163 | CE | LYS | 139 | 41.113 | 45.959 | 72.734 | 1.00 | 110.99 |
| ATOM | 164 | NZ | LYS | 139 | 42.277 | 46.819 | 73.056 | 1.00 | 110.99 |
| ATOM | 165 | C | LYS | 139 | 35.696 | 46.112 | 72.205 | 1.00 | 110.99 |
| ATOM | 166 | O | LYS | 139 | 35.380 | 47.274 | 71.954 | 1.00 | 110.99 |
| ATOM | 167 | N | ILE | 140 | 35.784 | 45.154 | 71.252 | 1.00 | 182.56 |
| ATOM | 168 | CA | ILE | 140 | 35.662 | 45.367 | 69.825 | 1.00 | 182.56 |
| ATOM | 169 | CB | ILE | 140 | 35.394 | 44.076 | 69.090 | 1.00 | 182.56 |
| ATOM | 170 | CG2 | ILE | 140 | 33.944 | 43.652 | 69.362 | 1.00 | 182.56 |
| ATOM | 171 | CG1 | ILE | 140 | 35.744 | 44.188 | 67.600 | 1.00 | 182.56 |
| ATOM | 172 | CD1 | ILE | 140 | 34.883 | 45.179 | 66.830 | 1.00 | 182.56 |
| ATOM | 173 | C | ILE | 140 | 34.591 | 46.380 | 69.511 | 1.00 | 182.56 |
| ATOM | 174 | O | ILE | 140 | 33.449 | 46.280 | 69.954 | 1.00 | 182.56 |
| ATOM | 175 | N | ASP | 141 | 34.971 | 47.425 | 68.741 | 1.00 | 152.17 |
| ATOM | 176 | CA | ASP | 141 | 34.097 | 48.531 | 68.453 | 1.00 | 152.17 |
| ATOM | 177 | CB | ASP | 141 | 34.810 | 49.688 | 67.725 | 1.00 | 152.17 |
| ATOM | 178 | CG | ASP | 141 | 33.873 | 50.896 | 67.721 | 1.00 | 152.17 |
| ATOM | 179 | OD1 | ASP | 141 | 32.825 | 50.827 | 68.417 | 1.00 | 152.17 |
| ATOM | 180 | OD2 | ASP | 141 | 34.188 | 51.898 | 67.025 | 1.00 | 152.17 |
| ATOM | 181 | C | ASP | 141 | 32.925 | 48.138 | 67.605 | 1.00 | 152.17 |
| ATOM | 182 | O | ASP | 141 | 31.792 | 48.505 | 67.908 | 1.00 | 152.17 |
| ATOM | 183 | N | ASP | 142 | 33.155 | 47.380 | 66.517 | 1.00 | 218.47 |
| ATOM | 184 | CA | ASP | 142 | 32.078 | 47.107 | 65.608 | 1.00 | 218.47 |
| ATOM | 185 | CB | ASP | 142 | 32.531 | 47.058 | 64.141 | 1.00 | 218.47 |
| ATOM | 186 | CG | ASP | 142 | 31.310 | 47.289 | 63.266 | 1.00 | 218.47 |
| ATOM | 187 | OD1 | ASP | 142 | 30.632 | 48.335 | 63.458 | 1.00 | 218.47 |
| ATOM | 188 | OD2 | ASP | 142 | 31.049 | 46.429 | 62.382 | 1.00 | 218.47 |
| ATOM | 189 | C | ASP | 142 | 31.409 | 45.813 | 65.949 | 1.00 | 218.47 |
| ATOM | 190 | O | ASP | 142 | 31.944 | 44.984 | 66.683 | 1.00 | 218.47 |
| ATOM | 191 | N | LEU | 143 | 30.195 | 45.611 | 65.401 | 1.00 | 82.28 |
| ATOM | 192 | CA | LEU | 143 | 29.456 | 44.420 | 65.681 | 1.00 | 82.28 |
| ATOM | 193 | CB | LEU | 143 | 27.940 | 44.671 | 65.688 | 1.00 | 82.28 |
| ATOM | 194 | CG | LEU | 143 | 27.528 | 45.802 | 66.656 | 1.00 | 82.28 |
| ATOM | 195 | CD2 | LEU | 143 | 28.095 | 45.575 | 68.067 | 1.00 | 82.28 |
| ATOM | 196 | CD1 | LEU | 143 | 26.009 | 46.028 | 66.645 | 1.00 | 82.28 |
| ATOM | 197 | C | LEU | 143 | 29.763 | 43.467 | 64.575 | 1.00 | 82.28 |
| ATOM | 198 | O | LEU | 143 | 29.085 | 43.442 | 63.548 | 1.00 | 82.28 |
| ATOM | 199 | N | SER | 144 | 30.806 | 42.642 | 64.773 | 1.00 | 84.93 |
| ATOM | 200 | CA | SER | 144 | 31.222 | 41.716 | 63.764 | 1.00 | 84.93 |
| ATOM | 201 | CB | SER | 144 | 32.744 | 41.714 | 63.557 | 1.00 | 84.93 |
| ATOM | 202 | OG | SER | 144 | 33.099 | 40.782 | 62.550 | 1.00 | 84.93 |
| ATOM | 203 | C | SER | 144 | 30.811 | 40.346 | 64.203 | 1.00 | 84.93 |
| ATOM | 204 | O | SER | 144 | 30.408 | 40.147 | 65.349 | 1.00 | 84.93 |
| ATOM | 205 | N | ARG | 145 | 30.893 | 39.361 | 63.285 | 1.00 | 99.45 |
| ATOM | 206 | CA | ARG | 145 | 30.495 | 38.020 | 63.611 | 1.00 | 99.45 |
| ATOM | 207 | CB | ARG | 145 | 29.996 | 37.210 | 62.402 | 1.00 | 99.45 |
| ATOM | 208 | CG | ARG | 145 | 31.049 | 37.044 | 61.307 | 1.00 | 99.45 |
| ATOM | 209 | CD | ARG | 145 | 30.544 | 36.270 | 60.089 | 1.00 | 99.45 |
| ATOM | 210 | NE | ARG | 145 | 31.664 | 36.206 | 59.108 | 1.00 | 99.45 |
| ATOM | 211 | CZ | ARG | 145 | 31.393 | 36.165 | 57.769 | 1.00 | 99.45 |
| ATOM | 212 | NH1 | ARG | 145 | 30.102 | 36.187 | 57.332 | 1.00 | 99.45 |
| ATOM | 213 | NH2 | ARG | 145 | 32.418 | 36.104 | 56.870 | 1.00 | 99.45 |
| ATOM | 214 | C | ARG | 145 | 31.681 | 37.305 | 64.173 | 1.00 | 99.45 |
| ATOM | 215 | O | ARG | 145 | 32.709 | 37.159 | 63.514 | 1.00 | 99.45 |
| ATOM | 216 | N | LYS | 146 | 31.566 | 36.900 | 65.454 | 1.00 | 170.67 |
| ATOM | 217 | CA | LYS | 146 | 32.599 | 36.199 | 66.166 | 1.00 | 170.67 |
| ATOM | 218 | CB | LYS | 146 | 32.405 | 36.207 | 67.689 | 1.00 | 170.67 |
| ATOM | 219 | CG | LYS | 146 | 33.548 | 35.509 | 68.432 | 1.00 | 170.67 |
| ATOM | 220 | CD | LYS | 146 | 34.895 | 36.235 | 68.340 | 1.00 | 170.67 |
| ATOM | 221 | CE | LYS | 146 | 35.822 | 35.707 | 67.238 | 1.00 | 170.67 |
| ATOM | 222 | NZ | LYS | 146 | 35.493 | 36.331 | 65.938 | 1.00 | 170.67 |
| ATOM | 223 | C | LYS | 146 | 32.714 | 34.770 | 65.741 | 1.00 | 170.67 |
| ATOM | 224 | O | LYS | 146 | 33.812 | 34.216 | 65.711 | 1.00 | 170.67 |
| ATOM | 225 | N | GLY | 147 | 31.578 | 34.107 | 65.446 | 1.00 | 42.81 |
| ATOM | 226 | CA | GLY | 147 | 31.717 | 32.728 | 65.079 | 1.00 | 42.81 |
| ATOM | 227 | C | GLY | 147 | 30.442 | 32.253 | 64.477 | 1.00 | 42.81 |
| ATOM | 228 | O | GLY | 147 | 29.360 | 32.720 | 64.831 | 1.00 | 42.81 |
| ATOM | 229 | N | ILE | 148 | 30.559 | 31.317 | 63.517 | 1.00 | 135.88 |
| ATOM | 230 | CA | ILE | 148 | 29.411 | 30.705 | 62.922 | 1.00 | 135.88 |
| ATOM | 231 | CB | ILE | 148 | 29.117 | 31.213 | 61.533 | 1.00 | 135.88 |
| ATOM | 232 | CG2 | ILE | 148 | 30.364 | 31.015 | 60.657 | 1.00 | 135.88 |
| ATOM | 233 | CG1 | ILE | 148 | 27.850 | 30.548 | 60.974 | 1.00 | 135.88 |
| ATOM | 234 | CD1 | ILE | 148 | 26.568 | 30.951 | 61.702 | 1.00 | 135.88 |
| ATOM | 235 | C | ILE | 148 | 29.693 | 29.237 | 62.839 | 1.00 | 135.88 |
| ATOM | 236 | O | ILE | 148 | 30.700 | 28.824 | 62.265 | 1.00 | 135.88 |
| ATOM | 237 | N | HIS | 149 | 28.822 | 28.397 | 63.435 | 1.00 | 129.16 |
| ATOM | 238 | CA | HIS | 149 | 29.042 | 26.989 | 63.306 | 1.00 | 129.16 |
| ATOM | 239 | ND1 | HIS | 149 | 31.259 | 24.787 | 62.306 | 1.00 | 129.16 |
| ATOM | 240 | CG | HIS | 149 | 30.723 | 25.107 | 63.534 | 1.00 | 129.16 |
| ATOM | 241 | CB | HIS | 149 | 30.353 | 26.501 | 63.947 | 1.00 | 129.16 |
| ATOM | 242 | NE2 | HIS | 149 | 31.102 | 22.884 | 63.445 | 1.00 | 129.16 |
| ATOM | 243 | CD2 | HIS | 149 | 30.633 | 23.933 | 64.217 | 1.00 | 129.16 |
| ATOM | 244 | CE1 | HIS | 149 | 31.468 | 23.446 | 62.307 | 1.00 | 129.16 |
| ATOM | 245 | C | HIS | 149 | 27.912 | 26.272 | 63.973 | 1.00 | 129.16 |
| ATOM | 246 | O | HIS | 149 | 27.326 | 26.763 | 64.935 | 1.00 | 129.16 |
| ATOM | 247 | N | THR | 150 | 27.571 | 25.081 | 63.445 | 1.00 | 179.98 |
| ATOM | 248 | CA | THR | 150 | 26.541 | 24.248 | 63.993 | 1.00 | 179.98 |
| ATOM | 249 | CB | THR | 150 | 26.887 | 23.769 | 65.380 | 1.00 | 179.98 |
| ATOM | 250 | OG1 | THR | 150 | 28.162 | 23.143 | 65.354 | 1.00 | 179.98 |
| ATOM | 251 | CG2 | THR | 150 | 25.847 | 22.736 | 65.856 | 1.00 | 179.98 |
| ATOM | 252 | C | THR | 150 | 25.249 | 25.014 | 64.002 | 1.00 | 179.98 |
| ATOM | 253 | O | THR | 150 | 24.363 | 24.774 | 64.819 | 1.00 | 179.98 |
| ATOM | 254 | N | GLY | 151 | 25.097 | 25.967 | 63.066 | 1.00 | 40.25 |
| ATOM | 255 | CA | GLY | 151 | 23.842 | 26.653 | 62.928 | 1.00 | 40.25 |
| ATOM | 256 | C | GLY | 151 | 23.686 | 27.753 | 63.937 | 1.00 | 40.25 |
| ATOM | 257 | O | GLY | 151 | 22.580 | 28.261 | 64.119 | 1.00 | 40.25 |
| ATOM | 258 | N | GLU | 152 | 24.761 | 28.150 | 64.641 | 1.00 | 77.36 |
| ATOM | 259 | CA | GLU | 152 | 24.597 | 29.251 | 65.551 | 1.00 | 77.36 |
| ATOM | 260 | CB | GLU | 152 | 24.867 | 28.897 | 67.024 | 1.00 | 77.36 |
| ATOM | 261 | CG | GLU | 152 | 24.688 | 30.087 | 67.968 | 1.00 | 77.36 |
| ATOM | 262 | CD | GLU | 152 | 23.221 | 30.490 | 67.936 | 1.00 | 77.36 |
| ATOM | 263 | OE1 | GLU | 152 | 22.411 | 29.729 | 67.341 | 1.00 | 77.36 |
| ATOM | 264 | OE2 | GLU | 152 | 22.889 | 31.567 | 68.502 | 1.00 | 77.36 |
| ATOM | 265 | C | GLU | 152 | 25.591 | 30.299 | 65.157 | 1.00 | 77.36 |
| ATOM | 266 | O | GLU | 152 | 26.781 | 30.013 | 65.031 | 1.00 | 77.36 |
| ATOM | 267 | N | ASN | 153 | 25.124 | 31.550 | 64.945 | 1.00 | 91.83 |
| ATOM | 268 | CA | ASN | 153 | 26.033 | 32.588 | 64.543 | 1.00 | 91.83 |
| ATOM | 269 | CB | ASN | 153 | 25.602 | 33.279 | 63.233 | 1.00 | 91.83 |
| ATOM | 270 | CG | ASN | 153 | 26.803 | 33.990 | 62.619 | 1.00 | 91.83 |
| ATOM | 271 | OD1 | ASN | 153 | 27.948 | 33.754 | 62.997 | 1.00 | 91.83 |
| ATOM | 272 | ND2 | ASN | 153 | 26.539 | 34.882 | 61.626 | 1.00 | 91.83 |
| ATOM | 273 | C | ASN | 153 | 26.041 | 33.642 | 65.611 | 1.00 | 91.83 |
| ATOM | 274 | O | ASN | 153 | 25.048 | 34.346 | 65.798 | 1.00 | 91.83 |
| ATOM | 275 | N | PRO | 154 | 27.105 | 33.707 | 66.372 | 1.00 | 157.76 |
| ATOM | 276 | CA | PRO | 154 | 27.188 | 34.780 | 67.333 | 1.00 | 157.76 |
| ATOM | 277 | CD | PRO | 154 | 27.523 | 32.448 | 66.972 | 1.00 | 157.76 |
| ATOM | 278 | CB | PRO | 154 | 27.889 | 34.220 | 68.566 | 1.00 | 157.76 |
| ATOM | 279 | CG | PRO | 154 | 27.607 | 32.717 | 68.482 | 1.00 | 157.76 |
| ATOM | 280 | C | PRO | 154 | 27.835 | 36.021 | 66.801 | 1.00 | 157.76 |
| ATOM | 281 | O | PRO | 154 | 28.727 | 35.922 | 65.960 | 1.00 | 157.76 |
| ATOM | 282 | N | LYS | 155 | 27.438 | 37.199 | 67.318 | 1.00 | 104.45 |
| ATOM | 283 | CA | LYS | 155 | 28.029 | 38.426 | 66.881 | 1.00 | 104.45 |
| ATOM | 284 | CB | LYS | 155 | 27.046 | 39.365 | 66.161 | 1.00 | 104.45 |
| ATOM | 285 | CG | LYS | 155 | 27.707 | 40.594 | 65.537 | 1.00 | 104.45 |
| ATOM | 286 | CD | LYS | 155 | 26.855 | 41.257 | 64.452 | 1.00 | 104.45 |
| ATOM | 287 | CE | LYS | 155 | 26.808 | 40.455 | 63.149 | 1.00 | 104.45 |
| ATOM | 288 | NZ | LYS | 155 | 25.975 | 41.155 | 62.145 | 1.00 | 104.45 |
| ATOM | 289 | C | LYS | 155 | 28.544 | 39.103 | 68.106 | 1.00 | 104.45 |
| ATOM | 290 | O | LYS | 155 | 28.388 | 38.600 | 69.218 | 1.00 | 104.45 |
| ATOM | 291 | N | VAL | 156 | 29.200 | 40.260 | 67.927 | 1.00 | 41.94 |
| ATOM | 292 | CA | VAL | 156 | 29.761 | 40.976 | 69.035 | 1.00 | 41.94 |
| ATOM | 293 | CB | VAL | 156 | 30.480 | 42.221 | 68.612 | 1.00 | 41.94 |
| ATOM | 294 | CG1 | VAL | 156 | 30.916 | 42.988 | 69.872 | 1.00 | 41.94 |
| ATOM | 295 | CG2 | VAL | 156 | 31.643 | 41.816 | 67.688 | 1.00 | 41.94 |
| ATOM | 296 | C | VAL | 156 | 28.653 | 41.373 | 69.958 | 1.00 | 41.94 |
| ATOM | 297 | O | VAL | 156 | 28.822 | 41.350 | 71.176 | 1.00 | 41.94 |
| ATOM | 298 | N | VAL | 157 | 27.485 | 41.744 | 69.400 | 1.00 | 88.03 |
| ATOM | 299 | CA | VAL | 157 | 26.391 | 42.181 | 70.216 | 1.00 | 88.03 |
| ATOM | 300 | CB | VAL | 157 | 25.167 | 42.545 | 69.417 | 1.00 | 88.03 |
| ATOM | 301 | CG1 | VAL | 157 | 25.470 | 43.799 | 68.581 | 1.00 | 88.03 |
| ATOM | 302 | CG2 | VAL | 157 | 24.767 | 41.331 | 68.561 | 1.00 | 88.03 |
| ATOM | 303 | C | VAL | 157 | 26.013 | 41.083 | 71.161 | 1.00 | 88.03 |
| ATOM | 304 | O | VAL | 157 | 25.806 | 41.332 | 72.348 | 1.00 | 88.03 |
| ATOM | 305 | N | LYS | 158 | 25.917 | 39.834 | 70.665 | 1.00 | 119.29 |
| ATOM | 306 | CA | LYS | 158 | 25.521 | 38.739 | 71.508 | 1.00 | 119.29 |
| ATOM | 307 | CB | LYS | 158 | 25.321 | 37.413 | 70.741 | 1.00 | 119.29 |
| ATOM | 308 | CG | LYS | 158 | 26.593 | 36.599 | 70.458 | 1.00 | 119.29 |
| ATOM | 309 | CD | LYS | 158 | 27.086 | 35.767 | 71.651 | 1.00 | 119.29 |
| ATOM | 310 | CE | LYS | 158 | 28.435 | 35.080 | 71.430 | 1.00 | 119.29 |
| ATOM | 311 | NZ | LYS | 158 | 28.872 | 34.421 | 72.683 | 1.00 | 119.29 |
| ATOM | 312 | C | LYS | 158 | 26.581 | 38.514 | 72.542 | 1.00 | 119.29 |
| ATOM | 313 | O | LYS | 158 | 26.291 | 38.253 | 73.708 | 1.00 | 119.29 |
| ATOM | 314 | N | MET | 159 | 27.851 | 38.634 | 72.120 | 1.00 | 113.21 |
| ATOM | 315 | CA | MET | 159 | 29.002 | 38.350 | 72.933 | 1.00 | 113.21 |
| ATOM | 316 | CB | MET | 159 | 30.299 | 38.614 | 72.151 | 1.00 | 113.21 |
| ATOM | 317 | CG | MET | 159 | 31.591 | 38.338 | 72.916 | 1.00 | 113.21 |
| ATOM | 318 | SD | MET | 159 | 31.999 | 36.577 | 73.119 | 1.00 | 113.21 |
| ATOM | 319 | CE | MET | 159 | 33.744 | 36.913 | 73.488 | 1.00 | 113.21 |
| ATOM | 320 | C | MET | 159 | 29.017 | 39.259 | 74.127 | 1.00 | 113.21 |
| ATOM | 321 | O | MET | 159 | 29.371 | 38.840 | 75.228 | 1.00 | 113.21 |
| ATOM | 322 | N | LYS | 160 | 28.612 | 40.527 | 73.928 | 1.00 | 132.62 |
| ATOM | 323 | CA | LYS | 160 | 28.633 | 41.576 | 74.914 | 1.00 | 132.62 |
| ATOM | 324 | CB | LYS | 160 | 28.228 | 42.940 | 74.336 | 1.00 | 132.62 |
| ATOM | 325 | CG | LYS | 160 | 28.501 | 44.097 | 75.296 | 1.00 | 132.62 |
| ATOM | 326 | CD | LYS | 160 | 28.568 | 45.457 | 74.602 | 1.00 | 132.62 |
| ATOM | 327 | CE | LYS | 160 | 29.870 | 45.660 | 73.822 | 1.00 | 132.62 |
| ATOM | 328 | NZ | LYS | 160 | 29.891 | 47.006 | 73.208 | 1.00 | 132.62 |
| ATOM | 329 | C | LYS | 160 | 27.727 | 41.236 | 76.058 | 1.00 | 132.62 |
| ATOM | 330 | O | LYS | 160 | 27.816 | 41.824 | 77.136 | 1.00 | 132.62 |
| ATOM | 331 | N | ILE | 161 | 26.778 | 40.318 | 75.834 | 1.00 | 105.62 |
| ATOM | 332 | CA | ILE | 161 | 25.916 | 39.853 | 76.882 | 1.00 | 105.62 |
| ATOM | 333 | CB | ILE | 161 | 24.969 | 38.804 | 76.397 | 1.00 | 105.62 |
| ATOM | 334 | CG2 | ILE | 161 | 24.558 | 37.977 | 77.615 | 1.00 | 105.62 |
| ATOM | 335 | CG1 | ILE | 161 | 23.824 | 39.418 | 75.571 | 1.00 | 105.62 |
| ATOM | 336 | CD1 | ILE | 161 | 24.275 | 40.036 | 74.249 | 1.00 | 105.62 |
| ATOM | 337 | C | ILE | 161 | 26.761 | 39.222 | 77.955 | 1.00 | 105.62 |
| ATOM | 338 | O | ILE | 161 | 26.429 | 39.283 | 79.139 | 1.00 | 105.62 |
| ATOM | 339 | N | GLU | 162 | 27.855 | 38.558 | 77.539 | 1.00 | 101.65 |
| ATOM | 340 | CA | GLU | 162 | 28.791 | 37.835 | 78.359 | 1.00 | 101.65 |
| ATOM | 341 | CB | GLU | 162 | 29.857 | 37.115 | 77.510 | 1.00 | 101.65 |
| ATOM | 342 | CG | GLU | 162 | 29.289 | 36.055 | 76.558 | 1.00 | 101.65 |
| ATOM | 343 | CD | GLU | 162 | 29.022 | 34.784 | 77.353 | 1.00 | 101.65 |
| ATOM | 344 | OE1 | GLU | 162 | 29.807 | 34.514 | 78.300 | 1.00 | 101.65 |
| ATOM | 345 | OE2 | GLU | 162 | 28.039 | 34.066 | 77.023 | 1.00 | 101.65 |
| ATOM | 346 | C | GLU | 162 | 29.520 | 38.760 | 79.301 | 1.00 | 101.65 |
| ATOM | 347 | O | GLU | 162 | 29.975 | 38.315 | 80.349 | 1.00 | 101.65 |
| ATOM | 348 | N | PRO | 163 | 29.709 | 40.011 | 78.991 | 1.00 | 149.57 |
| ATOM | 349 | CA | PRO | 163 | 30.404 | 40.832 | 79.941 | 1.00 | 149.57 |
| ATOM | 350 | CD | PRO | 163 | 30.143 | 40.348 | 77.648 | 1.00 | 149.57 |
| ATOM | 351 | CB | PRO | 163 | 30.630 | 42.156 | 79.228 | 1.00 | 149.57 |
| ATOM | 352 | CG | PRO | 163 | 30.900 | 41.687 | 77.784 | 1.00 | 149.57 |
| ATOM | 353 | C | PRO | 163 | 29.814 | 40.854 | 81.316 | 1.00 | 149.57 |
| ATOM | 354 | O | PRO | 163 | 28.611 | 40.645 | 81.486 | 1.00 | 149.57 |
| ATOM | 355 | N | GLU | 164 | 30.698 | 41.075 | 82.303 | 1.00 | 109.34 |
| ATOM | 356 | CA | GLU | 164 | 30.451 | 40.875 | 83.697 | 1.00 | 109.34 |
| ATOM | 357 | CB | GLU | 164 | 31.718 | 40.952 | 84.578 | 1.00 | 109.34 |
| ATOM | 358 | CG | GLU | 164 | 32.595 | 39.692 | 84.553 | 1.00 | 109.34 |
| ATOM | 359 | CD | GLU | 164 | 33.467 | 39.667 | 83.299 | 1.00 | 109.34 |
| ATOM | 360 | OE1 | GLU | 164 | 32.901 | 39.676 | 82.174 | 1.00 | 109.34 |
| ATOM | 361 | OE2 | GLU | 164 | 34.716 | 39.620 | 83.456 | 1.00 | 109.34 |
| ATOM | 362 | C | GLU | 164 | 29.426 | 41.788 | 84.262 | 1.00 | 109.34 |
| ATOM | 363 | O | GLU | 164 | 28.911 | 42.701 | 83.621 | 1.00 | 109.34 |
| ATOM | 364 | N | ARG | 165 | 29.114 | 41.483 | 85.534 | 1.00 | 129.57 |
| ATOM | 365 | CA | ARG | 165 | 28.160 | 42.146 | 86.357 | 1.00 | 129.57 |
| ATOM | 366 | CB | ARG | 165 | 28.490 | 43.624 | 86.611 | 1.00 | 129.57 |
| ATOM | 367 | CG | ARG | 165 | 29.804 | 43.774 | 87.382 | 1.00 | 129.57 |
| ATOM | 368 | CD | ARG | 165 | 29.823 | 44.959 | 88.349 | 1.00 | 129.57 |
| ATOM | 369 | NE | ARG | 165 | 29.072 | 44.525 | 89.562 | 1.00 | 129.57 |
| ATOM | 370 | CZ | ARG | 165 | 27.712 | 44.640 | 89.597 | 1.00 | 129.57 |
| ATOM | 371 | NH1 | ARG | 165 | 27.046 | 45.184 | 88.536 | 1.00 | 129.57 |
| ATOM | 372 | NH2 | ARG | 165 | 27.012 | 44.212 | 90.687 | 1.00 | 129.57 |
| ATOM | 373 | C | ARG | 165 | 26.770 | 41.983 | 85.845 | 1.00 | 129.57 |
| ATOM | 374 | O | ARG | 165 | 25.997 | 42.935 | 85.757 | 1.00 | 129.57 |
| ATOM | 375 | N | GLY | 166 | 26.427 | 40.733 | 85.489 | 1.00 | 25.71 |
| ATOM | 376 | CA | GLY | 166 | 25.066 | 40.405 | 85.201 | 1.00 | 25.71 |
| ATOM | 377 | C | GLY | 166 | 24.588 | 41.029 | 83.939 | 1.00 | 25.71 |
| ATOM | 378 | O | GLY | 166 | 23.469 | 41.537 | 83.889 | 1.00 | 25.71 |
| ATOM | 379 | N | ALA | 167 | 25.412 | 41.045 | 82.881 | 1.00 | 39.89 |
| ATOM | 380 | CA | ALA | 167 | 24.824 | 41.529 | 81.673 | 1.00 | 39.89 |
| ATOM | 381 | CB | ALA | 167 | 25.803 | 41.591 | 80.487 | 1.00 | 39.89 |
| ATOM | 382 | C | ALA | 167 | 23.765 | 40.517 | 81.363 | 1.00 | 39.89 |
| ATOM | 383 | O | ALA | 167 | 23.952 | 39.327 | 81.613 | 1.00 | 39.89 |
| ATOM | 384 | N | TRP | 168 | 22.604 | 40.959 | 80.841 | 1.00 | 48.42 |
| ATOM | 385 | CA | TRP | 168 | 21.553 | 40.012 | 80.588 | 1.00 | 48.42 |
| ATOM | 386 | CB | TRP | 168 | 20.214 | 40.650 | 80.184 | 1.00 | 48.42 |
| ATOM | 387 | CG | TRP | 168 | 19.480 | 41.360 | 81.299 | 1.00 | 48.42 |
| ATOM | 388 | CD2 | TRP | 168 | 18.264 | 42.095 | 81.105 | 1.00 | 48.42 |
| ATOM | 389 | CD1 | TRP | 168 | 19.780 | 41.444 | 82.626 | 1.00 | 48.42 |
| ATOM | 390 | NE1 | TRP | 168 | 18.822 | 42.187 | 83.277 | 1.00 | 48.42 |
| ATOM | 391 | CE2 | TRP | 168 | 17.882 | 42.594 | 82.351 | 1.00 | 48.42 |
| ATOM | 392 | CE3 | TRP | 168 | 17.522 | 42.337 | 79.985 | 1.00 | 48.42 |
| ATOM | 393 | CZ2 | TRP | 168 | 16.750 | 43.344 | 82.495 | 1.00 | 48.42 |
| ATOM | 394 | CZ3 | TRP | 168 | 16.382 | 43.094 | 80.130 | 1.00 | 48.42 |
| ATOM | 395 | CH2 | TRP | 168 | 16.003 | 43.586 | 81.360 | 1.00 | 48.42 |
| ATOM | 396 | C | TRP | 168 | 21.969 | 39.125 | 79.464 | 1.00 | 48.42 |
| ATOM | 397 | O | TRP | 168 | 22.502 | 39.585 | 78.456 | 1.00 | 48.42 |
| ATOM | 398 | N | MET | 169 | 21.721 | 37.810 | 79.626 | 1.00 | 113.87 |
| ATOM | 399 | CA | MET | 169 | 22.065 | 36.831 | 78.636 | 1.00 | 113.87 |
| ATOM | 400 | CB | MET | 169 | 22.066 | 35.398 | 79.189 | 1.00 | 113.87 |
| ATOM | 401 | CG | MET | 169 | 22.977 | 35.218 | 80.403 | 1.00 | 113.87 |
| ATOM | 402 | SD | MET | 169 | 24.741 | 35.504 | 80.082 | 1.00 | 113.87 |
| ATOM | 403 | CE | MET | 169 | 25.237 | 35.178 | 81.797 | 1.00 | 113.87 |
| ATOM | 404 | C | MET | 169 | 21.021 | 36.871 | 77.569 | 1.00 | 113.87 |
| ATOM | 405 | O | MET | 169 | 19.835 | 37.019 | 77.859 | 1.00 | 113.87 |
| ATOM | 406 | N | SER | 170 | 21.449 | 36.761 | 76.295 | 1.00 | 44.41 |
| ATOM | 407 | CA | SER | 170 | 20.522 | 36.747 | 75.200 | 1.00 | 44.41 |
| ATOM | 408 | CB | SER | 170 | 21.047 | 37.460 | 73.941 | 1.00 | 44.41 |
| ATOM | 409 | OG | SER | 170 | 22.180 | 36.772 | 73.432 | 1.00 | 44.41 |
| ATOM | 410 | C | SER | 170 | 20.251 | 35.320 | 74.832 | 1.00 | 44.41 |
| ATOM | 411 | O | SER | 170 | 20.873 | 34.395 | 75.353 | 1.00 | 44.41 |
| ATOM | 412 | N | ASN | 171 | 19.296 | 35.114 | 73.904 | 1.00 | 104.44 |
| ATOM | 413 | CA | ASN | 171 | 18.893 | 33.808 | 73.463 | 1.00 | 104.44 |
| ATOM | 414 | CB | ASN | 171 | 17.732 | 33.848 | 72.457 | 1.00 | 104.44 |
| ATOM | 415 | CG | ASN | 171 | 18.016 | 34.953 | 71.455 | 1.00 | 104.44 |
| ATOM | 416 | OD1 | ASN | 171 | 19.150 | 35.139 | 71.017 | 1.00 | 104.44 |
| ATOM | 417 | ND2 | ASN | 171 | 16.954 | 35.717 | 71.085 | 1.00 | 104.44 |
| ATOM | 418 | C | ASN | 171 | 20.036 | 33.154 | 72.758 | 1.00 | 104.44 |
| ATOM | 419 | O | ASN | 171 | 20.234 | 31.946 | 72.869 | 1.00 | 104.44 |
| ATOM | 420 | N | ARG | 172 | 20.813 | 33.945 | 71.997 | 1.00 | 54.25 |
| ATOM | 421 | CA | ARG | 172 | 21.870 | 33.392 | 71.204 | 1.00 | 54.25 |
| ATOM | 422 | CB | ARG | 172 | 22.516 | 34.441 | 70.288 | 1.00 | 54.25 |
| ATOM | 423 | CG | ARG | 172 | 21.483 | 35.000 | 69.305 | 1.00 | 54.25 |
| ATOM | 424 | CD | ARG | 172 | 22.058 | 35.740 | 68.098 | 1.00 | 54.25 |
| ATOM | 425 | NE | ARG | 172 | 20.902 | 36.112 | 67.233 | 1.00 | 54.25 |
| ATOM | 426 | CZ | ARG | 172 | 20.306 | 35.165 | 66.448 | 1.00 | 54.25 |
| ATOM | 427 | NH1 | ARG | 172 | 20.754 | 33.875 | 66.474 | 1.00 | 54.25 |
| ATOM | 428 | NH2 | ARG | 172 | 19.258 | 35.503 | 65.644 | 1.00 | 54.25 |
| ATOM | 429 | C | ARG | 172 | 22.901 | 32.758 | 72.085 | 1.00 | 54.25 |
| ATOM | 430 | O | ARG | 172 | 23.403 | 31.678 | 71.777 | 1.00 | 54.25 |
| ATOM | 431 | N | SER | 173 | 23.249 | 33.407 | 73.210 | 1.00 | 73.33 |
| ATOM | 432 | CA | SER | 173 | 24.218 | 32.835 | 74.104 | 1.00 | 73.33 |
| ATOM | 433 | CB | SER | 173 | 24.556 | 33.763 | 75.282 | 1.00 | 73.33 |
| ATOM | 434 | OG | SER | 173 | 25.518 | 33.149 | 76.127 | 1.00 | 73.33 |
| ATOM | 435 | C | SER | 173 | 23.647 | 31.573 | 74.677 | 1.00 | 73.33 |
| ATOM | 436 | O | SER | 173 | 24.340 | 30.566 | 74.810 | 1.00 | 73.33 |
| ATOM | 437 | N | ILE | 174 | 22.348 | 31.586 | 75.014 | 1.00 | 96.15 |
| ATOM | 438 | CA | ILE | 174 | 21.744 | 30.433 | 75.614 | 1.00 | 96.15 |
| ATOM | 439 | CB | ILE | 174 | 20.293 | 30.641 | 75.937 | 1.00 | 96.15 |
| ATOM | 440 | CG2 | ILE | 174 | 19.735 | 29.300 | 76.446 | 1.00 | 96.15 |
| ATOM | 441 | CG1 | ILE | 174 | 20.120 | 31.803 | 76.930 | 1.00 | 96.15 |
| ATOM | 442 | CD1 | ILE | 174 | 20.838 | 31.583 | 78.260 | 1.00 | 96.15 |
| ATOM | 443 | C | ILE | 174 | 21.819 | 29.293 | 74.642 | 1.00 | 96.15 |
| ATOM | 444 | O | ILE | 174 | 22.172 | 28.176 | 75.017 | 1.00 | 96.15 |
| ATOM | 445 | N | LYS | 175 | 21.501 | 29.548 | 73.356 | 1.00 | 57.53 |
| ATOM | 446 | CA | LYS | 175 | 21.513 | 28.498 | 72.378 | 1.00 | 57.53 |
| ATOM | 447 | CB | LYS | 175 | 21.072 | 28.944 | 70.974 | 1.00 | 57.53 |
| ATOM | 448 | CG | LYS | 175 | 21.119 | 27.794 | 69.964 | 1.00 | 57.53 |
| ATOM | 449 | CD | LYS | 175 | 21.869 | 26.552 | 70.448 | 1.00 | 57.53 |
| ATOM | 450 | CE | LYS | 175 | 23.357 | 26.545 | 70.092 | 1.00 | 57.53 |
| ATOM | 451 | NZ | LYS | 175 | 23.651 | 25.411 | 69.188 | 1.00 | 57.53 |
| ATOM | 452 | C | LYS | 175 | 22.897 | 27.961 | 72.228 | 1.00 | 57.53 |
| ATOM | 453 | O | LYS | 175 | 23.090 | 26.751 | 72.121 | 1.00 | 57.53 |
| ATOM | 454 | N | ASN | 176 | 23.906 | 28.846 | 72.220 | 1.00 | 42.26 |
| ATOM | 455 | CA | ASN | 176 | 25.247 | 28.390 | 71.997 | 1.00 | 42.26 |
| ATOM | 456 | CB | ASN | 176 | 26.279 | 29.530 | 72.010 | 1.00 | 42.26 |
| ATOM | 457 | CG | ASN | 176 | 27.581 | 28.964 | 71.463 | 1.00 | 42.26 |
| ATOM | 458 | OD1 | ASN | 176 | 27.661 | 27.787 | 71.116 | 1.00 | 42.26 |
| ATOM | 459 | ND2 | ASN | 176 | 28.637 | 29.819 | 71.389 | 1.00 | 42.26 |
| ATOM | 460 | C | ASN | 176 | 25.631 | 27.426 | 73.082 | 1.00 | 42.26 |
| ATOM | 461 | O | ASN | 176 | 26.225 | 26.382 | 72.812 | 1.00 | 42.26 |
| ATOM | 462 | N | LEU | 177 | 25.284 | 27.734 | 74.347 | 1.00 | 56.01 |
| ATOM | 463 | CA | LEU | 177 | 25.700 | 26.878 | 75.425 | 1.00 | 56.01 |
| ATOM | 464 | CB | LEU | 177 | 25.388 | 27.413 | 76.828 | 1.00 | 56.01 |
| ATOM | 465 | CG | LEU | 177 | 25.909 | 26.443 | 77.900 | 1.00 | 56.01 |
| ATOM | 466 | CD2 | LEU | 177 | 25.411 | 26.827 | 79.292 | 1.00 | 56.01 |
| ATOM | 467 | CD1 | LEU | 177 | 27.438 | 26.312 | 77.835 | 1.00 | 56.01 |
| ATOM | 468 | C | LEU | 177 | 25.025 | 25.556 | 75.293 | 1.00 | 56.01 |
| ATOM | 469 | O | LEU | 177 | 25.602 | 24.514 | 75.597 | 1.00 | 56.01 |
| ATOM | 470 | N | VAL | 178 | 23.765 | 25.580 | 74.838 | 1.00 | 56.57 |
| ATOM | 471 | CA | VAL | 178 | 22.968 | 24.413 | 74.640 | 1.00 | 56.57 |
| ATOM | 472 | CB | VAL | 178 | 21.687 | 24.840 | 73.994 | 1.00 | 56.57 |
| ATOM | 473 | CG1 | VAL | 178 | 20.954 | 23.617 | 73.470 | 1.00 | 56.57 |
| ATOM | 474 | CG2 | VAL | 178 | 20.889 | 25.678 | 75.004 | 1.00 | 56.57 |
| ATOM | 475 | C | VAL | 178 | 23.698 | 23.504 | 73.693 | 1.00 | 56.57 |
| ATOM | 476 | O | VAL | 178 | 23.829 | 22.308 | 73.952 | 1.00 | 56.57 |
| ATOM | 477 | N | SER | 179 | 24.213 | 24.056 | 72.576 | 1.00 | 79.14 |
| ATOM | 478 | CA | SER | 179 | 24.884 | 23.265 | 71.579 | 1.00 | 79.14 |
| ATOM | 479 | CB | SER | 179 | 25.288 | 24.075 | 70.334 | 1.00 | 79.14 |
| ATOM | 480 | OG | SER | 179 | 26.339 | 24.971 | 70.655 | 1.00 | 79.14 |
| ATOM | 481 | C | SER | 179 | 26.145 | 22.690 | 72.144 | 1.00 | 79.14 |
| ATOM | 482 | O | SER | 179 | 26.496 | 21.546 | 71.857 | 1.00 | 79.14 |
| ATOM | 483 | N | GLN | 180 | 26.859 | 23.474 | 72.974 | 1.00 | 128.89 |
| ATOM | 484 | CA | GLN | 180 | 28.111 | 23.039 | 73.526 | 1.00 | 128.89 |
| ATOM | 485 | CB | GLN | 180 | 28.745 | 24.099 | 74.447 | 1.00 | 128.89 |
| ATOM | 486 | CG | GLN | 180 | 29.169 | 25.386 | 73.735 | 1.00 | 128.89 |
| ATOM | 487 | CD | GLN | 180 | 30.494 | 25.121 | 73.032 | 1.00 | 128.89 |
| ATOM | 488 | OE1 | GLN | 180 | 30.978 | 23.992 | 73.010 | 1.00 | 128.89 |
| ATOM | 489 | NE2 | GLN | 180 | 31.101 | 26.189 | 72.447 | 1.00 | 128.89 |
| ATOM | 490 | C | GLN | 180 | 27.867 | 21.823 | 74.360 | 1.00 | 128.89 |
| ATOM | 491 | O | GLN | 180 | 28.607 | 20.843 | 74.288 | 1.00 | 128.89 |
| ATOM | 492 | N | PHE | 181 | 26.799 | 21.854 | 75.174 | 1.00 | 112.00 |
| ATOM | 493 | CA | PHE | 181 | 26.451 | 20.747 | 76.010 | 1.00 | 112.00 |
| ATOM | 494 | CB | PHE | 181 | 25.231 | 21.043 | 76.887 | 1.00 | 112.00 |
| ATOM | 495 | CG | PHE | 181 | 24.572 | 19.737 | 77.130 | 1.00 | 112.00 |
| ATOM | 496 | CD1 | PHE | 181 | 25.152 | 18.758 | 77.896 | 1.00 | 112.00 |
| ATOM | 497 | CD2 | PHE | 181 | 23.344 | 19.500 | 76.566 | 1.00 | 112.00 |
| ATOM | 498 | CE1 | PHE | 181 | 24.492 | 17.569 | 78.089 | 1.00 | 112.00 |
| ATOM | 499 | CE2 | PHE | 181 | 22.679 | 18.317 | 76.763 | 1.00 | 112.00 |
| ATOM | 500 | CZ | PHE | 181 | 23.259 | 17.344 | 77.532 | 1.00 | 112.00 |
| ATOM | 501 | C | PHE | 181 | 26.130 | 19.562 | 75.167 | 1.00 | 112.00 |
| ATOM | 502 | O | PHE | 181 | 26.570 | 18.450 | 75.454 | 1.00 | 112.00 |
| ATOM | 503 | N | ALA | 182 | 25.356 | 19.768 | 74.092 | 1.00 | 29.66 |
| ATOM | 504 | CA | ALA | 182 | 24.965 | 18.663 | 73.275 | 1.00 | 29.66 |
| ATOM | 505 | CB | ALA | 182 | 24.070 | 19.093 | 72.100 | 1.00 | 29.66 |
| ATOM | 506 | C | ALA | 182 | 26.192 | 18.038 | 72.700 | 1.00 | 29.66 |
| ATOM | 507 | O | ALA | 182 | 26.316 | 16.815 | 72.654 | 1.00 | 29.66 |
| ATOM | 508 | N | TYR | 183 | 27.151 | 18.871 | 72.267 | 1.00 | 86.70 |
| ATOM | 509 | CA | TYR | 183 | 28.319 | 18.347 | 71.629 | 1.00 | 86.70 |
| ATOM | 510 | CB | TYR | 183 | 29.252 | 19.486 | 71.164 | 1.00 | 86.70 |
| ATOM | 511 | CG | TYR | 183 | 30.260 | 18.956 | 70.203 | 1.00 | 86.70 |
| ATOM | 512 | CD1 | TYR | 183 | 29.917 | 18.769 | 68.883 | 1.00 | 86.70 |
| ATOM | 513 | CD2 | TYR | 183 | 31.546 | 18.668 | 70.602 | 1.00 | 86.70 |
| ATOM | 514 | CE1 | TYR | 183 | 30.830 | 18.288 | 67.975 | 1.00 | 86.70 |
| ATOM | 515 | CE2 | TYR | 183 | 32.465 | 18.186 | 69.698 | 1.00 | 86.70 |
| ATOM | 516 | CZ | TYR | 183 | 32.109 | 17.994 | 68.385 | 1.00 | 86.70 |
| ATOM | 517 | OH | TYR | 183 | 33.050 | 17.500 | 67.457 | 1.00 | 86.70 |
| ATOM | 518 | C | TYR | 183 | 29.055 | 17.492 | 72.623 | 1.00 | 86.70 |
| ATOM | 519 | O | TYR | 183 | 29.454 | 16.371 | 72.316 | 1.00 | 86.70 |
| ATOM | 520 | N | GLY | 184 | 29.246 | 18.018 | 73.850 | 1.00 | 53.23 |
| ATOM | 521 | CA | GLY | 184 | 30.008 | 17.399 | 74.905 | 1.00 | 53.23 |
| ATOM | 522 | C | GLY | 184 | 29.405 | 16.176 | 75.549 | 1.00 | 53.23 |
| ATOM | 523 | O | GLY | 184 | 30.124 | 15.219 | 75.821 | 1.00 | 53.23 |
| ATOM | 524 | N | SER | 185 | 28.088 | 16.154 | 75.842 | 1.00 | 120.41 |
| ATOM | 525 | CA | SER | 185 | 27.600 | 15.068 | 76.658 | 1.00 | 120.41 |
| ATOM | 526 | CB | SER | 185 | 26.311 | 15.371 | 77.423 | 1.00 | 120.41 |
| ATOM | 527 | OG | SER | 185 | 25.920 | 14.251 | 78.202 | 1.00 | 120.41 |
| ATOM | 528 | C | SER | 185 | 27.382 | 13.816 | 75.878 | 1.00 | 120.41 |
| ATOM | 529 | O | SER | 185 | 27.009 | 13.841 | 74.708 | 1.00 | 120.41 |
| ATOM | 530 | N | GLU | 186 | 27.606 | 12.679 | 76.574 | 1.00 | 233.92 |
| ATOM | 531 | CA | GLU | 186 | 27.606 | 11.349 | 76.034 | 1.00 | 233.92 |
| ATOM | 532 | CB | GLU | 186 | 28.197 | 10.300 | 76.993 | 1.00 | 233.92 |
| ATOM | 533 | CG | GLU | 186 | 27.438 | 10.153 | 78.313 | 1.00 | 233.92 |
| ATOM | 534 | CD | GLU | 186 | 28.204 | 10.926 | 79.376 | 1.00 | 233.92 |
| ATOM | 535 | OE1 | GLU | 186 | 29.463 | 10.895 | 79.323 | 1.00 | 233.92 |
| ATOM | 536 | OE2 | GLU | 186 | 27.549 | 11.552 | 80.252 | 1.00 | 233.92 |
| ATOM | 537 | C | GLU | 186 | 26.293 | 10.794 | 75.573 | 1.00 | 233.92 |
| ATOM | 538 | O | GLU | 186 | 26.228 | 10.305 | 74.451 | 1.00 | 233.92 |
| ATOM | 539 | N | VAL | 187 | 25.197 | 10.839 | 76.360 | 1.00 | 129.80 |
| ATOM | 540 | CA | VAL | 187 | 24.082 | 10.104 | 75.822 | 1.00 | 129.80 |
| ATOM | 541 | CB | VAL | 187 | 22.972 | 9.869 | 76.789 | 1.00 | 129.80 |
| ATOM | 542 | CG1 | VAL | 187 | 21.890 | 9.086 | 76.036 | 1.00 | 129.80 |
| ATOM | 543 | CG2 | VAL | 187 | 23.542 | 9.116 | 78.006 | 1.00 | 129.80 |
| ATOM | 544 | C | VAL | 187 | 23.589 | 10.872 | 74.667 | 1.00 | 129.80 |
| ATOM | 545 | O | VAL | 187 | 22.963 | 11.912 | 74.871 | 1.00 | 129.80 |
| ATOM | 546 | N | ASP | 188 | 23.768 | 10.264 | 73.471 | 1.00 | 52.21 |
| ATOM | 547 | CA | ASP | 188 | 23.717 | 10.816 | 72.144 | 1.00 | 52.21 |
| ATOM | 548 | CB | ASP | 188 | 23.899 | 9.762 | 71.036 | 1.00 | 52.21 |
| ATOM | 549 | CG | ASP | 188 | 25.365 | 9.352 | 70.982 | 1.00 | 52.21 |
| ATOM | 550 | OD1 | ASP | 188 | 26.195 | 10.032 | 71.642 | 1.00 | 52.21 |
| ATOM | 551 | OD2 | ASP | 188 | 25.672 | 8.356 | 70.275 | 1.00 | 52.21 |
| ATOM | 552 | C | ASP | 188 | 22.449 | 11.526 | 71.851 | 1.00 | 52.21 |
| ATOM | 553 | O | ASP | 188 | 22.464 | 12.498 | 71.095 | 1.00 | 52.21 |
| ATOM | 554 | N | TYR | 189 | 21.319 | 11.067 | 72.403 | 1.00 | 166.36 |
| ATOM | 555 | CA | TYR | 189 | 20.123 | 11.786 | 72.107 | 1.00 | 166.36 |
| ATOM | 556 | CB | TYR | 189 | 18.831 | 11.184 | 72.665 | 1.00 | 166.36 |
| ATOM | 557 | CG | TYR | 189 | 17.733 | 12.131 | 72.297 | 1.00 | 166.36 |
| ATOM | 558 | CD1 | TYR | 189 | 17.390 | 13.168 | 73.131 | 1.00 | 166.36 |
| ATOM | 559 | CD2 | TYR | 189 | 17.057 | 11.996 | 71.107 | 1.00 | 166.36 |
| ATOM | 560 | CE1 | TYR | 189 | 16.385 | 14.044 | 72.792 | 1.00 | 166.36 |
| ATOM | 561 | CE2 | TYR | 189 | 16.051 | 12.864 | 70.758 | 1.00 | 166.36 |
| ATOM | 562 | CZ | TYR | 189 | 15.714 | 13.894 | 71.602 | 1.00 | 166.36 |
| ATOM | 563 | OH | TYR | 189 | 14.682 | 14.789 | 71.248 | 1.00 | 166.36 |
| ATOM | 564 | C | TYR | 189 | 20.307 | 13.168 | 72.624 | 1.00 | 166.36 |
| ATOM | 565 | O | TYR | 189 | 19.731 | 14.076 | 72.027 | 1.00 | 166.36 |
| ATOM | 566 | N | ILE | 190 | 21.118 | 13.292 | 73.723 | 1.00 | 202.46 |
| ATOM | 567 | CA | ILE | 190 | 21.536 | 14.455 | 74.472 | 1.00 | 202.46 |
| ATOM | 568 | CB | ILE | 190 | 23.029 | 14.604 | 74.460 | 1.00 | 202.46 |
| ATOM | 569 | CG2 | ILE | 190 | 23.560 | 14.232 | 73.064 | 1.00 | 202.46 |
| ATOM | 570 | CG1 | ILE | 190 | 23.425 | 15.999 | 74.936 | 1.00 | 202.46 |
| ATOM | 571 | CD1 | ILE | 190 | 24.932 | 16.231 | 74.971 | 1.00 | 202.46 |
| ATOM | 572 | C | ILE | 190 | 21.016 | 15.628 | 73.777 | 1.00 | 202.46 |
| ATOM | 573 | O | ILE | 190 | 21.551 | 16.067 | 72.761 | 1.00 | 202.46 |
| ATOM | 574 | N | GLY | 191 | 19.934 | 16.184 | 74.316 | 1.00 | 65.34 |
| ATOM | 575 | CA | GLY | 191 | 19.400 | 17.209 | 73.507 | 1.00 | 65.34 |
| ATOM | 576 | C | GLY | 191 | 19.088 | 18.352 | 74.373 | 1.00 | 65.34 |
| ATOM | 577 | O | GLY | 191 | 18.357 | 18.240 | 75.355 | 1.00 | 65.34 |
| ATOM | 578 | N | GLN | 192 | 19.694 | 19.491 | 74.027 | 1.00 | 75.20 |
| ATOM | 579 | CA | GLN | 192 | 19.282 | 20.680 | 74.674 | 1.00 | 75.20 |
| ATOM | 580 | CB | GLN | 192 | 20.381 | 21.474 | 75.396 | 1.00 | 75.20 |
| ATOM | 581 | CG | GLN | 192 | 20.750 | 20.871 | 76.748 | 1.00 | 75.20 |
| ATOM | 582 | CD | GLN | 192 | 21.729 | 21.810 | 77.435 | 1.00 | 75.20 |
| ATOM | 583 | OE1 | GLN | 192 | 22.084 | 22.849 | 76.882 | 1.00 | 75.20 |
| ATOM | 584 | NE2 | GLN | 192 | 22.177 | 21.440 | 78.667 | 1.00 | 75.20 |
| ATOM | 585 | C | GLN | 192 | 18.705 | 21.484 | 73.573 | 1.00 | 75.20 |
| ATOM | 586 | O | GLN | 192 | 19.316 | 21.664 | 72.521 | 1.00 | 75.20 |
| ATOM | 587 | N | PHE | 193 | 17.460 | 21.929 | 73.771 | 1.00 | 131.19 |
| ATOM | 588 | CA | PHE | 193 | 16.815 | 22.693 | 72.758 | 1.00 | 131.19 |
| ATOM | 589 | CB | PHE | 193 | 15.278 | 22.596 | 72.752 | 1.00 | 131.19 |
| ATOM | 590 | CG | PHE | 193 | 14.829 | 21.254 | 72.283 | 1.00 | 131.19 |
| ATOM | 591 | CD1 | PHE | 193 | 14.637 | 21.019 | 70.941 | 1.00 | 131.19 |
| ATOM | 592 | CD2 | PHE | 193 | 14.591 | 20.238 | 73.179 | 1.00 | 131.19 |
| ATOM | 593 | CE1 | PHE | 193 | 14.216 | 19.787 | 70.497 | 1.00 | 131.19 |
| ATOM | 594 | CE2 | PHE | 193 | 14.171 | 19.004 | 72.739 | 1.00 | 131.19 |
| ATOM | 595 | CZ | PHE | 193 | 13.983 | 18.777 | 71.398 | 1.00 | 131.19 |
| ATOM | 596 | C | PHE | 193 | 17.109 | 24.126 | 73.014 | 1.00 | 131.19 |
| ATOM | 597 | O | PHE | 193 | 17.554 | 24.513 | 74.095 | 1.00 | 131.19 |
| ATOM | 598 | N | ASP | 194 | 16.882 | 24.941 | 71.974 | 1.00 | 136.05 |
| ATOM | 599 | CA | ASP | 194 | 16.986 | 26.361 | 72.067 | 1.00 | 136.05 |
| ATOM | 600 | CB | ASP | 194 | 16.874 | 27.007 | 70.669 | 1.00 | 136.05 |
| ATOM | 601 | CG | ASP | 194 | 16.238 | 26.078 | 69.643 | 1.00 | 136.05 |
| ATOM | 602 | OD1 | ASP | 194 | 15.729 | 24.995 | 70.027 | 1.00 | 136.05 |
| ATOM | 603 | OD2 | ASP | 194 | 16.250 | 26.455 | 68.441 | 1.00 | 136.05 |
| ATOM | 604 | C | ASP | 194 | 15.780 | 26.756 | 72.873 | 1.00 | 136.05 |
| ATOM | 605 | O | ASP | 194 | 14.927 | 25.924 | 73.178 | 1.00 | 136.05 |
| ATOM | 606 | N | MET | 195 | 15.692 | 28.045 | 73.242 | 1.00 | 86.54 |
| ATOM | 607 | CA | MET | 195 | 14.641 | 28.631 | 74.023 | 1.00 | 86.54 |
| ATOM | 608 | CB | MET | 195 | 14.877 | 30.130 | 74.272 | 1.00 | 86.54 |
| ATOM | 609 | CG | MET | 195 | 13.675 | 30.836 | 74.900 | 1.00 | 86.54 |
| ATOM | 610 | SD | MET | 195 | 12.979 | 32.177 | 73.888 | 1.00 | 86.54 |
| ATOM | 611 | CE | MET | 195 | 11.417 | 32.271 | 74.814 | 1.00 | 86.54 |
| ATOM | 612 | C | MET | 195 | 13.348 | 28.535 | 73.274 | 1.00 | 86.54 |
| ATOM | 613 | O | MET | 195 | 12.282 | 28.438 | 73.881 | 1.00 | 86.54 |
| ATOM | 614 | N | ARG | 196 | 13.415 | 28.579 | 71.931 | 1.00 | 106.06 |
| ATOM | 615 | CA | ARG | 196 | 12.260 | 28.602 | 71.075 | 1.00 | 106.06 |
| ATOM | 616 | CB | ARG | 196 | 12.622 | 28.667 | 69.581 | 1.00 | 106.06 |
| ATOM | 617 | CG | ARG | 196 | 13.170 | 30.024 | 69.130 | 1.00 | 106.06 |
| ATOM | 618 | CD | ARG | 196 | 12.349 | 31.207 | 69.650 | 1.00 | 106.06 |
| ATOM | 619 | NE | ARG | 196 | 11.021 | 31.185 | 68.972 | 1.00 | 106.06 |
| ATOM | 620 | CZ | ARG | 196 | 10.079 | 32.124 | 69.285 | 1.00 | 106.06 |
| ATOM | 621 | NH1 | ARG | 196 | 10.355 | 33.094 | 70.209 | 1.00 | 106.06 |
| ATOM | 622 | NH2 | ARG | 196 | 8.857 | 32.094 | 68.677 | 1.00 | 106.06 |
| ATOM | 623 | C | ARG | 196 | 11.425 | 27.371 | 71.275 | 1.00 | 106.06 |
| ATOM | 624 | O | ARG | 196 | 10.203 | 27.423 | 71.145 | 1.00 | 106.06 |
| ATOM | 625 | N | PHE | 197 | 12.058 | 26.231 | 71.600 | 1.00 | 81.65 |
| ATOM | 626 | CA | PHE | 197 | 11.374 | 24.977 | 71.747 | 1.00 | 81.65 |
| ATOM | 627 | CB | PHE | 197 | 12.338 | 23.902 | 72.276 | 1.00 | 81.65 |
| ATOM | 628 | CG | PHE | 197 | 11.562 | 22.710 | 72.718 | 1.00 | 81.65 |
| ATOM | 629 | CD1 | PHE | 197 | 11.089 | 21.800 | 71.804 | 1.00 | 81.65 |
| ATOM | 630 | CD2 | PHE | 197 | 11.325 | 22.497 | 74.059 | 1.00 | 81.65 |
| ATOM | 631 | CE1 | PHE | 197 | 10.382 | 20.703 | 72.225 | 1.00 | 81.65 |
| ATOM | 632 | CE2 | PHE | 197 | 10.617 | 21.397 | 74.486 | 1.00 | 81.65 |
| ATOM | 633 | CZ | PHE | 197 | 10.144 | 20.497 | 73.563 | 1.00 | 81.65 |
| ATOM | 634 | C | PHE | 197 | 10.260 | 25.112 | 72.737 | 1.00 | 81.65 |
| ATOM | 635 | O | PHE | 197 | 9.123 | 24.733 | 72.453 | 1.00 | 81.65 |
| ATOM | 636 | N | LEU | 198 | 10.546 | 25.674 | 73.923 | 1.00 | 91.14 |
| ATOM | 637 | CA | LEU | 198 | 9.522 | 25.774 | 74.919 | 1.00 | 91.14 |
| ATOM | 638 | CB | LEU | 198 | 9.988 | 26.424 | 76.224 | 1.00 | 91.14 |
| ATOM | 639 | CG | LEU | 198 | 8.832 | 26.534 | 77.232 | 1.00 | 91.14 |
| ATOM | 640 | CD2 | LEU | 198 | 9.108 | 27.614 | 78.284 | 1.00 | 91.14 |
| ATOM | 641 | CD1 | LEU | 198 | 8.452 | 25.160 | 77.810 | 1.00 | 91.14 |
| ATOM | 642 | C | LEU | 198 | 8.418 | 26.645 | 74.418 | 1.00 | 91.14 |
| ATOM | 643 | O | LEU | 198 | 7.243 | 26.337 | 74.610 | 1.00 | 91.14 |
| ATOM | 644 | N | ASN | 199 | 8.764 | 27.760 | 73.751 | 1.00 | 55.60 |
| ATOM | 645 | CA | ASN | 199 | 7.744 | 28.685 | 73.354 | 1.00 | 55.60 |
| ATOM | 646 | CB | ASN | 199 | 8.302 | 29.888 | 72.579 | 1.00 | 55.60 |
| ATOM | 647 | CG | ASN | 199 | 9.123 | 30.720 | 73.553 | 1.00 | 55.60 |
| ATOM | 648 | OD1 | ASN | 199 | 10.349 | 30.767 | 73.468 | 1.00 | 55.60 |
| ATOM | 649 | ND2 | ASN | 199 | 8.428 | 31.390 | 74.511 | 1.00 | 55.60 |
| ATOM | 650 | C | ASN | 199 | 6.765 | 27.995 | 72.457 | 1.00 | 55.60 |
| ATOM | 651 | O | ASN | 199 | 5.554 | 28.097 | 72.651 | 1.00 | 55.60 |
| ATOM | 652 | N | SER | 200 | 7.264 | 27.255 | 71.453 | 1.00 | 37.68 |
| ATOM | 653 | CA | SER | 200 | 6.381 | 26.626 | 70.516 | 1.00 | 37.68 |
| ATOM | 654 | CB | SER | 200 | 7.138 | 25.978 | 69.348 | 1.00 | 37.68 |
| ATOM | 655 | OG | SER | 200 | 7.729 | 26.981 | 68.534 | 1.00 | 37.68 |
| ATOM | 656 | C | SER | 200 | 5.567 | 25.572 | 71.203 | 1.00 | 37.68 |
| ATOM | 657 | O | SER | 200 | 4.366 | 25.448 | 70.962 | 1.00 | 37.68 |
| ATOM | 658 | N | LEU | 201 | 6.201 | 24.782 | 72.087 | 1.00 | 113.67 |
| ATOM | 659 | CA | LEU | 201 | 5.505 | 23.710 | 72.735 | 1.00 | 113.67 |
| ATOM | 660 | CB | LEU | 201 | 6.436 | 22.946 | 73.699 | 1.00 | 113.67 |
| ATOM | 661 | CG | LEU | 201 | 5.879 | 21.652 | 74.334 | 1.00 | 113.67 |
| ATOM | 662 | CD2 | LEU | 201 | 5.647 | 20.569 | 73.270 | 1.00 | 113.67 |
| ATOM | 663 | CD1 | LEU | 201 | 4.654 | 21.896 | 75.231 | 1.00 | 113.67 |
| ATOM | 664 | C | LEU | 201 | 4.402 | 24.300 | 73.551 | 1.00 | 113.67 |
| ATOM | 665 | O | LEU | 201 | 3.253 | 23.873 | 73.461 | 1.00 | 113.67 |
| ATOM | 666 | N | ALA | 202 | 4.738 | 25.309 | 74.375 | 1.00 | 48.96 |
| ATOM | 667 | CA | ALA | 202 | 3.776 | 25.881 | 75.269 | 1.00 | 48.96 |
| ATOM | 668 | CB | ALA | 202 | 4.412 | 26.873 | 76.260 | 1.00 | 48.96 |
| ATOM | 669 | C | ALA | 202 | 2.685 | 26.604 | 74.540 | 1.00 | 48.96 |
| ATOM | 670 | O | ALA | 202 | 1.507 | 26.362 | 74.793 | 1.00 | 48.96 |
| ATOM | 671 | N | ILE | 203 | 3.032 | 27.497 | 73.591 | 1.00 | 52.64 |
| ATOM | 672 | CA | ILE | 203 | 1.976 | 28.263 | 72.987 | 1.00 | 52.64 |
| ATOM | 673 | CB | ILE | 203 | 2.466 | 29.369 | 72.100 | 1.00 | 52.64 |
| ATOM | 674 | CG2 | ILE | 203 | 1.239 | 29.999 | 71.423 | 1.00 | 52.64 |
| ATOM | 675 | CG1 | ILE | 203 | 3.299 | 30.375 | 72.918 | 1.00 | 52.64 |
| ATOM | 676 | CD1 | ILE | 203 | 4.098 | 31.354 | 72.060 | 1.00 | 52.64 |
| ATOM | 677 | C | ILE | 203 | 1.109 | 27.367 | 72.172 | 1.00 | 52.64 |
| ATOM | 678 | O | ILE | 203 | −0.112 | 27.363 | 72.324 | 1.00 | 52.64 |
| ATOM | 679 | N | HIS | 204 | 1.721 | 26.555 | 71.293 | 1.00 | 151.99 |
| ATOM | 680 | CA | HIS | 204 | 0.914 | 25.674 | 70.508 | 1.00 | 151.99 |
| ATOM | 681 | ND1 | HIS | 204 | 1.405 | 27.230 | 67.048 | 1.00 | 151.99 |
| ATOM | 682 | CG | HIS | 204 | 1.285 | 26.992 | 68.398 | 1.00 | 151.99 |
| ATOM | 683 | CB | HIS | 204 | 1.337 | 25.630 | 69.032 | 1.00 | 151.99 |
| ATOM | 684 | NE2 | HIS | 204 | 1.157 | 29.214 | 68.026 | 1.00 | 151.99 |
| ATOM | 685 | CD2 | HIS | 204 | 1.137 | 28.211 | 68.983 | 1.00 | 151.99 |
| ATOM | 686 | CE1 | HIS | 204 | 1.320 | 28.578 | 66.883 | 1.00 | 151.99 |
| ATOM | 687 | C | HIS | 204 | 1.139 | 24.333 | 71.102 | 1.00 | 151.99 |
| ATOM | 688 | O | HIS | 204 | 1.898 | 23.522 | 70.574 | 1.00 | 151.99 |
| ATOM | 689 | N | GLU | 205 | 0.449 | 24.066 | 72.225 | 1.00 | 156.23 |
| ATOM | 690 | CA | GLU | 205 | 0.711 | 22.857 | 72.933 | 1.00 | 156.23 |
| ATOM | 691 | CB | GLU | 205 | −0.210 | 22.672 | 74.150 | 1.00 | 156.23 |
| ATOM | 692 | CG | GLU | 205 | 0.028 | 21.351 | 74.885 | 1.00 | 156.23 |
| ATOM | 693 | CD | GLU | 205 | −1.067 | 21.176 | 75.931 | 1.00 | 156.23 |
| ATOM | 694 | OE1 | GLU | 205 | −2.190 | 20.749 | 75.548 | 1.00 | 156.23 |
| ATOM | 695 | OE2 | GLU | 205 | −0.793 | 21.465 | 77.126 | 1.00 | 156.23 |
| ATOM | 696 | C | GLU | 205 | 0.462 | 21.702 | 72.042 | 1.00 | 156.23 |
| ATOM | 697 | O | GLU | 205 | 1.397 | 20.966 | 71.737 | 1.00 | 156.23 |
| ATOM | 698 | N | LYS | 206 | −0.782 | 21.540 | 71.548 | 1.00 | 205.50 |
| ATOM | 699 | CA | LYS | 206 | −1.007 | 20.396 | 70.719 | 1.00 | 205.50 |
| ATOM | 700 | CB | LYS | 206 | −1.205 | 19.084 | 71.499 | 1.00 | 205.50 |
| ATOM | 701 | CG | LYS | 206 | −0.059 | 18.679 | 72.424 | 1.00 | 205.50 |
| ATOM | 702 | CD | LYS | 206 | −0.356 | 17.392 | 73.198 | 1.00 | 205.50 |
| ATOM | 703 | CE | LYS | 206 | −1.759 | 17.342 | 73.812 | 1.00 | 205.50 |
| ATOM | 704 | NZ | LYS | 206 | −1.795 | 18.114 | 75.073 | 1.00 | 205.50 |
| ATOM | 705 | C | LYS | 206 | −2.308 | 20.561 | 70.016 | 1.00 | 205.50 |
| ATOM | 706 | O | LYS | 206 | −3.343 | 20.732 | 70.658 | 1.00 | 205.50 |
| ATOM | 707 | N | PHE | 207 | −2.301 | 20.529 | 68.671 | 1.00 | 72.61 |
| ATOM | 708 | CA | PHE | 207 | −3.578 | 20.476 | 68.032 | 1.00 | 72.61 |
| ATOM | 709 | CB | PHE | 207 | −3.496 | 20.581 | 66.501 | 1.00 | 72.61 |
| ATOM | 710 | CG | PHE | 207 | −3.224 | 22.015 | 66.198 | 1.00 | 72.61 |
| ATOM | 711 | CD1 | PHE | 207 | −1.956 | 22.539 | 66.311 | 1.00 | 72.61 |
| ATOM | 712 | CD2 | PHE | 207 | −4.252 | 22.837 | 65.797 | 1.00 | 72.61 |
| ATOM | 713 | CE1 | PHE | 207 | −1.724 | 23.865 | 66.030 | 1.00 | 72.61 |
| ATOM | 714 | CE2 | PHE | 207 | −4.025 | 24.162 | 65.515 | 1.00 | 72.61 |
| ATOM | 715 | CZ | PHE | 207 | −2.757 | 24.679 | 65.631 | 1.00 | 72.61 |
| ATOM | 716 | C | PHE | 207 | −4.106 | 19.138 | 68.423 | 1.00 | 72.61 |
| ATOM | 717 | O | PHE | 207 | −5.248 | 18.997 | 68.860 | 1.00 | 72.61 |
| ATOM | 718 | N | ASP | 208 | −3.238 | 18.118 | 68.281 | 1.00 | 124.13 |
| ATOM | 719 | CA | ASP | 208 | −3.514 | 16.787 | 68.731 | 1.00 | 124.13 |
| ATOM | 720 | CB | ASP | 208 | −3.667 | 15.769 | 67.588 | 1.00 | 124.13 |
| ATOM | 721 | CG | ASP | 208 | −5.011 | 16.013 | 66.921 | 1.00 | 124.13 |
| ATOM | 722 | OD1 | ASP | 208 | −5.724 | 16.956 | 67.359 | 1.00 | 124.13 |
| ATOM | 723 | OD2 | ASP | 208 | −5.353 | 15.256 | 65.974 | 1.00 | 124.13 |
| ATOM | 724 | C | ASP | 208 | −2.297 | 16.402 | 69.506 | 1.00 | 124.13 |
| ATOM | 725 | O | ASP | 208 | −2.317 | 15.487 | 70.328 | 1.00 | 124.13 |
| ATOM | 726 | N | ALA | 209 | −1.197 | 17.135 | 69.250 | 1.00 | 255.38 |
| ATOM | 727 | CA | ALA | 209 | 0.058 | 16.921 | 69.906 | 1.00 | 255.38 |
| ATOM | 728 | CB | ALA | 209 | 0.844 | 15.720 | 69.354 | 1.00 | 255.38 |
| ATOM | 729 | C | ALA | 209 | 0.860 | 18.146 | 69.624 | 1.00 | 255.38 |
| ATOM | 730 | O | ALA | 209 | 0.424 | 18.995 | 68.849 | 1.00 | 255.38 |
| ATOM | 731 | N | PHE | 210 | 2.040 | 18.286 | 70.266 | 1.00 | 276.72 |
| ATOM | 732 | CA | PHE | 210 | 2.848 | 19.437 | 70.008 | 1.00 | 276.72 |
| ATOM | 733 | CB | PHE | 210 | 3.978 | 19.598 | 71.040 | 1.00 | 276.72 |
| ATOM | 734 | CG | PHE | 210 | 4.550 | 18.246 | 71.293 | 1.00 | 276.72 |
| ATOM | 735 | CD1 | PHE | 210 | 5.582 | 17.725 | 70.548 | 1.00 | 276.72 |
| ATOM | 736 | CD2 | PHE | 210 | 4.023 | 17.486 | 72.311 | 1.00 | 276.72 |
| ATOM | 737 | CE1 | PHE | 210 | 6.073 | 16.471 | 70.816 | 1.00 | 276.72 |
| ATOM | 738 | CE2 | PHE | 210 | 4.509 | 16.234 | 72.586 | 1.00 | 276.72 |
| ATOM | 739 | CZ | PHE | 210 | 5.540 | 15.722 | 71.837 | 1.00 | 276.72 |
| ATOM | 740 | C | PHE | 210 | 3.365 | 19.370 | 68.611 | 1.00 | 276.72 |
| ATOM | 741 | O | PHE | 210 | 4.441 | 18.848 | 68.335 | 1.00 | 276.72 |
| ATOM | 742 | N | MET | 211 | 2.563 | 19.920 | 67.681 | 1.00 | 90.31 |
| ATOM | 743 | CA | MET | 211 | 2.873 | 19.955 | 66.287 | 1.00 | 90.31 |
| ATOM | 744 | CB | MET | 211 | 1.723 | 20.500 | 65.422 | 1.00 | 90.31 |
| ATOM | 745 | CG | MET | 211 | 0.500 | 19.583 | 65.367 | 1.00 | 90.31 |
| ATOM | 746 | SD | MET | 211 | −0.869 | 20.212 | 64.350 | 1.00 | 90.31 |
| ATOM | 747 | CE | MET | 211 | 0.015 | 20.005 | 62.774 | 1.00 | 90.31 |
| ATOM | 748 | C | MET | 211 | 4.031 | 20.863 | 66.088 | 1.00 | 90.31 |
| ATOM | 749 | O | MET | 211 | 4.908 | 20.603 | 65.265 | 1.00 | 90.31 |
| ATOM | 750 | N | ASN | 212 | 4.062 | 21.973 | 66.845 | 1.00 | 90.13 |
| ATOM | 751 | CA | ASN | 212 | 5.123 | 22.906 | 66.637 | 1.00 | 90.13 |
| ATOM | 752 | CB | ASN | 212 | 4.978 | 24.204 | 67.447 | 1.00 | 90.13 |
| ATOM | 753 | CG | ASN | 212 | 5.890 | 25.234 | 66.791 | 1.00 | 90.13 |
| ATOM | 754 | OD1 | ASN | 212 | 7.077 | 24.987 | 66.582 | 1.00 | 90.13 |
| ATOM | 755 | ND2 | ASN | 212 | 5.326 | 26.423 | 66.457 | 1.00 | 90.13 |
| ATOM | 756 | C | ASN | 212 | 6.400 | 22.233 | 67.018 | 1.00 | 90.13 |
| ATOM | 757 | O | ASN | 212 | 7.441 | 22.475 | 66.413 | 1.00 | 90.13 |
| ATOM | 758 | N | LYS | 213 | 6.345 | 21.424 | 68.092 | 1.00 | 142.77 |
| ATOM | 759 | CA | LYS | 213 | 7.426 | 20.654 | 68.651 | 1.00 | 142.77 |
| ATOM | 760 | CB | LYS | 213 | 7.131 | 20.197 | 70.088 | 1.00 | 142.77 |
| ATOM | 761 | CG | LYS | 213 | 8.178 | 19.226 | 70.645 | 1.00 | 142.77 |
| ATOM | 762 | CD | LYS | 213 | 8.019 | 18.934 | 72.136 | 1.00 | 142.77 |
| ATOM | 763 | CE | LYS | 213 | 8.827 | 17.726 | 72.617 | 1.00 | 142.77 |
| ATOM | 764 | NZ | LYS | 213 | 10.230 | 17.810 | 72.158 | 1.00 | 142.77 |
| ATOM | 765 | C | LYS | 213 | 7.773 | 19.407 | 67.888 | 1.00 | 142.77 |
| ATOM | 766 | O | LYS | 213 | 8.928 | 18.987 | 67.896 | 1.00 | 142.77 |
| ATOM | 767 | N | HIS | 214 | 6.801 | 18.776 | 67.202 | 1.00 | 151.89 |
| ATOM | 768 | CA | HIS | 214 | 6.993 | 17.422 | 66.740 | 1.00 | 151.89 |
| ATOM | 769 | ND1 | HIS | 214 | 6.475 | 16.168 | 63.639 | 1.00 | 151.89 |
| ATOM | 770 | CG | HIS | 214 | 5.807 | 17.013 | 64.500 | 1.00 | 151.89 |
| ATOM | 771 | CB | HIS | 214 | 5.781 | 16.828 | 65.991 | 1.00 | 151.89 |
| ATOM | 772 | NE2 | HIS | 214 | 5.499 | 17.715 | 62.378 | 1.00 | 151.89 |
| ATOM | 773 | CD2 | HIS | 214 | 5.217 | 17.953 | 63.712 | 1.00 | 151.89 |
| ATOM | 774 | CE1 | HIS | 214 | 6.256 | 16.634 | 62.383 | 1.00 | 151.89 |
| ATOM | 775 | C | HIS | 214 | 8.196 | 17.269 | 65.858 | 1.00 | 151.89 |
| ATOM | 776 | O | HIS | 214 | 8.878 | 16.248 | 65.927 | 1.00 | 151.89 |
| ATOM | 777 | N | ILE | 215 | 8.480 | 18.263 | 65.001 | 1.00 | 101.59 |
| ATOM | 778 | CA | ILE | 215 | 9.542 | 18.215 | 64.031 | 1.00 | 101.59 |
| ATOM | 779 | CB | ILE | 215 | 9.561 | 19.420 | 63.133 | 1.00 | 101.59 |
| ATOM | 780 | CG2 | ILE | 215 | 9.891 | 20.656 | 63.989 | 1.00 | 101.59 |
| ATOM | 781 | CG1 | ILE | 215 | 10.536 | 19.201 | 61.965 | 1.00 | 101.59 |
| ATOM | 782 | CD1 | ILE | 215 | 10.425 | 20.268 | 60.876 | 1.00 | 101.59 |
| ATOM | 783 | C | ILE | 215 | 10.905 | 18.140 | 64.654 | 1.00 | 101.59 |
| ATOM | 784 | O | ILE | 215 | 11.780 | 17.444 | 64.142 | 1.00 | 101.59 |
| ATOM | 785 | N | LEU | 216 | 11.122 | 18.846 | 65.777 | 1.00 | 71.07 |
| ATOM | 786 | CA | LEU | 216 | 12.441 | 19.086 | 66.298 | 1.00 | 71.07 |
| ATOM | 787 | CB | LEU | 216 | 12.443 | 19.971 | 67.554 | 1.00 | 71.07 |
| ATOM | 788 | CG | LEU | 216 | 11.974 | 21.411 | 67.274 | 1.00 | 71.07 |
| ATOM | 789 | CD2 | LEU | 216 | 12.717 | 22.018 | 66.072 | 1.00 | 71.07 |
| ATOM | 790 | CD1 | LEU | 216 | 12.062 | 22.281 | 68.538 | 1.00 | 71.07 |
| ATOM | 791 | C | LEU | 216 | 13.245 | 17.858 | 66.614 | 1.00 | 71.07 |
| ATOM | 792 | O | LEU | 216 | 14.434 | 17.832 | 66.307 | 1.00 | 71.07 |
| ATOM | 793 | N | SER | 217 | 12.668 | 16.807 | 67.217 | 1.00 | 91.67 |
| ATOM | 794 | CA | SER | 217 | 13.489 | 15.691 | 67.605 | 1.00 | 91.67 |
| ATOM | 795 | CB | SER | 217 | 12.686 | 14.580 | 68.299 | 1.00 | 91.67 |
| ATOM | 796 | OG | SER | 217 | 11.706 | 14.060 | 67.415 | 1.00 | 91.67 |
| ATOM | 797 | C | SER | 217 | 14.146 | 15.102 | 66.396 | 1.00 | 91.67 |
| ATOM | 798 | O | SER | 217 | 15.287 | 14.648 | 66.461 | 1.00 | 91.67 |
| ATOM | 799 | N | TYR | 218 | 13.450 | 15.117 | 65.249 | 1.00 | 91.93 |
| ATOM | 800 | CA | TYR | 218 | 13.967 | 14.526 | 64.052 | 1.00 | 91.93 |
| ATOM | 801 | CB | TYR | 218 | 12.965 | 14.580 | 62.887 | 1.00 | 91.93 |
| ATOM | 802 | CG | TYR | 218 | 13.598 | 13.904 | 61.723 | 1.00 | 91.93 |
| ATOM | 803 | CD1 | TYR | 218 | 13.594 | 12.531 | 61.639 | 1.00 | 91.93 |
| ATOM | 804 | CD2 | TYR | 218 | 14.187 | 14.636 | 60.716 | 1.00 | 91.93 |
| ATOM | 805 | CE1 | TYR | 218 | 14.172 | 11.891 | 60.569 | 1.00 | 91.93 |
| ATOM | 806 | CE2 | TYR | 218 | 14.768 | 14.000 | 59.643 | 1.00 | 91.93 |
| ATOM | 807 | CZ | TYR | 218 | 14.759 | 12.628 | 59.569 | 1.00 | 91.93 |
| ATOM | 808 | OH | TYR | 218 | 15.351 | 11.972 | 58.470 | 1.00 | 91.93 |
| ATOM | 809 | C | TYR | 218 | 15.220 | 15.241 | 63.624 | 1.00 | 91.93 |
| ATOM | 810 | O | TYR | 218 | 16.187 | 14.600 | 63.215 | 1.00 | 91.93 |
| ATOM | 811 | N | ILE | 219 | 15.247 | 16.586 | 63.726 | 1.00 | 130.52 |
| ATOM | 812 | CA | ILE | 219 | 16.367 | 17.377 | 63.277 | 1.00 | 130.52 |
| ATOM | 813 | CB | ILE | 219 | 16.191 | 18.863 | 63.444 | 1.00 | 130.52 |
| ATOM | 814 | CG2 | ILE | 219 | 16.362 | 19.210 | 64.932 | 1.00 | 130.52 |
| ATOM | 815 | CG1 | ILE | 219 | 17.184 | 19.615 | 62.541 | 1.00 | 130.52 |
| ATOM | 816 | CD1 | ILE | 219 | 16.896 | 19.452 | 61.050 | 1.00 | 130.52 |
| ATOM | 817 | C | ILE | 219 | 17.573 | 16.969 | 64.061 | 1.00 | 130.52 |
| ATOM | 818 | O | ILE | 219 | 18.698 | 17.008 | 63.569 | 1.00 | 130.52 |
| ATOM | 819 | N | LEU | 220 | 17.348 | 16.588 | 65.328 | 1.00 | 154.16 |
| ATOM | 820 | CA | LEU | 220 | 18.369 | 16.162 | 66.239 | 1.00 | 154.16 |
| ATOM | 821 | CB | LEU | 220 | 17.799 | 15.834 | 67.629 | 1.00 | 154.16 |
| ATOM | 822 | CG | LEU | 220 | 18.840 | 15.357 | 68.658 | 1.00 | 154.16 |
| ATOM | 823 | CD2 | LEU | 220 | 18.145 | 14.815 | 69.913 | 1.00 | 154.16 |
| ATOM | 824 | CD1 | LEU | 220 | 19.877 | 16.451 | 68.974 | 1.00 | 154.16 |
| ATOM | 825 | C | LEU | 220 | 18.998 | 14.921 | 65.676 | 1.00 | 154.16 |
| ATOM | 826 | O | LEU | 220 | 20.148 | 14.608 | 65.984 | 1.00 | 154.16 |
| ATOM | 827 | N | LYS | 221 | 18.239 | 14.166 | 64.850 | 1.00 | 116.78 |
| ATOM | 828 | CA | LYS | 221 | 18.713 | 12.951 | 64.248 | 1.00 | 116.78 |
| ATOM | 829 | CB | LYS | 221 | 20.010 | 13.104 | 63.431 | 1.00 | 116.78 |
| ATOM | 830 | CG | LYS | 221 | 19.781 | 13.446 | 61.955 | 1.00 | 116.78 |
| ATOM | 831 | CD | LYS | 221 | 19.173 | 14.823 | 61.684 | 1.00 | 116.78 |
| ATOM | 832 | CE | LYS | 221 | 18.960 | 15.100 | 60.193 | 1.00 | 116.78 |
| ATOM | 833 | NZ | LYS | 221 | 18.364 | 16.442 | 60.003 | 1.00 | 116.78 |
| ATOM | 834 | C | LYS | 221 | 18.933 | 11.916 | 65.294 | 1.00 | 116.78 |
| ATOM | 835 | O | LYS | 221 | 19.776 | 11.032 | 65.143 | 1.00 | 116.78 |
| ATOM | 836 | N | ASP | 222 | 18.163 | 11.994 | 66.391 | 1.00 | 95.70 |
| ATOM | 837 | CA | ASP | 222 | 18.285 | 10.985 | 67.390 | 1.00 | 95.70 |
| ATOM | 838 | CB | ASP | 222 | 19.088 | 11.446 | 68.619 | 1.00 | 95.70 |
| ATOM | 839 | CG | ASP | 222 | 19.764 | 10.227 | 69.239 | 1.00 | 95.70 |
| ATOM | 840 | OD1 | ASP | 222 | 19.230 | 9.095 | 69.101 | 1.00 | 95.70 |
| ATOM | 841 | OD2 | ASP | 222 | 20.850 | 10.418 | 69.847 | 1.00 | 95.70 |
| ATOM | 842 | C | ASP | 222 | 16.884 | 10.667 | 67.806 | 1.00 | 95.70 |
| ATOM | 843 | O | ASP | 222 | 15.936 | 11.314 | 67.355 | 1.00 | 95.70 |
| ATOM | 844 | N | LYS | 223 | 16.713 | 9.632 | 68.651 | 1.00 | 73.05 |
| ATOM | 845 | CA | LYS | 223 | 15.410 | 9.247 | 69.104 | 1.00 | 73.05 |
| ATOM | 846 | CB | LYS | 223 | 15.081 | 7.777 | 68.786 | 1.00 | 73.05 |
| ATOM | 847 | CG | LYS | 223 | 14.980 | 7.499 | 67.283 | 1.00 | 73.05 |
| ATOM | 848 | CD | LYS | 223 | 14.994 | 6.012 | 66.915 | 1.00 | 73.05 |
| ATOM | 849 | CE | LYS | 223 | 16.395 | 5.438 | 66.695 | 1.00 | 73.05 |
| ATOM | 850 | NZ | LYS | 223 | 16.301 | 4.004 | 66.340 | 1.00 | 73.05 |
| ATOM | 851 | C | LYS | 223 | 15.387 | 9.406 | 70.594 | 1.00 | 73.05 |
| ATOM | 852 | O | LYS | 223 | 16.419 | 9.335 | 71.254 | 1.00 | 73.05 |
| ATOM | 853 | N | ILE | 224 | 14.179 | 9.594 | 71.156 | 1.00 | 70.41 |
| ATOM | 854 | CA | ILE | 224 | 13.955 | 9.832 | 72.556 | 1.00 | 70.41 |
| ATOM | 855 | CB | ILE | 224 | 12.504 | 10.030 | 72.899 | 1.00 | 70.41 |
| ATOM | 856 | CG2 | ILE | 224 | 11.747 | 8.727 | 72.591 | 1.00 | 70.41 |
| ATOM | 857 | CG1 | ILE | 224 | 12.359 | 10.508 | 74.355 | 1.00 | 70.41 |
| ATOM | 858 | CD1 | ILE | 224 | 10.944 | 10.955 | 74.720 | 1.00 | 70.41 |
| ATOM | 859 | C | ILE | 224 | 14.450 | 8.672 | 73.367 | 1.00 | 70.41 |
| ATOM | 860 | O | ILE | 224 | 14.951 | 8.850 | 74.474 | 1.00 | 70.41 |
| ATOM | 861 | N | LYS | 225 | 14.307 | 7.443 | 72.851 | 1.00 | 97.06 |
| ATOM | 862 | CA | LYS | 225 | 14.661 | 6.273 | 73.604 | 1.00 | 97.06 |
| ATOM | 863 | CB | LYS | 225 | 14.480 | 4.980 | 72.798 | 1.00 | 97.06 |
| ATOM | 864 | CG | LYS | 225 | 13.054 | 4.737 | 72.315 | 1.00 | 97.06 |
| ATOM | 865 | CD | LYS | 225 | 12.965 | 3.668 | 71.226 | 1.00 | 97.06 |
| ATOM | 866 | CE | LYS | 225 | 12.377 | 2.339 | 71.707 | 1.00 | 97.06 |
| ATOM | 867 | NZ | LYS | 225 | 13.256 | 1.731 | 72.729 | 1.00 | 97.06 |
| ATOM | 868 | C | LYS | 225 | 16.112 | 6.313 | 73.984 | 1.00 | 97.06 |
| ATOM | 869 | O | LYS | 225 | 16.470 | 5.922 | 75.093 | 1.00 | 97.06 |
| ATOM | 870 | N | SER | 226 | 16.990 | 6.764 | 73.069 | 1.00 | 90.97 |
| ATOM | 871 | CA | SER | 226 | 18.410 | 6.730 | 73.291 | 1.00 | 90.97 |
| ATOM | 872 | CB | SER | 226 | 19.215 | 6.979 | 72.004 | 1.00 | 90.97 |
| ATOM | 873 | OG | SER | 226 | 20.605 | 6.933 | 72.287 | 1.00 | 90.97 |
| ATOM | 874 | C | SER | 226 | 18.870 | 7.741 | 74.308 | 1.00 | 90.97 |
| ATOM | 875 | O | SER | 226 | 19.916 | 7.548 | 74.922 | 1.00 | 90.97 |
| ATOM | 876 | N | SER | 227 | 18.108 | 8.833 | 74.522 | 1.00 | 110.32 |
| ATOM | 877 | CA | SER | 227 | 18.499 | 9.964 | 75.332 | 1.00 | 110.32 |
| ATOM | 878 | CB | SER | 227 | 17.489 | 11.119 | 75.265 | 1.00 | 110.32 |
| ATOM | 879 | OG | SER | 227 | 17.924 | 12.201 | 76.073 | 1.00 | 110.32 |
| ATOM | 880 | C | SER | 227 | 18.633 | 9.705 | 76.797 | 1.00 | 110.32 |
| ATOM | 881 | O | SER | 227 | 17.830 | 9.000 | 77.407 | 1.00 | 110.32 |
| ATOM | 882 | N | THR | 228 | 19.720 | 10.255 | 77.385 | 1.00 | 135.76 |
| ATOM | 883 | CA | THR | 228 | 19.856 | 10.302 | 78.811 | 1.00 | 135.76 |
| ATOM | 884 | CB | THR | 228 | 21.272 | 10.507 | 79.277 | 1.00 | 135.76 |
| ATOM | 885 | OG1 | THR | 228 | 21.325 | 10.466 | 80.694 | 1.00 | 135.76 |
| ATOM | 886 | CG2 | THR | 228 | 21.813 | 11.846 | 78.754 | 1.00 | 135.76 |
| ATOM | 887 | C | THR | 228 | 19.027 | 11.446 | 79.317 | 1.00 | 135.76 |
| ATOM | 888 | O | THR | 228 | 18.300 | 11.315 | 80.302 | 1.00 | 135.76 |
| ATOM | 889 | N | SER | 229 | 19.099 | 12.611 | 78.627 | 1.00 | 65.15 |
| ATOM | 890 | CA | SER | 229 | 18.361 | 13.736 | 79.125 | 1.00 | 65.15 |
| ATOM | 891 | CB | SER | 229 | 19.084 | 14.485 | 80.257 | 1.00 | 65.15 |
| ATOM | 892 | OG | SER | 229 | 19.237 | 13.627 | 81.380 | 1.00 | 65.15 |
| ATOM | 893 | C | SER | 229 | 18.107 | 14.715 | 78.024 | 1.00 | 65.15 |
| ATOM | 894 | O | SER | 229 | 18.783 | 14.717 | 76.997 | 1.00 | 65.15 |
| ATOM | 895 | N | ARG | 230 | 17.077 | 15.563 | 78.221 | 1.00 | 127.75 |
| ATOM | 896 | CA | ARG | 230 | 16.743 | 16.612 | 77.300 | 1.00 | 127.75 |
| ATOM | 897 | CB | ARG | 230 | 15.367 | 16.447 | 76.627 | 1.00 | 127.75 |
| ATOM | 898 | CG | ARG | 230 | 15.036 | 17.576 | 75.646 | 1.00 | 127.75 |
| ATOM | 899 | CD | ARG | 230 | 13.546 | 17.698 | 75.313 | 1.00 | 127.75 |
| ATOM | 900 | NE | ARG | 230 | 12.897 | 18.416 | 76.447 | 1.00 | 127.75 |
| ATOM | 901 | CZ | ARG | 230 | 12.371 | 17.715 | 77.493 | 1.00 | 127.75 |
| ATOM | 902 | NH1 | ARG | 230 | 12.392 | 16.351 | 77.471 | 1.00 | 127.75 |
| ATOM | 903 | NH2 | ARG | 230 | 11.832 | 18.376 | 78.560 | 1.00 | 127.75 |
| ATOM | 904 | C | ARG | 230 | 16.645 | 17.861 | 78.123 | 1.00 | 127.75 |
| ATOM | 905 | O | ARG | 230 | 15.977 | 17.874 | 79.157 | 1.00 | 127.75 |
| ATOM | 906 | N | PHE | 231 | 17.305 | 18.954 | 77.685 | 1.00 | 65.40 |
| ATOM | 907 | CA | PHE | 231 | 17.235 | 20.164 | 78.456 | 1.00 | 65.40 |
| ATOM | 908 | CB | PHE | 231 | 18.604 | 20.799 | 78.762 | 1.00 | 65.40 |
| ATOM | 909 | CG | PHE | 231 | 19.378 | 19.907 | 79.674 | 1.00 | 65.40 |
| ATOM | 910 | CD1 | PHE | 231 | 20.144 | 18.876 | 79.175 | 1.00 | 65.40 |
| ATOM | 911 | CD2 | PHE | 231 | 19.351 | 20.109 | 81.034 | 1.00 | 65.40 |
| ATOM | 912 | CE1 | PHE | 231 | 20.861 | 18.059 | 80.020 | 1.00 | 65.40 |
| ATOM | 913 | CE2 | PHE | 231 | 20.064 | 19.295 | 81.882 | 1.00 | 65.40 |
| ATOM | 914 | CZ | PHE | 231 | 20.824 | 18.268 | 81.377 | 1.00 | 65.40 |
| ATOM | 915 | C | PHE | 231 | 16.455 | 21.183 | 77.681 | 1.00 | 65.40 |
| ATOM | 916 | O | PHE | 231 | 16.590 | 21.284 | 76.464 | 1.00 | 65.40 |
| ATOM | 917 | N | VAL | 232 | 15.583 | 21.955 | 78.365 | 1.00 | 54.92 |
| ATOM | 918 | CA | VAL | 232 | 14.876 | 22.976 | 77.648 | 1.00 | 54.92 |
| ATOM | 919 | CB | VAL | 232 | 13.409 | 22.698 | 77.490 | 1.00 | 54.92 |
| ATOM | 920 | CG1 | VAL | 232 | 12.754 | 23.898 | 76.786 | 1.00 | 54.92 |
| ATOM | 921 | CG2 | VAL | 232 | 13.244 | 21.370 | 76.736 | 1.00 | 54.92 |
| ATOM | 922 | C | VAL | 232 | 15.011 | 24.260 | 78.404 | 1.00 | 54.92 |
| ATOM | 923 | O | VAL | 232 | 14.491 | 24.399 | 79.511 | 1.00 | 54.92 |
| ATOM | 924 | N | MET | 233 | 15.697 | 25.250 | 77.798 | 1.00 | 161.31 |
| ATOM | 925 | CA | MET | 233 | 15.841 | 26.540 | 78.406 | 1.00 | 161.31 |
| ATOM | 926 | CB | MET | 233 | 16.866 | 27.450 | 77.708 | 1.00 | 161.31 |
| ATOM | 927 | CG | MET | 233 | 18.319 | 27.051 | 77.977 | 1.00 | 161.31 |
| ATOM | 928 | SD | MET | 233 | 18.818 | 25.457 | 77.264 | 1.00 | 161.31 |
| ATOM | 929 | CE | MET | 233 | 18.262 | 24.451 | 78.667 | 1.00 | 161.31 |
| ATOM | 930 | C | MET | 233 | 14.501 | 27.185 | 78.306 | 1.00 | 161.31 |
| ATOM | 931 | O | MET | 233 | 13.759 | 26.978 | 77.345 | 1.00 | 161.31 |
| ATOM | 932 | N | PHE | 234 | 14.169 | 27.997 | 79.320 | 1.00 | 157.04 |
| ATOM | 933 | CA | PHE | 234 | 12.858 | 28.548 | 79.456 | 1.00 | 157.04 |
| ATOM | 934 | CB | PHE | 234 | 12.307 | 28.180 | 80.844 | 1.00 | 157.04 |
| ATOM | 935 | CG | PHE | 234 | 10.873 | 28.528 | 80.992 | 1.00 | 157.04 |
| ATOM | 936 | CD1 | PHE | 234 | 10.467 | 29.841 | 81.006 | 1.00 | 157.04 |
| ATOM | 937 | CD2 | PHE | 234 | 9.932 | 27.532 | 81.104 | 1.00 | 157.04 |
| ATOM | 938 | CE1 | PHE | 234 | 9.138 | 30.162 | 81.142 | 1.00 | 157.04 |
| ATOM | 939 | CE2 | PHE | 234 | 8.605 | 27.851 | 81.243 | 1.00 | 157.04 |
| ATOM | 940 | CZ | PHE | 234 | 8.202 | 29.165 | 81.262 | 1.00 | 157.04 |
| ATOM | 941 | C | PHE | 234 | 12.977 | 30.035 | 79.439 | 1.00 | 157.04 |
| ATOM | 942 | O | PHE | 234 | 13.862 | 30.610 | 80.072 | 1.00 | 157.04 |
| ATOM | 943 | N | GLY | 235 | 12.069 | 30.702 | 78.707 | 1.00 | 36.60 |
| ATOM | 944 | CA | GLY | 235 | 12.071 | 32.130 | 78.725 | 1.00 | 36.60 |
| ATOM | 945 | C | GLY | 235 | 10.788 | 32.496 | 79.392 | 1.00 | 36.60 |
| ATOM | 946 | O | GLY | 235 | 9.740 | 31.923 | 79.098 | 1.00 | 36.60 |
| ATOM | 947 | N | PHE | 236 | 10.847 | 33.476 | 80.310 | 1.00 | 124.45 |
| ATOM | 948 | CA | PHE | 236 | 9.688 | 33.908 | 81.033 | 1.00 | 124.45 |
| ATOM | 949 | CB | PHE | 236 | 10.025 | 34.424 | 82.451 | 1.00 | 124.45 |
| ATOM | 950 | CG | PHE | 236 | 8.777 | 34.878 | 83.134 | 1.00 | 124.45 |
| ATOM | 951 | CD1 | PHE | 236 | 7.844 | 33.978 | 83.598 | 1.00 | 124.45 |
| ATOM | 952 | CD2 | PHE | 236 | 8.552 | 36.220 | 83.328 | 1.00 | 124.45 |
| ATOM | 953 | CE1 | PHE | 236 | 6.701 | 34.418 | 84.226 | 1.00 | 124.45 |
| ATOM | 954 | CE2 | PHE | 236 | 7.412 | 36.666 | 83.956 | 1.00 | 124.45 |
| ATOM | 955 | CZ | PHE | 236 | 6.480 | 35.762 | 84.406 | 1.00 | 124.45 |
| ATOM | 956 | C | PHE | 236 | 9.074 | 35.005 | 80.228 | 1.00 | 124.45 |
| ATOM | 957 | O | PHE | 236 | 9.718 | 35.532 | 79.322 | 1.00 | 124.45 |
| ATOM | 958 | N | CYS | 237 | 7.805 | 35.361 | 80.530 | 1.00 | 168.32 |
| ATOM | 959 | CA | CYS | 237 | 7.128 | 36.378 | 79.777 | 1.00 | 168.32 |
| ATOM | 960 | CB | CYS | 237 | 5.751 | 36.753 | 80.352 | 1.00 | 168.32 |
| ATOM | 961 | SG | CYS | 237 | 4.549 | 35.394 | 80.243 | 1.00 | 168.32 |
| ATOM | 962 | C | CYS | 237 | 7.986 | 37.583 | 79.865 | 1.00 | 168.32 |
| ATOM | 963 | O | CYS | 237 | 8.268 | 38.226 | 78.854 | 1.00 | 168.32 |
| ATOM | 964 | N | TYR | 238 | 8.442 | 37.926 | 81.081 | 1.00 | 284.30 |
| ATOM | 965 | CA | TYR | 238 | 9.416 | 38.961 | 81.072 | 1.00 | 284.30 |
| ATOM | 966 | CB | TYR | 238 | 9.903 | 39.425 | 82.462 | 1.00 | 284.30 |
| ATOM | 967 | CG | TYR | 238 | 8.854 | 40.286 | 83.078 | 1.00 | 284.30 |
| ATOM | 968 | CD1 | TYR | 238 | 8.763 | 41.610 | 82.716 | 1.00 | 284.30 |
| ATOM | 969 | CD2 | TYR | 238 | 7.978 | 39.791 | 84.017 | 1.00 | 284.30 |
| ATOM | 970 | CE1 | TYR | 238 | 7.806 | 42.429 | 83.266 | 1.00 | 284.30 |
| ATOM | 971 | CE2 | TYR | 238 | 7.018 | 40.607 | 84.574 | 1.00 | 284.30 |
| ATOM | 972 | CZ | TYR | 238 | 6.932 | 41.927 | 84.199 | 1.00 | 284.30 |
| ATOM | 973 | OH | TYR | 238 | 5.948 | 42.765 | 84.766 | 1.00 | 284.30 |
| ATOM | 974 | C | TYR | 238 | 10.554 | 38.314 | 80.372 | 1.00 | 284.30 |
| ATOM | 975 | O | TYR | 238 | 10.991 | 37.226 | 80.741 | 1.00 | 284.30 |
| ATOM | 976 | N | LEU | 239 | 11.055 | 38.973 | 79.320 | 1.00 | 171.87 |
| ATOM | 977 | CA | LEU | 239 | 12.103 | 38.407 | 78.536 | 1.00 | 171.87 |
| ATOM | 978 | CB | LEU | 239 | 12.501 | 39.289 | 77.341 | 1.00 | 171.87 |
| ATOM | 979 | CG | LEU | 239 | 12.683 | 40.775 | 77.715 | 1.00 | 171.87 |
| ATOM | 980 | CD2 | LEU | 239 | 11.503 | 41.296 | 78.551 | 1.00 | 171.87 |
| ATOM | 981 | CD1 | LEU | 239 | 12.953 | 41.633 | 76.469 | 1.00 | 171.87 |
| ATOM | 982 | C | LEU | 239 | 13.273 | 38.263 | 79.446 | 1.00 | 171.87 |
| ATOM | 983 | O | LEU | 239 | 14.132 | 37.407 | 79.253 | 1.00 | 171.87 |
| ATOM | 984 | N | SER | 240 | 13.308 | 39.118 | 80.478 | 1.00 | 119.68 |
| ATOM | 985 | CA | SER | 240 | 14.403 | 39.216 | 81.390 | 1.00 | 119.68 |
| ATOM | 986 | CB | SER | 240 | 14.206 | 40.338 | 82.423 | 1.00 | 119.68 |
| ATOM | 987 | OG | SER | 240 | 15.316 | 40.390 | 83.307 | 1.00 | 119.68 |
| ATOM | 988 | C | SER | 240 | 14.663 | 37.940 | 82.151 | 1.00 | 119.68 |
| ATOM | 989 | O | SER | 240 | 15.794 | 37.735 | 82.584 | 1.00 | 119.68 |
| ATOM | 990 | N | HIS | 241 | 13.682 | 37.034 | 82.352 | 1.00 | 100.43 |
| ATOM | 991 | CA | HIS | 241 | 14.003 | 35.901 | 83.190 | 1.00 | 100.43 |
| ATOM | 992 | ND1 | HIS | 241 | 13.297 | 33.116 | 84.774 | 1.00 | 100.43 |
| ATOM | 993 | CG | HIS | 241 | 13.303 | 34.445 | 85.135 | 1.00 | 100.43 |
| ATOM | 994 | CB | HIS | 241 | 12.906 | 35.559 | 84.213 | 1.00 | 100.43 |
| ATOM | 995 | NE2 | HIS | 241 | 14.003 | 33.198 | 86.881 | 1.00 | 100.43 |
| ATOM | 996 | CD2 | HIS | 241 | 13.736 | 34.477 | 86.425 | 1.00 | 100.43 |
| ATOM | 997 | CE1 | HIS | 241 | 13.724 | 32.415 | 85.855 | 1.00 | 100.43 |
| ATOM | 998 | C | HIS | 241 | 14.250 | 34.656 | 82.382 | 1.00 | 100.43 |
| ATOM | 999 | O | HIS | 241 | 13.594 | 34.412 | 81.371 | 1.00 | 100.43 |
| ATOM | 1000 | N | TRP | 242 | 15.237 | 33.839 | 82.828 | 1.00 | 71.70 |
| ATOM | 1001 | CA | TRP | 242 | 15.568 | 32.596 | 82.183 | 1.00 | 71.70 |
| ATOM | 1002 | CB | TRP | 242 | 16.978 | 32.577 | 81.559 | 1.00 | 71.70 |
| ATOM | 1003 | CG | TRP | 242 | 17.211 | 31.501 | 80.518 | 1.00 | 71.70 |
| ATOM | 1004 | CD2 | TRP | 242 | 16.960 | 30.110 | 80.750 | 1.00 | 71.70 |
| ATOM | 1005 | CD1 | TRP | 242 | 17.689 | 31.602 | 79.246 | 1.00 | 71.70 |
| ATOM | 1006 | NE1 | TRP | 242 | 17.753 | 30.353 | 78.668 | 1.00 | 71.70 |
| ATOM | 1007 | CE2 | TRP | 242 | 17.306 | 29.425 | 79.588 | 1.00 | 71.70 |
| ATOM | 1008 | CE3 | TRP | 242 | 16.483 | 29.452 | 81.849 | 1.00 | 71.70 |
| ATOM | 1009 | CZ2 | TRP | 242 | 17.180 | 28.067 | 79.501 | 1.00 | 71.70 |
| ATOM | 1010 | CZ3 | TRP | 242 | 16.352 | 28.085 | 81.760 | 1.00 | 71.70 |
| ATOM | 1011 | CH2 | TRP | 242 | 16.694 | 27.406 | 80.610 | 1.00 | 71.70 |
| ATOM | 1012 | C | TRP | 242 | 15.543 | 31.511 | 83.223 | 1.00 | 71.70 |
| ATOM | 1013 | O | TRP | 242 | 16.038 | 31.691 | 84.334 | 1.00 | 71.70 |
| ATOM | 1014 | N | LYS | 243 | 14.954 | 30.348 | 82.873 | 1.00 | 134.01 |
| ATOM | 1015 | CA | LYS | 243 | 14.840 | 29.232 | 83.772 | 1.00 | 134.01 |
| ATOM | 1016 | CB | LYS | 243 | 13.473 | 29.195 | 84.481 | 1.00 | 134.01 |
| ATOM | 1017 | CG | LYS | 243 | 12.291 | 29.385 | 83.532 | 1.00 | 134.01 |
| ATOM | 1018 | CD | LYS | 243 | 10.931 | 29.354 | 84.229 | 1.00 | 134.01 |
| ATOM | 1019 | CE | LYS | 243 | 10.595 | 30.669 | 84.937 | 1.00 | 134.01 |
| ATOM | 1020 | NZ | LYS | 243 | 9.215 | 30.623 | 85.468 | 1.00 | 134.01 |
| ATOM | 1021 | C | LYS | 243 | 15.057 | 27.987 | 82.960 | 1.00 | 134.01 |
| ATOM | 1022 | O | LYS | 243 | 15.282 | 28.077 | 81.755 | 1.00 | 134.01 |
| ATOM | 1023 | N | CYS | 244 | 15.048 | 26.787 | 83.586 | 1.00 | 62.56 |
| ATOM | 1024 | CA | CYS | 244 | 15.340 | 25.638 | 82.771 | 1.00 | 62.56 |
| ATOM | 1025 | CB | CYS | 244 | 16.815 | 25.213 | 82.855 | 1.00 | 62.56 |
| ATOM | 1026 | SG | CYS | 244 | 17.198 | 23.765 | 81.826 | 1.00 | 62.56 |
| ATOM | 1027 | C | CYS | 244 | 14.518 | 24.452 | 83.180 | 1.00 | 62.56 |
| ATOM | 1028 | O | CYS | 244 | 14.132 | 24.296 | 84.337 | 1.00 | 62.56 |
| ATOM | 1029 | N | VAL | 245 | 14.220 | 23.573 | 82.204 | 1.00 | 105.02 |
| ATOM | 1030 | CA | VAL | 245 | 13.522 | 22.360 | 82.509 | 1.00 | 105.02 |
| ATOM | 1031 | CB | VAL | 245 | 12.237 | 22.162 | 81.758 | 1.00 | 105.02 |
| ATOM | 1032 | CG1 | VAL | 245 | 11.241 | 23.250 | 82.186 | 1.00 | 105.02 |
| ATOM | 1033 | CG2 | VAL | 245 | 12.541 | 22.149 | 80.254 | 1.00 | 105.02 |
| ATOM | 1034 | C | VAL | 245 | 14.437 | 21.242 | 82.137 | 1.00 | 105.02 |
| ATOM | 1035 | O | VAL | 245 | 15.161 | 21.330 | 81.145 | 1.00 | 105.02 |
| ATOM | 1036 | N | ILE | 246 | 14.469 | 20.170 | 82.956 | 1.00 | 69.99 |
| ATOM | 1037 | CA | ILE | 246 | 15.311 | 19.068 | 82.601 | 1.00 | 69.99 |
| ATOM | 1038 | CB | ILE | 246 | 16.362 | 18.704 | 83.605 | 1.00 | 69.99 |
| ATOM | 1039 | CG2 | ILE | 246 | 17.040 | 17.415 | 83.114 | 1.00 | 69.99 |
| ATOM | 1040 | CG1 | ILE | 246 | 17.357 | 19.840 | 83.845 | 1.00 | 69.99 |
| ATOM | 1041 | CD1 | ILE | 246 | 18.356 | 19.453 | 84.928 | 1.00 | 69.99 |
| ATOM | 1042 | C | ILE | 246 | 14.466 | 17.845 | 82.536 | 1.00 | 69.99 |
| ATOM | 1043 | O | ILE | 246 | 13.752 | 17.519 | 83.483 | 1.00 | 69.99 |
| ATOM | 1044 | N | TYR | 247 | 14.526 | 17.118 | 81.409 | 1.00 | 162.63 |
| ATOM | 1045 | CA | TYR | 247 | 13.821 | 15.877 | 81.419 | 1.00 | 162.63 |
| ATOM | 1046 | CB | TYR | 247 | 12.993 | 15.571 | 80.164 | 1.00 | 162.63 |
| ATOM | 1047 | CG | TYR | 247 | 12.404 | 14.225 | 80.410 | 1.00 | 162.63 |
| ATOM | 1048 | CD1 | TYR | 247 | 11.304 | 14.083 | 81.227 | 1.00 | 162.63 |
| ATOM | 1049 | CD2 | TYR | 247 | 12.952 | 13.106 | 79.831 | 1.00 | 162.63 |
| ATOM | 1050 | CE1 | TYR | 247 | 10.760 | 12.842 | 81.461 | 1.00 | 162.63 |
| ATOM | 1051 | CE2 | TYR | 247 | 12.411 | 11.864 | 80.062 | 1.00 | 162.63 |
| ATOM | 1052 | CZ | TYR | 247 | 11.313 | 11.730 | 80.876 | 1.00 | 162.63 |
| ATOM | 1053 | OH | TYR | 247 | 10.760 | 10.453 | 81.111 | 1.00 | 162.63 |
| ATOM | 1054 | C | TYR | 247 | 14.873 | 14.832 | 81.502 | 1.00 | 162.63 |
| ATOM | 1055 | O | TYR | 247 | 15.725 | 14.720 | 80.623 | 1.00 | 162.63 |
| ATOM | 1056 | N | ASP | 248 | 14.861 | 14.054 | 82.598 | 1.00 | 120.84 |
| ATOM | 1057 | CA | ASP | 248 | 15.853 | 13.040 | 82.731 | 1.00 | 120.84 |
| ATOM | 1058 | CB | ASP | 248 | 16.545 | 13.029 | 84.105 | 1.00 | 120.84 |
| ATOM | 1059 | CG | ASP | 248 | 15.489 | 12.886 | 85.182 | 1.00 | 120.84 |
| ATOM | 1060 | OD1 | ASP | 248 | 15.119 | 11.728 | 85.497 | 1.00 | 120.84 |
| ATOM | 1061 | OD2 | ASP | 248 | 15.045 | 13.937 | 85.714 | 1.00 | 120.84 |
| ATOM | 1062 | C | ASP | 248 | 15.220 | 11.721 | 82.447 | 1.00 | 120.84 |
| ATOM | 1063 | O | ASP | 248 | 14.346 | 11.239 | 83.161 | 1.00 | 120.84 |
| ATOM | 1064 | N | LYS | 249 | 15.627 | 11.115 | 81.325 | 1.00 | 137.23 |
| ATOM | 1065 | CA | LYS | 249 | 15.099 | 9.839 | 80.954 | 1.00 | 137.23 |
| ATOM | 1066 | CB | LYS | 249 | 15.586 | 9.390 | 79.563 | 1.00 | 137.23 |
| ATOM | 1067 | CG | LYS | 249 | 15.422 | 7.890 | 79.295 | 1.00 | 137.23 |
| ATOM | 1068 | CD | LYS | 249 | 13.983 | 7.378 | 79.300 | 1.00 | 137.23 |
| ATOM | 1069 | CE | LYS | 249 | 13.903 | 5.865 | 79.081 | 1.00 | 137.23 |
| ATOM | 1070 | NZ | LYS | 249 | 12.538 | 5.377 | 79.380 | 1.00 | 137.23 |
| ATOM | 1071 | C | LYS | 249 | 15.536 | 8.806 | 81.941 | 1.00 | 137.23 |
| ATOM | 1072 | O | LYS | 249 | 14.751 | 7.941 | 82.325 | 1.00 | 137.23 |
| ATOM | 1073 | N | LYS | 250 | 16.810 | 8.864 | 82.375 | 1.00 | 140.70 |
| ATOM | 1074 | CA | LYS | 250 | 17.312 | 7.828 | 83.232 | 1.00 | 140.70 |
| ATOM | 1075 | CB | LYS | 250 | 18.817 | 7.965 | 83.526 | 1.00 | 140.70 |
| ATOM | 1076 | CG | LYS | 250 | 19.206 | 9.188 | 84.359 | 1.00 | 140.70 |
| ATOM | 1077 | CD | LYS | 250 | 20.614 | 9.087 | 84.948 | 1.00 | 140.70 |
| ATOM | 1078 | CE | LYS | 250 | 21.722 | 9.373 | 83.934 | 1.00 | 140.70 |
| ATOM | 1079 | NZ | LYS | 250 | 21.855 | 10.833 | 83.730 | 1.00 | 140.70 |
| ATOM | 1080 | C | LYS | 250 | 16.603 | 7.804 | 84.555 | 1.00 | 140.70 |
| ATOM | 1081 | O | LYS | 250 | 16.115 | 6.759 | 84.982 | 1.00 | 140.70 |
| ATOM | 1082 | N | GLN | 251 | 16.534 | 8.962 | 85.239 | 1.00 | 123.46 |
| ATOM | 1083 | CA | GLN | 251 | 15.928 | 9.069 | 86.537 | 1.00 | 123.46 |
| ATOM | 1084 | CB | GLN | 251 | 16.416 | 10.269 | 87.378 | 1.00 | 123.46 |
| ATOM | 1085 | CG | GLN | 251 | 15.776 | 10.383 | 88.762 | 1.00 | 123.46 |
| ATOM | 1086 | CD | GLN | 251 | 16.494 | 11.496 | 89.518 | 1.00 | 123.46 |
| ATOM | 1087 | OE1 | GLN | 251 | 15.986 | 12.034 | 90.499 | 1.00 | 123.46 |
| ATOM | 1088 | NE2 | GLN | 251 | 17.723 | 11.844 | 89.053 | 1.00 | 123.46 |
| ATOM | 1089 | C | GLN | 251 | 14.433 | 9.026 | 86.417 | 1.00 | 123.46 |
| ATOM | 1090 | O | GLN | 251 | 13.737 | 8.731 | 87.387 | 1.00 | 123.46 |
| ATOM | 1091 | N | CYS | 252 | 13.900 | 9.307 | 85.212 | 1.00 | 57.14 |
| ATOM | 1092 | CA | CYS | 252 | 12.481 | 9.332 | 85.003 | 1.00 | 57.14 |
| ATOM | 1093 | CB | CYS | 252 | 11.792 | 8.009 | 85.384 | 1.00 | 57.14 |
| ATOM | 1094 | SG | CYS | 252 | 12.283 | 6.624 | 84.314 | 1.00 | 57.14 |
| ATOM | 1095 | C | CYS | 252 | 11.864 | 10.429 | 85.808 | 1.00 | 57.14 |
| ATOM | 1096 | O | CYS | 252 | 10.816 | 10.259 | 86.429 | 1.00 | 57.14 |
| ATOM | 1097 | N | LEU | 253 | 12.527 | 11.600 | 85.826 | 1.00 | 58.16 |
| ATOM | 1098 | CA | LEU | 253 | 11.977 | 12.742 | 86.490 | 1.00 | 58.16 |
| ATOM | 1099 | CB | LEU | 253 | 12.742 | 13.160 | 87.761 | 1.00 | 58.16 |
| ATOM | 1100 | CG | LEU | 253 | 12.666 | 12.118 | 88.897 | 1.00 | 58.16 |
| ATOM | 1101 | CD2 | LEU | 253 | 11.225 | 11.641 | 89.125 | 1.00 | 58.16 |
| ATOM | 1102 | CD1 | LEU | 253 | 13.328 | 12.646 | 90.181 | 1.00 | 58.16 |
| ATOM | 1103 | C | LEU | 253 | 11.998 | 13.897 | 85.533 | 1.00 | 58.16 |
| ATOM | 1104 | O | LEU | 253 | 12.768 | 13.915 | 84.572 | 1.00 | 58.16 |
| ATOM | 1105 | N | VAL | 254 | 11.093 | 14.870 | 85.756 | 1.00 | 54.62 |
| ATOM | 1106 | CA | VAL | 254 | 11.055 | 16.079 | 84.986 | 1.00 | 54.62 |
| ATOM | 1107 | CB | VAL | 254 | 9.737 | 16.349 | 84.318 | 1.00 | 54.62 |
| ATOM | 1108 | CG1 | VAL | 254 | 9.768 | 17.773 | 83.745 | 1.00 | 54.62 |
| ATOM | 1109 | CG2 | VAL | 254 | 9.498 | 15.270 | 83.249 | 1.00 | 54.62 |
| ATOM | 1110 | C | VAL | 254 | 11.251 | 17.154 | 85.994 | 1.00 | 54.62 |
| ATOM | 1111 | O | VAL | 254 | 10.523 | 17.214 | 86.985 | 1.00 | 54.62 |
| ATOM | 1112 | N | SER | 255 | 12.232 | 18.045 | 85.775 | 1.00 | 89.13 |
| ATOM | 1113 | CA | SER | 255 | 12.477 | 18.995 | 86.812 | 1.00 | 89.13 |
| ATOM | 1114 | CB | SER | 255 | 13.855 | 18.822 | 87.471 | 1.00 | 89.13 |
| ATOM | 1115 | OG | SER | 255 | 13.919 | 17.580 | 88.156 | 1.00 | 89.13 |
| ATOM | 1116 | C | SER | 255 | 12.418 | 20.377 | 86.264 | 1.00 | 89.13 |
| ATOM | 1117 | O | SER | 255 | 12.668 | 20.611 | 85.081 | 1.00 | 89.13 |
| ATOM | 1118 | N | PHE | 256 | 12.042 | 21.321 | 87.151 | 1.00 | 81.52 |
| ATOM | 1119 | CA | PHE | 256 | 11.974 | 22.719 | 86.856 | 1.00 | 81.52 |
| ATOM | 1120 | CB | PHE | 256 | 10.587 | 23.303 | 87.192 | 1.00 | 81.52 |
| ATOM | 1121 | CG | PHE | 256 | 10.553 | 24.775 | 86.949 | 1.00 | 81.52 |
| ATOM | 1122 | CD1 | PHE | 256 | 10.544 | 25.283 | 85.670 | 1.00 | 81.52 |
| ATOM | 1123 | CD2 | PHE | 256 | 10.493 | 25.650 | 88.011 | 1.00 | 81.52 |
| ATOM | 1124 | CE1 | PHE | 256 | 10.502 | 26.641 | 85.457 | 1.00 | 81.52 |
| ATOM | 1125 | CE2 | PHE | 256 | 10.450 | 27.009 | 87.805 | 1.00 | 81.52 |
| ATOM | 1126 | CZ | PHE | 256 | 10.457 | 27.507 | 86.524 | 1.00 | 81.52 |
| ATOM | 1127 | C | PHE | 256 | 12.995 | 23.343 | 87.754 | 1.00 | 81.52 |
| ATOM | 1128 | O | PHE | 256 | 12.908 | 23.224 | 88.974 | 1.00 | 81.52 |
| ATOM | 1129 | N | TYR | 257 | 13.991 | 24.020 | 87.148 | 1.00 | 150.24 |
| ATOM | 1130 | CA | TYR | 257 | 15.109 | 24.629 | 87.809 | 1.00 | 150.24 |
| ATOM | 1131 | CB | TYR | 257 | 16.428 | 24.122 | 87.204 | 1.00 | 150.24 |
| ATOM | 1132 | CG | TYR | 257 | 17.512 | 25.123 | 87.394 | 1.00 | 150.24 |
| ATOM | 1133 | CD1 | TYR | 257 | 18.208 | 25.218 | 88.567 | 1.00 | 150.24 |
| ATOM | 1134 | CD2 | TYR | 257 | 17.837 | 25.972 | 86.361 | 1.00 | 150.24 |
| ATOM | 1135 | CE1 | TYR | 257 | 19.206 | 26.151 | 88.715 | 1.00 | 150.24 |
| ATOM | 1136 | CE2 | TYR | 257 | 18.832 | 26.908 | 86.498 | 1.00 | 150.24 |
| ATOM | 1137 | CZ | TYR | 257 | 19.522 | 26.996 | 87.681 | 1.00 | 150.24 |
| ATOM | 1138 | OH | TYR | 257 | 20.546 | 27.950 | 87.840 | 1.00 | 150.24 |
| ATOM | 1139 | C | TYR | 257 | 15.053 | 26.098 | 87.599 | 1.00 | 150.24 |
| ATOM | 1140 | O | TYR | 257 | 15.127 | 26.570 | 86.467 | 1.00 | 150.24 |
| ATOM | 1141 | N | ASP | 258 | 14.945 | 26.863 | 88.706 | 1.00 | 96.85 |
| ATOM | 1142 | CA | ASP | 258 | 14.800 | 28.282 | 88.571 | 1.00 | 96.85 |
| ATOM | 1143 | CB | ASP | 258 | 13.335 | 28.709 | 88.797 | 1.00 | 96.85 |
| ATOM | 1144 | CG | ASP | 258 | 13.113 | 30.119 | 88.281 | 1.00 | 96.85 |
| ATOM | 1145 | OD1 | ASP | 258 | 14.109 | 30.883 | 88.199 | 1.00 | 96.85 |
| ATOM | 1146 | OD2 | ASP | 258 | 11.941 | 30.448 | 87.958 | 1.00 | 96.85 |
| ATOM | 1147 | C | ASP | 258 | 15.644 | 28.937 | 89.624 | 1.00 | 96.85 |
| ATOM | 1148 | O | ASP | 258 | 15.412 | 28.753 | 90.817 | 1.00 | 96.85 |
| ATOM | 1149 | N | SER | 259 | 16.665 | 29.708 | 89.204 | 1.00 | 85.86 |
| ATOM | 1150 | CA | SER | 259 | 17.530 | 30.407 | 90.117 | 1.00 | 85.86 |
| ATOM | 1151 | CB | SER | 259 | 18.781 | 30.984 | 89.432 | 1.00 | 85.86 |
| ATOM | 1152 | OG | SER | 259 | 18.407 | 31.895 | 88.409 | 1.00 | 85.86 |
| ATOM | 1153 | C | SER | 259 | 16.768 | 31.549 | 90.718 | 1.00 | 85.86 |
| ATOM | 1154 | O | SER | 259 | 17.222 | 32.172 | 91.678 | 1.00 | 85.86 |
| ATOM | 1155 | N | GLY | 260 | 15.605 | 31.865 | 90.112 | 1.00 | 113.20 |
| ATOM | 1156 | CA | GLY | 260 | 14.706 | 32.930 | 90.474 | 1.00 | 113.20 |
| ATOM | 1157 | C | GLY | 260 | 14.045 | 32.686 | 91.792 | 1.00 | 113.20 |
| ATOM | 1158 | O | GLY | 260 | 13.764 | 33.636 | 92.515 | 1.00 | 113.20 |
| ATOM | 1159 | N | GLY | 261 | 13.720 | 31.424 | 92.130 | 1.00 | 86.72 |
| ATOM | 1160 | CA | GLY | 261 | 13.064 | 31.199 | 93.385 | 1.00 | 86.72 |
| ATOM | 1161 | C | GLY | 261 | 11.592 | 31.341 | 93.186 | 1.00 | 86.72 |
| ATOM | 1162 | O | GLY | 261 | 11.067 | 30.999 | 92.130 | 1.00 | 86.72 |
| ATOM | 1163 | N | ASN | 262 | 10.881 | 31.879 | 94.198 | 1.00 | 207.82 |
| ATOM | 1164 | CA | ASN | 262 | 9.456 | 31.925 | 94.083 | 1.00 | 207.82 |
| ATOM | 1165 | CB | ASN | 262 | 8.966 | 32.726 | 92.860 | 1.00 | 207.82 |
| ATOM | 1166 | CG | ASN | 262 | 9.258 | 34.208 | 93.079 | 1.00 | 207.82 |
| ATOM | 1167 | OD1 | ASN | 262 | 9.119 | 34.718 | 94.189 | 1.00 | 207.82 |
| ATOM | 1168 | ND2 | ASN | 262 | 9.670 | 34.916 | 91.994 | 1.00 | 207.82 |
| ATOM | 1169 | C | ASN | 262 | 9.035 | 30.503 | 93.904 | 1.00 | 207.82 |
| ATOM | 1170 | O | ASN | 262 | 8.251 | 30.184 | 93.012 | 1.00 | 207.82 |
| ATOM | 1171 | N | ILE | 263 | 9.571 | 29.630 | 94.787 | 1.00 | 193.31 |
| ATOM | 1172 | CA | ILE | 263 | 9.388 | 28.206 | 94.792 | 1.00 | 193.31 |
| ATOM | 1173 | CB | ILE | 263 | 9.688 | 27.587 | 96.127 | 1.00 | 193.31 |
| ATOM | 1174 | CG2 | ILE | 263 | 8.780 | 28.259 | 97.166 | 1.00 | 193.31 |
| ATOM | 1175 | CG1 | ILE | 263 | 9.539 | 26.058 | 96.070 | 1.00 | 193.31 |
| ATOM | 1176 | CD1 | ILE | 263 | 10.598 | 25.377 | 95.202 | 1.00 | 193.31 |
| ATOM | 1177 | C | ILE | 263 | 7.983 | 27.869 | 94.442 | 1.00 | 193.31 |
| ATOM | 1178 | O | ILE | 263 | 7.026 | 28.491 | 94.897 | 1.00 | 193.31 |
| ATOM | 1179 | N | PRO | 264 | 7.860 | 26.906 | 93.580 | 1.00 | 100.94 |
| ATOM | 1180 | CA | PRO | 264 | 6.545 | 26.501 | 93.191 | 1.00 | 100.94 |
| ATOM | 1181 | CD | PRO | 264 | 8.797 | 26.817 | 92.472 | 1.00 | 100.94 |
| ATOM | 1182 | CB | PRO | 264 | 6.707 | 25.738 | 91.886 | 1.00 | 100.94 |
| ATOM | 1183 | CG | PRO | 264 | 7.964 | 26.365 | 91.262 | 1.00 | 100.94 |
| ATOM | 1184 | C | PRO | 264 | 5.889 | 25.722 | 94.276 | 1.00 | 100.94 |
| ATOM | 1185 | O | PRO | 264 | 6.579 | 25.112 | 95.091 | 1.00 | 100.94 |
| ATOM | 1186 | N | THR | 265 | 4.550 | 25.758 | 94.313 | 1.00 | 232.51 |
| ATOM | 1187 | CA | THR | 265 | 3.808 | 25.043 | 95.300 | 1.00 | 232.51 |
| ATOM | 1188 | CB | THR | 265 | 3.702 | 25.797 | 96.601 | 1.00 | 232.51 |
| ATOM | 1189 | OG1 | THR | 265 | 3.098 | 24.996 | 97.606 | 1.00 | 232.51 |
| ATOM | 1190 | CG2 | THR | 265 | 2.911 | 27.097 | 96.380 | 1.00 | 232.51 |
| ATOM | 1191 | C | THR | 265 | 2.453 | 24.873 | 94.706 | 1.00 | 232.51 |
| ATOM | 1192 | O | THR | 265 | 2.308 | 24.753 | 93.489 | 1.00 | 232.51 |
| ATOM | 1193 | N | GLU | 266 | 1.419 | 24.847 | 95.556 | 1.00 | 72.96 |
| ATOM | 1194 | CA | GLU | 266 | 0.090 | 24.777 | 95.058 | 1.00 | 72.96 |
| ATOM | 1195 | CB | GLU | 266 | −0.973 | 24.865 | 96.163 | 1.00 | 72.96 |
| ATOM | 1196 | CG | GLU | 266 | −0.967 | 23.675 | 97.125 | 1.00 | 72.96 |
| ATOM | 1197 | CD | GLU | 266 | −2.060 | 23.897 | 98.160 | 1.00 | 72.96 |
| ATOM | 1198 | OE1 | GLU | 266 | −3.191 | 24.275 | 97.757 | 1.00 | 72.96 |
| ATOM | 1199 | OE2 | GLU | 266 | −1.776 | 23.693 | 99.371 | 1.00 | 72.96 |
| ATOM | 1200 | C | GLU | 266 | −0.048 | 26.011 | 94.241 | 1.00 | 72.96 |
| ATOM | 1201 | O | GLU | 266 | −0.736 | 26.023 | 93.223 | 1.00 | 72.96 |
| ATOM | 1202 | N | PHE | 267 | 0.662 | 27.073 | 94.666 | 1.00 | 75.25 |
| ATOM | 1203 | CA | PHE | 267 | 0.549 | 28.365 | 94.062 | 1.00 | 75.25 |
| ATOM | 1204 | CB | PHE | 267 | 1.597 | 29.354 | 94.601 | 1.00 | 75.25 |
| ATOM | 1205 | CG | PHE | 267 | 1.160 | 30.739 | 94.260 | 1.00 | 75.25 |
| ATOM | 1206 | CD1 | PHE | 267 | 0.265 | 31.380 | 95.082 | 1.00 | 75.25 |
| ATOM | 1207 | CD2 | PHE | 267 | 1.637 | 31.400 | 93.151 | 1.00 | 75.25 |
| ATOM | 1208 | CE1 | PHE | 267 | −0.159 | 32.658 | 94.808 | 1.00 | 75.25 |
| ATOM | 1209 | CE2 | PHE | 267 | 1.218 | 32.682 | 92.871 | 1.00 | 75.25 |
| ATOM | 1210 | CZ | PHE | 267 | 0.318 | 33.312 | 93.698 | 1.00 | 75.25 |
| ATOM | 1211 | C | PHE | 267 | 0.806 | 28.206 | 92.600 | 1.00 | 75.25 |
| ATOM | 1212 | O | PHE | 267 | −0.005 | 28.644 | 91.785 | 1.00 | 75.25 |
| ATOM | 1213 | N | HIS | 268 | 1.926 | 27.569 | 92.209 | 1.00 | 120.57 |
| ATOM | 1214 | CA | HIS | 268 | 2.071 | 27.374 | 90.801 | 1.00 | 120.57 |
| ATOM | 1215 | ND1 | HIS | 268 | 4.629 | 28.952 | 91.451 | 1.00 | 120.57 |
| ATOM | 1216 | CG | HIS | 268 | 4.424 | 28.128 | 90.367 | 1.00 | 120.57 |
| ATOM | 1217 | CB | HIS | 268 | 3.487 | 26.957 | 90.371 | 1.00 | 120.57 |
| ATOM | 1218 | NE2 | HIS | 268 | 5.893 | 29.745 | 89.801 | 1.00 | 120.57 |
| ATOM | 1219 | CD2 | HIS | 268 | 5.204 | 28.626 | 89.368 | 1.00 | 120.57 |
| ATOM | 1220 | CE1 | HIS | 268 | 5.514 | 29.902 | 91.057 | 1.00 | 120.57 |
| ATOM | 1221 | C | HIS | 268 | 1.090 | 26.308 | 90.438 | 1.00 | 120.57 |
| ATOM | 1222 | O | HIS | 268 | 0.964 | 25.311 | 91.144 | 1.00 | 120.57 |
| ATOM | 1223 | N | HIS | 269 | 0.382 | 26.478 | 89.304 | 1.00 | 285.66 |
| ATOM | 1224 | CA | HIS | 269 | −0.638 | 25.533 | 88.947 | 1.00 | 285.66 |
| ATOM | 1225 | ND1 | HIS | 269 | −1.508 | 22.985 | 86.957 | 1.00 | 285.66 |
| ATOM | 1226 | CG | HIS | 269 | −1.094 | 23.103 | 88.265 | 1.00 | 285.66 |
| ATOM | 1227 | CB | HIS | 269 | −0.088 | 24.110 | 88.745 | 1.00 | 285.66 |
| ATOM | 1228 | NE2 | HIS | 269 | −2.589 | 21.420 | 88.112 | 1.00 | 285.66 |
| ATOM | 1229 | CD2 | HIS | 269 | −1.765 | 22.141 | 88.955 | 1.00 | 285.66 |
| ATOM | 1230 | CE1 | HIS | 269 | −2.403 | 21.963 | 86.922 | 1.00 | 285.66 |
| ATOM | 1231 | C | HIS | 269 | −1.663 | 25.496 | 90.041 | 1.00 | 285.66 |
| ATOM | 1232 | O | HIS | 269 | −2.053 | 24.430 | 90.513 | 1.00 | 285.66 |
| ATOM | 1233 | N | TYR | 270 | −2.135 | 26.680 | 90.480 | 1.00 | 275.40 |
| ATOM | 1234 | CA | TYR | 270 | −3.136 | 26.703 | 91.507 | 1.00 | 275.40 |
| ATOM | 1235 | CB | TYR | 270 | −2.831 | 27.685 | 92.652 | 1.00 | 275.40 |
| ATOM | 1236 | CG | TYR | 270 | −3.831 | 27.449 | 93.732 | 1.00 | 275.40 |
| ATOM | 1237 | CD1 | TYR | 270 | −3.682 | 26.373 | 94.578 | 1.00 | 275.40 |
| ATOM | 1238 | CD2 | TYR | 270 | −4.904 | 28.292 | 93.910 | 1.00 | 275.40 |
| ATOM | 1239 | CE1 | TYR | 270 | −4.589 | 26.135 | 95.583 | 1.00 | 275.40 |
| ATOM | 1240 | CE2 | TYR | 270 | −5.814 | 28.060 | 94.915 | 1.00 | 275.40 |
| ATOM | 1241 | CZ | TYR | 270 | −5.658 | 26.980 | 95.752 | 1.00 | 275.40 |
| ATOM | 1242 | OH | TYR | 270 | −6.591 | 26.743 | 96.784 | 1.00 | 275.40 |
| ATOM | 1243 | C | TYR | 270 | −4.386 | 27.189 | 90.857 | 1.00 | 275.40 |
| ATOM | 1244 | O | TYR | 270 | −4.368 | 28.183 | 90.132 | 1.00 | 275.40 |
| ATOM | 1245 | N | ASN | 271 | −5.513 | 26.488 | 91.082 | 1.00 | 242.49 |
| ATOM | 1246 | CA | ASN | 271 | −6.723 | 26.931 | 90.459 | 1.00 | 242.49 |
| ATOM | 1247 | CB | ASN | 271 | −7.903 | 25.953 | 90.624 | 1.00 | 242.49 |
| ATOM | 1248 | CG | ASN | 271 | −8.189 | 25.790 | 92.112 | 1.00 | 242.49 |
| ATOM | 1249 | OD1 | ASN | 271 | −7.323 | 25.367 | 92.876 | 1.00 | 242.49 |
| ATOM | 1250 | ND2 | ASN | 271 | −9.431 | 26.143 | 92.537 | 1.00 | 242.49 |
| ATOM | 1251 | C | ASN | 271 | −7.092 | 28.242 | 91.067 | 1.00 | 242.49 |
| ATOM | 1252 | O | ASN | 271 | −7.266 | 28.364 | 92.279 | 1.00 | 242.49 |
| ATOM | 1253 | N | ASN | 272 | −7.182 | 29.279 | 90.218 | 1.00 | 289.61 |
| ATOM | 1254 | CA | ASN | 272 | −7.544 | 30.581 | 90.681 | 1.00 | 289.61 |
| ATOM | 1255 | CB | ASN | 272 | −6.612 | 31.124 | 91.781 | 1.00 | 289.61 |
| ATOM | 1256 | CG | ASN | 272 | −5.168 | 31.036 | 91.298 | 1.00 | 289.61 |
| ATOM | 1257 | OD1 | ASN | 272 | −4.407 | 30.209 | 91.794 | 1.00 | 289.61 |
| ATOM | 1258 | ND2 | ASN | 272 | −4.774 | 31.887 | 90.314 | 1.00 | 289.61 |
| ATOM | 1259 | C | ASN | 272 | −7.490 | 31.497 | 89.508 | 1.00 | 289.61 |
| ATOM | 1260 | O | ASN | 272 | −6.959 | 31.145 | 88.456 | 1.00 | 289.61 |
| ATOM | 1261 | N | PHE | 273 | −8.071 | 32.701 | 89.651 | 1.00 | 223.87 |
| ATOM | 1262 | CA | PHE | 273 | −7.991 | 33.613 | 88.555 | 1.00 | 223.87 |
| ATOM | 1263 | CB | PHE | 273 | −9.254 | 34.480 | 88.413 | 1.00 | 223.87 |
| ATOM | 1264 | CG | PHE | 273 | −9.184 | 35.214 | 87.119 | 1.00 | 223.87 |
| ATOM | 1265 | CD1 | PHE | 273 | −9.640 | 34.621 | 85.963 | 1.00 | 223.87 |
| ATOM | 1266 | CD2 | PHE | 273 | −8.669 | 36.488 | 87.053 | 1.00 | 223.87 |
| ATOM | 1267 | CE1 | PHE | 273 | −9.584 | 35.284 | 84.761 | 1.00 | 223.87 |
| ATOM | 1268 | CE2 | PHE | 273 | −8.611 | 37.156 | 85.852 | 1.00 | 223.87 |
| ATOM | 1269 | CZ | PHE | 273 | −9.068 | 36.556 | 84.703 | 1.00 | 223.87 |
| ATOM | 1270 | C | PHE | 273 | −6.857 | 34.529 | 88.874 | 1.00 | 223.87 |
| ATOM | 1271 | O | PHE | 273 | −7.064 | 35.676 | 89.266 | 1.00 | 223.87 |
| ATOM | 1272 | N | TYR | 274 | −5.615 | 34.038 | 88.712 | 1.00 | 256.35 |
| ATOM | 1273 | CA | TYR | 274 | −4.475 | 34.866 | 88.967 | 1.00 | 256.35 |
| ATOM | 1274 | CB | TYR | 274 | −3.716 | 34.548 | 90.268 | 1.00 | 256.35 |
| ATOM | 1275 | CG | TYR | 274 | −4.554 | 34.961 | 91.425 | 1.00 | 256.35 |
| ATOM | 1276 | CD1 | TYR | 274 | −5.525 | 34.132 | 91.933 | 1.00 | 256.35 |
| ATOM | 1277 | CD2 | TYR | 274 | −4.353 | 36.193 | 92.007 | 1.00 | 256.35 |
| ATOM | 1278 | CE1 | TYR | 274 | −6.290 | 34.526 | 93.006 | 1.00 | 256.35 |
| ATOM | 1279 | CE2 | TYR | 274 | −5.113 | 36.595 | 93.079 | 1.00 | 256.35 |
| ATOM | 1280 | CZ | TYR | 274 | −6.080 | 35.760 | 93.580 | 1.00 | 256.35 |
| ATOM | 1281 | OH | TYR | 274 | −6.862 | 36.167 | 94.680 | 1.00 | 256.35 |
| ATOM | 1282 | C | TYR | 274 | −3.500 | 34.635 | 87.867 | 1.00 | 256.35 |
| ATOM | 1283 | O | TYR | 274 | −3.453 | 33.556 | 87.277 | 1.00 | 256.35 |
| ATOM | 1284 | N | PHE | 275 | −2.699 | 35.667 | 87.550 | 1.00 | 303.44 |
| ATOM | 1285 | CA | PHE | 275 | −1.698 | 35.480 | 86.550 | 1.00 | 303.44 |
| ATOM | 1286 | CB | PHE | 275 | −1.587 | 36.682 | 85.587 | 1.00 | 303.44 |
| ATOM | 1287 | CG | PHE | 275 | −1.447 | 37.922 | 86.400 | 1.00 | 303.44 |
| ATOM | 1288 | CD1 | PHE | 275 | −2.552 | 38.467 | 87.016 | 1.00 | 303.44 |
| ATOM | 1289 | CD2 | PHE | 275 | −0.233 | 38.554 | 86.539 | 1.00 | 303.44 |
| ATOM | 1290 | CE1 | PHE | 275 | −2.442 | 39.612 | 87.769 | 1.00 | 303.44 |
| ATOM | 1291 | CE2 | PHE | 275 | −0.116 | 39.698 | 87.293 | 1.00 | 303.44 |
| ATOM | 1292 | CZ | PHE | 275 | −1.222 | 40.231 | 87.910 | 1.00 | 303.44 |
| ATOM | 1293 | C | PHE | 275 | −0.395 | 35.232 | 87.247 | 1.00 | 303.44 |
| ATOM | 1294 | O | PHE | 275 | 0.256 | 36.148 | 87.747 | 1.00 | 303.44 |
| ATOM | 1295 | N | TYR | 276 | −0.001 | 33.947 | 87.316 | 1.00 | 249.15 |
| ATOM | 1296 | CA | TYR | 276 | 1.246 | 33.560 | 87.901 | 1.00 | 249.15 |
| ATOM | 1297 | CB | TYR | 276 | 1.157 | 33.083 | 89.363 | 1.00 | 249.15 |
| ATOM | 1298 | CG | TYR | 276 | 1.040 | 34.282 | 90.245 | 1.00 | 249.15 |
| ATOM | 1299 | CD1 | TYR | 276 | −0.159 | 34.928 | 90.435 | 1.00 | 249.15 |
| ATOM | 1300 | CD2 | TYR | 276 | 2.158 | 34.758 | 90.891 | 1.00 | 249.15 |
| ATOM | 1301 | CE1 | TYR | 276 | −0.240 | 36.029 | 91.256 | 1.00 | 249.15 |
| ATOM | 1302 | CE2 | TYR | 276 | 2.086 | 35.857 | 91.713 | 1.00 | 249.15 |
| ATOM | 1303 | CZ | TYR | 276 | 0.887 | 36.497 | 91.894 | 1.00 | 249.15 |
| ATOM | 1304 | OH | TYR | 276 | 0.813 | 37.627 | 92.736 | 1.00 | 249.15 |
| ATOM | 1305 | C | TYR | 276 | 1.775 | 32.444 | 87.073 | 1.00 | 249.15 |
| ATOM | 1306 | O | TYR | 276 | 1.053 | 31.868 | 86.260 | 1.00 | 249.15 |
| ATOM | 1307 | N | SER | 277 | 3.071 | 32.124 | 87.243 | 1.00 | 212.61 |
| ATOM | 1308 | CA | SER | 277 | 3.655 | 31.079 | 86.459 | 1.00 | 212.61 |
| ATOM | 1309 | CB | SER | 277 | 5.186 | 31.022 | 86.551 | 1.00 | 212.61 |
| ATOM | 1310 | OG | SER | 277 | 5.676 | 29.934 | 85.782 | 1.00 | 212.61 |
| ATOM | 1311 | C | SER | 277 | 3.147 | 29.777 | 86.954 | 1.00 | 212.61 |
| ATOM | 1312 | O | SER | 277 | 2.899 | 29.589 | 88.143 | 1.00 | 212.61 |
| ATOM | 1313 | N | PHE | 278 | 2.950 | 28.826 | 86.033 | 1.00 | 225.57 |
| ATOM | 1314 | CA | PHE | 278 | 2.565 | 27.549 | 86.524 | 1.00 | 225.57 |
| ATOM | 1315 | CB | PHE | 278 | 1.482 | 26.853 | 85.681 | 1.00 | 225.57 |
| ATOM | 1316 | CG | PHE | 278 | 0.264 | 27.710 | 85.688 | 1.00 | 225.57 |
| ATOM | 1317 | CD1 | PHE | 278 | −0.538 | 27.793 | 86.804 | 1.00 | 225.57 |
| ATOM | 1318 | CD2 | PHE | 278 | −0.085 | 28.421 | 84.564 | 1.00 | 225.57 |
| ATOM | 1319 | CE1 | PHE | 278 | −1.663 | 28.585 | 86.801 | 1.00 | 225.57 |
| ATOM | 1320 | CE2 | PHE | 278 | −1.209 | 29.212 | 84.555 | 1.00 | 225.57 |
| ATOM | 1321 | CZ | PHE | 278 | −2.000 | 29.297 | 85.676 | 1.00 | 225.57 |
| ATOM | 1322 | C | PHE | 278 | 3.792 | 26.723 | 86.394 | 1.00 | 225.57 |
| ATOM | 1323 | O | PHE | 278 | 4.126 | 26.285 | 85.296 | 1.00 | 225.57 |
| ATOM | 1324 | N | SER | 279 | 4.509 | 26.495 | 87.509 | 1.00 | 63.44 |
| ATOM | 1325 | CA | SER | 279 | 5.684 | 25.695 | 87.383 | 1.00 | 63.44 |
| ATOM | 1326 | CB | SER | 279 | 6.414 | 25.459 | 88.712 | 1.00 | 63.44 |
| ATOM | 1327 | OG | SER | 279 | 5.673 | 24.541 | 89.502 | 1.00 | 63.44 |
| ATOM | 1328 | C | SER | 279 | 5.183 | 24.367 | 86.941 | 1.00 | 63.44 |
| ATOM | 1329 | O | SER | 279 | 5.805 | 23.687 | 86.126 | 1.00 | 63.44 |
| ATOM | 1330 | N | ASP | 280 | 4.011 | 23.979 | 87.478 | 1.00 | 78.81 |
| ATOM | 1331 | CA | ASP | 280 | 3.420 | 22.723 | 87.134 | 1.00 | 78.81 |
| ATOM | 1332 | CB | ASP | 280 | 2.171 | 22.387 | 87.972 | 1.00 | 78.81 |
| ATOM | 1333 | CG | ASP | 280 | 1.793 | 20.921 | 87.778 | 1.00 | 78.81 |
| ATOM | 1334 | OD1 | ASP | 280 | 2.351 | 20.272 | 86.853 | 1.00 | 78.81 |
| ATOM | 1335 | OD2 | ASP | 280 | 0.932 | 20.429 | 88.557 | 1.00 | 78.81 |
| ATOM | 1336 | C | ASP | 280 | 3.030 | 22.764 | 85.691 | 1.00 | 78.81 |
| ATOM | 1337 | O | ASP | 280 | 3.170 | 21.773 | 84.979 | 1.00 | 78.81 |
| ATOM | 1338 | N | GLY | 281 | 2.542 | 23.920 | 85.202 | 1.00 | 25.80 |
| ATOM | 1339 | CA | GLY | 281 | 2.096 | 23.971 | 83.838 | 1.00 | 25.80 |
| ATOM | 1340 | C | GLY | 281 | 3.249 | 23.655 | 82.943 | 1.00 | 25.80 |
| ATOM | 1341 | O | GLY | 281 | 3.109 | 22.929 | 81.960 | 1.00 | 25.80 |
| ATOM | 1342 | N | PHE | 282 | 4.428 | 24.220 | 83.251 | 1.00 | 106.36 |
| ATOM | 1343 | CA | PHE | 282 | 5.584 | 23.975 | 82.445 | 1.00 | 106.36 |
| ATOM | 1344 | CB | PHE | 282 | 6.742 | 24.933 | 82.760 | 1.00 | 106.36 |
| ATOM | 1345 | CG | PHE | 282 | 6.193 | 26.279 | 82.417 | 1.00 | 106.36 |
| ATOM | 1346 | CD1 | PHE | 282 | 5.939 | 26.615 | 81.107 | 1.00 | 106.36 |
| ATOM | 1347 | CD2 | PHE | 282 | 5.873 | 27.191 | 83.396 | 1.00 | 106.36 |
| ATOM | 1348 | CE1 | PHE | 282 | 5.420 | 27.847 | 80.783 | 1.00 | 106.36 |
| ATOM | 1349 | CE2 | PHE | 282 | 5.354 | 28.426 | 83.081 | 1.00 | 106.36 |
| ATOM | 1350 | CZ | PHE | 282 | 5.129 | 28.759 | 81.769 | 1.00 | 106.36 |
| ATOM | 1351 | C | PHE | 282 | 5.994 | 22.546 | 82.609 | 1.00 | 106.36 |
| ATOM | 1352 | O | PHE | 282 | 6.395 | 21.879 | 81.655 | 1.00 | 106.36 |
| ATOM | 1353 | N | ASN | 283 | 5.894 | 22.022 | 83.837 | 1.00 | 71.40 |
| ATOM | 1354 | CA | ASN | 283 | 6.291 | 20.668 | 84.067 | 1.00 | 71.40 |
| ATOM | 1355 | CB | ASN | 283 | 6.129 | 20.284 | 85.548 | 1.00 | 71.40 |
| ATOM | 1356 | CG | ASN | 283 | 7.090 | 19.149 | 85.868 | 1.00 | 71.40 |
| ATOM | 1357 | OD1 | ASN | 283 | 7.211 | 18.171 | 85.133 | 1.00 | 71.40 |
| ATOM | 1358 | ND2 | ASN | 283 | 7.820 | 19.297 | 87.008 | 1.00 | 71.40 |
| ATOM | 1359 | C | ASN | 283 | 5.407 | 19.779 | 83.242 | 1.00 | 71.40 |
| ATOM | 1360 | O | ASN | 283 | 5.874 | 18.832 | 82.610 | 1.00 | 71.40 |
| ATOM | 1361 | N | THR | 284 | 4.096 | 20.080 | 83.210 | 1.00 | 44.86 |
| ATOM | 1362 | CA | THR | 284 | 3.160 | 19.258 | 82.495 | 1.00 | 44.86 |
| ATOM | 1363 | CB | THR | 284 | 1.723 | 19.648 | 82.719 | 1.00 | 44.86 |
| ATOM | 1364 | OG1 | THR | 284 | 1.471 | 20.953 | 82.223 | 1.00 | 44.86 |
| ATOM | 1365 | CG2 | THR | 284 | 1.431 | 19.587 | 84.228 | 1.00 | 44.86 |
| ATOM | 1366 | C | THR | 284 | 3.429 | 19.312 | 81.021 | 1.00 | 44.86 |
| ATOM | 1367 | O | THR | 284 | 3.338 | 18.295 | 80.336 | 1.00 | 44.86 |
| ATOM | 1368 | N | ASN | 285 | 3.767 | 20.490 | 80.464 | 1.00 | 113.18 |
| ATOM | 1369 | CA | ASN | 285 | 3.937 | 20.471 | 79.040 | 1.00 | 113.18 |
| ATOM | 1370 | CB | ASN | 285 | 4.035 | 21.849 | 78.339 | 1.00 | 113.18 |
| ATOM | 1371 | CG | ASN | 285 | 5.264 | 22.649 | 78.742 | 1.00 | 113.18 |
| ATOM | 1372 | OD1 | ASN | 285 | 5.305 | 23.238 | 79.820 | 1.00 | 113.18 |
| ATOM | 1373 | ND2 | ASN | 285 | 6.279 | 22.708 | 77.839 | 1.00 | 113.18 |
| ATOM | 1374 | C | ASN | 285 | 5.103 | 19.610 | 78.677 | 1.00 | 113.18 |
| ATOM | 1375 | O | ASN | 285 | 5.067 | 18.915 | 77.663 | 1.00 | 113.18 |
| ATOM | 1376 | N | HIS | 286 | 6.174 | 19.630 | 79.493 | 1.00 | 90.92 |
| ATOM | 1377 | CA | HIS | 286 | 7.325 | 18.828 | 79.199 | 1.00 | 90.92 |
| ATOM | 1378 | ND1 | HIS | 286 | 8.719 | 21.730 | 80.154 | 1.00 | 90.92 |
| ATOM | 1379 | CG | HIS | 286 | 9.117 | 20.516 | 79.637 | 1.00 | 90.92 |
| ATOM | 1380 | CB | HIS | 286 | 8.553 | 19.186 | 80.056 | 1.00 | 90.92 |
| ATOM | 1381 | NE2 | HIS | 286 | 10.242 | 22.175 | 78.595 | 1.00 | 90.92 |
| ATOM | 1382 | CD2 | HIS | 286 | 10.049 | 20.808 | 78.687 | 1.00 | 90.92 |
| ATOM | 1383 | CE1 | HIS | 286 | 9.423 | 22.686 | 79.496 | 1.00 | 90.92 |
| ATOM | 1384 | C | HIS | 286 | 6.981 | 17.374 | 79.330 | 1.00 | 90.92 |
| ATOM | 1385 | O | HIS | 286 | 7.465 | 16.548 | 78.558 | 1.00 | 90.92 |
| ATOM | 1386 | N | ARG | 287 | 6.138 | 17.004 | 80.312 | 1.00 | 141.18 |
| ATOM | 1387 | CA | ARG | 287 | 5.788 | 15.618 | 80.444 | 1.00 | 141.18 |
| ATOM | 1388 | CB | ARG | 287 | 4.986 | 15.299 | 81.722 | 1.00 | 141.18 |
| ATOM | 1389 | CG | ARG | 287 | 3.659 | 16.045 | 81.861 | 1.00 | 141.18 |
| ATOM | 1390 | CD | ARG | 287 | 3.010 | 15.899 | 83.240 | 1.00 | 141.18 |
| ATOM | 1391 | NE | ARG | 287 | 2.505 | 14.503 | 83.359 | 1.00 | 141.18 |
| ATOM | 1392 | CZ | ARG | 287 | 2.130 | 14.010 | 84.576 | 1.00 | 141.18 |
| ATOM | 1393 | NH1 | ARG | 287 | 2.255 | 14.780 | 85.697 | 1.00 | 141.18 |
| ATOM | 1394 | NH2 | ARG | 287 | 1.628 | 12.745 | 84.674 | 1.00 | 141.18 |
| ATOM | 1395 | C | ARG | 287 | 5.012 | 15.190 | 79.231 | 1.00 | 141.18 |
| ATOM | 1396 | O | ARG | 287 | 5.196 | 14.084 | 78.724 | 1.00 | 141.18 |
| ATOM | 1397 | N | HIS | 288 | 4.133 | 16.070 | 78.717 | 1.00 | 43.21 |
| ATOM | 1398 | CA | HIS | 288 | 3.338 | 15.721 | 77.574 | 1.00 | 43.21 |
| ATOM | 1399 | ND1 | HIS | 288 | 1.012 | 17.652 | 79.158 | 1.00 | 43.21 |
| ATOM | 1400 | CG | HIS | 288 | 1.124 | 16.884 | 78.021 | 1.00 | 43.21 |
| ATOM | 1401 | CB | HIS | 288 | 2.343 | 16.816 | 77.150 | 1.00 | 43.21 |
| ATOM | 1402 | NE2 | HIS | 288 | −0.925 | 16.585 | 78.920 | 1.00 | 43.21 |
| ATOM | 1403 | CD2 | HIS | 288 | −0.068 | 16.239 | 77.890 | 1.00 | 43.21 |
| ATOM | 1404 | CE1 | HIS | 288 | −0.231 | 17.436 | 79.655 | 1.00 | 43.21 |
| ATOM | 1405 | C | HIS | 288 | 4.234 | 15.466 | 76.408 | 1.00 | 43.21 |
| ATOM | 1406 | O | HIS | 288 | 4.005 | 14.539 | 75.632 | 1.00 | 43.21 |
| ATOM | 1407 | N | SER | 289 | 5.288 | 16.283 | 76.253 | 1.00 | 89.65 |
| ATOM | 1408 | CA | SER | 289 | 6.140 | 16.122 | 75.117 | 1.00 | 89.65 |
| ATOM | 1409 | CB | SER | 289 | 7.274 | 17.163 | 75.059 | 1.00 | 89.65 |
| ATOM | 1410 | OG | SER | 289 | 8.195 | 16.969 | 76.123 | 1.00 | 89.65 |
| ATOM | 1411 | C | SER | 289 | 6.756 | 14.760 | 75.151 | 1.00 | 89.65 |
| ATOM | 1412 | O | SER | 289 | 6.803 | 14.067 | 74.135 | 1.00 | 89.65 |
| ATOM | 1413 | N | VAL | 290 | 7.217 | 14.320 | 76.336 | 1.00 | 99.64 |
| ATOM | 1414 | CA | VAL | 290 | 7.893 | 13.056 | 76.415 | 1.00 | 99.64 |
| ATOM | 1415 | CB | VAL | 290 | 8.469 | 12.758 | 77.774 | 1.00 | 99.64 |
| ATOM | 1416 | CG1 | VAL | 290 | 7.346 | 12.382 | 78.758 | 1.00 | 99.64 |
| ATOM | 1417 | CG2 | VAL | 290 | 9.536 | 11.666 | 77.605 | 1.00 | 99.64 |
| ATOM | 1418 | C | VAL | 290 | 6.953 | 11.956 | 76.037 | 1.00 | 99.64 |
| ATOM | 1419 | O | VAL | 290 | 7.327 | 11.026 | 75.320 | 1.00 | 99.64 |
| ATOM | 1420 | N | LEU | 291 | 5.691 | 12.036 | 76.497 | 1.00 | 46.15 |
| ATOM | 1421 | CA | LEU | 291 | 4.779 | 10.965 | 76.218 | 1.00 | 46.15 |
| ATOM | 1422 | CB | LEU | 291 | 3.395 | 11.206 | 76.843 | 1.00 | 46.15 |
| ATOM | 1423 | CG | LEU | 291 | 3.406 | 11.257 | 78.381 | 1.00 | 46.15 |
| ATOM | 1424 | CD2 | LEU | 291 | 4.089 | 10.018 | 78.976 | 1.00 | 46.15 |
| ATOM | 1425 | CD1 | LEU | 291 | 1.993 | 11.495 | 78.941 | 1.00 | 46.15 |
| ATOM | 1426 | C | LEU | 291 | 4.587 | 10.835 | 74.738 | 1.00 | 46.15 |
| ATOM | 1427 | O | LEU | 291 | 4.734 | 9.747 | 74.188 | 1.00 | 46.15 |
| ATOM | 1428 | N | ASP | 292 | 4.279 | 11.942 | 74.041 | 1.00 | 47.77 |
| ATOM | 1429 | CA | ASP | 292 | 4.022 | 11.838 | 72.632 | 1.00 | 47.77 |
| ATOM | 1430 | CB | ASP | 292 | 3.490 | 13.142 | 72.008 | 1.00 | 47.77 |
| ATOM | 1431 | CG | ASP | 292 | 2.051 | 13.321 | 72.471 | 1.00 | 47.77 |
| ATOM | 1432 | OD1 | ASP | 292 | 1.653 | 12.617 | 73.437 | 1.00 | 47.77 |
| ATOM | 1433 | OD2 | ASP | 292 | 1.328 | 14.153 | 71.860 | 1.00 | 47.77 |
| ATOM | 1434 | C | ASP | 292 | 5.268 | 11.458 | 71.892 | 1.00 | 47.77 |
| ATOM | 1435 | O | ASP | 292 | 5.248 | 10.591 | 71.021 | 1.00 | 47.77 |
| ATOM | 1436 | N | ASN | 293 | 6.401 | 12.074 | 72.258 | 1.00 | 70.18 |
| ATOM | 1437 | CA | ASN | 293 | 7.631 | 11.877 | 71.552 | 1.00 | 70.18 |
| ATOM | 1438 | CB | ASN | 293 | 8.800 | 12.681 | 72.147 | 1.00 | 70.18 |
| ATOM | 1439 | CG | ASN | 293 | 8.565 | 14.161 | 71.889 | 1.00 | 70.18 |
| ATOM | 1440 | OD1 | ASN | 293 | 8.744 | 14.990 | 72.780 | 1.00 | 70.18 |
| ATOM | 1441 | ND2 | ASN | 293 | 8.158 | 14.506 | 70.638 | 1.00 | 70.18 |
| ATOM | 1442 | C | ASN | 293 | 8.041 | 10.445 | 71.641 | 1.00 | 70.18 |
| ATOM | 1443 | O | ASN | 293 | 8.595 | 9.890 | 70.694 | 1.00 | 70.18 |
| ATOM | 1444 | N | THR | 294 | 7.720 | 9.801 | 72.774 | 1.00 | 170.59 |
| ATOM | 1445 | CA | THR | 294 | 8.211 | 8.503 | 73.129 | 1.00 | 170.59 |
| ATOM | 1446 | CB | THR | 294 | 7.949 | 8.123 | 74.555 | 1.00 | 170.59 |
| ATOM | 1447 | OG1 | THR | 294 | 8.805 | 7.051 | 74.907 | 1.00 | 170.59 |
| ATOM | 1448 | CG2 | THR | 294 | 6.491 | 7.702 | 74.748 | 1.00 | 170.59 |
| ATOM | 1449 | C | THR | 294 | 7.757 | 7.433 | 72.190 | 1.00 | 170.59 |
| ATOM | 1450 | O | THR | 294 | 8.237 | 6.304 | 72.282 | 1.00 | 170.59 |
| ATOM | 1451 | N | ASN | 295 | 6.774 | 7.731 | 71.317 | 1.00 | 213.44 |
| ATOM | 1452 | CA | ASN | 295 | 6.301 | 6.773 | 70.350 | 1.00 | 213.44 |
| ATOM | 1453 | CB | ASN | 295 | 5.514 | 7.401 | 69.190 | 1.00 | 213.44 |
| ATOM | 1454 | CG | ASN | 295 | 5.078 | 6.279 | 68.254 | 1.00 | 213.44 |
| ATOM | 1455 | OD1 | ASN | 295 | 5.051 | 6.437 | 67.033 | 1.00 | 213.44 |
| ATOM | 1456 | ND2 | ASN | 295 | 4.729 | 5.109 | 68.851 | 1.00 | 213.44 |
| ATOM | 1457 | C | ASN | 295 | 7.468 | 6.132 | 69.673 | 1.00 | 213.44 |
| ATOM | 1458 | O | ASN | 295 | 8.429 | 6.801 | 69.292 | 1.00 | 213.44 |
| ATOM | 1459 | N | CYS | 296 | 7.412 | 4.792 | 69.533 | 1.00 | 101.49 |
| ATOM | 1460 | CA | CYS | 296 | 8.454 | 4.083 | 68.851 | 1.00 | 101.49 |
| ATOM | 1461 | CB | CYS | 296 | 8.568 | 2.604 | 69.264 | 1.00 | 101.49 |
| ATOM | 1462 | SG | CYS | 296 | 9.930 | 1.754 | 68.413 | 1.00 | 101.49 |
| ATOM | 1463 | C | CYS | 296 | 8.104 | 4.134 | 67.402 | 1.00 | 101.49 |
| ATOM | 1464 | O | CYS | 296 | 6.929 | 4.186 | 67.044 | 1.00 | 101.49 |
| ATOM | 1465 | N | ASP | 297 | 9.119 | 4.140 | 66.521 | 1.00 | 198.12 |
| ATOM | 1466 | CA | ASP | 297 | 8.815 | 4.244 | 65.127 | 1.00 | 198.12 |
| ATOM | 1467 | CB | ASP | 297 | 10.019 | 4.633 | 64.246 | 1.00 | 198.12 |
| ATOM | 1468 | CG | ASP | 297 | 11.101 | 3.567 | 64.361 | 1.00 | 198.12 |
| ATOM | 1469 | OD1 | ASP | 297 | 11.108 | 2.835 | 65.387 | 1.00 | 198.12 |
| ATOM | 1470 | OD2 | ASP | 297 | 11.935 | 3.473 | 63.422 | 1.00 | 198.12 |
| ATOM | 1471 | C | ASP | 297 | 8.269 | 2.946 | 64.633 | 1.00 | 198.12 |
| ATOM | 1472 | O | ASP | 297 | 8.807 | 1.874 | 64.906 | 1.00 | 198.12 |
| ATOM | 1473 | N | ILE | 298 | 7.142 | 3.027 | 63.905 | 1.00 | 116.45 |
| ATOM | 1474 | CA | ILE | 298 | 6.549 | 1.879 | 63.287 | 1.00 | 116.45 |
| ATOM | 1475 | CB | ILE | 298 | 5.264 | 1.433 | 63.922 | 1.00 | 116.45 |
| ATOM | 1476 | CG2 | ILE | 298 | 4.663 | 0.329 | 63.035 | 1.00 | 116.45 |
| ATOM | 1477 | CG1 | ILE | 298 | 5.513 | 0.971 | 65.367 | 1.00 | 116.45 |
| ATOM | 1478 | CD1 | ILE | 298 | 6.452 | −0.232 | 65.460 | 1.00 | 116.45 |
| ATOM | 1479 | C | ILE | 298 | 6.254 | 2.310 | 61.889 | 1.00 | 116.45 |
| ATOM | 1480 | O | ILE | 298 | 5.966 | 3.481 | 61.648 | 1.00 | 116.45 |
| ATOM | 1481 | N | ASP | 299 | 6.333 | 1.387 | 60.914 | 1.00 | 128.04 |
| ATOM | 1482 | CA | ASP | 299 | 6.120 | 1.839 | 59.573 | 1.00 | 128.04 |
| ATOM | 1483 | CB | ASP | 299 | 6.821 | 0.987 | 58.505 | 1.00 | 128.04 |
| ATOM | 1484 | CG | ASP | 299 | 8.305 | 1.313 | 58.560 | 1.00 | 128.04 |
| ATOM | 1485 | OD1 | ASP | 299 | 8.641 | 2.446 | 58.996 | 1.00 | 128.04 |
| ATOM | 1486 | OD2 | ASP | 299 | 9.123 | 0.440 | 58.162 | 1.00 | 128.04 |
| ATOM | 1487 | C | ASP | 299 | 4.663 | 1.841 | 59.266 | 1.00 | 128.04 |
| ATOM | 1488 | O | ASP | 299 | 4.075 | 0.803 | 58.966 | 1.00 | 128.04 |
| ATOM | 1489 | N | VAL | 300 | 4.045 | 3.036 | 59.358 | 1.00 | 95.52 |
| ATOM | 1490 | CA | VAL | 390 | 2.676 | 3.219 | 58.980 | 1.00 | 95.52 |
| ATOM | 1491 | CB | VAL | 300 | 1.693 | 3.088 | 60.109 | 1.00 | 95.52 |
| ATOM | 1492 | CG1 | VAL | 300 | 1.938 | 4.223 | 61.112 | 1.00 | 95.52 |
| ATOM | 1493 | CG2 | VAL | 300 | 0.271 | 3.068 | 59.522 | 1.00 | 95.52 |
| ATOM | 1494 | C | VAL | 300 | 2.586 | 4.610 | 58.444 | 1.00 | 95.52 |
| ATOM | 1495 | O | VAL | 300 | 3.372 | 5.482 | 58.813 | 1.00 | 95.52 |
| ATOM | 1496 | N | LEU | 301 | 1.639 | 4.850 | 57.521 | 1.00 | 134.46 |
| ATOM | 1497 | CA | LEU | 301 | 1.513 | 6.160 | 56.958 | 1.00 | 134.46 |
| ATOM | 1498 | CB | LEU | 301 | 0.478 | 6.198 | 55.812 | 1.00 | 134.46 |
| ATOM | 1499 | CG | LEU | 301 | 0.286 | 7.570 | 55.135 | 1.00 | 134.46 |
| ATOM | 1500 | CD2 | LEU | 301 | 1.623 | 8.122 | 54.624 | 1.00 | 134.46 |
| ATOM | 1501 | CD1 | LEU | 301 | −0.477 | 8.575 | 56.022 | 1.00 | 134.46 |
| ATOM | 1502 | C | LEU | 301 | 1.070 | 7.096 | 58.034 | 1.00 | 134.46 |
| ATOM | 1503 | O | LEU | 301 | 1.647 | 8.167 | 58.210 | 1.00 | 134.46 |
| ATOM | 1504 | N | PHE | 302 | 0.051 | 6.683 | 58.809 | 1.00 | 199.62 |
| ATOM | 1505 | CA | PHE | 302 | −0.511 | 7.566 | 59.788 | 1.00 | 199.62 |
| ATOM | 1506 | CB | PHE | 302 | −1.706 | 6.990 | 60.564 | 1.00 | 199.62 |
| ATOM | 1507 | CG | PHE | 302 | −2.899 | 7.050 | 59.679 | 1.00 | 199.62 |
| ATOM | 1508 | CD1 | PHE | 302 | −3.141 | 6.069 | 58.746 | 1.00 | 199.62 |
| ATOM | 1509 | CD2 | PHE | 302 | −3.783 | 8.099 | 59.792 | 1.00 | 199.62 |
| ATOM | 1510 | CE1 | PHE | 302 | −4.251 | 6.139 | 57.938 | 1.00 | 199.62 |
| ATOM | 1511 | CE2 | PHE | 302 | −4.894 | 8.174 | 58.987 | 1.00 | 199.62 |
| ATOM | 1512 | CZ | PHE | 302 | −5.128 | 7.192 | 58.057 | 1.00 | 199.62 |
| ATOM | 1513 | C | PHE | 302 | 0.527 | 7.940 | 60.779 | 1.00 | 199.62 |
| ATOM | 1514 | O | PHE | 302 | 1.359 | 7.129 | 61.181 | 1.00 | 199.62 |
| ATOM | 1515 | N | ARG | 303 | 0.492 | 9.225 | 61.173 | 1.00 | 292.70 |
| ATOM | 1516 | CA | ARG | 303 | 1.403 | 9.730 | 62.147 | 1.00 | 292.70 |
| ATOM | 1517 | CB | ARG | 303 | 1.470 | 11.268 | 62.135 | 1.00 | 292.70 |
| ATOM | 1518 | CG | ARG | 303 | 1.638 | 11.837 | 60.722 | 1.00 | 292.70 |
| ATOM | 1519 | CD | ARG | 303 | 2.555 | 11.002 | 59.823 | 1.00 | 292.70 |
| ATOM | 1520 | NE | ARG | 303 | 3.962 | 11.304 | 60.204 | 1.00 | 292.70 |
| ATOM | 1521 | CZ | ARG | 303 | 4.645 | 12.265 | 59.519 | 1.00 | 292.70 |
| ATOM | 1522 | NH1 | ARG | 303 | 4.042 | 12.911 | 58.477 | 1.00 | 292.70 |
| ATOM | 1523 | NH2 | ARG | 303 | 5.926 | 12.578 | 59.870 | 1.00 | 292.70 |
| ATOM | 1524 | C | ARG | 303 | 0.840 | 9.292 | 63.457 | 1.00 | 292.70 |
| ATOM | 1525 | O | ARG | 303 | −0.374 | 9.323 | 63.656 | 1.00 | 292.70 |
| ATOM | 1526 | N | PHE | 304 | 1.696 | 8.828 | 64.386 | 1.00 | 364.50 |
| ATOM | 1527 | CA | PHE | 304 | 1.136 | 8.409 | 65.635 | 1.00 | 364.50 |
| ATOM | 1528 | CB | PHE | 304 | 0.619 | 6.960 | 65.616 | 1.00 | 364.50 |
| ATOM | 1529 | CG | PHE | 304 | 1.788 | 6.043 | 65.500 | 1.00 | 364.50 |
| ATOM | 1530 | CD1 | PHE | 304 | 2.484 | 5.926 | 64.319 | 1.00 | 364.50 |
| ATOM | 1531 | CD2 | PHE | 304 | 2.179 | 5.282 | 66.579 | 1.00 | 364.50 |
| ATOM | 1532 | CE1 | PHE | 304 | 3.561 | 5.076 | 64.219 | 1.00 | 364.50 |
| ATOM | 1533 | CE2 | PHE | 304 | 3.252 | 4.430 | 66.486 | 1.00 | 364.50 |
| ATOM | 1534 | CZ | PHE | 304 | 3.948 | 4.329 | 65.305 | 1.00 | 364.50 |
| ATOM | 1535 | C | PHE | 304 | 2.211 | 8.484 | 66.662 | 1.00 | 364.50 |
| ATOM | 1536 | O | PHE | 304 | 3.395 | 8.553 | 66.337 | 1.00 | 364.50 |
| ATOM | 1537 | N | PHE | 305 | 1.813 | 8.500 | 67.948 | 1.00 | 306.52 |
| ATOM | 1538 | CA | PHE | 305 | 2.791 | 8.519 | 68.989 | 1.00 | 306.52 |
| ATOM | 1539 | CB | PHE | 305 | 2.949 | 9.878 | 69.683 | 1.00 | 306.52 |
| ATOM | 1540 | CG | PHE | 305 | 3.405 | 10.843 | 68.644 | 1.00 | 306.52 |
| ATOM | 1541 | CD1 | PHE | 305 | 4.742 | 10.999 | 68.357 | 1.00 | 306.52 |
| ATOM | 1542 | CD2 | PHE | 305 | 2.483 | 11.584 | 67.941 | 1.00 | 306.52 |
| ATOM | 1543 | CE1 | PHE | 305 | 5.151 | 11.892 | 67.394 | 1.00 | 306.52 |
| ATOM | 1544 | CE2 | PHE | 305 | 2.884 | 12.476 | 66.980 | 1.00 | 306.52 |
| ATOM | 1545 | CZ | PHE | 305 | 4.222 | 12.633 | 66.704 | 1.00 | 306.52 |
| ATOM | 1546 | C | PHE | 305 | 2.345 | 7.530 | 70.011 | 1.00 | 306.52 |
| ATOM | 1547 | O | PHE | 305 | 1.177 | 7.147 | 70.053 | 1.00 | 306.52 |
| ATOM | 1548 | N | GLU | 306 | 3.284 | 7.068 | 70.857 | 1.00 | 342.97 |
| ATOM | 1549 | CA | GLU | 306 | 2.943 | 6.091 | 71.839 | 1.00 | 342.97 |
| ATOM | 1550 | CB | GLU | 306 | 3.653 | 4.743 | 71.637 | 1.00 | 342.97 |
| ATOM | 1551 | CG | GLU | 306 | 3.154 | 3.659 | 72.591 | 1.00 | 342.97 |
| ATOM | 1552 | CD | GLU | 306 | 1.759 | 3.263 | 72.136 | 1.00 | 342.97 |
| ATOM | 1553 | OE1 | GLU | 306 | 0.911 | 4.177 | 71.957 | 1.00 | 342.97 |
| ATOM | 1554 | OE2 | GLU | 306 | 1.526 | 2.040 | 71.953 | 1.00 | 342.97 |
| ATOM | 1555 | C | GLU | 306 | 3.403 | 6.632 | 73.134 | 1.00 | 342.97 |
| ATOM | 1556 | O | GLU | 306 | 4.288 | 7.477 | 73.156 | 1.00 | 342.97 |
| ATOM | 1557 | N | CYS | 307 | 2.782 | 6.194 | 74.242 | 1.00 | 213.88 |
| ATOM | 1558 | CA | CYS | 307 | 3.216 | 6.642 | 75.528 | 1.00 | 213.88 |
| ATOM | 1559 | CB | CYS | 307 | 2.049 | 6.937 | 76.485 | 1.00 | 213.88 |
| ATOM | 1560 | SG | CYS | 307 | 2.584 | 7.483 | 78.133 | 1.00 | 213.88 |
| ATOM | 1561 | C | CYS | 307 | 3.980 | 5.518 | 76.139 | 1.00 | 213.88 |
| ATOM | 1562 | O | CYS | 307 | 3.536 | 4.924 | 77.120 | 1.00 | 213.88 |
| ATOM | 1563 | N | THR | 308 | 5.153 | 5.179 | 75.571 | 1.00 | 57.58 |
| ATOM | 1564 | CA | THR | 308 | 5.880 | 4.113 | 76.186 | 1.00 | 57.58 |
| ATOM | 1565 | CB | THR | 308 | 7.029 | 3.587 | 75.371 | 1.00 | 57.58 |
| ATOM | 1566 | OG1 | THR | 308 | 8.022 | 4.581 | 75.190 | 1.00 | 57.58 |
| ATOM | 1567 | CG2 | THR | 308 | 6.482 | 3.124 | 74.008 | 1.00 | 57.58 |
| ATOM | 1568 | C | THR | 308 | 6.367 | 4.607 | 77.510 | 1.00 | 57.58 |
| ATOM | 1569 | O | THR | 308 | 6.287 | 3.892 | 78.508 | 1.00 | 57.58 |
| ATOM | 1570 | N | PHE | 309 | 6.869 | 5.859 | 77.568 | 1.00 | 67.82 |
| ATOM | 1571 | CA | PHE | 309 | 7.312 | 6.349 | 78.840 | 1.00 | 67.82 |
| ATOM | 1572 | CB | PHE | 309 | 8.826 | 6.214 | 79.115 | 1.00 | 67.82 |
| ATOM | 1573 | CG | PHE | 309 | 9.636 | 6.893 | 78.063 | 1.00 | 67.82 |
| ATOM | 1574 | CD1 | PHE | 309 | 9.635 | 8.263 | 77.934 | 1.00 | 67.82 |
| ATOM | 1575 | CD2 | PHE | 309 | 10.439 | 6.147 | 77.228 | 1.00 | 67.82 |
| ATOM | 1576 | CE1 | PHE | 309 | 10.399 | 8.871 | 76.964 | 1.00 | 67.82 |
| ATOM | 1577 | CE2 | PHE | 309 | 11.207 | 6.748 | 76.258 | 1.00 | 67.82 |
| ATOM | 1578 | CZ | PHE | 309 | 11.184 | 8.116 | 76.125 | 1.00 | 67.82 |
| ATOM | 1579 | C | PHE | 309 | 6.919 | 7.779 | 79.026 | 1.00 | 67.82 |
| ATOM | 1580 | O | PHE | 309 | 6.449 | 8.450 | 78.106 | 1.00 | 67.82 |
| ATOM | 1581 | N | GLY | 310 | 7.095 | 8.266 | 80.272 | 1.00 | 35.84 |
| ATOM | 1582 | CA | GLY | 310 | 6.795 | 9.622 | 80.629 | 1.00 | 35.84 |
| ATOM | 1583 | C | GLY | 310 | 5.596 | 9.675 | 81.529 | 1.00 | 35.84 |
| ATOM | 1584 | O | GLY | 310 | 5.433 | 10.622 | 82.292 | 1.00 | 35.84 |
| ATOM | 1585 | N | ALA | 311 | 4.715 | 8.665 | 81.494 | 1.00 | 33.99 |
| ATOM | 1586 | CA | ALA | 311 | 3.551 | 8.737 | 82.334 | 1.00 | 33.99 |
| ATOM | 1587 | CB | ALA | 311 | 2.593 | 7.553 | 82.123 | 1.00 | 33.99 |
| ATOM | 1588 | C | ALA | 311 | 3.963 | 8.717 | 83.777 | 1.00 | 33.99 |
| ATOM | 1589 | O | ALA | 311 | 3.420 | 9.452 | 84.601 | 1.00 | 33.99 |
| ATOM | 1590 | N | LYS | 312 | 4.942 | 7.855 | 84.105 | 1.00 | 97.86 |
| ATOM | 1591 | CA | LYS | 312 | 5.431 | 7.608 | 85.435 | 1.00 | 97.86 |
| ATOM | 1592 | CB | LYS | 312 | 6.471 | 6.478 | 85.476 | 1.00 | 97.86 |
| ATOM | 1593 | CG | LYS | 312 | 7.054 | 6.237 | 86.870 | 1.00 | 97.86 |
| ATOM | 1594 | CD | LYS | 312 | 8.056 | 5.083 | 86.912 | 1.00 | 97.86 |
| ATOM | 1595 | CE | LYS | 312 | 8.821 | 4.978 | 88.232 | 1.00 | 97.86 |
| ATOM | 1596 | NZ | LYS | 312 | 9.860 | 3.929 | 88.129 | 1.00 | 97.86 |
| ATOM | 1597 | C | LYS | 312 | 6.119 | 8.801 | 86.022 | 1.00 | 97.86 |
| ATOM | 1598 | O | LYS | 312 | 6.024 | 9.029 | 87.226 | 1.00 | 97.86 |
| ATOM | 1599 | N | ILE | 313 | 6.830 | 9.577 | 85.180 | 1.00 | 184.69 |
| ATOM | 1600 | CA | ILE | 313 | 7.702 | 10.644 | 85.599 | 1.00 | 184.69 |
| ATOM | 1601 | CB | ILE | 313 | 8.110 | 11.557 | 84.467 | 1.00 | 184.69 |
| ATOM | 1602 | CG2 | ILE | 313 | 6.838 | 12.252 | 83.963 | 1.00 | 184.69 |
| ATOM | 1603 | CG1 | ILE | 313 | 9.144 | 12.612 | 84.889 | 1.00 | 184.69 |
| ATOM | 1604 | CD1 | ILE | 313 | 8.499 | 13.804 | 85.601 | 1.00 | 184.69 |
| ATOM | 1605 | C | ILE | 313 | 7.132 | 11.465 | 86.706 | 1.00 | 184.69 |
| ATOM | 1606 | O | ILE | 313 | 5.961 | 11.845 | 86.706 | 1.00 | 184.69 |
| ATOM | 1607 | N | GLY | 314 | 7.997 | 11.749 | 87.704 | 1.00 | 35.77 |
| ATOM | 1608 | CA | GLY | 314 | 7.623 | 12.563 | 88.821 | 1.00 | 35.77 |
| ATOM | 1609 | C | GLY | 314 | 8.114 | 13.944 | 88.534 | 1.00 | 35.77 |
| ATOM | 1610 | O | GLY | 314 | 9.280 | 14.149 | 88.197 | 1.00 | 35.77 |
| ATOM | 1611 | N | CYS | 315 | 7.215 | 14.934 | 88.701 | 1.00 | 51.27 |
| ATOM | 1612 | CA | CYS | 315 | 7.513 | 16.300 | 88.388 | 1.00 | 51.27 |
| ATOM | 1613 | CB | CYS | 315 | 6.266 | 17.071 | 87.920 | 1.00 | 51.27 |
| ATOM | 1614 | SG | CYS | 315 | 5.480 | 16.313 | 86.465 | 1.00 | 51.27 |
| ATOM | 1615 | C | CYS | 315 | 7.996 | 16.961 | 89.641 | 1.00 | 51.27 |
| ATOM | 1616 | O | CYS | 315 | 7.345 | 16.879 | 90.680 | 1.00 | 51.27 |
| ATOM | 1617 | N | ILE | 316 | 9.167 | 17.633 | 89.588 | 1.00 | 113.12 |
| ATOM | 1618 | CA | ILE | 316 | 9.648 | 18.251 | 90.791 | 1.00 | 113.12 |
| ATOM | 1619 | CB | ILE | 316 | 10.793 | 17.532 | 91.440 | 1.00 | 113.12 |
| ATOM | 1620 | CG2 | ILE | 316 | 10.331 | 16.122 | 91.832 | 1.00 | 113.12 |
| ATOM | 1621 | CG1 | ILE | 316 | 12.019 | 17.553 | 90.513 | 1.00 | 113.12 |
| ATOM | 1622 | CD1 | ILE | 316 | 13.308 | 17.116 | 91.205 | 1.00 | 113.12 |
| ATOM | 1623 | C | ILE | 316 | 10.183 | 19.612 | 90.486 | 1.00 | 113.12 |
| ATOM | 1624 | O | ILE | 316 | 10.554 | 19.915 | 89.352 | 1.00 | 113.12 |
| ATOM | 1625 | N | ASN | 317 | 10.206 | 20.482 | 91.518 | 1.00 | 92.47 |
| ATOM | 1626 | CA | ASN | 317 | 10.838 | 21.761 | 91.377 | 1.00 | 92.47 |
| ATOM | 1627 | CB | ASN | 317 | 10.161 | 22.905 | 92.150 | 1.00 | 92.47 |
| ATOM | 1628 | CG | ASN | 317 | 10.876 | 24.189 | 91.747 | 1.00 | 92.47 |
| ATOM | 1629 | OD1 | ASN | 317 | 10.384 | 24.950 | 90.915 | 1.00 | 92.47 |
| ATOM | 1630 | ND2 | ASN | 317 | 12.075 | 24.434 | 92.341 | 1.00 | 92.47 |
| ATOM | 1631 | C | ASN | 317 | 12.201 | 21.563 | 91.963 | 1.00 | 92.47 |
| ATOM | 1632 | O | ASN | 317 | 12.334 | 21.185 | 93.126 | 1.00 | 92.47 |
| ATOM | 1633 | N | VAL | 318 | 13.250 | 21.804 | 91.152 | 1.00 | 256.82 |
| ATOM | 1634 | CA | VAL | 318 | 14.596 | 21.482 | 91.537 | 1.00 | 256.82 |
| ATOM | 1635 | CB | VAL | 318 | 15.623 | 21.610 | 90.449 | 1.00 | 256.82 |
| ATOM | 1636 | CG1 | VAL | 318 | 15.173 | 20.771 | 89.246 | 1.00 | 256.82 |
| ATOM | 1637 | CG2 | VAL | 318 | 15.914 | 23.088 | 90.171 | 1.00 | 256.82 |
| ATOM | 1638 | C | VAL | 318 | 15.119 | 22.296 | 92.674 | 1.00 | 256.82 |
| ATOM | 1639 | O | VAL | 318 | 15.781 | 21.736 | 93.533 | 1.00 | 256.82 |
| ATOM | 1640 | N | GLU | 319 | 14.886 | 23.621 | 92.735 | 1.00 | 148.90 |
| ATOM | 1641 | CA | GLU | 319 | 15.486 | 24.392 | 93.794 | 1.00 | 148.90 |
| ATOM | 1642 | CB | GLU | 319 | 15.190 | 23.832 | 95.199 | 1.00 | 148.90 |
| ATOM | 1643 | CG | GLU | 319 | 13.709 | 23.927 | 95.574 | 1.00 | 148.90 |
| ATOM | 1644 | CD | GLU | 319 | 13.460 | 23.130 | 96.851 | 1.00 | 148.90 |
| ATOM | 1645 | OE1 | GLU | 319 | 13.574 | 21.877 | 96.798 | 1.00 | 148.90 |
| ATOM | 1646 | OE2 | GLU | 319 | 13.148 | 23.765 | 97.892 | 1.00 | 148.90 |
| ATOM | 1647 | C | GLU | 319 | 16.978 | 24.456 | 93.572 | 1.00 | 148.90 |
| ATOM | 1648 | O | GLU | 319 | 17.639 | 23.445 | 93.335 | 1.00 | 148.90 |
| ATOM | 1649 | N | VAL | 320 | 17.541 | 25.684 | 93.630 | 1.00 | 135.20 |
| ATOM | 1650 | CA | VAL | 320 | 18.939 | 25.956 | 93.415 | 1.00 | 135.20 |
| ATOM | 1651 | CB | VAL | 320 | 19.301 | 26.059 | 91.973 | 1.00 | 135.20 |
| ATOM | 1652 | CG1 | VAL | 320 | 19.047 | 24.688 | 91.331 | 1.00 | 135.20 |
| ATOM | 1653 | CG2 | VAL | 320 | 18.490 | 27.217 | 91.365 | 1.00 | 135.20 |
| ATOM | 1654 | C | VAL | 320 | 19.198 | 27.310 | 94.009 | 1.00 | 135.20 |
| ATOM | 1655 | O | VAL | 320 | 18.335 | 27.853 | 94.695 | 1.00 | 135.20 |
| ATOM | 1656 | N | ASN | 321 | 20.400 | 27.891 | 93.786 | 1.00 | 93.84 |
| ATOM | 1657 | CA | ASN | 321 | 20.666 | 29.190 | 94.359 | 1.00 | 93.84 |
| ATOM | 1658 | CB | ASN | 321 | 21.812 | 29.200 | 95.388 | 1.00 | 93.84 |
| ATOM | 1659 | CG | ASN | 321 | 21.303 | 28.624 | 96.706 | 1.00 | 93.84 |
| ATOM | 1660 | OD1 | ASN | 321 | 20.829 | 27.491 | 96.775 | 1.00 | 93.84 |
| ATOM | 1661 | ND2 | ASN | 321 | 21.410 | 29.436 | 97.792 | 1.00 | 93.84 |
| ATOM | 1662 | C | ASN | 321 | 21.035 | 30.190 | 93.295 | 1.00 | 93.84 |
| ATOM | 1663 | O | ASN | 321 | 21.555 | 29.809 | 92.247 | 1.00 | 93.84 |
| ATOM | 1664 | N | GLN | 322 | 20.714 | 31.494 | 93.532 | 1.00 | 148.83 |
| ATOM | 1665 | CA | GLN | 322 | 21.092 | 32.602 | 92.679 | 1.00 | 148.83 |
| ATOM | 1666 | CB | GLN | 322 | 20.070 | 32.903 | 91.568 | 1.00 | 148.83 |
| ATOM | 1667 | CG | GLN | 322 | 20.478 | 34.077 | 90.674 | 1.00 | 148.83 |
| ATOM | 1668 | CD | GLN | 322 | 19.349 | 34.341 | 89.685 | 1.00 | 148.83 |
| ATOM | 1669 | OE1 | GLN | 322 | 18.191 | 34.027 | 89.953 | 1.00 | 148.83 |
| ATOM | 1670 | NE2 | GLN | 322 | 19.687 | 34.933 | 88.508 | 1.00 | 148.83 |
| ATOM | 1671 | C | GLN | 322 | 21.136 | 33.844 | 93.533 | 1.00 | 148.83 |
| ATOM | 1672 | O | GLN | 322 | 20.094 | 34.357 | 93.940 | 1.00 | 148.83 |
| ATOM | 1673 | N | LEU | 323 | 22.347 | 34.356 | 93.837 | 1.00 | 98.47 |
| ATOM | 1674 | CA | LEU | 323 | 22.494 | 35.530 | 94.658 | 1.00 | 98.47 |
| ATOM | 1675 | CB | LEU | 323 | 23.936 | 35.739 | 95.155 | 1.00 | 98.47 |
| ATOM | 1676 | CG | LEU | 323 | 24.402 | 34.643 | 96.134 | 1.00 | 98.47 |
| ATOM | 1677 | CD2 | LEU | 323 | 25.708 | 35.041 | 96.839 | 1.00 | 98.47 |
| ATOM | 1678 | CD1 | LEU | 323 | 24.481 | 33.271 | 95.446 | 1.00 | 98.47 |
| ATOM | 1679 | C | LEU | 323 | 22.063 | 36.788 | 93.956 | 1.00 | 98.47 |
| ATOM | 1680 | O | LEU | 323 | 21.361 | 37.611 | 94.542 | 1.00 | 98.47 |
| ATOM | 1681 | N | LEU | 324 | 22.461 | 36.971 | 92.679 | 1.00 | 102.11 |
| ATOM | 1682 | CA | LEU | 324 | 22.197 | 38.215 | 91.998 | 1.00 | 102.11 |
| ATOM | 1683 | CB | LEU | 324 | 23.396 | 38.736 | 91.189 | 1.00 | 102.11 |
| ATOM | 1684 | CG | LEU | 324 | 24.622 | 39.078 | 92.054 | 1.00 | 102.11 |
| ATOM | 1685 | CD2 | LEU | 324 | 25.679 | 39.847 | 91.245 | 1.00 | 102.11 |
| ATOM | 1686 | CD1 | LEU | 324 | 25.189 | 37.824 | 92.735 | 1.00 | 102.11 |
| ATOM | 1687 | C | LEU | 324 | 21.072 | 38.030 | 91.029 | 1.00 | 102.11 |
| ATOM | 1688 | O | LEU | 324 | 20.724 | 36.910 | 90.663 | 1.00 | 102.11 |
| ATOM | 1689 | N | GLU | 325 | 20.431 | 39.156 | 90.650 | 1.00 | 108.72 |
| ATOM | 1690 | CA | GLU | 325 | 19.301 | 39.181 | 89.763 | 1.00 | 108.72 |
| ATOM | 1691 | CB | GLU | 325 | 18.537 | 40.512 | 89.835 | 1.00 | 108.72 |
| ATOM | 1692 | CG | GLU | 325 | 17.134 | 40.441 | 89.235 | 1.00 | 108.72 |
| ATOM | 1693 | CD | GLU | 325 | 16.380 | 41.683 | 89.684 | 1.00 | 108.72 |
| ATOM | 1694 | OE1 | GLU | 325 | 17.036 | 42.746 | 89.850 | 1.00 | 108.72 |
| ATOM | 1695 | OE2 | GLU | 325 | 15.137 | 41.585 | 89.868 | 1.00 | 108.72 |
| ATOM | 1696 | C | GLU | 325 | 19.644 | 38.919 | 88.314 | 1.00 | 108.72 |
| ATOM | 1697 | O | GLU | 325 | 18.895 | 38.230 | 87.627 | 1.00 | 108.72 |
| ATOM | 1698 | N | SER | 326 | 20.757 | 39.493 | 87.804 | 1.00 | 114.97 |
| ATOM | 1699 | CA | SER | 326 | 21.134 | 39.467 | 86.406 | 1.00 | 114.97 |
| ATOM | 1700 | CB | SER | 326 | 22.097 | 40.613 | 86.069 | 1.00 | 114.97 |
| ATOM | 1701 | OG | SER | 326 | 21.438 | 41.862 | 86.241 | 1.00 | 114.97 |
| ATOM | 1702 | C | SER | 326 | 21.748 | 38.170 | 85.936 | 1.00 | 114.97 |
| ATOM | 1703 | O | SER | 326 | 21.853 | 37.921 | 84.736 | 1.00 | 114.97 |
| ATOM | 1704 | N | GLU | 327 | 22.181 | 37.316 | 86.870 | 1.00 | 104.93 |
| ATOM | 1705 | CA | GLU | 327 | 22.890 | 36.083 | 86.653 | 1.00 | 104.93 |
| ATOM | 1706 | CB | GLU | 327 | 23.539 | 35.575 | 87.950 | 1.00 | 104.93 |
| ATOM | 1707 | CG | GLU | 327 | 24.691 | 36.466 | 88.432 | 1.00 | 104.93 |
| ATOM | 1708 | CD | GLU | 327 | 25.159 | 35.965 | 89.792 | 1.00 | 104.93 |
| ATOM | 1709 | OE1 | GLU | 327 | 24.287 | 35.748 | 90.677 | 1.00 | 104.93 |
| ATOM | 1710 | OE2 | GLU | 327 | 26.396 | 35.797 | 89.967 | 1.00 | 104.93 |
| ATOM | 1711 | C | GLU | 327 | 22.049 | 34.976 | 86.057 | 1.00 | 104.93 |
| ATOM | 1712 | O | GLU | 327 | 22.597 | 33.944 | 85.674 | 1.00 | 104.93 |
| ATOM | 1713 | N | CYS | 328 | 20.712 | 35.125 | 85.963 | 1.00 | 88.66 |
| ATOM | 1714 | CA | CYS | 328 | 19.835 | 34.019 | 85.648 | 1.00 | 88.66 |
| ATOM | 1715 | CB | CYS | 328 | 18.367 | 34.439 | 85.426 | 1.00 | 88.66 |
| ATOM | 1716 | SG | CYS | 328 | 18.128 | 35.433 | 83.921 | 1.00 | 88.66 |
| ATOM | 1717 | C | CYS | 328 | 20.255 | 33.241 | 84.426 | 1.00 | 88.66 |
| ATOM | 1718 | O | CYS | 328 | 20.216 | 32.013 | 84.459 | 1.00 | 88.66 |
| ATOM | 1719 | N | GLY | 329 | 20.650 | 32.889 | 83.316 | 1.00 | 48.60 |
| ATOM | 1720 | CA | GLY | 329 | 21.026 | 33.129 | 82.149 | 1.00 | 48.60 |
| ATOM | 1721 | C | GLY | 329 | 22.236 | 32.301 | 82.465 | 1.00 | 48.60 |
| ATOM | 1722 | O | GLY | 329 | 22.398 | 31.182 | 81.981 | 1.00 | 48.60 |
| ATOM | 1723 | N | MET | 330 | 23.148 | 32.862 | 83.269 | 1.00 | 133.02 |
| ATOM | 1724 | CA | MET | 330 | 24.370 | 32.223 | 83.650 | 1.00 | 133.02 |
| ATOM | 1725 | CB | MET | 330 | 25.183 | 33.184 | 84.533 | 1.00 | 133.02 |
| ATOM | 1726 | CG | MET | 330 | 26.681 | 32.964 | 84.459 | 1.00 | 133.02 |
| ATOM | 1727 | SD | MET | 330 | 27.124 | 31.237 | 84.706 | 1.00 | 133.02 |
| ATOM | 1728 | CE | MET | 330 | 26.458 | 31.100 | 86.390 | 1.00 | 133.02 |
| ATOM | 1729 | C | MET | 330 | 24.027 | 30.990 | 84.449 | 1.00 | 133.02 |
| ATOM | 1730 | O | MET | 330 | 24.615 | 29.924 | 84.265 | 1.00 | 133.02 |
| ATOM | 1731 | N | PHE | 331 | 23.036 | 31.109 | 85.354 | 1.00 | 83.63 |
| ATOM | 1732 | CA | PHE | 331 | 22.607 | 30.029 | 86.201 | 1.00 | 83.63 |
| ATOM | 1733 | CB | PHE | 331 | 21.599 | 30.466 | 87.280 | 1.00 | 83.63 |
| ATOM | 1734 | CG | PHE | 331 | 22.375 | 31.106 | 88.383 | 1.00 | 83.63 |
| ATOM | 1735 | CD1 | PHE | 331 | 22.824 | 32.400 | 88.281 | 1.00 | 83.63 |
| ATOM | 1736 | CD2 | PHE | 331 | 22.650 | 30.399 | 89.530 | 1.00 | 83.63 |
| ATOM | 1737 | CE1 | PHE | 331 | 23.538 | 32.971 | 89.311 | 1.00 | 83.63 |
| ATOM | 1738 | CE2 | PHE | 331 | 23.366 | 30.972 | 90.557 | 1.00 | 83.63 |
| ATOM | 1739 | CZ | PHE | 331 | 23.812 | 32.262 | 90.451 | 1.00 | 83.63 |
| ATOM | 1740 | C | PHE | 331 | 21.992 | 28.937 | 85.379 | 1.00 | 83.63 |
| ATOM | 1741 | O | PHE | 331 | 22.178 | 27.760 | 85.688 | 1.00 | 83.63 |
| ATOM | 1742 | N | ILE | 332 | 21.228 | 29.279 | 84.319 | 1.00 | 106.83 |
| ATOM | 1743 | CA | ILE | 332 | 20.640 | 28.222 | 83.545 | 1.00 | 106.83 |
| ATOM | 1744 | CB | ILE | 332 | 19.753 | 28.643 | 82.400 | 1.00 | 106.83 |
| ATOM | 1745 | CG2 | ILE | 332 | 18.631 | 29.519 | 82.984 | 1.00 | 106.83 |
| ATOM | 1746 | CG1 | ILE | 332 | 20.539 | 29.315 | 81.268 | 1.00 | 106.83 |
| ATOM | 1747 | CD1 | ILE | 332 | 19.748 | 29.434 | 79.964 | 1.00 | 106.83 |
| ATOM | 1748 | C | ILE | 332 | 21.772 | 27.428 | 82.972 | 1.00 | 106.83 |
| ATOM | 1749 | O | ILE | 332 | 21.715 | 26.202 | 82.906 | 1.00 | 106.83 |
| ATOM | 1750 | N | SER | 333 | 22.837 | 28.125 | 82.537 | 1.00 | 51.79 |
| ATOM | 1751 | CA | SER | 333 | 24.000 | 27.510 | 81.960 | 1.00 | 51.79 |
| ATOM | 1752 | CB | SER | 333 | 25.082 | 28.555 | 81.640 | 1.00 | 51.79 |
| ATOM | 1753 | OG | SER | 333 | 24.618 | 29.446 | 80.638 | 1.00 | 51.79 |
| ATOM | 1754 | C | SER | 333 | 24.613 | 26.548 | 82.947 | 1.00 | 51.79 |
| ATOM | 1755 | O | SER | 333 | 24.893 | 25.402 | 82.597 | 1.00 | 51.79 |
| ATOM | 1756 | N | LEU | 334 | 24.843 | 26.981 | 84.206 | 1.00 | 121.38 |
| ATOM | 1757 | CA | LEU | 334 | 25.440 | 26.123 | 85.202 | 1.00 | 121.38 |
| ATOM | 1758 | CB | LEU | 334 | 25.762 | 26.813 | 86.544 | 1.00 | 121.38 |
| ATOM | 1759 | CG | LEU | 334 | 27.176 | 27.413 | 86.586 | 1.00 | 121.38 |
| ATOM | 1760 | CD2 | LEU | 334 | 27.429 | 28.161 | 87.905 | 1.00 | 121.38 |
| ATOM | 1761 | CD1 | LEU | 334 | 27.448 | 28.271 | 85.352 | 1.00 | 121.38 |
| ATOM | 1762 | C | LEU | 334 | 24.542 | 24.973 | 85.501 | 1.00 | 121.38 |
| ATOM | 1763 | O | LEU | 334 | 25.001 | 23.850 | 85.696 | 1.00 | 121.38 |
| ATOM | 1764 | N | PHE | 335 | 23.230 | 25.226 | 85.556 | 1.00 | 159.54 |
| ATOM | 1765 | CA | PHE | 335 | 22.292 | 24.196 | 85.851 | 1.00 | 159.54 |
| ATOM | 1766 | CB | PHE | 335 | 20.865 | 24.767 | 85.906 | 1.00 | 159.54 |
| ATOM | 1767 | CG | PHE | 335 | 19.899 | 23.684 | 86.217 | 1.00 | 159.54 |
| ATOM | 1768 | CD1 | PHE | 335 | 19.906 | 23.083 | 87.455 | 1.00 | 159.54 |
| ATOM | 1769 | CD2 | PHE | 335 | 18.970 | 23.298 | 85.280 | 1.00 | 159.54 |
| ATOM | 1770 | CE1 | PHE | 335 | 19.005 | 22.091 | 87.753 | 1.00 | 159.54 |
| ATOM | 1771 | CE2 | PHE | 335 | 18.069 | 22.306 | 85.573 | 1.00 | 159.54 |
| ATOM | 1772 | CZ | PHE | 335 | 18.085 | 21.704 | 86.810 | 1.00 | 159.54 |
| ATOM | 1773 | C | PHE | 335 | 22.388 | 23.163 | 84.775 | 1.00 | 159.54 |
| ATOM | 1774 | O | PHE | 335 | 22.380 | 21.967 | 85.054 | 1.00 | 159.54 |
| ATOM | 1775 | N | MET | 336 | 22.458 | 23.588 | 83.503 | 1.00 | 155.16 |
| ATOM | 1776 | CA | MET | 336 | 22.560 | 22.615 | 82.458 | 1.00 | 155.16 |
| ATOM | 1777 | CB | MET | 336 | 22.361 | 23.188 | 81.042 | 1.00 | 155.16 |
| ATOM | 1778 | CG | MET | 336 | 23.323 | 24.301 | 80.633 | 1.00 | 155.16 |
| ATOM | 1779 | SD | MET | 336 | 23.119 | 24.827 | 78.905 | 1.00 | 155.16 |
| ATOM | 1780 | CE | MET | 336 | 24.318 | 23.631 | 78.251 | 1.00 | 155.16 |
| ATOM | 1781 | C | MET | 336 | 23.876 | 21.912 | 82.535 | 1.00 | 155.16 |
| ATOM | 1782 | O | MET | 336 | 23.932 | 20.692 | 82.421 | 1.00 | 155.16 |
| ATOM | 1783 | N | ILE | 337 | 24.979 | 22.643 | 82.775 | 1.00 | 107.96 |
| ATOM | 1784 | CA | ILE | 337 | 26.257 | 21.998 | 82.747 | 1.00 | 107.96 |
| ATOM | 1785 | CB | ILE | 337 | 27.408 | 22.968 | 82.889 | 1.00 | 107.96 |
| ATOM | 1786 | CG2 | ILE | 337 | 27.325 | 23.676 | 84.251 | 1.00 | 107.96 |
| ATOM | 1787 | CG1 | ILE | 337 | 28.745 | 22.255 | 82.635 | 1.00 | 107.96 |
| ATOM | 1788 | CD1 | ILE | 337 | 29.919 | 23.221 | 82.483 | 1.00 | 107.96 |
| ATOM | 1789 | C | ILE | 337 | 26.349 | 20.969 | 83.830 | 1.00 | 107.96 |
| ATOM | 1790 | O | ILE | 337 | 26.711 | 19.823 | 83.563 | 1.00 | 107.96 |
| ATOM | 1791 | N | LEU | 338 | 26.009 | 21.320 | 85.084 | 1.00 | 143.54 |
| ATOM | 1792 | CA | LEU | 338 | 26.178 | 20.325 | 86.096 | 1.00 | 143.54 |
| ATOM | 1793 | CB | LEU | 338 | 26.128 | 20.815 | 87.546 | 1.00 | 143.54 |
| ATOM | 1794 | CG | LEU | 338 | 24.723 | 20.956 | 88.125 | 1.00 | 143.54 |
| ATOM | 1795 | CD2 | LEU | 338 | 23.877 | 21.963 | 87.343 | 1.00 | 143.54 |
| ATOM | 1796 | CD1 | LEU | 338 | 24.834 | 21.309 | 89.605 | 1.00 | 143.54 |
| ATOM | 1797 | C | LEU | 338 | 25.176 | 19.233 | 85.930 | 1.00 | 143.54 |
| ATOM | 1798 | O | LEU | 338 | 25.494 | 18.064 | 86.118 | 1.00 | 143.54 |
| ATOM | 1799 | N | CYS | 339 | 23.931 | 19.564 | 85.556 | 1.00 | 53.20 |
| ATOM | 1800 | CA | CYS | 339 | 22.950 | 18.526 | 85.471 | 1.00 | 53.20 |
| ATOM | 1801 | CB | CYS | 339 | 21.552 | 19.054 | 85.129 | 1.00 | 53.20 |
| ATOM | 1802 | SG | CYS | 339 | 20.905 | 20.013 | 86.534 | 1.00 | 53.20 |
| ATOM | 1803 | C | CYS | 339 | 23.383 | 17.513 | 84.458 | 1.00 | 53.20 |
| ATOM | 1804 | O | CYS | 339 | 23.210 | 16.313 | 84.665 | 1.00 | 53.20 |
| ATOM | 1805 | N | THR | 340 | 23.978 | 17.961 | 83.338 | 1.00 | 59.69 |
| ATOM | 1806 | CA | THR | 340 | 24.410 | 17.037 | 82.331 | 1.00 | 59.69 |
| ATOM | 1807 | CB | THR | 340 | 24.867 | 17.743 | 81.102 | 1.00 | 59.69 |
| ATOM | 1808 | OG1 | THR | 340 | 26.007 | 18.545 | 81.373 | 1.00 | 59.69 |
| ATOM | 1809 | CG2 | THR | 340 | 23.682 | 18.627 | 80.673 | 1.00 | 59.69 |
| ATOM | 1810 | C | THR | 340 | 25.503 | 16.173 | 82.890 | 1.00 | 59.69 |
| ATOM | 1811 | O | THR | 340 | 25.566 | 14.979 | 82.607 | 1.00 | 59.69 |
| ATOM | 1812 | N | ARG | 341 | 26.400 | 16.767 | 83.697 | 1.00 | 166.50 |
| ATOM | 1813 | CA | ARG | 341 | 27.485 | 16.067 | 84.324 | 1.00 | 166.50 |
| ATOM | 1814 | CB | ARG | 341 | 28.540 | 16.994 | 84.956 | 1.00 | 166.50 |
| ATOM | 1815 | CG | ARG | 341 | 29.402 | 17.720 | 83.917 | 1.00 | 166.50 |
| ATOM | 1816 | CD | ARG | 341 | 30.426 | 16.817 | 83.216 | 1.00 | 166.50 |
| ATOM | 1817 | NE | ARG | 341 | 29.666 | 15.747 | 82.509 | 1.00 | 166.50 |
| ATOM | 1818 | CZ | ARG | 341 | 30.255 | 14.997 | 81.531 | 1.00 | 166.50 |
| ATOM | 1819 | NH1 | ARG | 341 | 31.532 | 15.268 | 81.142 | 1.00 | 166.50 |
| ATOM | 1820 | NH2 | ARG | 341 | 29.559 | 13.977 | 80.950 | 1.00 | 166.50 |
| ATOM | 1821 | C | ARG | 341 | 26.969 | 15.144 | 85.384 | 1.00 | 166.50 |
| ATOM | 1822 | O | ARG | 341 | 27.625 | 14.155 | 85.703 | 1.00 | 166.50 |
| ATOM | 1823 | N | THR | 342 | 25.773 | 15.453 | 85.929 | 1.00 | 243.88 |
| ATOM | 1824 | CA | THR | 342 | 25.109 | 14.842 | 87.056 | 1.00 | 243.88 |
| ATOM | 1825 | CB | THR | 342 | 25.115 | 13.329 | 87.094 | 1.00 | 243.88 |
| ATOM | 1826 | OG1 | THR | 342 | 26.378 | 12.820 | 87.496 | 1.00 | 243.88 |
| ATOM | 1827 | CG2 | THR | 342 | 24.757 | 12.802 | 85.693 | 1.00 | 243.88 |
| ATOM | 1828 | C | THR | 342 | 25.625 | 15.308 | 88.408 | 1.00 | 243.88 |
| ATOM | 1829 | O | THR | 342 | 25.437 | 14.562 | 89.369 | 1.00 | 243.88 |
| ATOM | 1830 | N | PRO | 343 | 26.237 | 16.465 | 88.607 | 1.00 | 235.84 |
| ATOM | 1831 | CA | PRO | 343 | 26.455 | 16.863 | 89.969 | 1.00 | 235.84 |
| ATOM | 1832 | CD | PRO | 343 | 27.394 | 16.878 | 87.814 | 1.00 | 235.84 |
| ATOM | 1833 | CB | PRO | 343 | 27.440 | 18.025 | 89.938 | 1.00 | 235.84 |
| ATOM | 1834 | CG | PRO | 343 | 28.320 | 17.688 | 88.732 | 1.00 | 235.84 |
| ATOM | 1835 | C | PRO | 343 | 25.199 | 17.159 | 90.732 | 1.00 | 235.84 |
| ATOM | 1836 | O | PRO | 343 | 25.343 | 17.430 | 91.916 | 1.00 | 235.84 |
| ATOM | 1837 | N | PRO | 344 | 24.013 | 17.210 | 90.200 | 1.00 | 146.86 |
| ATOM | 1838 | CA | PRO | 344 | 22.908 | 17.373 | 91.105 | 1.00 | 146.86 |
| ATOM | 1839 | CD | PRO | 344 | 23.778 | 17.891 | 88.936 | 1.00 | 146.86 |
| ATOM | 1840 | CB | PRO | 344 | 21.731 | 17.831 | 90.252 | 1.00 | 146.86 |
| ATOM | 1841 | CG | PRO | 344 | 22.405 | 18.572 | 89.085 | 1.00 | 146.86 |
| ATOM | 1842 | C | PRO | 344 | 22.725 | 16.036 | 91.726 | 1.00 | 146.86 |
| ATOM | 1843 | O | PRO | 344 | 23.180 | 15.072 | 91.117 | 1.00 | 146.86 |
| ATOM | 1844 | N | LYS | 345 | 22.109 | 15.944 | 92.923 | 1.00 | 269.51 |
| ATOM | 1845 | CA | LYS | 345 | 21.937 | 14.657 | 93.535 | 1.00 | 269.51 |
| ATOM | 1846 | CB | LYS | 345 | 22.991 | 14.317 | 94.601 | 1.00 | 269.51 |
| ATOM | 1847 | CG | LYS | 345 | 24.410 | 14.175 | 94.054 | 1.00 | 269.51 |
| ATOM | 1848 | CD | LYS | 345 | 24.559 | 13.061 | 93.019 | 1.00 | 269.51 |
| ATOM | 1849 | CE | LYS | 345 | 25.977 | 12.940 | 92.455 | 1.00 | 269.51 |
| ATOM | 1850 | NZ | LYS | 345 | 26.850 | 12.229 | 93.416 | 1.00 | 269.51 |
| ATOM | 1851 | C | LYS | 345 | 20.637 | 14.655 | 94.265 | 1.00 | 269.51 |
| ATOM | 1852 | O | LYS | 345 | 19.963 | 15.678 | 94.376 | 1.00 | 269.51 |
| ATOM | 1853 | N | SER | 346 | 20.247 | 13.468 | 94.770 | 1.00 | 69.56 |
| ATOM | 1854 | CA | SER | 346 | 19.058 | 13.362 | 95.555 | 1.00 | 69.56 |
| ATOM | 1855 | CB | SER | 346 | 18.802 | 11.932 | 96.066 | 1.00 | 69.56 |
| ATOM | 1856 | OG | SER | 346 | 19.821 | 11.548 | 96.979 | 1.00 | 69.56 |
| ATOM | 1857 | C | SER | 346 | 19.293 | 14.225 | 96.748 | 1.00 | 69.56 |
| ATOM | 1858 | O | SER | 346 | 18.432 | 15.003 | 97.153 | 1.00 | 69.56 |
| ATOM | 1859 | N | PHE | 347 | 20.502 | 14.110 | 97.330 | 1.00 | 222.83 |
| ATOM | 1860 | CA | PHE | 347 | 20.861 | 14.913 | 98.458 | 1.00 | 222.83 |
| ATOM | 1861 | CB | PHE | 347 | 21.482 | 14.125 | 99.626 | 1.00 | 222.83 |
| ATOM | 1862 | CG | PHE | 347 | 20.372 | 13.414 | 100.316 | 1.00 | 222.83 |
| ATOM | 1863 | CD1 | PHE | 347 | 19.858 | 12.247 | 99.804 | 1.00 | 222.83 |
| ATOM | 1864 | CD2 | PHE | 347 | 19.843 | 13.923 | 101.481 | 1.00 | 222.83 |
| ATOM | 1865 | CE1 | PHE | 347 | 18.831 | 11.598 | 100.447 | 1.00 | 222.83 |
| ATOM | 1866 | CE2 | PHE | 347 | 18.816 | 13.278 | 102.129 | 1.00 | 222.83 |
| ATOM | 1867 | CZ | PHE | 347 | 18.308 | 12.113 | 101.609 | 1.00 | 222.83 |
| ATOM | 1868 | C | PHE | 347 | 21.879 | 15.884 | 97.977 | 1.00 | 222.83 |
| ATOM | 1869 | O | PHE | 347 | 22.550 | 15.648 | 96.974 | 1.00 | 222.83 |
| ATOM | 1870 | N | LYS | 348 | 21.990 | 17.027 | 98.681 | 1.00 | 288.70 |
| ATOM | 1871 | CA | LYS | 348 | 22.925 | 18.038 | 98.299 | 1.00 | 288.70 |
| ATOM | 1872 | CB | LYS | 348 | 24.321 | 17.471 | 97.993 | 1.00 | 288.70 |
| ATOM | 1873 | CG | LYS | 348 | 24.934 | 16.735 | 99.186 | 1.00 | 288.70 |
| ATOM | 1874 | CD | LYS | 348 | 26.080 | 15.801 | 98.798 | 1.00 | 288.70 |
| ATOM | 1875 | CE | LYS | 348 | 25.601 | 14.449 | 98.265 | 1.00 | 288.70 |
| ATOM | 1876 | NZ | LYS | 348 | 26.768 | 13.593 | 97.958 | 1.00 | 288.70 |
| ATOM | 1877 | C | LYS | 348 | 22.379 | 18.685 | 97.068 | 1.00 | 288.70 |
| ATOM | 1878 | O | LYS | 348 | 21.881 | 18.011 | 96.168 | 1.00 | 288.70 |
| ATOM | 1879 | N | SER | 349 | 22.438 | 20.031 | 97.016 | 1.00 | 159.92 |
| ATOM | 1880 | CA | SER | 349 | 21.932 | 20.754 | 95.887 | 1.00 | 159.92 |
| ATOM | 1881 | CB | SER | 349 | 21.494 | 22.193 | 96.215 | 1.00 | 159.92 |
| ATOM | 1882 | OG | SER | 349 | 20.391 | 22.176 | 97.112 | 1.00 | 159.92 |
| ATOM | 1883 | C | SER | 349 | 23.021 | 20.837 | 94.878 | 1.00 | 159.92 |
| ATOM | 1884 | O | SER | 349 | 24.086 | 20.248 | 95.051 | 1.00 | 159.92 |
| ATOM | 1885 | N | LEU | 350 | 22.767 | 21.569 | 93.776 | 1.00 | 150.01 |
| ATOM | 1886 | CA | LEU | 350 | 23.746 | 21.711 | 92.751 | 1.00 | 150.01 |
| ATOM | 1887 | CB | LEU | 350 | 23.317 | 22.709 | 91.670 | 1.00 | 150.01 |
| ATOM | 1888 | CG | LEU | 350 | 22.158 | 22.234 | 90.778 | 1.00 | 150.01 |
| ATOM | 1889 | CD2 | LEU | 350 | 21.987 | 23.148 | 89.553 | 1.00 | 150.01 |
| ATOM | 1890 | CD1 | LEU | 350 | 20.866 | 22.057 | 91.587 | 1.00 | 150.01 |
| ATOM | 1891 | C | LEU | 350 | 24.986 | 22.232 | 93.392 | 1.00 | 150.01 |
| ATOM | 1892 | O | LEU | 350 | 24.993 | 23.291 | 94.020 | 1.00 | 150.01 |
| ATOM | 1893 | N | LYS | 351 | 26.070 | 21.445 | 93.267 | 1.00 | 285.93 |
| ATOM | 1894 | CA | LYS | 351 | 27.330 | 21.808 | 93.827 | 1.00 | 285.93 |
| ATOM | 1895 | CB | LYS | 351 | 27.583 | 21.249 | 95.236 | 1.00 | 285.93 |
| ATOM | 1896 | CG | LYS | 351 | 26.595 | 21.702 | 96.300 | 1.00 | 285.93 |
| ATOM | 1897 | CD | LYS | 351 | 26.817 | 21.034 | 97.659 | 1.00 | 285.93 |
| ATOM | 1898 | CE | LYS | 351 | 28.030 | 21.589 | 98.414 | 1.00 | 285.93 |
| ATOM | 1899 | NZ | LYS | 351 | 28.195 | 20.882 | 99.704 | 1.00 | 285.93 |
| ATOM | 1900 | C | LYS | 351 | 28.364 | 21.123 | 93.007 | 1.00 | 285.93 |
| ATOM | 1901 | O | LYS | 351 | 28.060 | 20.255 | 92.193 | 1.00 | 285.93 |
| ATOM | 1902 | N | LYS | 352 | 29.625 | 21.540 | 93.192 | 1.00 | 262.02 |
| ATOM | 1903 | CA | LYS | 352 | 30.745 | 20.865 | 92.618 | 1.00 | 262.02 |
| ATOM | 1904 | CB | LYS | 352 | 31.952 | 21.787 | 92.381 | 1.00 | 262.02 |
| ATOM | 1905 | CG | LYS | 352 | 31.819 | 22.672 | 91.138 | 1.00 | 262.02 |
| ATOM | 1906 | CD | LYS | 352 | 30.600 | 23.594 | 91.162 | 1.00 | 262.02 |
| ATOM | 1907 | CE | LYS | 352 | 29.518 | 23.209 | 90.146 | 1.00 | 262.02 |
| ATOM | 1908 | NZ | LYS | 352 | 29.188 | 21.769 | 90.259 | 1.00 | 262.02 |
| ATOM | 1909 | C | LYS | 352 | 31.118 | 19.856 | 93.656 | 1.00 | 262.02 |
| ATOM | 1910 | O | LYS | 352 | 30.529 | 19.818 | 94.732 | 1.00 | 262.02 |
| ATOM | 1911 | N | VAL | 353 | 32.064 | 18.956 | 93.357 | 1.00 | 96.29 |
| ATOM | 1912 | CA | VAL | 353 | 32.401 | 18.034 | 94.396 | 1.00 | 96.29 |
| ATOM | 1913 | CB | VAL | 353 | 33.454 | 17.048 | 93.992 | 1.00 | 96.29 |
| ATOM | 1914 | CG1 | VAL | 353 | 33.825 | 16.202 | 95.221 | 1.00 | 96.29 |
| ATOM | 1915 | CG2 | VAL | 353 | 32.929 | 16.222 | 92.803 | 1.00 | 96.29 |
| ATOM | 1916 | C | VAL | 353 | 32.962 | 18.832 | 95.531 | 1.00 | 96.29 |
| ATOM | 1917 | O | VAL | 353 | 32.568 | 18.665 | 96.685 | 1.00 | 96.29 |
| ATOM | 1918 | N | TYR | 354 | 33.900 | 19.743 | 95.213 | 1.00 | 110.82 |
| ATOM | 1919 | CA | TYR | 354 | 34.573 | 20.510 | 96.218 | 1.00 | 110.82 |
| ATOM | 1920 | CB | TYR | 354 | 35.752 | 21.329 | 95.661 | 1.00 | 110.82 |
| ATOM | 1921 | CG | TYR | 354 | 36.565 | 21.799 | 96.822 | 1.00 | 110.82 |
| ATOM | 1922 | CD1 | TYR | 354 | 37.557 | 20.991 | 97.328 | 1.00 | 110.82 |
| ATOM | 1923 | CD2 | TYR | 354 | 36.350 | 23.026 | 97.405 | 1.00 | 110.82 |
| ATOM | 1924 | CE1 | TYR | 354 | 38.322 | 21.393 | 98.396 | 1.00 | 110.82 |
| ATOM | 1925 | CE2 | TYR | 354 | 37.114 | 23.435 | 98.475 | 1.00 | 110.82 |
| ATOM | 1926 | CZ | TYR | 354 | 38.103 | 22.620 | 98.972 | 1.00 | 110.82 |
| ATOM | 1927 | OH | TYR | 354 | 38.887 | 23.040 | 100.067 | 1.00 | 110.82 |
| ATOM | 1928 | C | TYR | 354 | 33.630 | 21.476 | 96.875 | 1.00 | 110.82 |
| ATOM | 1929 | O | TYR | 354 | 33.613 | 21.591 | 98.099 | 1.00 | 110.82 |
| ATOM | 1930 | N | THR | 355 | 32.796 | 22.186 | 96.086 | 1.00 | 255.20 |
| ATOM | 1931 | CA | THR | 355 | 31.997 | 23.218 | 96.692 | 1.00 | 255.20 |
| ATOM | 1932 | CB | THR | 355 | 32.495 | 24.598 | 96.375 | 1.00 | 255.20 |
| ATOM | 1933 | OG1 | THR | 355 | 32.426 | 24.834 | 94.975 | 1.00 | 255.20 |
| ATOM | 1934 | CG2 | THR | 355 | 33.950 | 24.725 | 96.861 | 1.00 | 255.20 |
| ATOM | 1935 | C | THR | 355 | 30.593 | 23.148 | 96.186 | 1.00 | 255.20 |
| ATOM | 1936 | O | THR | 355 | 30.144 | 22.125 | 95.686 | 1.00 | 255.20 |
| ATOM | 1937 | N | PHE | 356 | 29.847 | 24.257 | 96.373 | 1.00 | 322.17 |
| ATOM | 1938 | CA | PHE | 356 | 28.493 | 24.408 | 95.916 | 1.00 | 322.17 |
| ATOM | 1939 | CB | PHE | 356 | 27.639 | 25.183 | 96.950 | 1.00 | 322.17 |
| ATOM | 1940 | CG | PHE | 356 | 26.183 | 25.190 | 96.604 | 1.00 | 322.17 |
| ATOM | 1941 | CD1 | PHE | 356 | 25.653 | 26.176 | 95.805 | 1.00 | 322.17 |
| ATOM | 1942 | CD2 | PHE | 356 | 25.329 | 24.227 | 97.092 | 1.00 | 322.17 |
| ATOM | 1943 | CE1 | PHE | 356 | 24.315 | 26.192 | 95.485 | 1.00 | 322.17 |
| ATOM | 1944 | CE2 | PHE | 356 | 23.992 | 24.232 | 96.779 | 1.00 | 322.17 |
| ATOM | 1945 | CZ | PHE | 356 | 23.478 | 25.217 | 95.971 | 1.00 | 322.17 |
| ATOM | 1946 | C | PHE | 356 | 28.646 | 25.273 | 94.705 | 1.00 | 322.17 |
| ATOM | 1947 | O | PHE | 356 | 29.539 | 26.119 | 94.691 | 1.00 | 322.17 |
| ATOM | 1948 | N | PHE | 357 | 27.836 | 25.084 | 93.637 | 1.00 | 120.88 |
| ATOM | 1949 | CA | PHE | 357 | 28.089 | 25.979 | 92.549 | 1.00 | 120.88 |
| ATOM | 1950 | CB | PHE | 357 | 27.319 | 25.680 | 91.245 | 1.00 | 120.88 |
| ATOM | 1951 | CG | PHE | 357 | 25.892 | 26.079 | 91.379 | 1.00 | 120.88 |
| ATOM | 1952 | CD1 | PHE | 357 | 25.525 | 27.364 | 91.063 | 1.00 | 120.88 |
| ATOM | 1953 | CD2 | PHE | 357 | 24.931 | 25.194 | 91.801 | 1.00 | 120.88 |
| ATOM | 1954 | CE1 | PHE | 357 | 24.219 | 27.770 | 91.167 | 1.00 | 120.88 |
| ATOM | 1955 | CE2 | PHE | 357 | 23.623 | 25.607 | 91.904 | 1.00 | 120.88 |
| ATOM | 1956 | CZ | PHE | 357 | 23.257 | 26.891 | 91.590 | 1.00 | 120.88 |
| ATOM | 1957 | C | PHE | 357 | 27.698 | 27.319 | 93.070 | 1.00 | 120.88 |
| ATOM | 1958 | O | PHE | 357 | 26.608 | 27.501 | 93.610 | 1.00 | 120.88 |
| ATOM | 1959 | N | LYS | 358 | 28.604 | 28.300 | 92.942 | 1.00 | 147.15 |
| ATOM | 1960 | CA | LYS | 358 | 28.329 | 29.562 | 93.552 | 1.00 | 147.15 |
| ATOM | 1961 | CB | LYS | 358 | 29.297 | 29.904 | 94.692 | 1.00 | 147.15 |
| ATOM | 1962 | CG | LYS | 358 | 30.771 | 29.744 | 94.321 | 1.00 | 147.15 |
| ATOM | 1963 | CD | LYS | 358 | 31.733 | 30.473 | 95.261 | 1.00 | 147.15 |
| ATOM | 1964 | CE | LYS | 358 | 31.409 | 30.288 | 96.743 | 1.00 | 147.15 |
| ATOM | 1965 | NZ | LYS | 358 | 30.264 | 31.151 | 97.126 | 1.00 | 147.15 |
| ATOM | 1966 | C | LYS | 358 | 28.429 | 30.643 | 92.538 | 1.00 | 147.15 |
| ATOM | 1967 | O | LYS | 358 | 28.609 | 30.394 | 91.347 | 1.00 | 147.15 |
| ATOM | 1968 | N | PHE | 359 | 28.283 | 31.889 | 93.022 | 1.00 | 116.80 |
| ATOM | 1969 | CA | PHE | 359 | 28.319 | 33.059 | 92.206 | 1.00 | 116.80 |
| ATOM | 1970 | CB | PHE | 359 | 27.859 | 34.340 | 92.937 | 1.00 | 116.80 |
| ATOM | 1971 | CG | PHE | 359 | 28.713 | 34.619 | 94.120 | 1.00 | 116.80 |
| ATOM | 1972 | CD1 | PHE | 359 | 28.456 | 34.001 | 95.325 | 1.00 | 116.80 |
| ATOM | 1973 | CD2 | PHE | 359 | 29.767 | 35.498 | 94.036 | 1.00 | 116.80 |
| ATOM | 1974 | CE1 | PHE | 359 | 29.237 | 34.255 | 96.427 | 1.00 | 116.80 |
| ATOM | 1975 | CE2 | PHE | 359 | 30.549 | 35.757 | 95.135 | 1.00 | 116.80 |
| ATOM | 1976 | CZ | PHE | 359 | 30.285 | 35.136 | 96.333 | 1.00 | 116.80 |
| ATOM | 1977 | C | PHE | 359 | 29.687 | 33.211 | 91.623 | 1.00 | 116.80 |
| ATOM | 1978 | O | PHE | 359 | 29.829 | 33.701 | 90.505 | 1.00 | 116.80 |
| ATOM | 1979 | N | LEU | 360 | 30.742 | 32.806 | 92.360 | 1.00 | 80.96 |
| ATOM | 1980 | CA | LEU | 360 | 32.057 | 32.919 | 91.795 | 1.00 | 80.96 |
| ATOM | 1981 | CB | LEU | 360 | 33.203 | 32.471 | 92.725 | 1.00 | 80.96 |
| ATOM | 1982 | CG | LEU | 360 | 33.432 | 33.416 | 93.923 | 1.00 | 80.96 |
| ATOM | 1983 | CD2 | LEU | 360 | 34.798 | 33.177 | 94.586 | 1.00 | 80.96 |
| ATOM | 1984 | CD1 | LEU | 360 | 32.260 | 33.365 | 94.915 | 1.00 | 80.96 |
| ATOM | 1985 | C | LEU | 360 | 32.093 | 32.064 | 90.567 | 1.00 | 80.96 |
| ATOM | 1986 | O | LEU | 360 | 32.682 | 32.447 | 89.557 | 1.00 | 80.96 |
| ATOM | 1987 | N | ALA | 361 | 31.450 | 30.882 | 90.622 | 1.00 | 33.90 |
| ATOM | 1988 | CA | ALA | 361 | 31.404 | 30.015 | 89.480 | 1.00 | 33.90 |
| ATOM | 1989 | CB | ALA | 361 | 30.636 | 28.711 | 89.746 | 1.00 | 33.90 |
| ATOM | 1990 | C | ALA | 361 | 30.683 | 30.761 | 88.399 | 1.00 | 33.90 |
| ATOM | 1991 | O | ALA | 361 | 31.024 | 30.680 | 87.220 | 1.00 | 33.90 |
| ATOM | 1992 | N | ASP | 362 | 29.652 | 31.531 | 88.776 | 1.00 | 92.51 |
| ATOM | 1993 | CA | ASP | 362 | 28.901 | 32.266 | 87.801 | 1.00 | 92.51 |
| ATOM | 1994 | CB | ASP | 362 | 27.776 | 33.095 | 88.461 | 1.00 | 92.51 |
| ATOM | 1995 | CG | ASP | 362 | 26.929 | 33.822 | 87.417 | 1.00 | 92.51 |
| ATOM | 1996 | OD1 | ASP | 362 | 27.501 | 34.539 | 86.554 | 1.00 | 92.51 |
| ATOM | 1997 | OD2 | ASP | 362 | 25.681 | 33.659 | 87.473 | 1.00 | 92.51 |
| ATOM | 1998 | C | ASP | 362 | 29.829 | 33.214 | 87.101 | 1.00 | 92.51 |
| ATOM | 1999 | O | ASP | 362 | 29.778 | 33.357 | 85.880 | 1.00 | 92.51 |
| ATOM | 2000 | N | LYS | 363 | 30.713 | 33.889 | 87.858 | 1.00 | 102.78 |
| ATOM | 2001 | CA | LYS | 363 | 31.580 | 34.866 | 87.261 | 1.00 | 102.78 |
| ATOM | 2002 | CB | LYS | 363 | 32.441 | 35.585 | 88.315 | 1.00 | 102.78 |
| ATOM | 2003 | CG | LYS | 363 | 33.389 | 36.645 | 87.750 | 1.00 | 102.78 |
| ATOM | 2004 | CD | LYS | 363 | 33.968 | 37.566 | 88.828 | 1.00 | 102.78 |
| ATOM | 2005 | CE | LYS | 363 | 35.188 | 38.365 | 88.370 | 1.00 | 102.78 |
| ATOM | 2006 | NZ | LYS | 363 | 36.386 | 37.488 | 88.348 | 1.00 | 102.78 |
| ATOM | 2007 | C | LYS | 363 | 32.496 | 34.220 | 86.264 | 1.00 | 102.78 |
| ATOM | 2008 | O | LYS | 363 | 32.609 | 34.680 | 85.129 | 1.00 | 102.78 |
| ATOM | 2009 | N | LYS | 364 | 33.170 | 33.120 | 86.648 | 1.00 | 86.80 |
| ATOM | 2010 | CA | LYS | 364 | 34.086 | 32.497 | 85.736 | 1.00 | 86.80 |
| ATOM | 2011 | CB | LYS | 364 | 35.057 | 31.490 | 86.379 | 1.00 | 86.80 |
| ATOM | 2012 | CG | LYS | 364 | 36.209 | 32.158 | 87.136 | 1.00 | 86.80 |
| ATOM | 2013 | CD | LYS | 364 | 37.021 | 31.212 | 88.023 | 1.00 | 86.80 |
| ATOM | 2014 | CE | LYS | 364 | 36.440 | 31.043 | 89.428 | 1.00 | 86.80 |
| ATOM | 2015 | NZ | LYS | 364 | 37.385 | 30.291 | 90.284 | 1.00 | 86.80 |
| ATOM | 2016 | C | LYS | 364 | 33.344 | 31.863 | 84.602 | 1.00 | 86.80 |
| ATOM | 2017 | O | LYS | 364 | 33.873 | 31.749 | 83.498 | 1.00 | 86.80 |
| ATOM | 2018 | N | MET | 365 | 32.092 | 31.429 | 84.831 | 1.00 | 53.49 |
| ATOM | 2019 | CA | MET | 365 | 31.359 | 30.755 | 83.796 | 1.00 | 53.49 |
| ATOM | 2020 | CB | MET | 365 | 29.982 | 30.264 | 84.255 | 1.00 | 53.49 |
| ATOM | 2021 | CG | MET | 365 | 29.226 | 29.461 | 83.196 | 1.00 | 53.49 |
| ATOM | 2022 | SD | MET | 365 | 29.905 | 27.805 | 82.885 | 1.00 | 53.49 |
| ATOM | 2023 | CE | MET | 365 | 28.617 | 27.319 | 81.701 | 1.00 | 53.49 |
| ATOM | 2024 | C | MET | 365 | 31.170 | 31.664 | 82.625 | 1.00 | 53.49 |
| ATOM | 2025 | O | MET | 365 | 31.208 | 31.220 | 81.478 | 1.00 | 53.49 |
| ATOM | 2026 | N | THR | 366 | 30.951 | 32.966 | 82.866 | 1.00 | 70.35 |
| ATOM | 2027 | CA | THR | 366 | 30.705 | 33.792 | 81.730 | 1.00 | 70.35 |
| ATOM | 2028 | CB | THR | 366 | 30.255 | 35.162 | 82.075 | 1.00 | 70.35 |
| ATOM | 2029 | OG1 | THR | 366 | 29.230 | 35.112 | 83.058 | 1.00 | 70.35 |
| ATOM | 2030 | CG2 | THR | 366 | 29.616 | 35.667 | 80.778 | 1.00 | 70.35 |
| ATOM | 2031 | C | THR | 366 | 31.948 | 33.865 | 80.887 | 1.00 | 70.35 |
| ATOM | 2032 | O | THR | 366 | 31.868 | 33.895 | 79.660 | 1.00 | 70.35 |
| ATOM | 2033 | N | LEU | 367 | 33.136 | 33.919 | 81.526 | 1.00 | 81.70 |
| ATOM | 2034 | CA | LEU | 367 | 34.382 | 33.971 | 80.809 | 1.00 | 81.70 |
| ATOM | 2035 | CB | LEU | 367 | 35.609 | 34.150 | 81.721 | 1.00 | 81.70 |
| ATOM | 2036 | CG | LEU | 367 | 35.688 | 35.525 | 82.413 | 1.00 | 81.70 |
| ATOM | 2037 | CD2 | LEU | 367 | 37.070 | 35.740 | 83.050 | 1.00 | 81.70 |
| ATOM | 2038 | CD1 | LEU | 367 | 34.531 | 35.733 | 83.400 | 1.00 | 81.70 |
| ATOM | 2039 | C | LEU | 367 | 34.564 | 32.683 | 80.071 | 1.00 | 81.70 |
| ATOM | 2040 | O | LEU | 367 | 35.063 | 32.663 | 78.947 | 1.00 | 81.70 |
| ATOM | 2041 | N | PHE | 368 | 34.163 | 31.566 | 80.708 | 1.00 | 59.75 |
| ATOM | 2042 | CA | PHE | 368 | 34.302 | 30.249 | 80.153 | 1.00 | 59.75 |
| ATOM | 2043 | CB | PHE | 368 | 33.778 | 29.185 | 81.136 | 1.00 | 59.75 |
| ATOM | 2044 | CG | PHE | 368 | 33.868 | 27.826 | 80.529 | 1.00 | 59.75 |
| ATOM | 2045 | CD1 | PHE | 368 | 35.075 | 27.174 | 80.426 | 1.00 | 59.75 |
| ATOM | 2046 | CD2 | PHE | 368 | 32.731 | 27.191 | 80.091 | 1.00 | 59.75 |
| ATOM | 2047 | CE1 | PHE | 368 | 35.143 | 25.915 | 79.873 | 1.00 | 59.75 |
| ATOM | 2048 | CE2 | PHE | 368 | 32.792 | 25.932 | 79.538 | 1.00 | 59.75 |
| ATOM | 2049 | CZ | PHE | 368 | 34.003 | 25.293 | 79.427 | 1.00 | 59.75 |
| ATOM | 2050 | C | PHE | 368 | 33.512 | 30.169 | 78.886 | 1.00 | 59.75 |
| ATOM | 2051 | O | PHE | 368 | 34.011 | 29.728 | 77.853 | 1.00 | 59.75 |
| ATOM | 2052 | N | LYS | 369 | 32.250 | 30.623 | 78.918 | 1.00 | 110.95 |
| ATOM | 2053 | CA | LYS | 369 | 31.446 | 30.530 | 77.736 | 1.00 | 110.95 |
| ATOM | 2054 | CB | LYS | 369 | 30.015 | 31.029 | 77.952 | 1.00 | 110.95 |
| ATOM | 2055 | CG | LYS | 369 | 29.190 | 30.880 | 76.683 | 1.00 | 110.95 |
| ATOM | 2056 | CD | LYS | 369 | 27.688 | 30.943 | 76.907 | 1.00 | 110.95 |
| ATOM | 2057 | CE | LYS | 369 | 26.937 | 30.514 | 75.656 | 1.00 | 110.95 |
| ATOM | 2058 | NZ | LYS | 369 | 27.482 | 29.223 | 75.183 | 1.00 | 110.95 |
| ATOM | 2059 | C | LYS | 369 | 32.063 | 31.367 | 76.659 | 1.00 | 110.95 |
| ATOM | 2060 | O | LYS | 369 | 32.098 | 30.975 | 75.494 | 1.00 | 110.95 |
| ATOM | 2061 | N | SER | 370 | 32.579 | 32.549 | 77.028 | 1.00 | 75.96 |
| ATOM | 2062 | CA | SER | 370 | 33.162 | 33.448 | 76.078 | 1.00 | 75.96 |
| ATOM | 2063 | CB | SER | 370 | 33.710 | 34.714 | 76.757 | 1.00 | 75.96 |
| ATOM | 2064 | OG | SER | 370 | 34.387 | 35.523 | 75.810 | 1.00 | 75.96 |
| ATOM | 2065 | C | SER | 370 | 34.315 | 32.775 | 75.399 | 1.00 | 75.96 |
| ATOM | 2066 | O | SER | 370 | 34.474 | 32.884 | 74.184 | 1.00 | 75.96 |
| ATOM | 2067 | N | ILE | 371 | 35.154 | 32.052 | 76.163 | 1.00 | 124.77 |
| ATOM | 2068 | CA | ILE | 371 | 36.307 | 31.439 | 75.569 | 1.00 | 124.77 |
| ATOM | 2069 | CB | ILE | 371 | 37.271 | 30.824 | 76.546 | 1.00 | 124.77 |
| ATOM | 2070 | CG2 | ILE | 371 | 36.641 | 29.548 | 77.119 | 1.00 | 124.77 |
| ATOM | 2071 | CG1 | ILE | 371 | 38.620 | 30.560 | 75.853 | 1.00 | 124.77 |
| ATOM | 2072 | CD1 | ILE | 371 | 39.348 | 31.834 | 75.428 | 1.00 | 124.77 |
| ATOM | 2073 | C | ILE | 371 | 35.882 | 30.387 | 74.597 | 1.00 | 124.77 |
| ATOM | 2074 | O | ILE | 371 | 36.477 | 30.250 | 73.530 | 1.00 | 124.77 |
| ATOM | 2075 | N | LEU | 372 | 34.838 | 29.605 | 74.927 | 1.00 | 105.73 |
| ATOM | 2076 | CA | LEU | 372 | 34.451 | 28.565 | 74.019 | 1.00 | 105.73 |
| ATOM | 2077 | CB | LEU | 372 | 33.292 | 27.682 | 74.510 | 1.00 | 105.73 |
| ATOM | 2078 | CG | LEU | 372 | 33.737 | 26.614 | 75.522 | 1.00 | 105.73 |
| ATOM | 2079 | CD2 | LEU | 372 | 32.585 | 25.650 | 75.845 | 1.00 | 105.73 |
| ATOM | 2080 | CD1 | LEU | 372 | 34.372 | 27.235 | 76.772 | 1.00 | 105.73 |
| ATOM | 2081 | C | LEU | 372 | 34.060 | 29.165 | 72.714 | 1.00 | 105.73 |
| ATOM | 2082 | O | LEU | 372 | 34.364 | 28.606 | 71.662 | 1.00 | 105.73 |
| ATOM | 2083 | N | PHE | 373 | 33.365 | 30.314 | 72.732 | 1.00 | 64.70 |
| ATOM | 2084 | CA | PHE | 373 | 32.945 | 30.855 | 71.478 | 1.00 | 64.70 |
| ATOM | 2085 | CB | PHE | 373 | 31.996 | 32.050 | 71.593 | 1.00 | 64.70 |
| ATOM | 2086 | CG | PHE | 373 | 31.471 | 32.113 | 70.211 | 1.00 | 64.70 |
| ATOM | 2087 | CD1 | PHE | 373 | 30.661 | 31.089 | 69.784 | 1.00 | 64.70 |
| ATOM | 2088 | CD2 | PHE | 373 | 31.779 | 33.147 | 69.361 | 1.00 | 64.70 |
| ATOM | 2089 | CE1 | PHE | 373 | 30.154 | 31.086 | 68.513 | 1.00 | 64.70 |
| ATOM | 2090 | CE2 | PHE | 373 | 31.269 | 33.146 | 68.086 | 1.00 | 64.70 |
| ATOM | 2091 | CZ | PHE | 373 | 30.458 | 32.118 | 67.664 | 1.00 | 64.70 |
| ATOM | 2092 | C | PHE | 373 | 34.131 | 31.280 | 70.664 | 1.00 | 64.70 |
| ATOM | 2093 | O | PHE | 373 | 34.206 | 30.989 | 69.472 | 1.00 | 64.70 |
| ATOM | 2094 | N | ASN | 374 | 35.105 | 31.971 | 71.286 | 1.00 | 35.72 |
| ATOM | 2095 | CA | ASN | 374 | 36.247 | 32.451 | 70.559 | 1.00 | 35.72 |
| ATOM | 2096 | CB | ASN | 374 | 37.207 | 33.269 | 71.437 | 1.00 | 35.72 |
| ATOM | 2097 | CG | ASN | 374 | 36.483 | 34.537 | 71.865 | 1.00 | 35.72 |
| ATOM | 2098 | OD1 | ASN | 374 | 35.692 | 35.105 | 71.114 | 1.00 | 35.72 |
| ATOM | 2099 | ND2 | ASN | 374 | 36.758 | 34.995 | 73.115 | 1.00 | 35.72 |
| ATOM | 2100 | C | ASN | 374 | 37.011 | 31.277 | 70.026 | 1.00 | 35.72 |
| ATOM | 2101 | O | ASN | 374 | 37.540 | 31.315 | 68.917 | 1.00 | 35.72 |
| ATOM | 2102 | N | LEU | 375 | 37.099 | 30.205 | 70.833 | 1.00 | 138.95 |
| ATOM | 2103 | CA | LEU | 375 | 37.815 | 29.003 | 70.512 | 1.00 | 138.95 |
| ATOM | 2104 | CB | LEU | 375 | 37.964 | 28.066 | 71.731 | 1.00 | 138.95 |
| ATOM | 2105 | CG | LEU | 375 | 38.995 | 26.926 | 71.570 | 1.00 | 138.95 |
| ATOM | 2106 | CD2 | LEU | 375 | 40.379 | 27.498 | 71.223 | 1.00 | 138.95 |
| ATOM | 2107 | CD1 | LEU | 375 | 38.548 | 25.833 | 70.589 | 1.00 | 138.95 |
| ATOM | 2108 | C | LEU | 375 | 37.093 | 28.291 | 69.406 | 1.00 | 138.95 |
| ATOM | 2109 | O | LEU | 375 | 37.711 | 27.552 | 68.641 | 1.00 | 138.95 |
| ATOM | 2110 | N | HIS | 376 | 35.766 | 28.517 | 69.292 | 1.00 | 123.01 |
| ATOM | 2111 | CA | HIS | 376 | 34.901 | 27.828 | 68.370 | 1.00 | 123.01 |
| ATOM | 2112 | ND1 | HIS | 376 | 36.992 | 27.064 | 65.722 | 1.00 | 123.01 |
| ATOM | 2113 | CG | HIS | 376 | 36.407 | 28.177 | 66.282 | 1.00 | 123.01 |
| ATOM | 2114 | CB | HIS | 376 | 35.031 | 28.206 | 66.871 | 1.00 | 123.01 |
| ATOM | 2115 | NE2 | HIS | 376 | 38.477 | 28.713 | 65.561 | 1.00 | 123.01 |
| ATOM | 2116 | CD2 | HIS | 376 | 37.327 | 29.175 | 66.176 | 1.00 | 123.01 |
| ATOM | 2117 | CE1 | HIS | 376 | 38.228 | 27.440 | 65.307 | 1.00 | 123.01 |
| ATOM | 2118 | C | HIS | 376 | 35.014 | 26.360 | 68.605 | 1.00 | 123.01 |
| ATOM | 2119 | O | HIS | 376 | 35.402 | 25.581 | 67.735 | 1.00 | 123.01 |
| ATOM | 2120 | N | ASP | 377 | 34.645 | 25.976 | 69.845 | 1.00 | 65.93 |
| ATOM | 2121 | CA | ASP | 377 | 34.668 | 24.635 | 70.353 | 1.00 | 65.93 |
| ATOM | 2122 | CB | ASP | 377 | 34.286 | 24.519 | 71.842 | 1.00 | 65.93 |
| ATOM | 2123 | CG | ASP | 377 | 35.531 | 24.786 | 72.676 | 1.00 | 65.93 |
| ATOM | 2124 | OD1 | ASP | 377 | 36.651 | 24.598 | 72.132 | 1.00 | 65.93 |
| ATOM | 2125 | OD2 | ASP | 377 | 35.380 | 25.159 | 73.869 | 1.00 | 65.93 |
| ATOM | 2126 | C | ASP | 377 | 33.737 | 23.760 | 69.578 | 1.00 | 65.93 |
| ATOM | 2127 | O | ASP | 377 | 33.945 | 22.551 | 69.506 | 1.00 | 65.93 |
| ATOM | 2128 | N | LEU | 378 | 32.671 | 24.325 | 68.988 | 1.00 | 87.86 |
| ATOM | 2129 | CA | LEU | 378 | 31.748 | 23.489 | 68.277 | 1.00 | 87.86 |
| ATOM | 2130 | CB | LEU | 378 | 30.589 | 24.271 | 67.642 | 1.00 | 87.86 |
| ATOM | 2131 | CG | LEU | 378 | 29.593 | 24.813 | 68.680 | 1.00 | 87.86 |
| ATOM | 2132 | CD2 | LEU | 378 | 30.294 | 25.697 | 69.726 | 1.00 | 87.86 |
| ATOM | 2133 | CD1 | LEU | 378 | 28.792 | 23.673 | 69.319 | 1.00 | 87.86 |
| ATOM | 2134 | C | LEU | 378 | 32.477 | 22.779 | 67.182 | 1.00 | 87.86 |
| ATOM | 2135 | O | LEU | 378 | 32.211 | 21.606 | 66.929 | 1.00 | 87.86 |
| ATOM | 2136 | N | SER | 379 | 33.403 | 23.460 | 66.483 | 1.00 | 17.91 |
| ATOM | 2137 | CA | SER | 379 | 34.122 | 22.754 | 65.465 | 1.00 | 17.91 |
| ATOM | 2138 | CB | SER | 379 | 34.647 | 23.656 | 64.331 | 1.00 | 17.91 |
| ATOM | 2139 | OG | SER | 379 | 35.608 | 24.576 | 64.827 | 1.00 | 17.91 |
| ATOM | 2140 | C | SER | 379 | 35.317 | 22.106 | 66.145 | 1.00 | 17.91 |
| ATOM | 2141 | O | SER | 379 | 36.181 | 22.858 | 66.669 | 1.00 | 17.91 |
| ATOM | 2142 | OXT | SER | 379 | 35.380 | 20.848 | 66.153 | 1.00 | 17.91 |
| END | | | | | | | | | |

TABLE 3

| REMARK | 4 | | | | | | | |
|---|---|---|---|---|---|---|---|---|
| REMARK | TTP-A Computed low-energy docking mode-1 | | | | | | | |
| REMARK | Free Energy of Binding = −11.24 kcal/mol | | | | | | | |
| ATOM | 1 | C9 | MOL | 1 | 14.331 | 35.024 | 76.250 | −0.49 |
| ATOM | 2 | C4 | MOL | 1 | 15.175 | 35.446 | 77.272 | −0.50 |
| ATOM | 3 | C12 | MOL | 1 | 14.648 | 35.356 | 74.948 | −0.41 |
| ATOM | 4 | C1 | MOL | 1 | 16.340 | 36.195 | 77.047 | −0.52 |
| ATOM | 5 | C3 | MOL | 1 | 16.661 | 36.522 | 75.696 | −0.49 |
| ATOM | 6 | C7 | MOL | 1 | 15.793 | 36.088 | 74.698 | −0.42 |
| ATOM | 7 | C14 | MOL | 1 | 13.069 | 34.215 | 76.522 | −0.35 |
| ATOM | 8 | C16 | MOL | 1 | 12.147 | 35.063 | 77.449 | −0.61 |
| ATOM | 9 | N17 | MOL | 1 | 10.746 | 34.939 | 77.134 | −0.19 |
| ATOM | 10 | H17 | MOL | 1 | 10.090 | 34.523 | 77.810 | −0.19 |
| ATOM | 11 | C18 | MOL | 1 | 10.294 | 35.400 | 75.880 | −0.47 |
| ATOM | 12 | O20 | MOL | 1 | 11.112 | 35.909 | 75.103 | +0.04 |
| ATOM | 13 | C19 | MOL | 1 | 8.875 | 35.299 | 75.453 | −0.39 |
| ATOM | 14 | C22 | MOL | 1 | 8.475 | 34.568 | 74.332 | −0.31 |
| ATOM | 15 | O25 | MOL | 1 | 9.402 | 33.882 | 73.533 | −0.10 |
| ATOM | 16 | H25 | MOL | 1 | 9.655 | 33.026 | 73.978 | −0.14 |
| ATOM | 17 | C24 | MOL | 1 | 7.129 | 34.514 | 73.990 | −0.26 |
| ATOM | 18 | C30 | MOL | 1 | 3.884 | 35.791 | 75.169 | −0.09 |
| ATOM | 19 | C28 | MOL | 1 | 4.833 | 35.121 | 74.403 | −0.13 |
| ATOM | 20 | C27 | MOL | 1 | 5.623 | 36.575 | 76.636 | −0.25 |
| ATOM | 21 | C29 | MOL | 1 | 4.281 | 36.517 | 76.287 | −0.15 |
| ATOM | 22 | C26 | MOL | 1 | 6.177 | 35.180 | 74.753 | −0.18 |
| ATOM | 23 | C23 | MOL | 1 | 6.572 | 35.908 | 75.868 | −0.27 |
| ATOM | 24 | C21 | MOL | 1 | 7.916 | 35.963 | 76.214 | −0.39 |
| ATOM | 25 | C2 | MOL | 1 | 17.063 | 36.529 | 78.390 | −0.54 |
| ATOM | 26 | C6 | MOL | 1 | 17.552 | 35.601 | 79.301 | −0.75 |
| ATOM | 27 | C11 | MOL | 1 | 18.194 | 35.978 | 80.472 | −0.84 |
| ATOM | 28 | C15 | MOL | 1 | 18.364 | 37.322 | 80.761 | −0.83 |
| ATOM | 29 | N1 | MOL | 1 | 19.005 | 37.698 | 81.944 | −0.59 |
| ATOM | 30 | O2 | MOL | 1 | 18.437 | 38.366 | 82.727 | −0.29 |
| ATOM | 31 | O3 | MOL | 1 | 20.246 | 37.308 | 82.183 | −0.77 |
| ATOM | 32 | C10 | MOL | 1 | 17.889 | 38.277 | 79.867 | −0.73 |
| ATOM | 33 | C5 | MOL | 1 | 17.251 | 37.877 | 78.694 | −0.60 |
| ATOM | 34 | O8 | MOL | 1 | 17.778 | 37.255 | 75.046 | +0.02 |
| ATOM | 35 | C13 | MOL | 1 | 17.743 | 38.555 | 74.504 | −0.36 |
| END | | | | | | | | |
| REMARK | TTP-A Computed low-energy docking mode-2 | | | | | | | |
| REMARK | Free Energy of Binding = −11.24 kcal/mol | | | | | | | |
| ATOM | 1 | C9 | MOL | 2 | 14.546 | 35.957 | 75.646 | −0.41 |
| ATOM | 2 | C4 | MOL | 2 | 15.319 | 36.210 | 76.776 | −0.43 |
| ATOM | 3 | C12 | MOL | 2 | 14.848 | 36.618 | 74.473 | −0.33 |
| ATOM | 4 | C1 | MOL | 2 | 16.397 | 37.106 | 76.783 | −0.49 |
| ATOM | 5 | C3 | MOL | 2 | 16.705 | 37.776 | 75.560 | −0.43 |
| ATOM | 6 | C7 | MOL | 2 | 15.909 | 37.503 | 74.451 | −0.35 |
| ATOM | 7 | C14 | MOL | 2 | 13.377 | 34.979 | 75.667 | −0.40 |
| ATOM | 8 | C16 | MOL | 2 | 12.063 | 35.802 | 75.507 | −0.40 |
| ATOM | 9 | N17 | MOL | 2 | 10.877 | 34.985 | 75.452 | −0.12 |
| ATOM | 10 | H17 | MOL | 2 | 10.840 | 34.151 | 74.849 | +0.28 |
| ATOM | 11 | C18 | MOL | 2 | 9.769 | 35.352 | 76.244 | −0.52 |
| ATOM | 12 | O20 | MOL | 2 | 9.861 | 36.351 | 76.969 | −0.12 |
| ATOM | 13 | C19 | MOL | 2 | 8.495 | 34.588 | 76.243 | −0.49 |
| ATOM | 14 | C22 | MOL | 2 | 7.581 | 34.648 | 75.187 | −0.31 |
| ATOM | 15 | O25 | MOL | 2 | 7.816 | 35.443 | 74.057 | +0.13 |
| ATOM | 16 | H25 | MOL | 2 | 8.798 | 35.512 | 73.896 | +0.11 |
| ATOM | 17 | C24 | MOL | 2 | 6.408 | 33.905 | 75.251 | −0.29 |
| ATOM | 18 | C30 | MOL | 2 | 4.690 | 31.567 | 77.516 | −0.33 |
| ATOM | 19 | C28 | MOL | 2 | 4.959 | 32.366 | 76.409 | −0.31 |
| ATOM | 20 | C27 | MOL | 2 | 6.774 | 32.243 | 78.510 | −0.59 |
| ATOM | 21 | C29 | MOL | 2 | 5.599 | 31.506 | 78.566 | −0.47 |
| ATOM | 22 | C26 | MOL | 2 | 6.135 | 33.104 | 76.354 | −0.36 |
| ATOM | 23 | C23 | MOL | 2 | 7.042 | 33.044 | 77.405 | −0.54 |
| ATOM | 24 | C21 | MOL | 2 | 8.216 | 33.783 | 77.344 | −0.53 |
| ATOM | 25 | C2 | MOL | 2 | 17.054 | 37.186 | 78.197 | −0.46 |
| ATOM | 26 | C6 | MOL | 2 | 17.338 | 36.106 | 79.022 | −0.65 |
| ATOM | 27 | C11 | MOL | 2 | 17.934 | 36.258 | 80.266 | −0.82 |
| ATOM | 28 | C15 | MOL | 2 | 18.266 | 37.524 | 80.719 | −0.82 |
| ATOM | 29 | N1 | MOL | 2 | 18.860 | 37.674 | 81.974 | −0.55 |
| ATOM | 30 | O2 | MOL | 2 | 18.306 | 38.286 | 82.812 | −0.23 |
| ATOM | 31 | O3 | MOL | 2 | 20.042 | 37.134 | 82.222 | −0.76 |
| ATOM | 32 | C10 | MOL | 2 | 17.999 | 38.628 | 79.915 | −0.61 |
| ATOM | 33 | C5 | MOL | 2 | 17.404 | 38.452 | 78.666 | −0.61 |
| ATOM | 34 | O8 | MOL | 2 | 17.746 | 38.753 | 75.149 | +0.00 |
| ATOM | 35 | C13 | MOL | 2 | 17.705 | 40.154 | 75.297 | −0.29 |
| END | | | | | | | | |
| REMARK | TTP-A Computed low-energy docking mode-3 | | | | | | | |
| REMARK | Free Energy of Binding = −11.24 kcal/mol | | | | | | | |
| ATOM | 1 | C9 | MOL | 3 | 17.997 | 38.677 | 73.823 | −0.35 |
| ATOM | 2 | C4 | MOL | 3 | 17.513 | 37.647 | 74.624 | −0.35 |
| ATOM | 3 | C12 | MOL | 3 | 18.452 | 39.831 | 74.429 | −0.29 |
| ATOM | 4 | C1 | MOL | 3 | 17.465 | 37.720 | 76.024 | −0.42 |
| ATOM | 5 | C3 | MOL | 3 | 17.948 | 38.915 | 76.638 | −0.44 |
| ATOM | 6 | C7 | MOL | 3 | 18.421 | 39.927 | 75.807 | −0.39 |
| ATOM | 7 | C14 | MOL | 3 | 18.036 | 38.573 | 72.304 | −0.34 |
| ATOM | 8 | C16 | MOL | 3 | 16.629 | 38.966 | 71.761 | −0.19 |
| ATOM | 9 | N17 | MOL | 3 | 15.601 | 38.008 | 72.082 | −0.28 |
| ATOM | 10 | H17 | MOL | 3 | 15.740 | 37.005 | 71.896 | −0.22 |
| ATOM | 11 | C18 | MOL | 3 | 14.401 | 38.475 | 72.657 | −0.15 |
| ATOM | 12 | O20 | MOL | 3 | 14.280 | 39.687 | 72.881 | +0.17 |
| ATOM | 13 | C19 | MOL | 3 | 13.274 | 37.571 | 73.004 | −0.17 |
| ATOM | 14 | C22 | MOL | 3 | 12.524 | 36.896 | 72.038 | −0.16 |
| ATOM | 15 | O25 | MOL | 3 | 12.793 | 37.037 | 70.669 | +0.18 |
| ATOM | 16 | H25 | MOL | 3 | 13.755 | 36.838 | 70.497 | +0.10 |
| ATOM | 17 | C24 | MOL | 3 | 11.483 | 36.064 | 72.434 | −0.22 |
| ATOM | 18 | C30 | MOL | 3 | 9.839 | 34.901 | 75.515 | −0.38 |
| ATOM | 19 | C28 | MOL | 3 | 10.138 | 35.063 | 74.166 | −0.24 |
| ATOM | 20 | C27 | MOL | 3 | 11.629 | 36.404 | 76.092 | −0.38 |
| ATOM | 21 | C29 | MOL | 3 | 10.587 | 35.572 | 76.478 | −0.54 |
| ATOM | 22 | C26 | MOL | 3 | 11.181 | 35.897 | 73.780 | −0.26 |
| ATOM | 23 | C23 | MOL | 3 | 11.925 | 36.568 | 74.743 | −0.30 |
| ATOM | 24 | C21 | MOL | 3 | 12.967 | 37.399 | 74.351 | −0.25 |
| ATOM | 25 | C2 | MOL | 3 | 16.858 | 36.418 | 76.636 | −0.54 |
| ATOM | 26 | C6 | MOL | 3 | 17.578 | 35.307 | 77.056 | −0.61 |
| ATOM | 27 | C11 | MOL | 3 | 16.964 | 34.188 | 77.600 | −0.64 |
| ATOM | 28 | C15 | MOL | 3 | 15.586 | 34.159 | 77.739 | −0.69 |
| ATOM | 29 | N1 | MOL | 3 | 14.972 | 33.028 | 78.281 | −0.52 |
| ATOM | 30 | O2 | MOL | 3 | 14.651 | 33.025 | 79.413 | −0.21 |
| ATOM | 31 | O3 | MOL | 3 | 14.752 | 31.962 | 77.529 | −0.27 |
| ATOM | 32 | C10 | MOL | 3 | 14.836 | 35.257 | 77.331 | −0.54 |
| ATOM | 33 | C5 | MOL | 3 | 15.473 | 36.374 | 76.791 | −0.43 |
| ATOM | 34 | O8 | MOL | 3 | 18.089 | 39.372 | 78.044 | −0.15 |
| ATOM | 35 | C13 | MOL | 3 | 17.310 | 38.979 | 79.150 | −0.69 |
| END | | | | | | | | |
| REMARK | TTP-A Computed low-energy docking mode-4 | | | | | | | |
| REMARK | Free Energy of Binding = −11.24 kcal/mol | | | | | | | |
| ATOM | 1 | C9 | MOL | 4 | 10.690 | 36.976 | 72.708 | −0.14 |
| ATOM | 2 | C4 | MOL | 4 | 9.929 | 36.252 | 73.621 | −0.21 |
| ATOM | 3 | C12 | MOL | 4 | 10.923 | 38.314 | 72.951 | −0.11 |
| ATOM | 4 | C1 | MOL | 4 | 9.385 | 36.815 | 74.784 | −0.25 |
| ATOM | 5 | C3 | MOL | 4 | 9.642 | 38.198 | 75.029 | −0.27 |
| ATOM | 6 | C7 | MOL | 4 | 10.402 | 38.893 | 74.093 | −0.18 |
| ATOM | 7 | C14 | MOL | 4 | 11.267 | 36.340 | 71.449 | −0.17 |
| ATOM | 8 | C16 | MOL | 4 | 12.241 | 35.206 | 71.890 | −0.28 |
| ATOM | 9 | N17 | MOL | 4 | 12.937 | 35.491 | 73.119 | −0.17 |
| ATOM | 10 | H17 | MOL | 4 | 12.485 | 36.039 | 73.864 | +0.10 |
| ATOM | 11 | C18 | MOL | 4 | 14.251 | 35.003 | 73.278 | −0.27 |
| ATOM | 12 | O20 | MOL | 4 | 14.751 | 34.334 | 72.365 | −0.29 |
| ATOM | 13 | C19 | MOL | 4 | 15.059 | 35.261 | 74.498 | −0.42 |
| ATOM | 14 | C22 | MOL | 4 | 16.165 | 36.114 | 74.503 | −0.41 |
| ATOM | 15 | O25 | MOL | 4 | 16.584 | 36.781 | 73.342 | −0.21 |
| ATOM | 16 | H25 | MOL | 4 | 15.824 | 36.835 | 72.698 | −0.17 |
| ATOM | 17 | C24 | MOL | 4 | 16.876 | 36.310 | 75.681 | −0.50 |
| ATOM | 18 | C30 | MOL | 4 | 16.832 | 35.223 | 79.197 | −0.76 |
| ATOM | 19 | C28 | MOL | 4 | 17.215 | 35.870 | 78.027 | −0.58 |
| ATOM | 20 | C27 | MOL | 4 | 15.013 | 34.174 | 78.022 | −0.74 |
| ATOM | 21 | C29 | MOL | 4 | 15.729 | 34.375 | 79.194 | −0.69 |
| ATOM | 22 | C26 | MOL | 4 | 16.497 | 35.667 | 76.854 | −0.55 |
| ATOM | 23 | C23 | MOL | 4 | 15.397 | 34.818 | 76.851 | −0.55 |
| ATOM | 24 | C21 | MOL | 4 | 14.683 | 34.621 | 75.676 | −0.45 |
| ATOM | 25 | C2 | MOL | 4 | 8.571 | 35.757 | 75.595 | −0.37 |
| ATOM | 26 | C6 | MOL | 4 | 7.192 | 35.599 | 75.566 | −0.28 |
| ATOM | 27 | C11 | MOL | 4 | 6.540 | 34.626 | 76.311 | −0.35 |
| ATOM | 28 | C15 | MOL | 4 | 7.275 | 33.771 | 77.117 | −0.52 |
| ATOM | 29 | N1 | MOL | 4 | 6.615 | 32.797 | 77.870 | −0.34 |
| ATOM | 30 | O2 | MOL | 4 | 6.313 | 33.026 | 78.983 | −0.12 |
| ATOM | 31 | O3 | MOL | 4 | 6.333 | 31.619 | 77.337 | −0.05 |
| ATOM | 32 | C10 | MOL | 4 | 8.659 | 33.901 | 77.165 | −0.44 |
| ATOM | 33 | C5 | MOL | 4 | 9.294 | 34.882 | 76.405 | −0.52 |
| ATOM | 34 | O8 | MOL | 4 | 9.280 | 39.141 | 76.118 | −0.03 |
| ATOM | 35 | C13 | MOL | 4 | 8.017 | 39.717 | 76.363 | −0.25 |
| END | | | | | | | | |
| REMARK | TTP-A Computed low-energy docking mode-5 | | | | | | | |
| REMARK | Free Energy of Binding = −11.24 kcal/mol | | | | | | | |
| ATOM | 1 | C9 | MOL | 5 | 13.105 | 36.487 | 73.198 | −0.23 |
| ATOM | 2 | C4 | MOL | 5 | 11.920 | 36.000 | 72.657 | −0.23 |
| ATOM | 3 | C12 | MOL | 5 | 13.046 | 37.547 | 74.081 | −0.23 |
| ATOM | 4 | C1 | MOL | 5 | 10.659 | 36.532 | 72.965 | −0.18 |
| ATOM | 5 | C3 | MOL | 5 | 10.612 | 37.621 | 73.887 | −0.18 |
| ATOM | 6 | C7 | MOL | 5 | 11.817 | 38.087 | 74.405 | −0.18 |
| ATOM | 7 | C14 | MOL | 5 | 14.463 | 35.893 | 72.844 | −0.13 |
| ATOM | 8 | C16 | MOL | 5 | 14.872 | 34.918 | 73.989 | −0.37 |
| ATOM | 9 | N17 | MOL | 5 | 15.745 | 35.515 | 74.967 | −0.28 |
| ATOM | 10 | H17 | MOL | 5 | 16.727 | 35.724 | 74.738 | −0.00 |
| ATOM | 11 | C18 | MOL | 5 | 15.225 | 35.808 | 76.245 | −0.45 |
| ATOM | 12 | O20 | MOL | 5 | 14.035 | 35.558 | 76.475 | −0.04 |
| ATOM | 13 | C19 | MOL | 5 | 16.049 | 36.404 | 77.329 | −0.46 |
| ATOM | 14 | C22 | MOL | 5 | 16.163 | 37.784 | 77.517 | −0.33 |
| ATOM | 15 | O25 | MOL | 5 | 15.500 | 38.696 | 76.683 | −0.02 |
| ATOM | 16 | H25 | MOL | 5 | 14.531 | 38.465 | 76.641 | +0.09 |
| ATOM | 17 | C24 | MOL | 5 | 16.951 | 38.273 | 78.552 | −0.62 |
| ATOM | 18 | C30 | MOL | 5 | 19.086 | 37.030 | 81.280 | −0.78 |
| ATOM | 19 | C28 | MOL | 5 | 18.412 | 37.904 | 80.433 | −0.77 |
| ATOM | 20 | C27 | MOL | 5 | 18.187 | 35.158 | 80.063 | −0.78 |
| ATOM | 21 | C29 | MOL | 5 | 18.972 | 35.656 | 81.094 | −0.67 |
| ATOM | 22 | C26 | MOL | 5 | 17.626 | 37.405 | 79.401 | −0.59 |
| ATOM | 23 | C23 | MOL | 5 | 17.515 | 36.032 | 79.216 | −0.67 |
| ATOM | 24 | C21 | MOL | 5 | 16.727 | 35.539 | 78.184 | −0.65 |
| ATOM | 25 | C2 | MOL | 5 | 9.528 | 35.786 | 72.190 | −0.19 |
| ATOM | 26 | C6 | MOL | 5 | 9.139 | 36.037 | 70.880 | −0.13 |
| ATOM | 27 | C11 | MOL | 5 | 8.127 | 35.322 | 70.256 | −0.06 |
| ATOM | 28 | C15 | MOL | 5 | 7.470 | 34.317 | 70.946 | −0.22 |
| ATOM | 29 | N1 | MOL | 5 | 6.448 | 33.603 | 70.316 | −0.41 |
| ATOM | 30 | O2 | MOL | 5 | 5.410 | 34.120 | 70.120 | +0.13 |
| ATOM | 31 | O3 | MOL | 5 | 6.642 | 32.348 | 69.943 | −0.23 |
| ATOM | 32 | C10 | MOL | 5 | 7.838 | 34.037 | 72.258 | −0.34 |
| ATOM | 33 | C5 | MOL | 5 | 8.860 | 34.764 | 72.865 | −0.31 |
| ATOM | 34 | O8 | MOL | 5 | 9.514 | 38.430 | 74.478 | +0.14 |
| ATOM | 35 | C13 | MOL | 5 | 8.926 | 38.269 | 75.749 | −0.34 |
| END | | | | | | | | |

TABLE 4

| REMARK | 4 | | | | | | | | |
|---|---|---|---|---|---|---|---|---|---|
| REMARK | Computed Free energy of binding = −10.68 kcal/mol | | | | | | | | |
| REMARK | TTP-B Computed low-energy docking mode-1 | | | | | | | | |
| ATOM | 1 | C1 | TTB | 1 | 16.460 | 36.607 | 76.845 | −0.00 | 0.51 |
| ATOM | 2 | C3 | TTB | 1 | 15.068 | 36.607 | 76.816 | −0.00 | 0.27 |
| ATOM | 3 | C4 | TTB | 1 | 17.148 | 35.418 | 77.039 | −0.00 | 0.61 |
| ATOM | 4 | C7 | TTB | 1 | 14.360 | 35.417 | 76.974 | −0.00 | 0.51 |
| ATOM | 5 | C8 | TTB | 1 | 16.447 | 34.230 | 77.202 | −0.00 | 0.66 |
| ATOM | 6 | C12 | TTB | 1 | 15.058 | 34.223 | 77.169 | −0.00 | 0.63 |
| ATOM | 7 | C2 | TTB | 1 | 17.213 | 37.852 | 76.663 | −0.00 | 0.48 |
| ATOM | 8 | C5 | TTB | 1 | 17.535 | 38.651 | 77.755 | −0.00 | 0.51 |
| ATOM | 9 | C9 | TTB | 1 | 18.241 | 39.834 | 77.565 | −0.00 | 0.51 |
| ATOM | 10 | C13 | TTB | 1 | 18.621 | 40.220 | 76.284 | −0.00 | 0.44 |
| ATOM | 11 | C | TTB | 1 | 19.378 | 41.498 | 76.076 | −0.00 | 0.34 |
| ATOM | 12 | F2 | TTB | 1 | 19.510 | 42.182 | 77.268 | −0.00 | 0.28 |
| ATOM | 13 | F3 | TTB | 1 | 20.635 | 41.175 | 75.610 | −0.00 | 0.35 |
| ATOM | 14 | F4 | TTB | 1 | 18.761 | 42.258 | 75.105 | −0.00 | 0.12 |
| ATOM | 15 | C10 | TTB | 1 | 18.301 | 39.422 | 75.193 | −0.00 | 0.36 |
| ATOM | 16 | C6 | TTB | 1 | 17.596 | 38.240 | 75.383 | −0.00 | 0.40 |
| ATOM | 17 | C11 | TTB | 1 | 12.874 | 35.461 | 76.923 | −0.00 | 0.57 |
| ATOM | 18 | O15 | TTB | 1 | 12.223 | 34.713 | 77.662 | −0.00 | 0.12 |
| ATOM | 19 | N14 | TTB | 1 | 12.209 | 36.345 | 76.056 | −0.00 | 0.26 |
| ATOM | 20 | C17 | TTB | 1 | 10.796 | 36.441 | 76.065 | −0.00 | 0.46 |
| ATOM | 21 | C18 | TTB | 1 | 10.270 | 35.386 | 75.053 | −0.00 | 0.34 |
| ATOM | 22 | C20 | TTB | 1 | 9.070 | 34.590 | 75.558 | −0.00 | 0.42 |
| ATOM | 23 | C23 | TTB | 1 | 7.858 | 34.704 | 74.888 | −0.00 | 0.30 |
| ATOM | 24 | C26 | TTB | 1 | 6.751 | 33.978 | 75.314 | −0.00 | 0.29 |
| ATOM | 25 | C28 | TTB | 1 | 6.852 | 33.133 | 76.413 | −0.00 | 0.37 |
| ATOM | 26 | C29 | TTB | 1 | 5.684 | 32.375 | 76.857 | −0.00 | 0.37 |
| ATOM | 27 | C30 | TTB | 1 | 4.745 | 32.975 | 77.688 | −0.00 | 0.28 |
| ATOM | 28 | C32 | TTB | 1 | 3.634 | 32.260 | 78.113 | −0.00 | 0.21 |
| ATOM | 29 | C34 | TTB | 1 | 3.460 | 30.940 | 77.709 | −0.00 | 0.27 |
| ATOM | 30 | F36 | TTB | 1 | 2.387 | 30.249 | 78.123 | −0.00 | 0.18 |
| ATOM | 31 | C33 | TTB | 1 | 4.397 | 30.339 | 76.879 | −0.00 | 0.43 |
| ATOM | 32 | C31 | TTB | 1 | 5.510 | 31.056 | 76.451 | −0.00 | 0.47 |
| ATOM | 33 | C27 | TTB | 1 | 8.062 | 33.011 | 77.085 | −0.00 | 0.43 |
| ATOM | 34 | C24 | TTB | 1 | 9.168 | 33.737 | 76.656 | −0.00 | 0.47 |
| ATOM | 35 | C19 | TTB | 1 | 10.463 | 37.836 | 75.633 | −0.00 | 0.21 |
| ATOM | 36 | O22 | TTB | 1 | 11.083 | 38.357 | 74.697 | 0.00 | 0.09 |
| ATOM | 37 | O21 | TTB | 1 | 9.471 | 38.542 | 76.299 | −0.00 | 0.06 |
| ATOM | 38 | C25 | TTB | 1 | 9.019 | 39.626 | 75.493 | −0.00 | 0.28 |
| ATOM | 39 | O16 | TTB | 1 | 14.394 | 33.003 | 77.335 | −0.00 | 0.15 |
| ATOM | 40 | H14 | TTB | 1 | 12.755 | 36.931 | 75.407 | 0.00 | 0.09 |
| ATOM | 41 | H16 | TTB | 1 | 14.333 | 32.541 | 76.458 | 0.00 | 0.03 |
| END | | | | | | | | | |
| REMARK | 4 | | | | | | | | |
| REMARK | TTP-B Computed low-energy docking mode-2 | | | | | | | | |
| REMARK | Computed Free energy of binding = −9.51 kcal/mol | | | | | | | | |
| ATOM | 1 | C1 | TTB | 2 | 11.151 | 36.020 | 75.575 | −0.00 | 0.41 |
| ATOM | 2 | C3 | TTB | 2 | 10.922 | 35.738 | 74.231 | −0.00 | 0.28 |
| ATOM | 3 | C4 | TTB | 2 | 10.133 | 36.554 | 76.352 | −0.00 | 0.50 |
| ATOM | 4 | C7 | TTB | 2 | 9.674 | 35.983 | 73.662 | −0.00 | 0.22 |
| ATOM | 5 | C8 | TTB | 2 | 8.888 | 36.804 | 75.789 | −0.00 | 0.37 |
| ATOM | 6 | C12 | TTB | 2 | 8.654 | 36.520 | 74.449 | −0.00 | 0.20 |
| ATOM | 7 | C2 | TTB | 2 | 12.456 | 35.751 | 76.186 | −0.00 | 0.49 |
| ATOM | 8 | C5 | TTB | 2 | 12.595 | 34.762 | 77.154 | −0.00 | 0.54 |
| ATOM | 9 | C9 | TTB | 2 | 13.838 | 34.526 | 77.732 | −0.00 | 0.65 |
| ATOM | 10 | C13 | TTB | 2 | 14.940 | 35.280 | 77.344 | −0.00 | 0.53 |
| ATOM | 11 | C | TTB | 2 | 16.280 | 35.031 | 77.970 | −0.00 | 0.65 |
| ATOM | 12 | F2 | TTB | 2 | 17.004 | 36.205 | 78.046 | −0.00 | 0.44 |
| ATOM | 13 | F3 | TTB | 2 | 16.070 | 34.559 | 79.248 | −0.00 | 0.54 |
| ATOM | 14 | F4 | TTB | 2 | 16.951 | 34.050 | 77.273 | −0.00 | 0.52 |
| ATOM | 15 | C10 | TTB | 2 | 14.803 | 36.268 | 76.377 | −0.00 | 0.42 |
| ATOM | 16 | C6 | TTB | 2 | 13.562 | 36.503 | 75.799 | −0.00 | 0.37 |
| ATOM | 17 | C11 | TTB | 2 | 9.471 | 35.654 | 72.225 | −0.00 | 0.20 |
| ATOM | 18 | O15 | TTB | 2 | 9.001 | 34.550 | 71.921 | −0.00 | 0.23 |
| ATOM | 19 | N14 | TTB | 2 | 9.794 | 36.582 | 71.220 | −0.00 | 0.12 |
| ATOM | 20 | C17 | TTB | 2 | 9.527 | 36.296 | 69.859 | −0.00 | 0.12 |
| ATOM | 21 | C18 | TTB | 2 | 10.801 | 36.688 | 69.061 | −0.00 | 0.11 |
| ATOM | 22 | C20 | TTB | 2 | 11.963 | 35.716 | 69.239 | −0.00 | 0.17 |
| ATOM | 23 | C23 | TTB | 2 | 12.818 | 35.881 | 70.323 | −0.00 | 0.22 |
| ATOM | 24 | C26 | TTB | 2 | 13.876 | 35.001 | 70.522 | −0.00 | 0.30 |
| ATOM | 25 | C28 | TTB | 2 | 14.084 | 33.950 | 69.636 | −0.00 | 0.31 |
| ATOM | 26 | C29 | TTB | 2 | 15.200 | 33.030 | 69.849 | −0.00 | 0.40 |
| ATOM | 27 | C30 | TTB | 2 | 16.254 | 32.999 | 68.944 | −0.00 | 0.39 |
| ATOM | 28 | C32 | TTB | 2 | 17.316 | 32.127 | 69.141 | −0.00 | 0.48 |
| ATOM | 29 | C34 | TTB | 2 | 17.326 | 31.282 | 70.245 | −0.00 | 0.62 |
| ATOM | 30 | F36 | TTB | 2 | 18.351 | 30.438 | 70.433 | −0.00 | 0.52 |
| ATOM | 31 | C33 | TTB | 2 | 16.273 | 31.311 | 71.152 | −0.00 | 0.62 |
| ATOM | 32 | C31 | TTB | 2 | 15.209 | 32.185 | 70.955 | −0.00 | 0.51 |
| ATOM | 33 | C27 | TTB | 2 | 13.232 | 33.776 | 68.553 | −0.00 | 0.06 |
| ATOM | 34 | C24 | TTB | 2 | 12.173 | 34.657 | 68.357 | −0.00 | 0.15 |
| ATOM | 35 | C19 | TTB | 2 | 8.350 | 37.140 | 69.473 | −0.00 | 0.07 |
| ATOM | 36 | O22 | TTB | 2 | 8.431 | 38.373 | 69.525 | 0.00 | 0.23 |
| ATOM | 37 | O21 | TTB | 2 | 7.170 | 36.528 | 69.074 | 0.00 | 0.20 |
| ATOM | 38 | C25 | TTB | 2 | 6.157 | 36.738 | 70.054 | −0.00 | 0.04 |
| ATOM | 39 | O16 | TTB | 2 | 7.384 | 36.786 | 73.924 | 0.00 | 0.19 |
| ATOM | 40 | H14 | TTB | 2 | 10.230 | 37.479 | 71.476 | 0.00 | 0.12 |
| ATOM | 41 | H16 | TTB | 2 | 6.855 | 35.946 | 73.905 | 0.00 | 0.11 |
| END | | | | | | | | | |
| REMARK | 4 | | | | | | | | |
| REMARK | TTP-B Computed low-energy docking mode-3 | | | | | | | | |
| REMARK | Computed Free energy of binding = −9.72 kcal/mol | | | | | | | | |
| ATOM | 1 | C1 | TTB | 3 | 16.497 | 36.818 | 77.723 | −0.00 | 0.50 |
| ATOM | 2 | C3 | TTB | 3 | 15.398 | 36.382 | 76.989 | −0.00 | 0.37 |
| ATOM | 3 | C4 | TTB | 3 | 16.865 | 36.149 | 78.882 | −0.00 | 0.68 |
| ATOM | 4 | C7 | TTB | 3 | 14.666 | 35.272 | 77.408 | −0.00 | 0.52 |
| ATOM | 5 | C8 | TTB | 3 | 16.137 | 35.044 | 79.305 | −0.00 | 0.74 |
| ATOM | 6 | C12 | TTB | 3 | 15.041 | 34.602 | 78.574 | −0.00 | 0.72 |
| ATOM | 7 | C2 | TTB | 3 | 17.281 | 37.975 | 77.281 | −0.00 | 0.43 |
| ATOM | 8 | C5 | TTB | 3 | 17.913 | 37.972 | 76.042 | −0.00 | 0.20 |
| ATOM | 9 | C9 | TTB | 3 | 18.662 | 39.074 | 75.642 | −0.00 | 0.26 |
| ATOM | 10 | C13 | TTB | 3 | 18.782 | 40.175 | 76.482 | −0.00 | 0.47 |
| ATOM | 11 | C | TTB | 3 | 19.594 | 41.362 | 76.055 | −0.00 | 0.37 |
| ATOM | 12 | F2 | TTB | 3 | 19.158 | 42.503 | 76.698 | −0.00 | 0.23 |
| ATOM | 13 | F3 | TTB | 3 | 20.905 | 41.128 | 76.411 | −0.00 | 0.39 |
| ATOM | 14 | F4 | TTB | 3 | 19.556 | 41.491 | 74.683 | −0.00 | 0.18 |
| ATOM | 15 | C10 | TTB | 3 | 18.150 | 40.181 | 77.719 | −0.00 | 0.43 |
| ATOM | 16 | C6 | TTB | 3 | 17.402 | 39.081 | 78.118 | −0.00 | 0.61 |
| ATOM | 17 | C11 | TTB | 3 | 13.506 | 34.832 | 76.586 | −0.00 | 0.54 |
| ATOM | 18 | O15 | TTB | 3 | 13.425 | 33.646 | 76.245 | 0.00 | 0.14 |
| ATOM | 19 | N14 | TTB | 3 | 12.506 | 35.744 | 76.206 | −0.00 | 0.31 |
| ATOM | 20 | C17 | TTB | 3 | 11.364 | 35.307 | 75.490 | −0.00 | 0.35 |
| ATOM | 21 | C18 | TTB | 3 | 11.085 | 36.377 | 74.398 | −0.00 | 0.27 |
| ATOM | 22 | C20 | TTB | 3 | 12.345 | 36.921 | 73.732 | −0.00 | 0.22 |
| ATOM | 23 | C23 | TTB | 3 | 13.086 | 36.082 | 72.908 | −0.00 | 0.25 |
| ATOM | 24 | C26 | TTB | 3 | 14.229 | 36.554 | 72.273 | −0.00 | 0.15 |
| ATOM | 25 | C28 | TTB | 3 | 14.638 | 37.870 | 72.458 | −0.00 | 0.18 |
| ATOM | 26 | C29 | TTB | 3 | 15.842 | 38.359 | 71.790 | −0.00 | 0.11 |
| ATOM | 27 | C30 | TTB | 3 | 15.774 | 38.788 | 70.470 | −0.00 | 0.13 |
| ATOM | 28 | C32 | TTB | 3 | 16.915 | 39.253 | 69.830 | −0.00 | 0.14 |
| ATOM | 29 | C34 | TTB | 3 | 18.128 | 39.288 | 70.510 | −0.00 | 0.22 |
| ATOM | 30 | F36 | TTB | 3 | 19.230 | 39.736 | 69.889 | −0.00 | 0.17 |
| ATOM | 31 | C33 | TTB | 3 | 18.198 | 38.860 | 71.829 | −0.00 | 0.32 |
| ATOM | 32 | C31 | TTB | 3 | 17.055 | 38.395 | 72.471 | −0.00 | 0.25 |
| ATOM | 33 | C27 | TTB | 3 | 13.900 | 38.716 | 73.277 | −0.00 | 0.16 |
| ATOM | 34 | C24 | TTB | 3 | 12.756 | 38.242 | 73.910 | −0.00 | 0.19 |
| ATOM | 35 | C19 | TTB | 3 | 10.246 | 35.227 | 76.485 | −0.00 | 0.52 |
| ATOM | 36 | O22 | TTB | 3 | 9.666 | 36.259 | 76.846 | −0.00 | 0.11 |
| ATOM | 37 | O21 | TTB | 3 | 9.881 | 33.994 | 77.008 | −0.00 | 0.17 |
| ATOM | 38 | C25 | TTB | 3 | 8.461 | 33.878 | 77.034 | −0.00 | 0.54 |
| ATOM | 39 | O16 | TTB | 3 | 14.339 | 33.484 | 79.037 | −0.00 | 0.10 |
| ATOM | 40 | H14 | TTB | 3 | 12.604 | 36.740 | 76.451 | 0.00 | 0.07 |
| ATOM | 41 | H16 | TTB | 3 | 13.868 | 33.718 | 79.880 | −0.00 | 0.28 |
| END | | | | | | | | | |
| REMARK | 4 | | | | | | | | |
| REMARK | TTP-B Computed low-energy docking mode-4 | | | | | | | | |
| REMARK | Computed Free energy of binding = −10.23 kcal/mol | | | | | | | | |
| ATOM | 1 | C1 | TTB | 4 | 17.143 | 39.598 | 75.386 | −0.00 | 0.31 |
| ATOM | 2 | C3 | TTB | 4 | 17.445 | 38.517 | 76.209 | −0.00 | 0.44 |
| ATOM | 3 | C4 | TTB | 4 | 16.386 | 39.404 | 74.239 | −0.00 | 0.23 |
| ATOM | 4 | C7 | TTB | 4 | 16.986 | 37.239 | 75.892 | −0.00 | 0.48 |
| ATOM | 5 | C8 | TTB | 4 | 15.929 | 38.132 | 73.917 | −0.00 | 0.28 |
| ATOM | 6 | C12 | TTB | 4 | 16.224 | 37.051 | 74.737 | −0.00 | 0.41 |
| ATOM | 7 | C2 | TTB | 4 | 17.609 | 40.947 | 75.720 | −0.00 | 0.27 |
| ATOM | 8 | C5 | TTB | 4 | 16.917 | 41.727 | 76.641 | −0.00 | 0.29 |
| ATOM | 9 | C9 | TTB | 4 | 17.367 | 43.009 | 76.940 | −0.00 | 0.16 |
| ATOM | 10 | C13 | TTB | 4 | 18.503 | 43.512 | 76.315 | −0.00 | 0.18 |
| ATOM | 11 | C | TTB | 4 | 18.985 | 44.897 | 76.631 | −0.00 | 0.12 |
| ATOM | 12 | F2 | TTB | 4 | 17.946 | 45.676 | 77.099 | −0.00 | 0.09 |
| ATOM | 13 | F3 | TTB | 4 | 19.942 | 44.796 | 77.619 | −0.00 | 0.15 |
| ATOM | 14 | F4 | TTB | 4 | 19.593 | 45.448 | 75.524 | −0.00 | 0.03 |
| ATOM | 15 | C10 | TTB | 4 | 19.194 | 42.733 | 75.396 | −0.00 | 0.16 |
| ATOM | 16 | C6 | TTB | 4 | 18.747 | 41.453 | 75.098 | −0.00 | 0.22 |
| ATOM | 17 | C11 | TTB | 4 | 17.321 | 36.115 | 76.808 | −0.00 | 0.49 |
| ATOM | 18 | O15 | TTB | 4 | 18.340 | 35.448 | 76.594 | 0.00 | 0.20 |
| ATOM | 19 | N14 | TTB | 4 | 16.501 | 35.815 | 77.909 | −0.00 | 0.35 |
| ATOM | 20 | C17 | TTB | 4 | 16.864 | 34.795 | 78.823 | −0.00 | 0.70 |
| ATOM | 21 | C18 | TTB | 4 | 15.710 | 33.755 | 78.814 | −0.00 | 0.52 |
| ATOM | 22 | C20 | TTB | 4 | 14.449 | 34.240 | 78.105 | −0.00 | 0.72 |
| ATOM | 23 | C23 | TTB | 4 | 13.472 | 34.897 | 78.844 | −0.00 | 0.25 |
| ATOM | 24 | C26 | TTB | 4 | 12.320 | 35.366 | 78.223 | −0.00 | 0.39 |
| ATOM | 25 | C28 | TTB | 4 | 12.138 | 35.180 | 76.857 | −0.00 | 0.61 |
| ATOM | 26 | C29 | TTB | 4 | 10.923 | 35.673 | 76.211 | −0.00 | 0.53 |
| ATOM | 27 | C30 | TTB | 4 | 9.795 | 34.865 | 76.154 | −0.00 | 0.51 |
| ATOM | 28 | C32 | TTB | 4 | 8.638 | 35.328 | 75.541 | −0.00 | 0.39 |
| ATOM | 29 | C34 | TTB | 4 | 8.609 | 36.601 | 74.983 | −0.00 | 0.25 |
| ATOM | 30 | F36 | TTB | 4 | 7.491 | 37.046 | 74.388 | −0.00 | 0.10 |
| ATOM | 31 | C33 | TTB | 4 | 9.736 | 37.411 | 75.039 | −0.00 | 0.29 |
| ATOM | 32 | C31 | TTB | 4 | 10.895 | 36.948 | 75.654 | −0.00 | 0.35 |
| ATOM | 33 | C27 | TTB | 4 | 13.112 | 34.528 | 76.111 | −0.00 | 0.36 |
| ATOM | 34 | C24 | TTB | 4 | 14.265 | 34.061 | 76.735 | −0.00 | 0.58 |
| ATOM | 35 | C19 | TTB | 4 | 17.003 | 35.456 | 80.161 | −0.00 | 0.75 |
| ATOM | 36 | O22 | TTB | 4 | 16.055 | 36.094 | 80.636 | −0.00 | 0.01 |
| ATOM | 37 | O21 | TTB | 4 | 18.203 | 35.360 | 80.851 | −0.00 | 0.28 |
| ATOM | 38 | C25 | TTB | 4 | 18.897 | 36.603 | 80.797 | −0.00 | 0.80 |
| ATOM | 39 | O16 | TTB | 4 | 15.741 | 35.788 | 74.375 | −0.00 | 0.06 |
| ATOM | 40 | H14 | TTB | 4 | 15.628 | 36.342 | 78.054 | −0.00 | 0.17 |
| ATOM | 41 | H16 | TTB | 4 | 14.949 | 35.568 | 74.931 | 0.00 | 0.10 |
| END | | | | | | | | | |
| REMARK | 4 | | | | | | | | |
| REMARK | TTP-B Computed low-energy docking mode-5 | | | | | | | | |
| REMARK | Computed Free energy of binding = −8.81 kcal/mol | | | | | | | | |
| ATOM | 1 | C1 | TTB | 5 | 4.526 | 31.683 | 76.605 | −0.00 | 0.33 |
| ATOM | 2 | C3 | TTB | 5 | 5.097 | 32.667 | 75.804 | −0.00 | 0.30 |
| ATOM | 3 | C4 | TTB | 5 | 5.268 | 31.104 | 77.625 | −0.00 | 0.41 |
| ATOM | 4 | C7 | TTB | 5 | 6.410 | 33.080 | 76.022 | −0.00 | 0.31 |
| ATOM | 5 | C8 | TTB | 5 | 6.579 | 31.509 | 77.844 | −0.00 | 0.56 |
| ATOM | 6 | C12 | TTB | 5 | 7.152 | 32.494 | 77.050 | −0.00 | 0.48 |
| ATOM | 7 | C2 | TTB | 5 | 3.140 | 31.254 | 76.392 | −0.00 | 0.29 |
| ATOM | 8 | C5 | TTB | 5 | 2.845 | 29.923 | 76.117 | −0.00 | 0.35 |
| ATOM | 9 | C9 | TTB | 5 | 1.526 | 29.534 | 75.908 | −0.00 | 0.32 |
| ATOM | 10 | C13 | TTB | 5 | 0.504 | 30.475 | 75.970 | −0.00 | 0.26 |
| ATOM | 11 | C | TTB | 5 | −0.918 | 30.059 | 75.738 | −0.00 | 0.19 |
| ATOM | 12 | F2 | TTB | 5 | −1.743 | 30.598 | 76.705 | −0.00 | 0.04 |
| ATOM | 13 | F3 | TTB | 5 | −1.306 | 30.543 | 74.507 | −0.00 | 0.17 |
| ATOM | 14 | F4 | TTB | 5 | −1.004 | 28.684 | 75.686 | −0.00 | 0.23 |
| ATOM | 15 | C10 | TTB | 5 | 0.798 | 31.805 | 76.246 | −0.00 | 0.14 |
| ATOM | 16 | C6 | TTB | 5 | 2.115 | 32.193 | 76.456 | −0.00 | 0.17 |
| ATOM | 17 | C11 | TTB | 5 | 6.976 | 34.145 | 75.150 | −0.00 | 0.29 |
| ATOM | 18 | O15 | TTB | 5 | 7.833 | 33.843 | 74.311 | −0.00 | 0.18 |
| ATOM | 19 | N14 | TTB | 5 | 6.540 | 35.476 | 75.264 | −0.00 | 0.11 |
| ATOM | 20 | C17 | TTB | 5 | 7.023 | 36.473 | 74.380 | −0.00 | 0.14 |
| ATOM | 21 | C18 | TTB | 5 | 7.909 | 37.429 | 75.225 | −0.00 | 0.23 |
| ATOM | 22 | C20 | TTB | 5 | 9.314 | 36.895 | 75.489 | −0.00 | 0.35 |
| ATOM | 23 | C23 | TTB | 5 | 10.230 | 36.867 | 74.443 | −0.00 | 0.24 |
| ATOM | 24 | C26 | TTB | 5 | 11.523 | 36.403 | 74.656 | −0.00 | 0.30 |
| ATOM | 25 | C28 | TTB | 5 | 11.908 | 35.965 | 75.918 | −0.00 | 0.45 |
| ATOM | 26 | C29 | TTB | 5 | 13.268 | 35.476 | 76.134 | −0.00 | 0.47 |
| ATOM | 27 | C30 | TTB | 5 | 13.473 | 34.177 | 76.583 | −0.00 | 0.49 |
| ATOM | 28 | C32 | TTB | 5 | 14.762 | 33.707 | 76.790 | −0.00 | 0.61 |
| ATOM | 29 | C34 | TTB | 5 | 15.852 | 34.538 | 76.551 | −0.00 | 0.57 |
| ATOM | 30 | F36 | TTB | 5 | 17.098 | 34.083 | 76.755 | −0.00 | 0.57 |
| ATOM | 31 | C33 | TTB | 5 | 15.650 | 35.837 | 76.103 | −0.00 | 0.46 |
| ATOM | 32 | C31 | TTB | 5 | 14.357 | 36.308 | 75.893 | −0.00 | 0.40 |
| ATOM | 33 | C27 | TTB | 5 | 11.000 | 35.995 | 76.969 | −0.00 | 0.41 |
| ATOM | 34 | C24 | TTB | 5 | 9.707 | 36.461 | 76.754 | −0.00 | 0.36 |
| ATOM | 35 | C19 | TTB | 5 | 5.817 | 37.174 | 73.834 | −0.00 | 0.06 |
| ATOM | 36 | O22 | TTB | 5 | 5.068 | 37.798 | 74.596 | 0.00 | 0.21 |
| ATOM | 37 | O21 | TTB | 5 | 5.540 | 37.104 | 72.475 | 0.00 | 0.22 |
| ATOM | 38 | C25 | TTB | 5 | 4.369 | 37.860 | 72.178 | −0.00 | 0.01 |
| ATOM | 39 | O16 | TTB | 5 | 8.474 | 32.873 | 77.308 | −0.00 | 0.21 |
| ATOM | 40 | H14 | TTB | 5 | 5.863 | 35.730 | 75.997 | 0.00 | 0.11 |
| ATOM | 41 | H16 | TTB | 5 | 8.626 | 32.887 | 78.289 | −0.00 | 0.09 |
| END | | | | | | | | | |

TABLE 5
Atomic Interactions Between I7L and TTP-A

| TTP-A Atom¹ | I7L Atom² | Distance (Angstoms) | Interaction type |
|---|---|---|---|
| O2 | Cys328 - SG | 3.18 | Charge |
| O3 | Gly329 - N | 3.62 | Charge |
| C10 | Trp168 - CB | 3.34 | Hydrophobic |
| O8 | Asn171 - N | 2.86 | Hydrogen bond |
| C12 | Met195 - SG | 3.74 | Hydrophobic |
| O25 | Asn199 - OD1 | 3.26 | Hydrogen bond |
| H17 | Phe236 - O | 1.86 | Hydrogen bond |
| C24 | Ile203 - CD1 | 4.79 | Hydrophobic |
| C14 | Met195 - SG | 3.33 | Hydrophobic |
| O2 | Ser240 - OG | 3.76 | Hydrogen bond |

¹Designations for atoms on TTP-A are as shown in FIG. 6
²Designations for atoms in I7L are as shown in Table 2

TABLE 6
Atomic Interactions Between I7L and TTP-B

| TTP-B Atom¹ | I7L Atom² | Distance (Angstoms) | Interaction type |
|---|---|---|---|
| O21 | Cys328 - SG | 3.07 | Electrostatic |
| C25 | Met169 - CB | 3.70 | Hydrophobic |
| O22 | His241 - N | 3.08 | Hydrogen bond |
| O15 | Asn171 - N | 2.87 | Hydrogen bond |
| H14 | Leu239 - O | 2.20 | Hydrogen bond |
| O16 | Asn171 - ND2 | 3.50 | Hydrogen bond |
| C26 | Leu239 - CA | 3.06 | Hydrophobic |
| C27 | Met195 - SD | 3.24 | Hydrophobic |
| C9 | Trp168 - CE3 | 3.12 | Hydrophobic |
| C5 | Leu239 - CD1 | 3.97 | Hydrophobic |

¹Designations for atoms on TTP-B are as shown in FIG. 6
²Designations for atoms in I7L are as shown in Table 2

1. A method for identifying a compound having the ability to modulate virus propagation in a host cell comprising the steps of:
(a) generating a three-dimensional model of a protein required for viability of a virus, or a portion thereof;
(b) generating a three-dimensional model of a potential modulator compound of interest; and
(c) determining at least one atomic interaction between the potential modulator compound and the protein, or a portion thereof, as defined by the three-dimensional models of (a) and (b).

2-6. (canceled)

7. Compounds identified by the method of claim 1.

8. A method for identifying a compound having the ability to modulate orthopox virus propagation in a host cell comprising the steps of:
(a) generating a three-dimensional model of an I7L protein, or a portion thereof,
(b) generating a three-dimensional model of a potential modulator compound of interest; and
(c) determining at least one atomic interaction between the potential modulator compound and the I7L, or a portion thereof, as defined by the three-dimensional models of (a) and (b).

9-28. (canceled)

29. Compounds identified by the method of claim 8.

30. A method of generating a three-dimensional model of a protein, or a portion thereof, comprising the steps of: (a) providing an amino acid sequence of a protein of interest; (b) comparing the amino acid sequence of the protein of interest to the amino acid sequences for a plurality of other proteins; (c) using the plurality of proteins to identify a second protein for which a three-dimensional structure has been defined, and that has a predetermined level of sequence identity to the protein of interest; (d) aligning conserved residues from the protein of interest with conserved residues from the second protein; and (e) threading the protein of interest along the three-dimensional structure of the second protein such that a position of at least two conserved residues from both proteins are aligned.

31-34. (canceled)

35. A computer model for I7L protein, or a portion thereof, comprising atomic coordinates for a three-dimensional model for I7L protein, or a portion thereof, operable to be visualizable on a computer screen.

36-44. (canceled)

45. A pharmacophore comprising at least one atom that interacts with at least one atom of an I7L protein, or a portion thereof.

46-54. (canceled)

55. A compound comprising at least one atom that that interacts with at least one atom of an I7L protein, or a portion thereof, to modulate the activity of I7L.

56-66. (canceled)

67. A pharmaceutical composition comprising a compound identified by docking a computer representation of the compound with a computer representation of a structure of I7L protein, or a portion thereof.

68-78. (canceled)

79. A method of conducting a drug discovery business comprising:
(a) generating a three-dimensional structural model of a target molecule of interest on a computer;
(b) generating a three-dimensional structural model of a potential modulator compound of the target molecule of interest on a computer; and
(c) docking the model for the potential modulator compound with the target molecule of interest so as to minimize the free energy of the interaction between the target molecule and the potential modulator.

80. (canceled)

81. A method of treating orthopox infections comprising administering a therapeutically effective amount of a compound identified by the steps of:
(a) generating a three-dimensional model of a I7L protein, or a portion thereof,
(b) generating a three-dimensional model of a potential modulator compound of interest; and
(c) determining the atomic interactions between the potential modulator compound and the I7L protein, or a portion thereof, as defined by the three-dimensional models of (a) and (b).


SEQUENCE LISTING (1 sequence)

SEQ ID NO: 1 - protein, 260 aa, Vaccinia virus
KPRLREKVSKAIDFSQMDLKIDDLSRKGIHTGENPKVVKMKIEPERGAWMSNRSIKNLVSQFAYGSEVDYIGQFDMRFLNSLAIHEKFDAFMNKHILSYILKDKIKSSTSRFVMFGFCYLSHWKCVIYDKKQCLVSFYDSGGNIPTEFHHYNNFYFYSFSDGFNTNHRHSVLDNTNCDIDVLFRFFECTFGAKIGCINVEVNQLLESECGMFISLFMILCTRTPPKSFKSLKKVYTFFKFLADKKMTLFKSILFNLHDLS